(19) United States
(12) Patent Application Publication
(10) Pub. No.: US 2026/0186630 A1
(43) Pub. Date: Jul. 2, 2026

(54) DEVICES, METHODS, AND GRAPHICAL USER INTERFACES FOR DISPLAYING VIRTUAL OBJECTS ASSOCIATED WITH PHYSICAL LOCATIONS

(71) Applicant: Apple Inc., Cupertino, CA (US)

(72) Inventors: Vincent P. ARROYO, Union City, CA (US); Devin FLOOD, Los Angeles, CA (US); Giovanni S. LUIS, Manhattan Beach, CA (US); Rachel F. NEEDLE, New York, NY (US); William N. DANNER, Santa Cruz, CA (US); Chloe J. KRAWCZYK, San Francisco, CA (US); Benjamin H. BOESEL, Jackson, WY (US)

(21) Appl. No.: 19/313,565

(22) Filed: Aug. 28, 2025

Related U.S. Application Data
(60) Provisional application No. 63/700,660, filed on Sep. 28, 2024.
(60) Provisional application No. 63/771,541, filed on Mar. 13, 2025.

(51) Int. Cl. G06F 3/0484; G06F 3/0481

(52) U.S. Cl. CPC G06F 3/0484; G06F 3/0481; G06F 2203/04806

(57) ABSTRACT

In some embodiments, a computer system computer system dynamically presents content in response to user input. In some embodiments, the computer system dynamically presents user interface elements according to one or more appearance conditions in response to detecting an event. In some embodiments, the computer system presents relevant content in response to user input. In some embodiments, the computer system presents user interface elements based on a location of a user of the computer system. In some embodiments, the computer system presents spatial audio corresponding to content. In some embodiments, the computer system provides navigation assistance.

### CROSS REFERENCE TO RELATED APPLICATIONS

This application claims the benefit of U.S. Provisional Application No. 63/771,541, filed Mar. 13, 2025, and U.S. Provisional Application No. 63/700,660, filed Sep. 28, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system dynamically presents content in response to user input. In some embodiments, the computer system dynamically presents user interface elements according to one or more appearance conditions in response to detecting an event. In some embodiments, the computer system presents relevant content in response to user input. In some embodiments, the computer system presents user interface elements based on a location of a user of the computer system. In some embodiments, the computer system presents spatial audio corresponding to content. In some embodiments, the computer system provides navigation assistance.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7Q illustrate examples of a computer system dynamically presenting content in response to user input in accordance with some embodiments.

FIG. 8 is a flowchart illustrating an exemplary method of dynamically presenting content in response to user input in accordance with some embodiments.

FIGS. 9A-9F illustrate examples of a computer system dynamically presenting user interface elements according to one or more appearance conditions in response to detecting an event in accordance with some embodiments.

FIG. 10 is a flowchart illustrating an exemplary method of dynamically presenting user interface elements according to one or more appearance conditions in response to detecting an event in accordance with some embodiments.

FIGS. 11A-11G illustrate examples of a computer system presenting relevant content in response to user input in accordance with some embodiments.

FIG. 12 is a flowchart illustrating an exemplary method of presenting relevant content in response to user input in accordance with some embodiments.

FIGS. 13A-13I illustrate examples of a computer system presenting user interface elements based on a location of a user of the computer system in accordance with some embodiments.

FIG. 14 is a flowchart illustrating an exemplary method of presenting user interface elements based on a location of a user of the computer system in accordance with some embodiments.

FIGS. 15A-150 illustrate examples of a computer system presenting spatial audio corresponding to content in accordance with some embodiments.

FIG. 16 is a flowchart illustrating an exemplary method of presenting spatial audio corresponding to content in accordance with some embodiments.

FIGS. 17A-17I illustrate examples of a computer system providing navigation assistance in accordance with some embodiments.

FIG. 18 is a flowchart illustrating an exemplary method of providing navigation assistance in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a user interface of a map application including a first user interface element associated with a search operation and a navigation user interface element representing a first physical area. In some embodiments, while displaying the user interface the computer system detects, an attention of a user of the computer system directed to the first user interface element and in response to detecting the attention of the user directed to the first user interface element, the computer system displays the user interface including a second user interface element, wherein the second user interface element includes a text entry field and a plurality of first location user interface elements of a first type and a plurality of second location user interface elements of a second type different from the first type, grouped according to type and associated with the first physical area.

In some embodiments, while displaying a user interface of a map application including a navigation user interface element representing a first physical area according to a first appearance condition, the computer system detects an event. In some embodiments, in response to detecting the event, in accordance with a determination that one or more criteria are satisfied, including a criterion that is satisfied when the event indicates a change from displaying the navigation user interface element according to the first appearance condition to displaying the navigation user interface element according to a second appearance condition, the computer system ceases display of the navigation user interface element according to the first appearance condition and displays the navigation user interface element according to the second appearance condition. In some embodiments, in response to detecting the event and in accordance with a determination that the one or more criteria are not satisfied, the computer system continues to display the navigation user interface element according to the first appearance condition.

In some embodiments, a computer system displays a user interface of a map application including a navigation user interface element representing a first physical area including a plurality of first geographic features. In some embodiments, while displaying the user interface, the computer system receives a user input directed to a digital assistant operating on the computer system, the user input corresponding to a request to present content. In some embodiments, in response to receiving the user input, in accordance with a determination that the user input satisfies one or more criteria including a criterion that is satisfied when the user input includes a gesture input directed to the first physical area and a voice input from a user of the computer system, and in accordance with a determination that the input includes attention of a user of the computer system directed to a first location of the navigation user interface element, the computer system presents, using the digital assistant, content related to a first physical location corresponding to the first location of the navigation user interface element. In some embodiments, in response to receiving the user input, and in accordance with a determination that the input includes attention of the user of the computer system directed to a second location of the navigation user interface element different from the first location of the navigation user interface element, the computer system presents, using the digital assistant, content related to a second physical location corresponding to the second location of the navigation user interface element and different from the first physical location.

In some embodiments, while a three-dimensional environment is visible via the display generation component, in accordance with a determination that one or more first criteria are satisfied, including a criterion that is satisfied when a location of a user of the computer system is a first physical environment, the computer system displays, in the three-dimensional environment, a first user interface element associated with the first physical environment, wherein the first user interface element is a user interface of a map application on the computer system, In some embodiments, while the three-dimensional environment is visible via the display generation component, in accordance with a determination that one or more second criteria are satisfied, including a criterion that is satisfied when the location of the user of the computer system is a second physical environment, different from the first physical environment, the computer system displays in the three-dimensional environment, a second user interface element associated with the second physical environment, wherein the second user interface element is different from the first user interface element and is a user interface of the map application on the computer system.

In some embodiments, while displaying, via the display generation component, content in a three-dimensional environment, wherein the content is not associated with corresponding audio, in accordance with a determination that a viewpoint of a user of the computer system is a first viewpoint, the computer system presents first spatial audio corresponding to the first viewpoint. In some embodiments, while displaying the content in the three-dimensional environment, in accordance with a determination that the viewpoint of the user is a second viewpoint, different from the first viewpoint, the computer system presents second spatial audio, different from the first spatial audio, corresponding to the second viewpoint.

In some embodiments, the computer system receives a request to provide navigation assistance to the second computer system. In some embodiments, in response to receiving the request, the computer system displays, via the display generation component, a user interface including a view of a physical environment of the second computer system corresponding to a current location of the second computer system navigating along a route to a destination. In some embodiments, while displaying the view of the physical environment of the second computer system corresponding to the current location of the second computer system, the computer system detects, via the one or more input devices, a first input corresponding to a request to include an annotation within the view. In some embodiments, in response to detecting the first input, the computer system displays the view of the physical environment of the second computer system corresponding to the current location of the second computer system including the annotation and initiates a process to cause the second computer system to display a visual indication of the annotation.

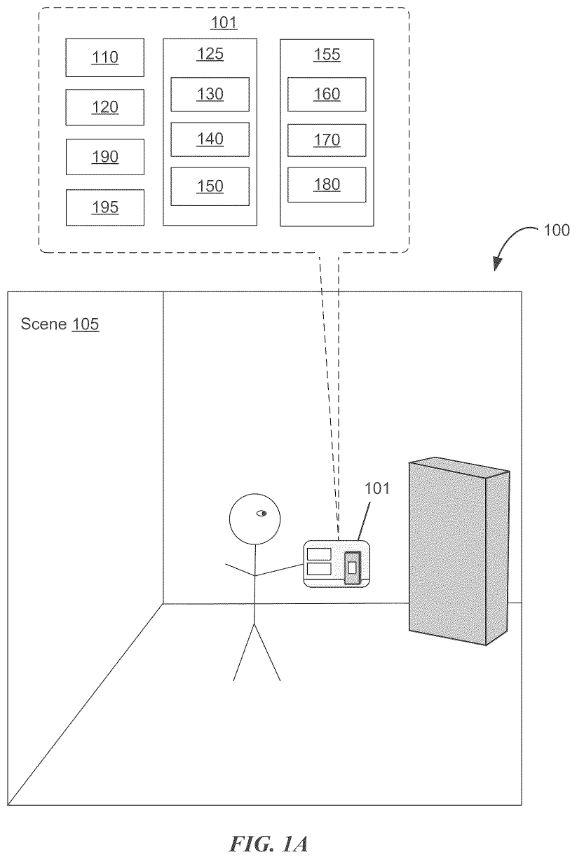

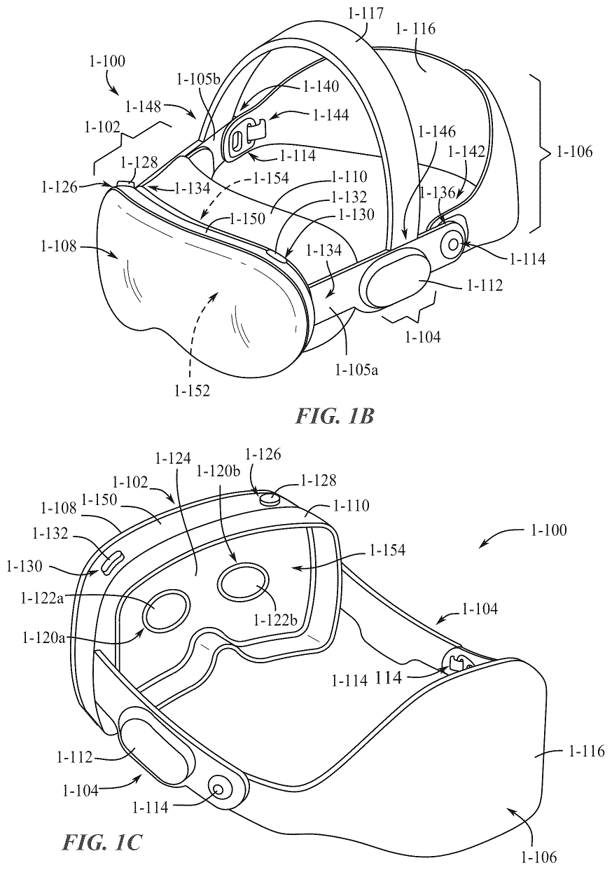

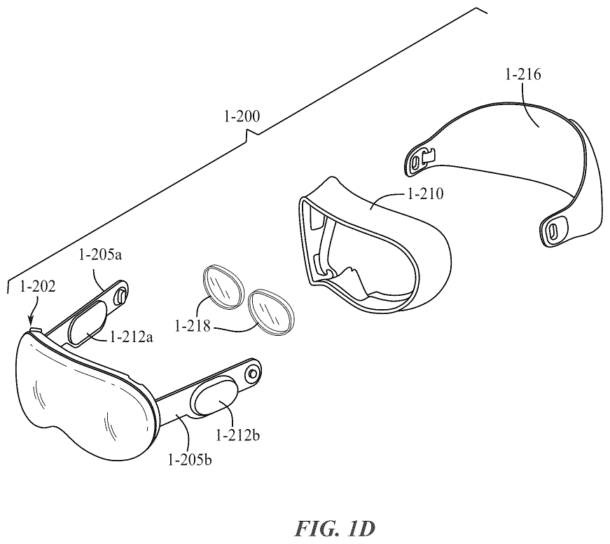

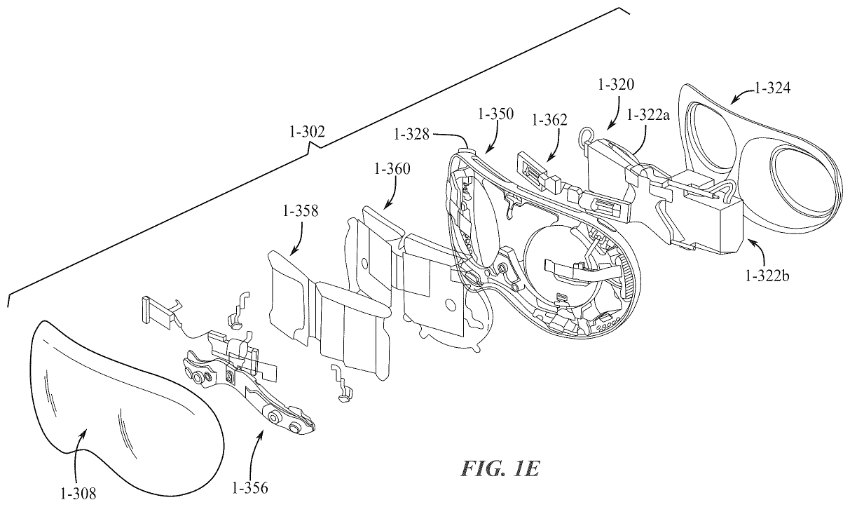

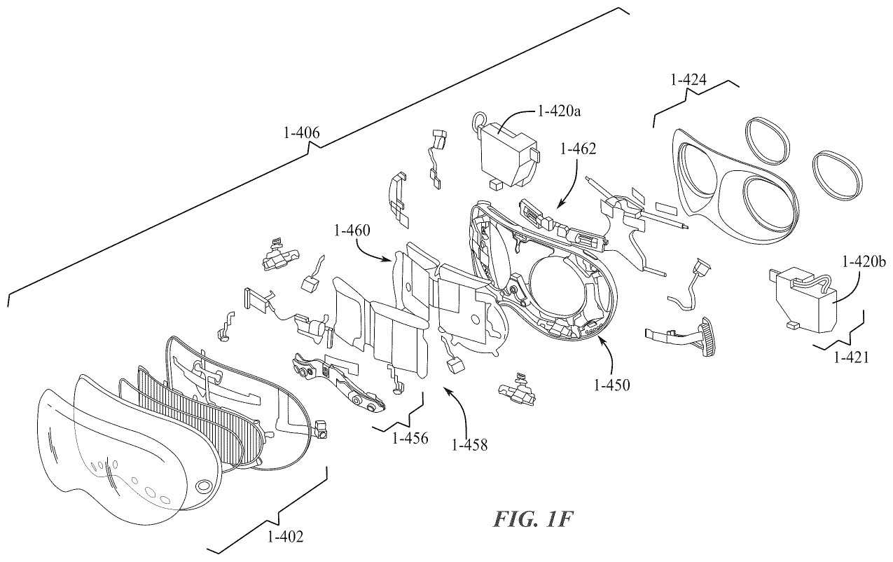

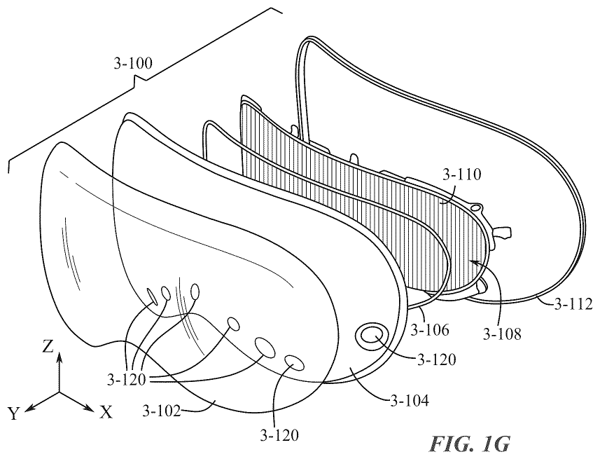

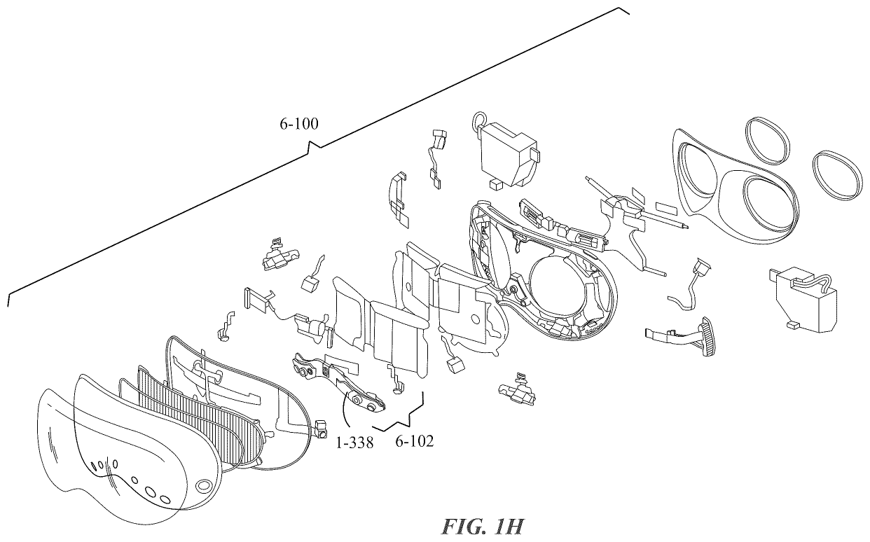

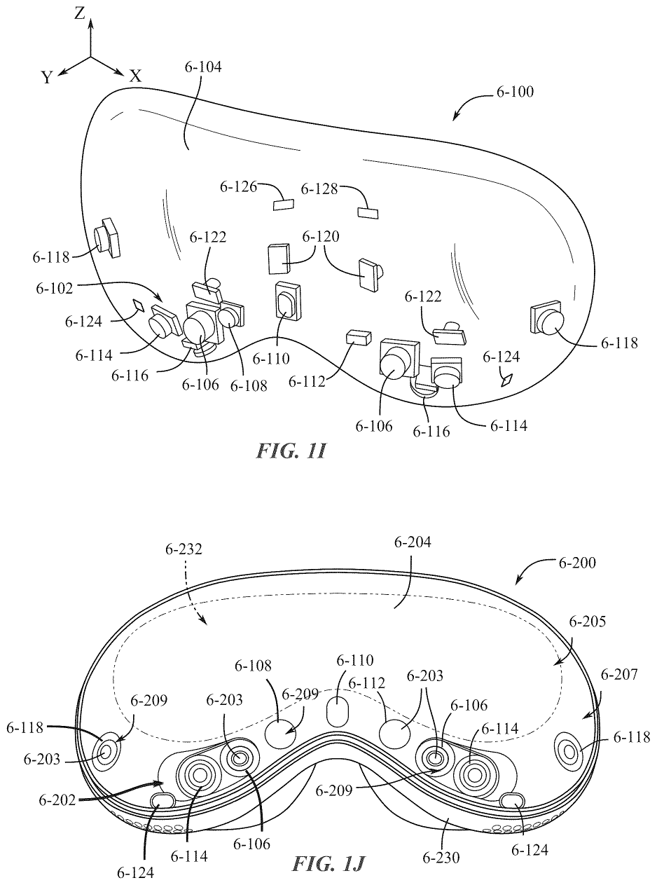

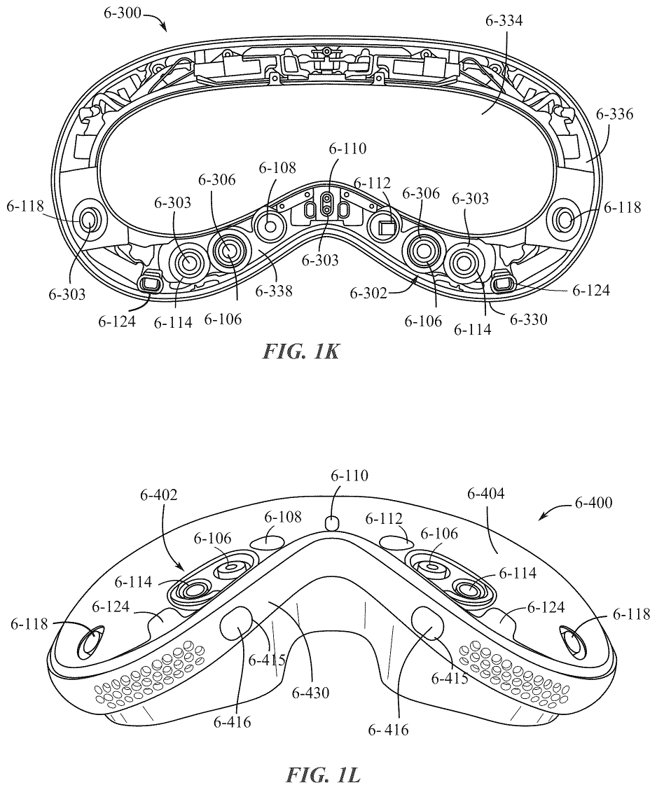

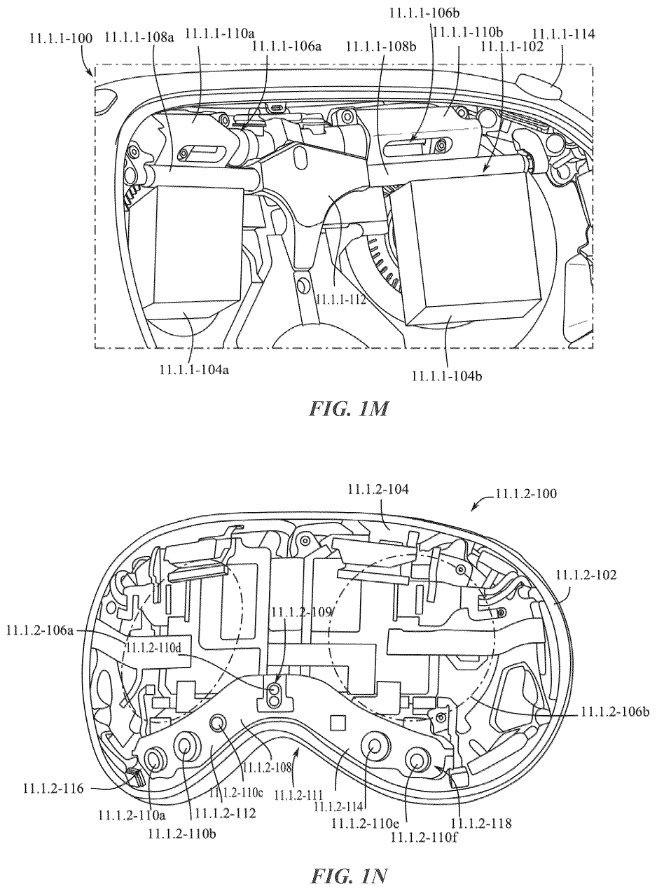

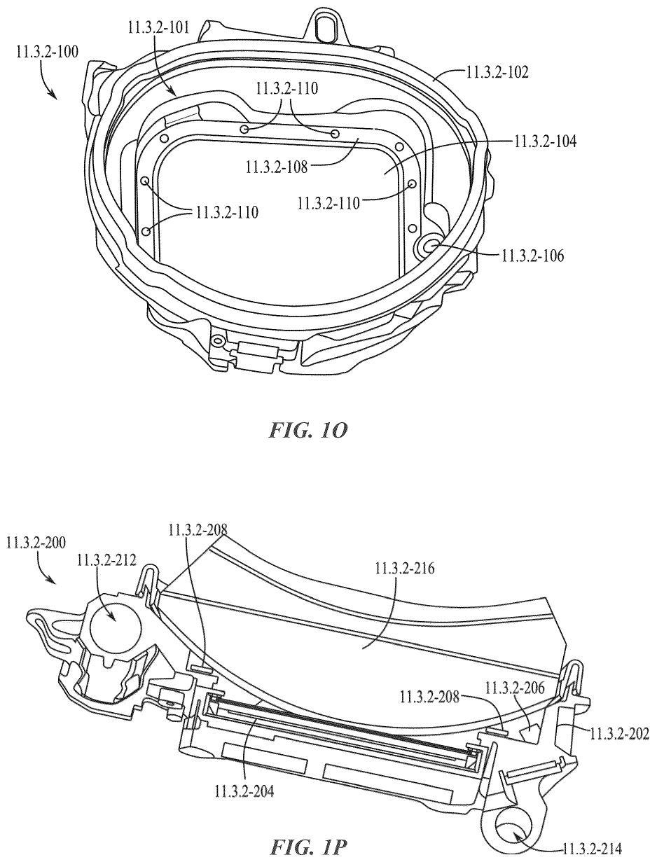

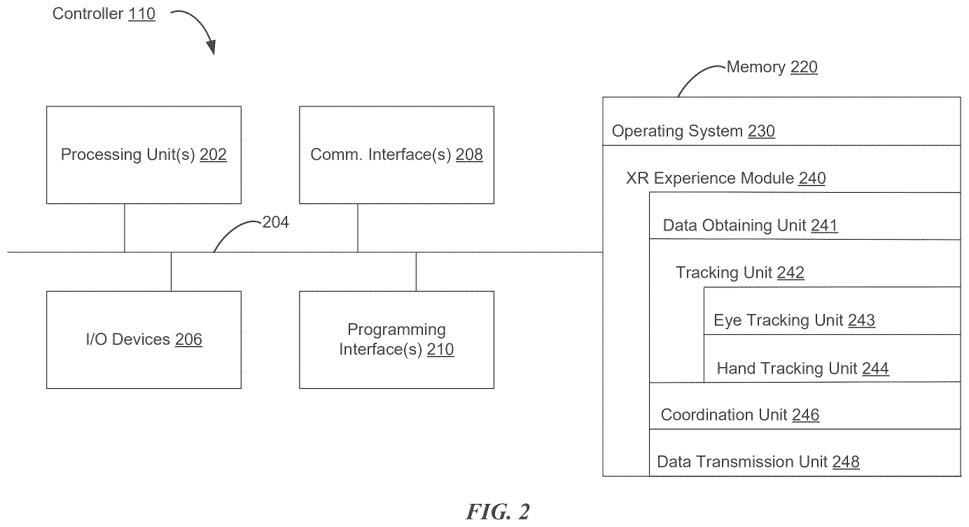

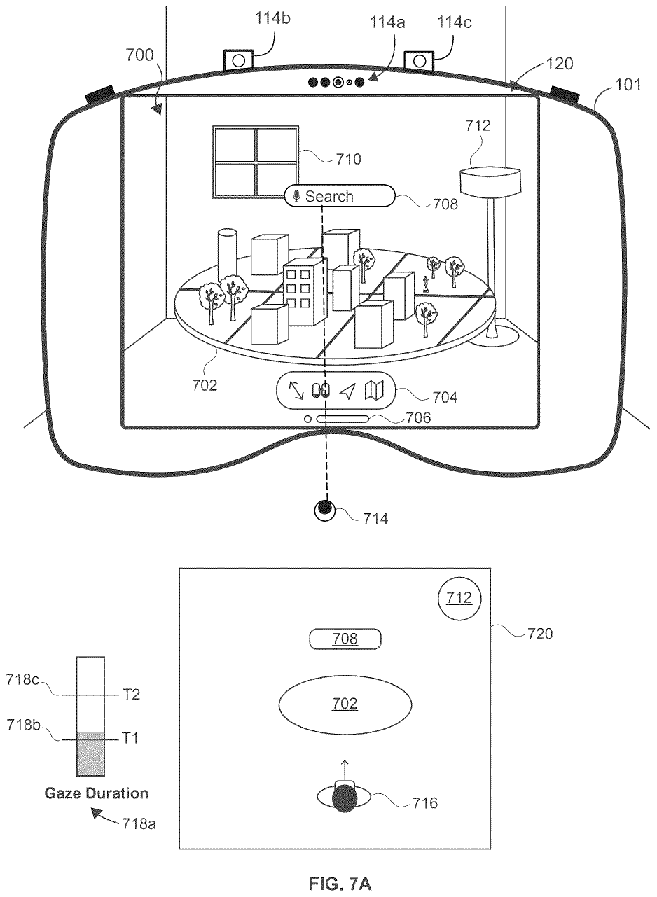

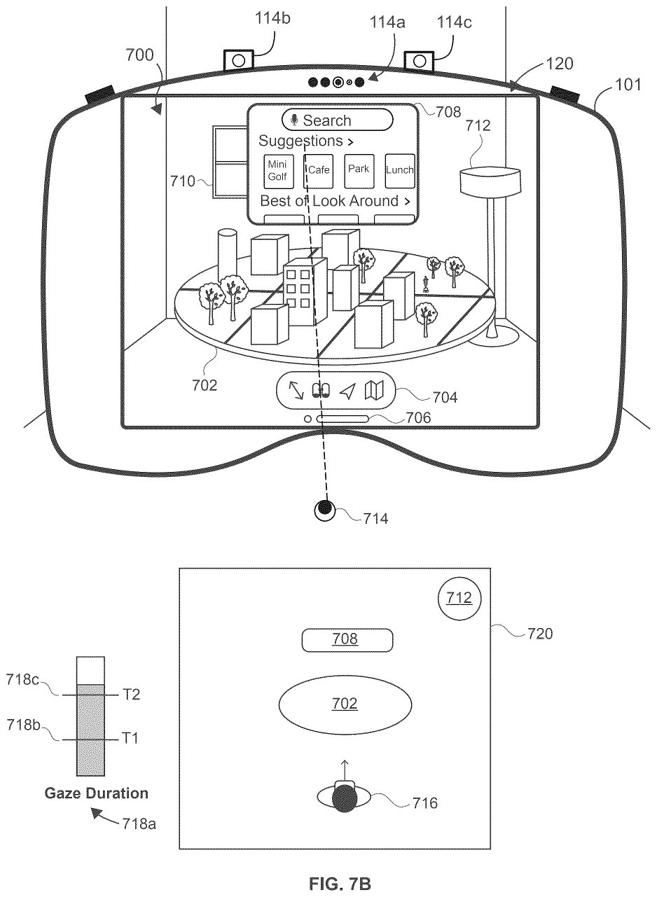

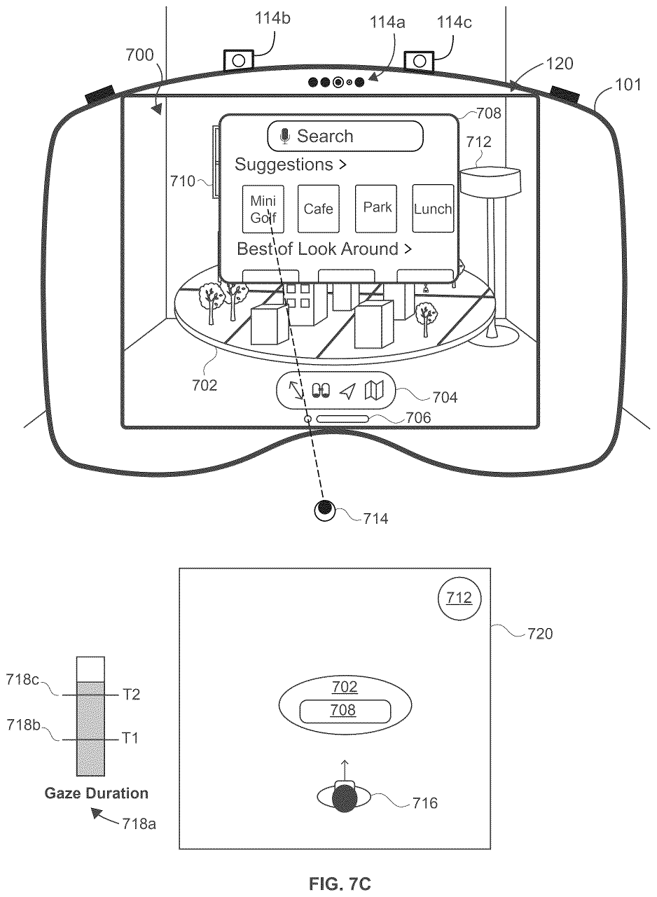

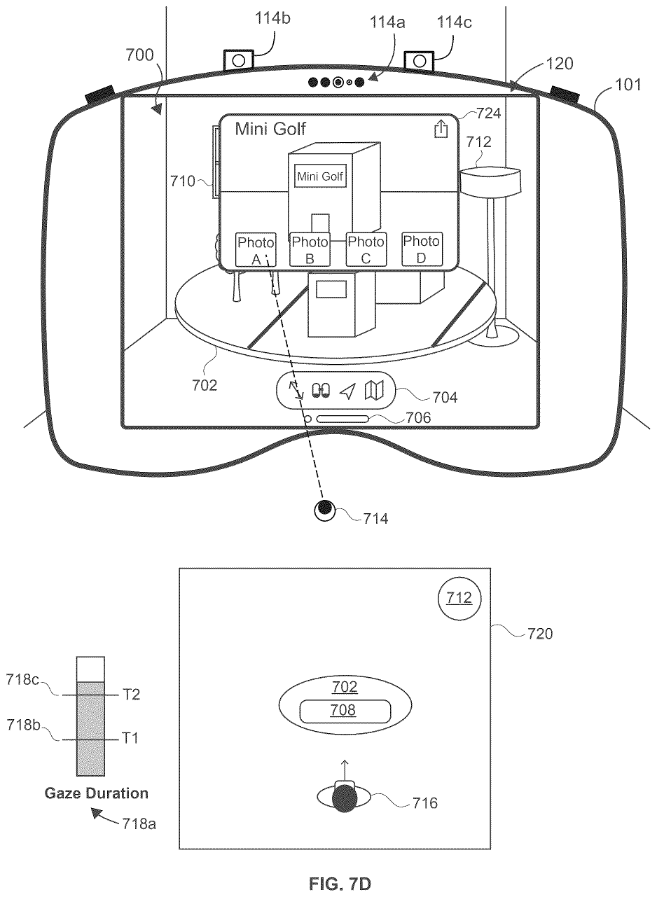

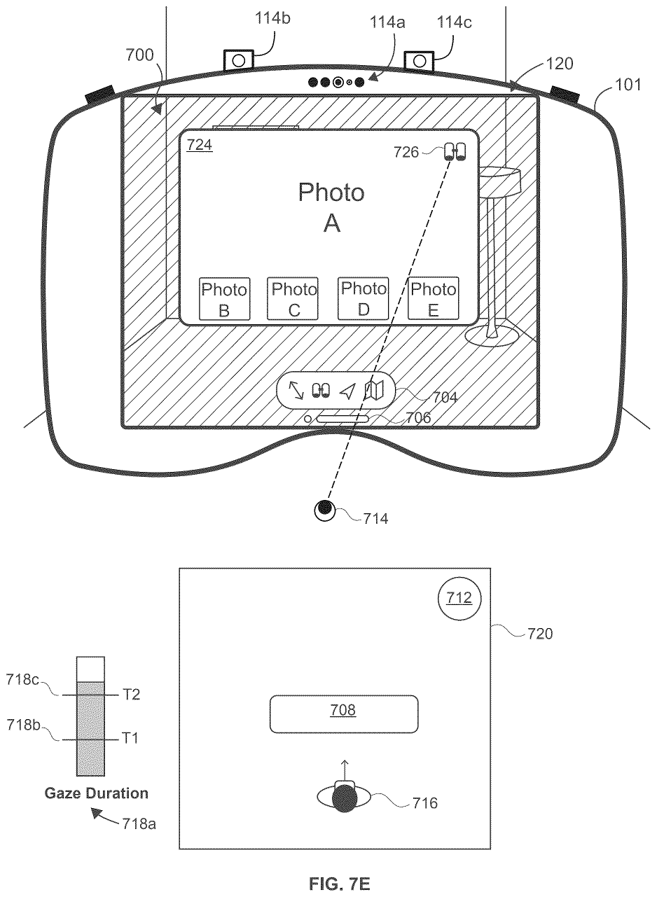

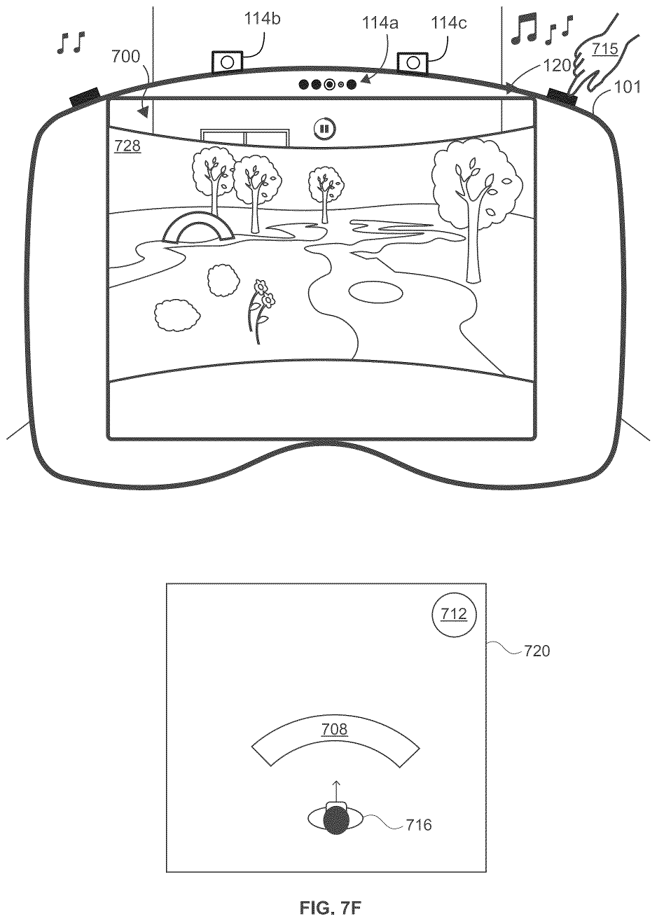

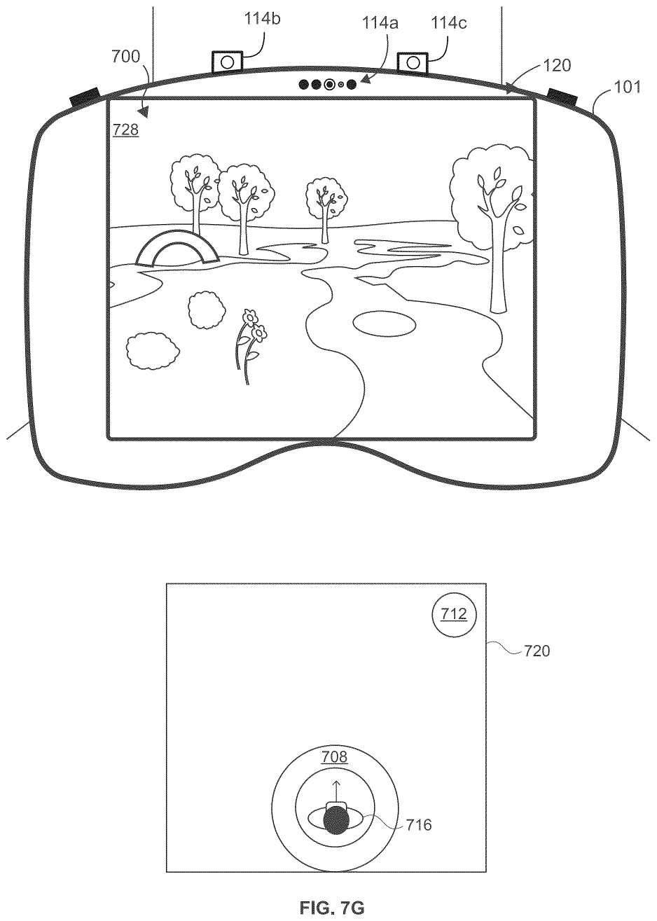

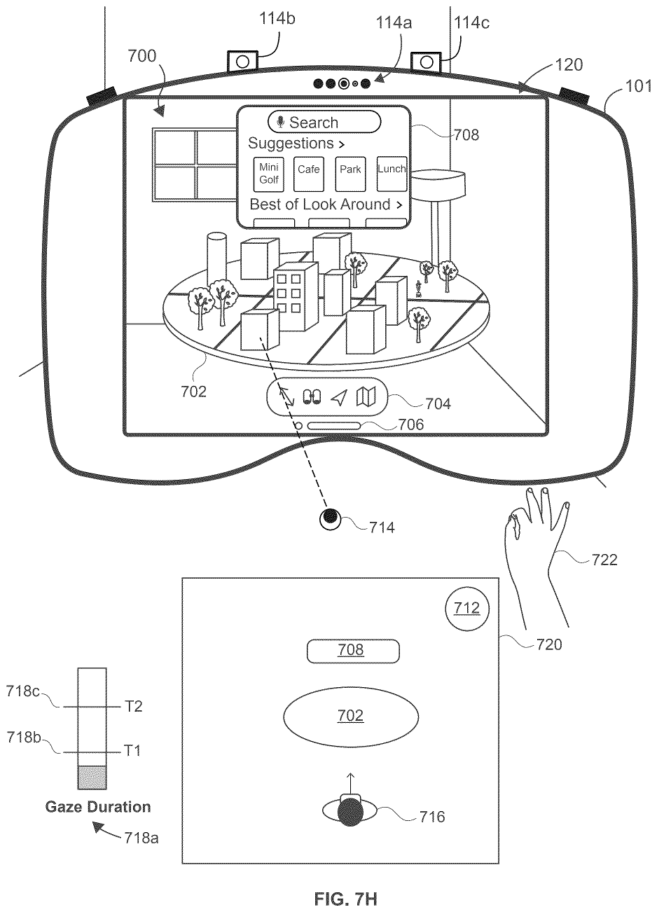

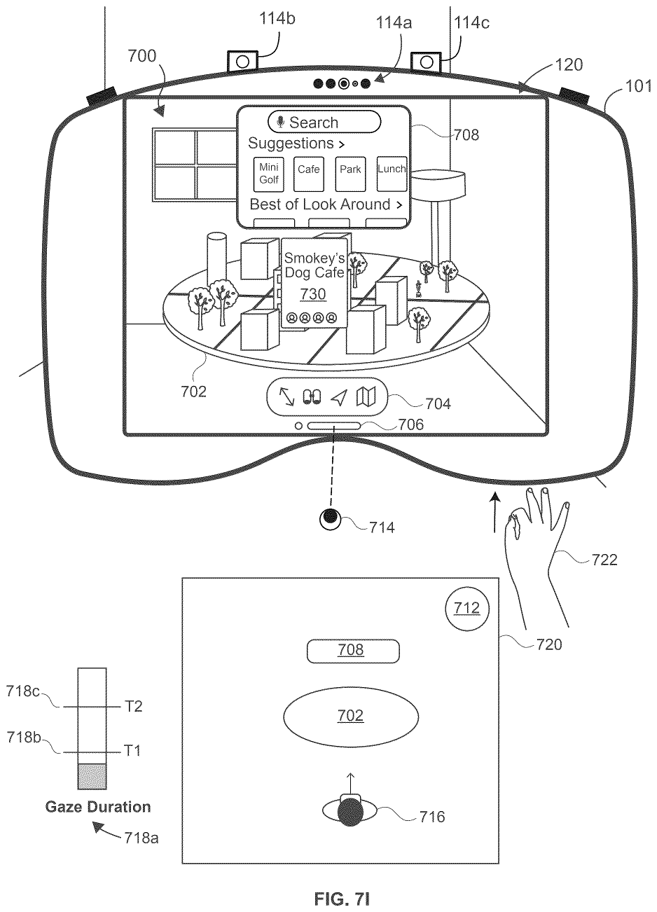

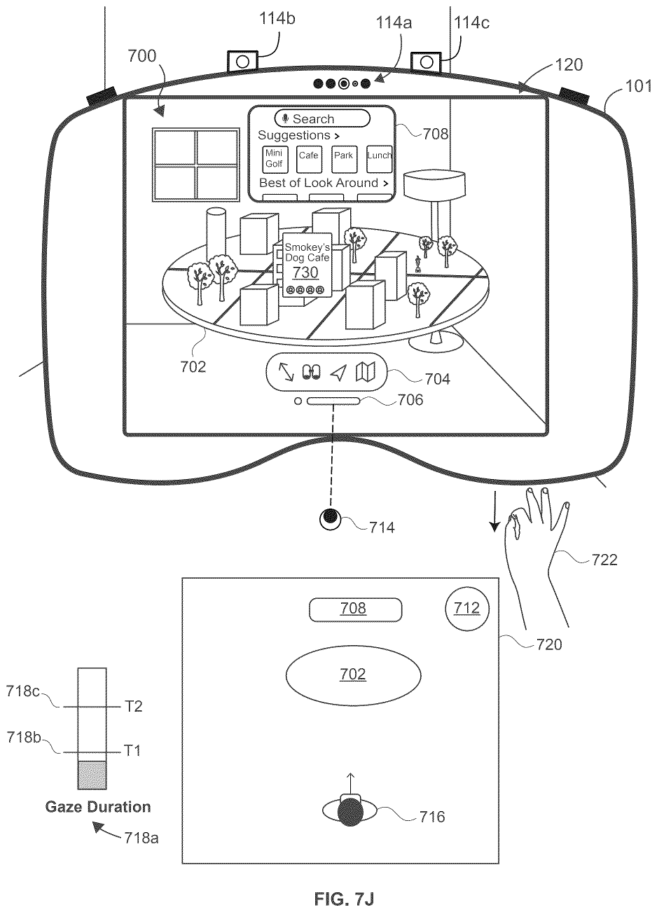

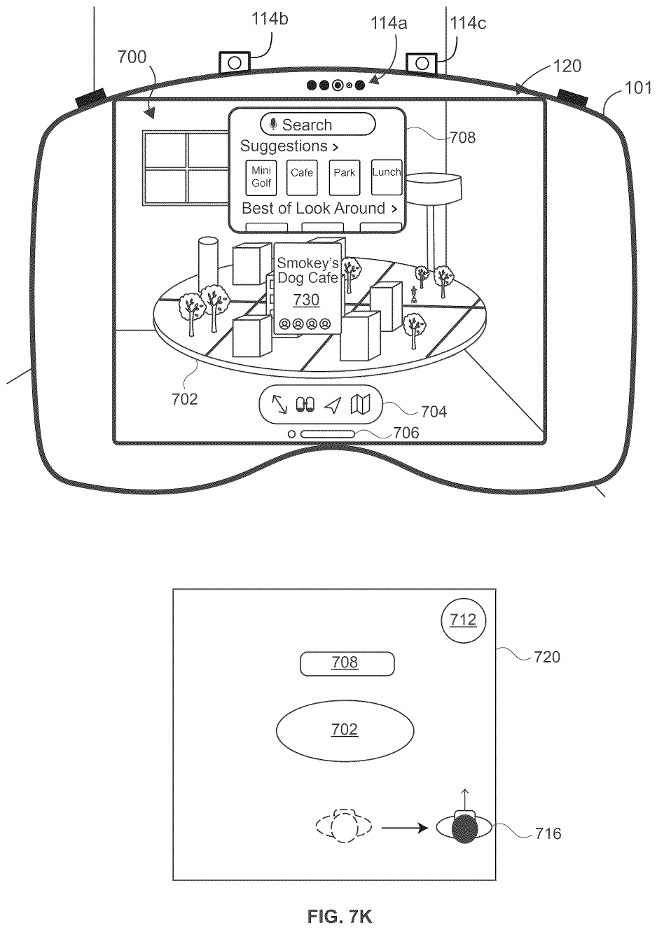

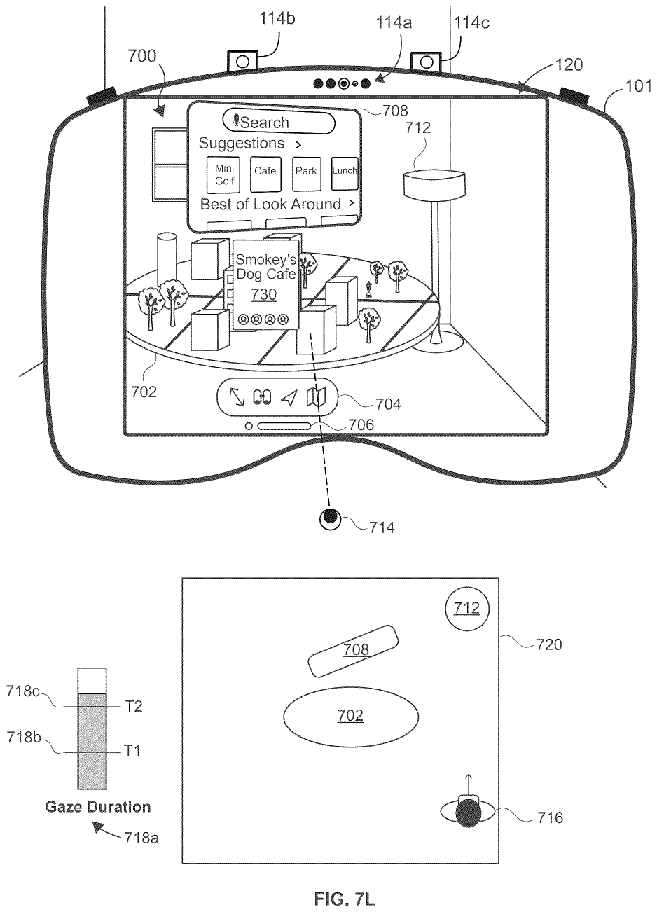

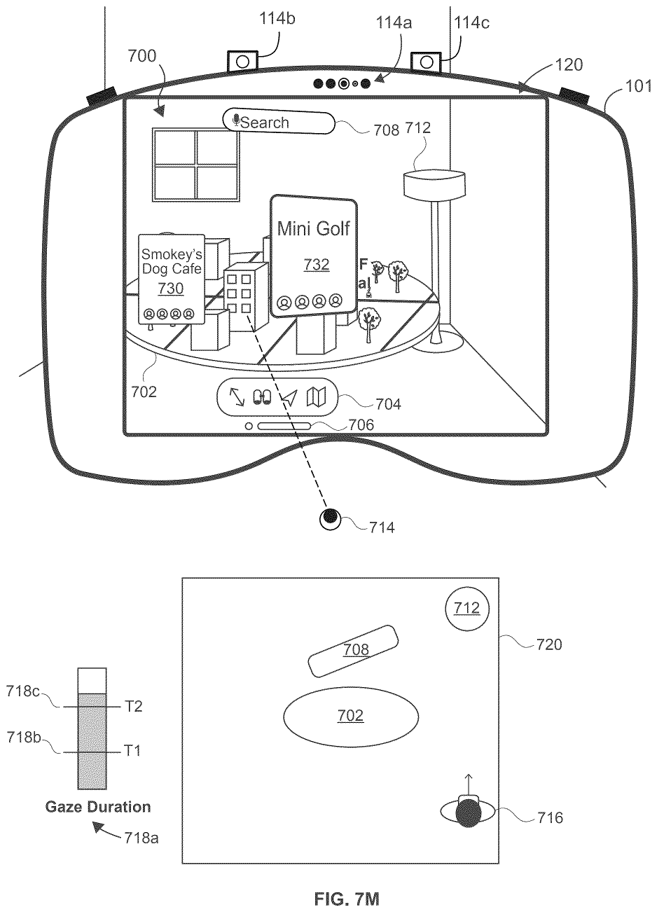

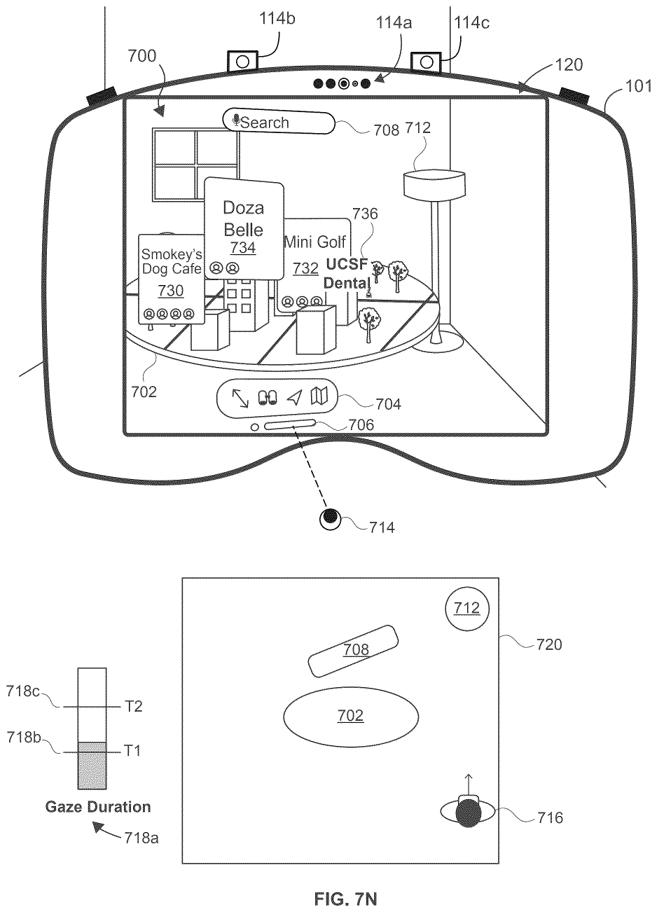

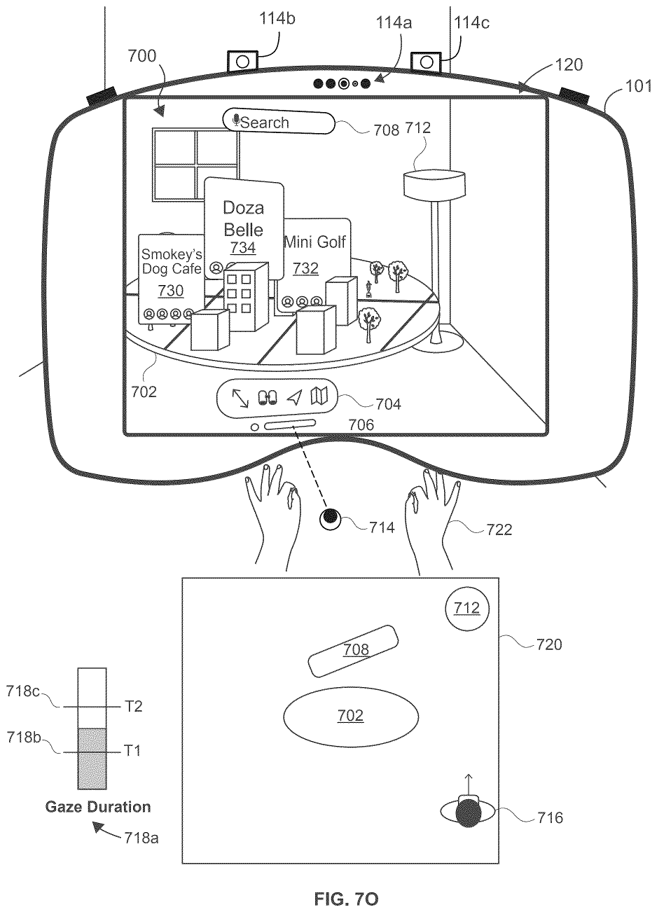

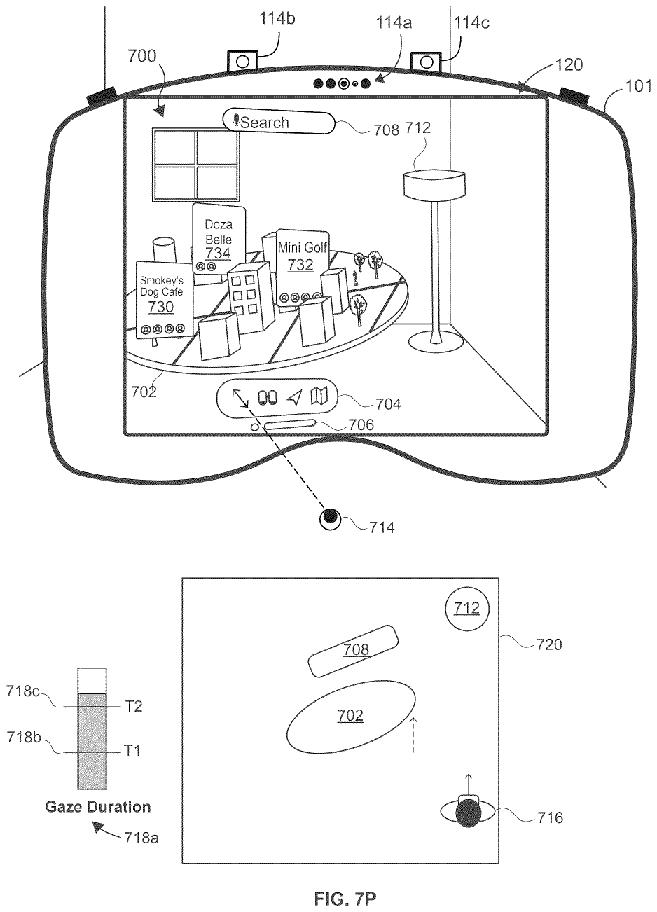

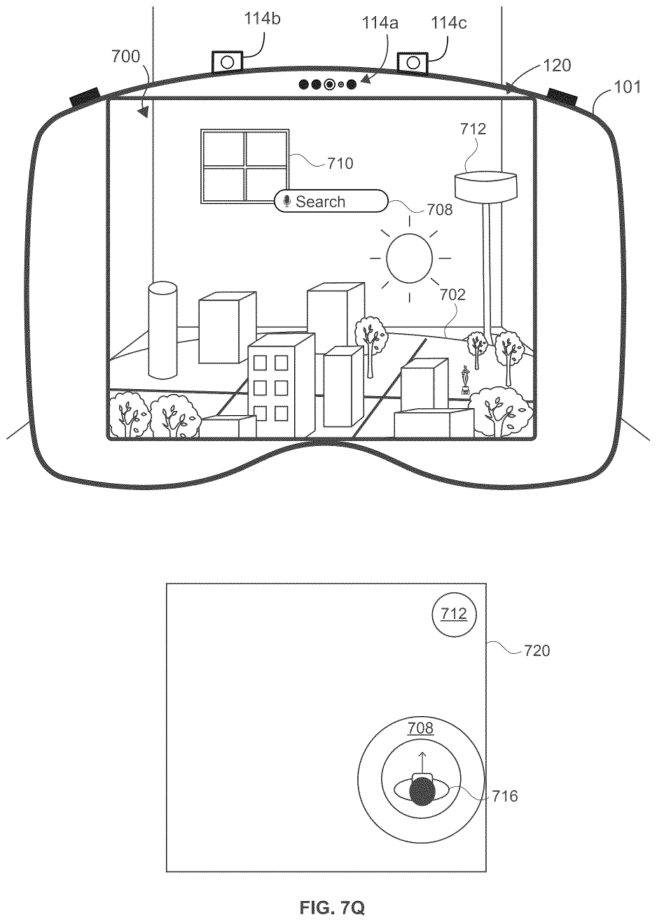

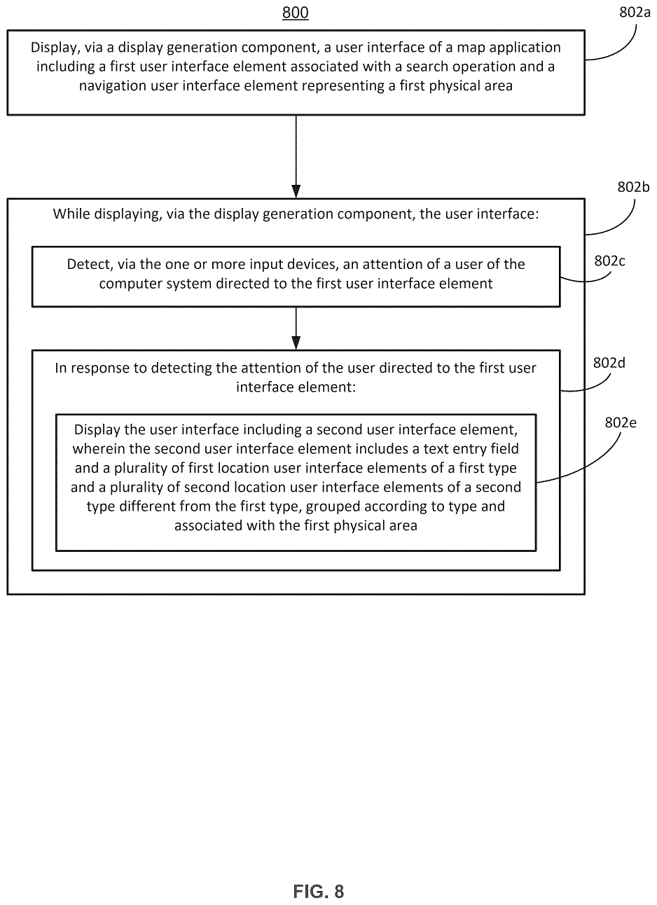

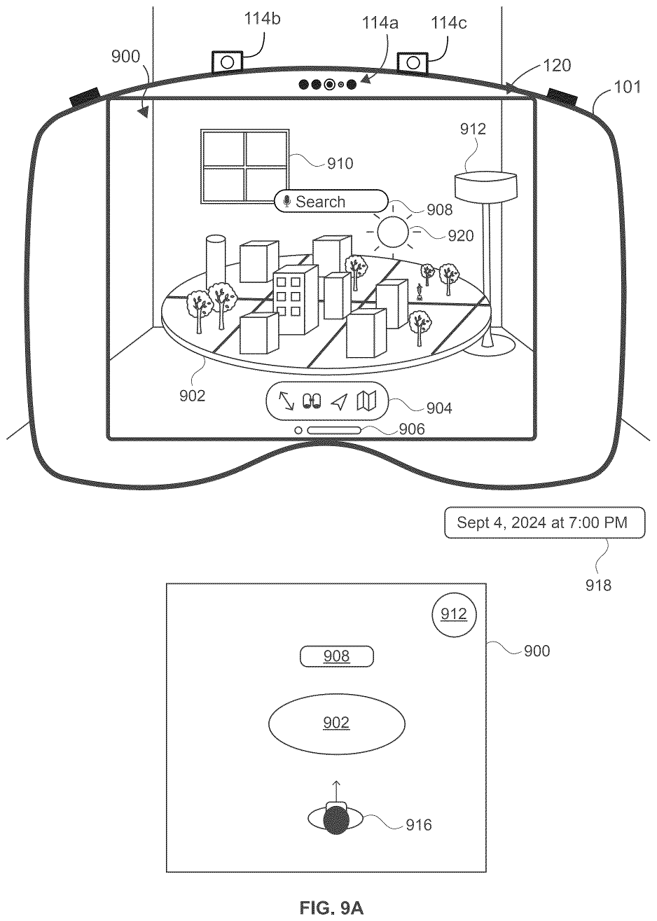

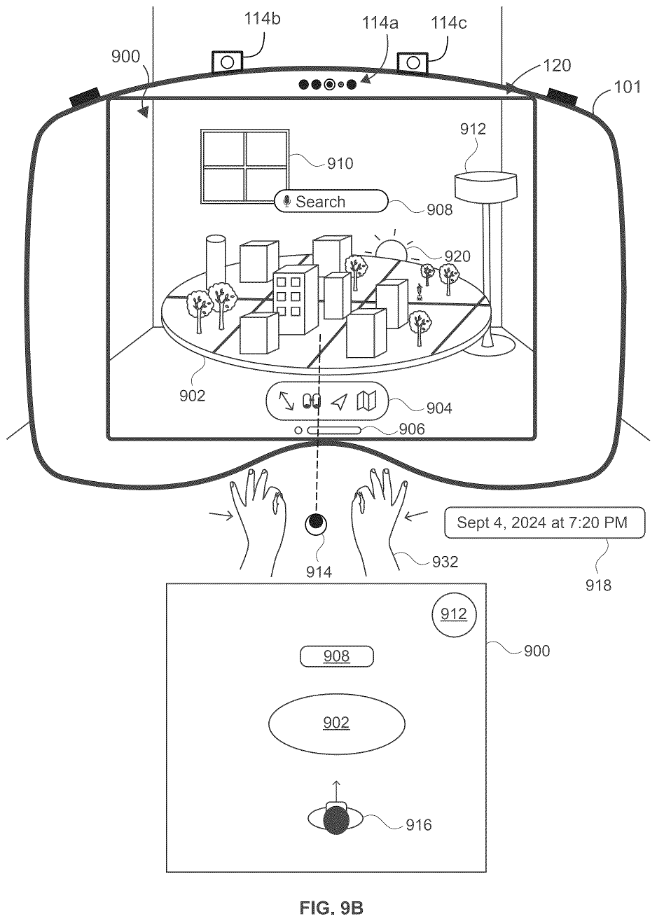

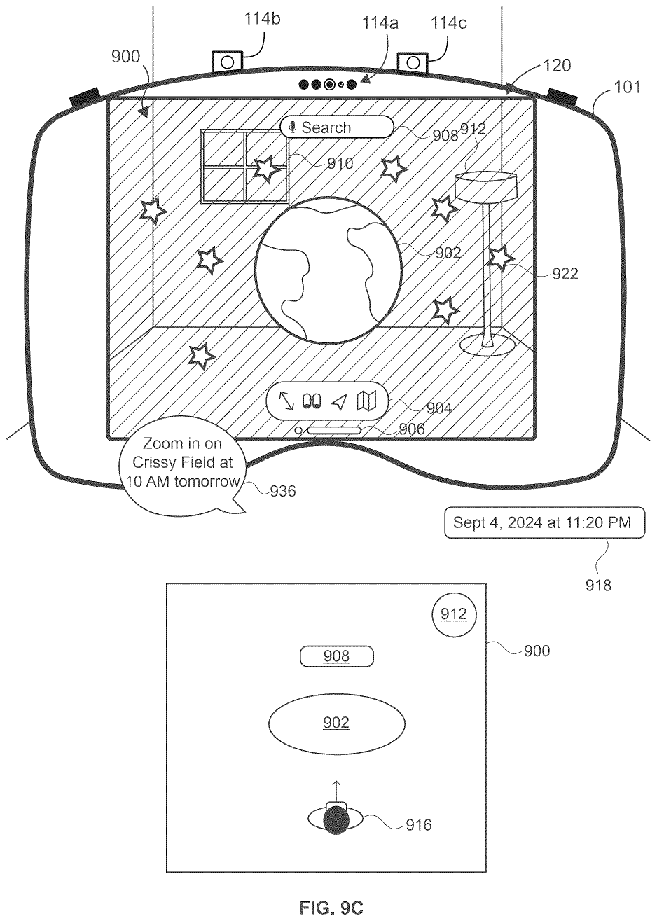

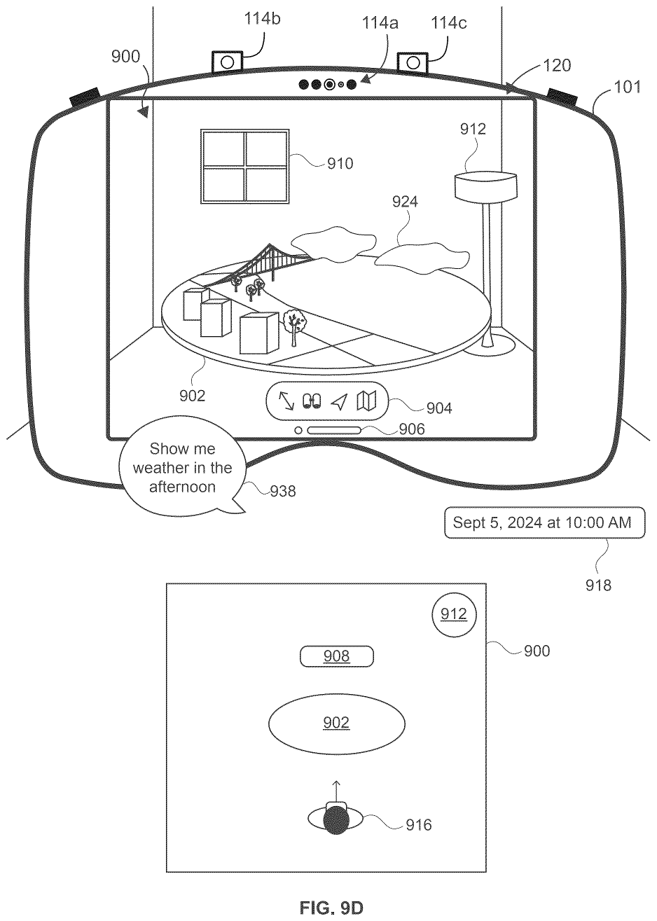

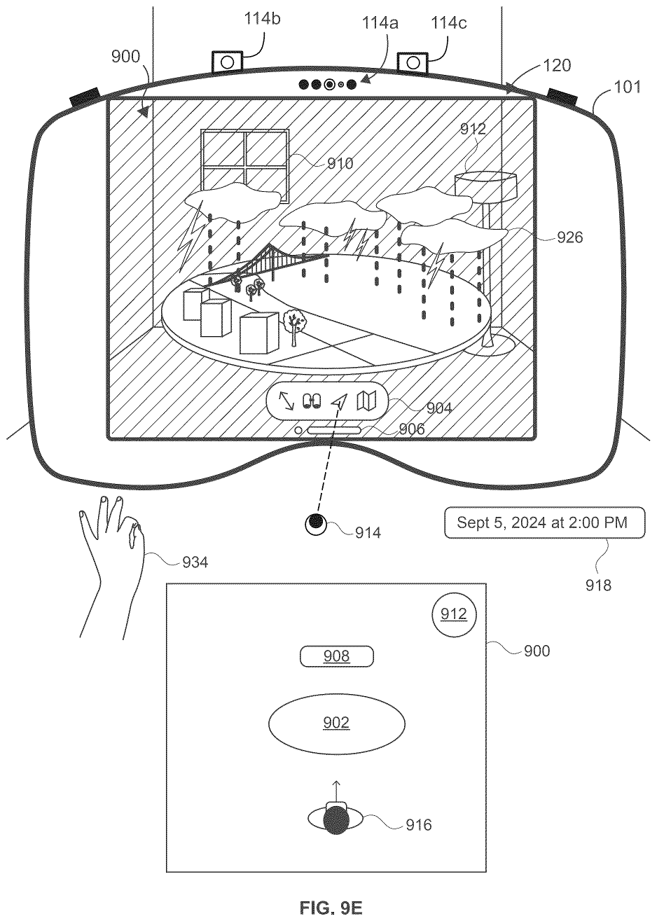

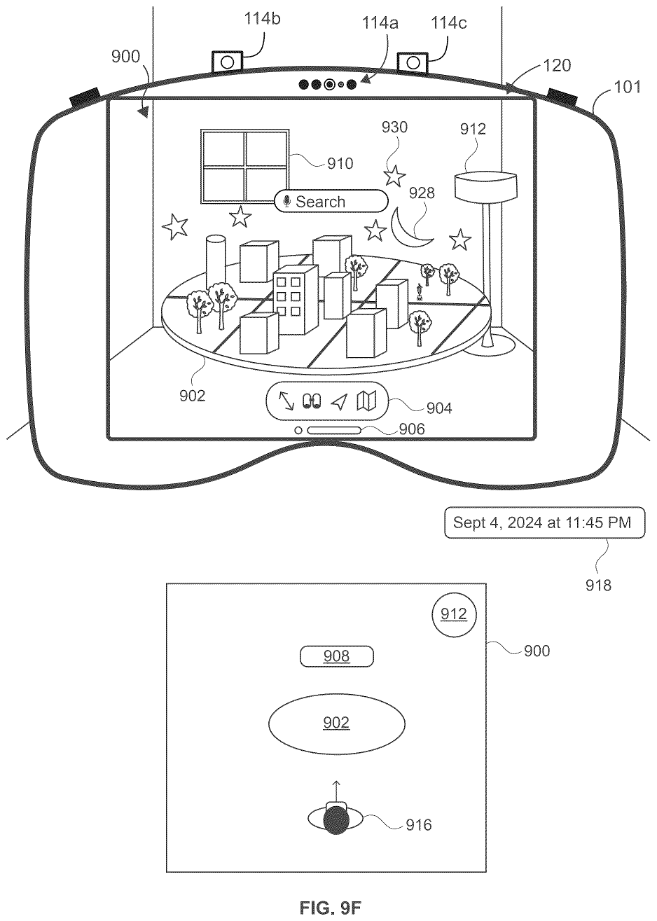

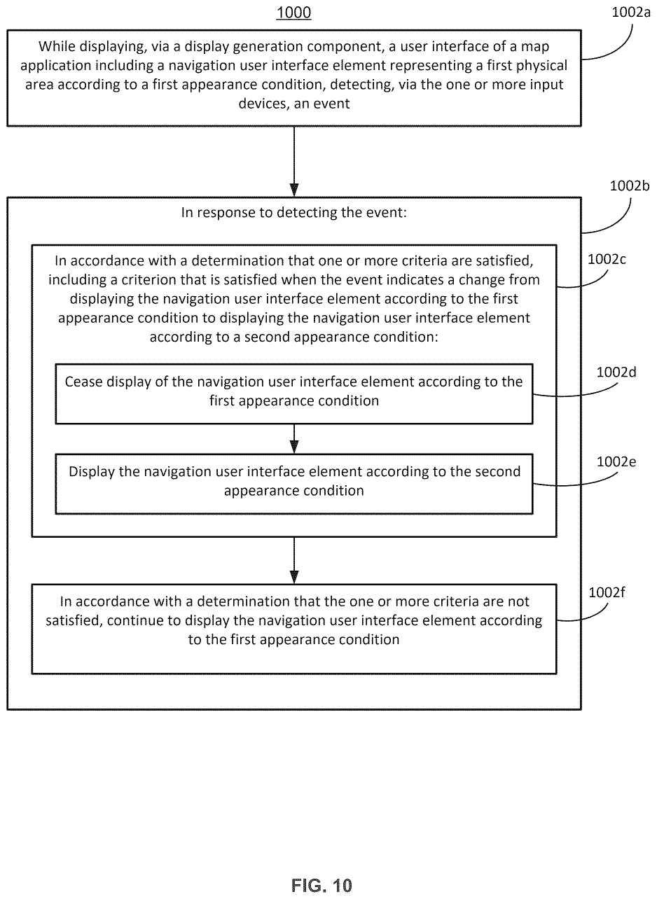

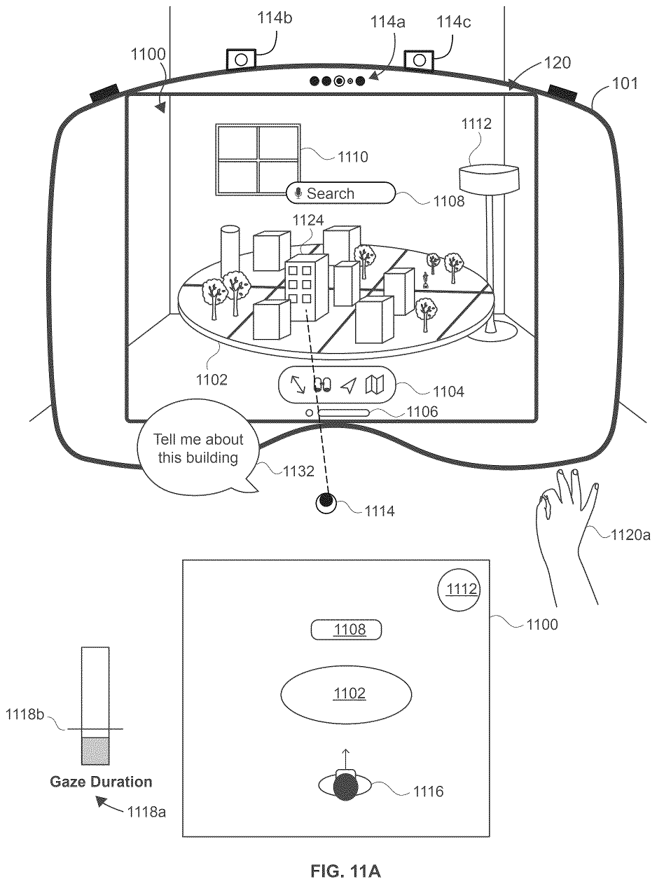

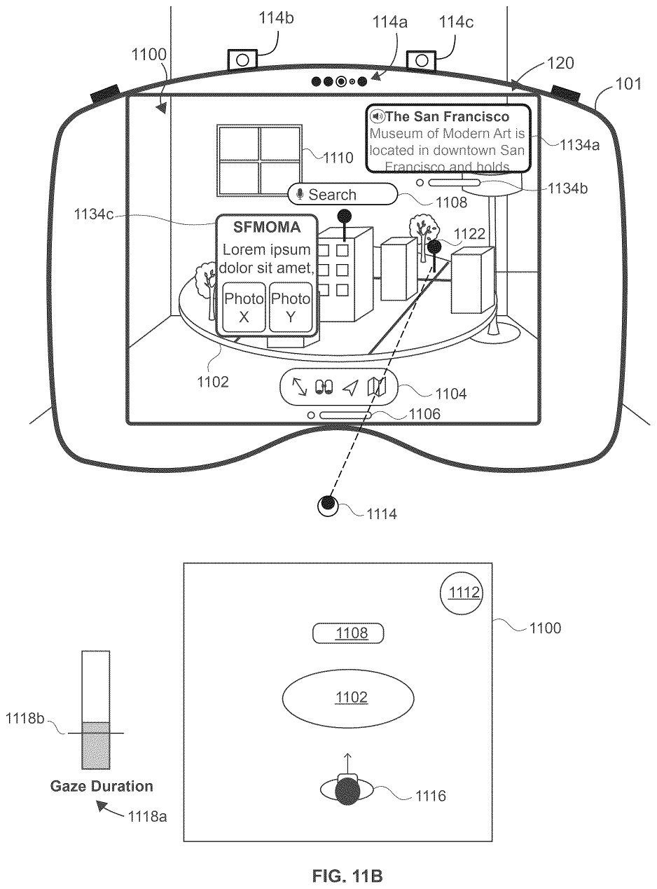

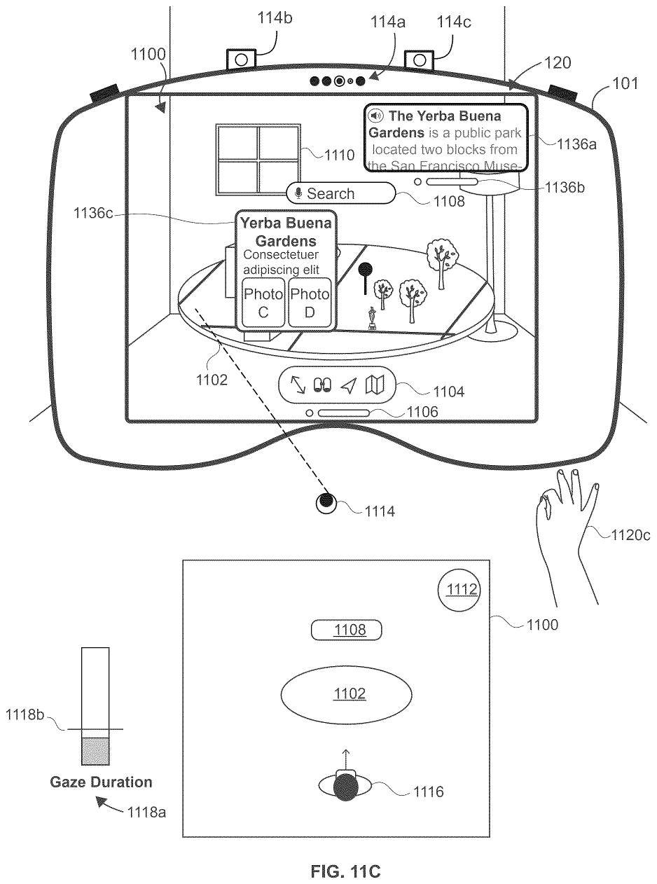

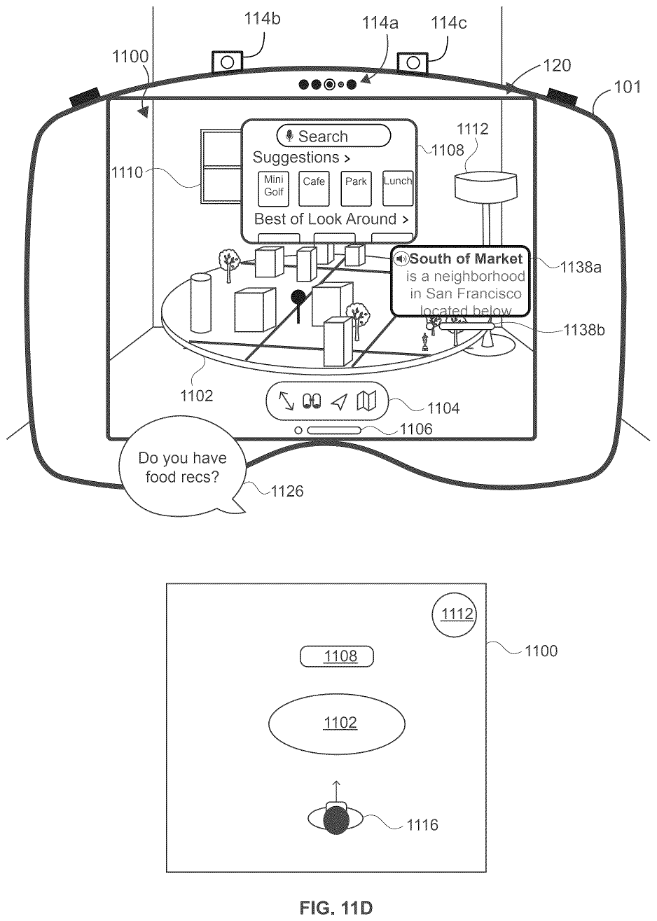

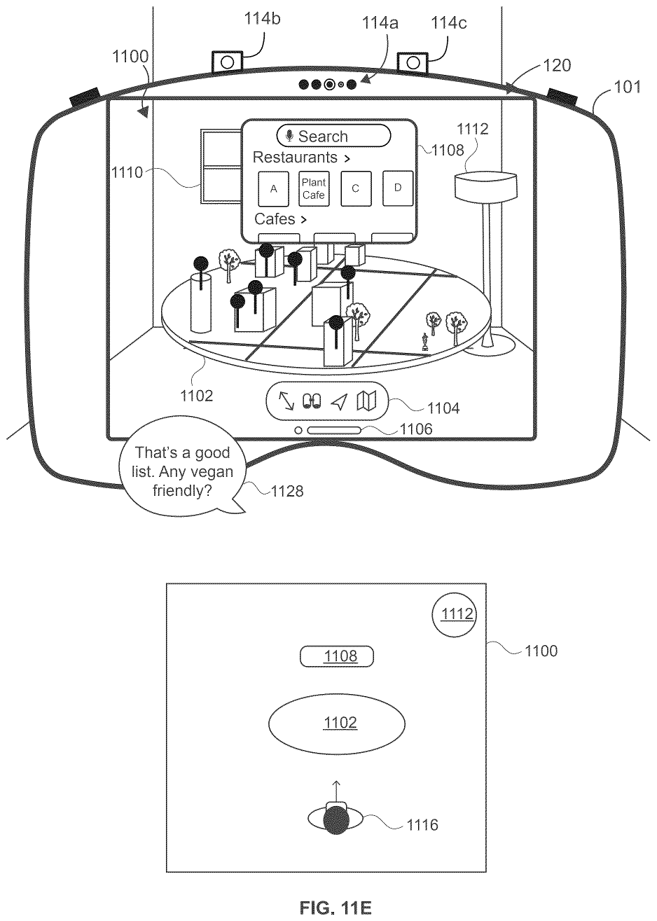

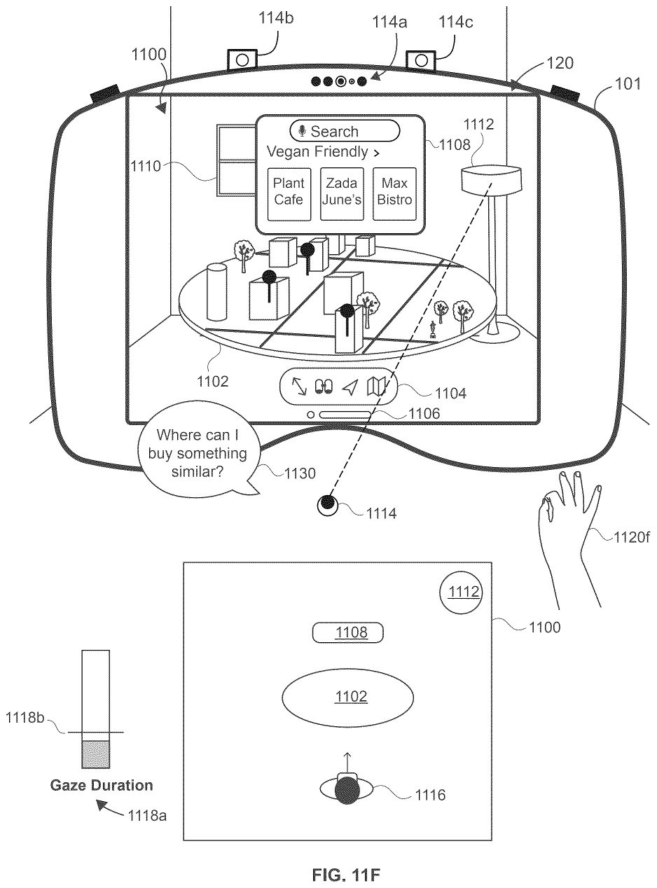

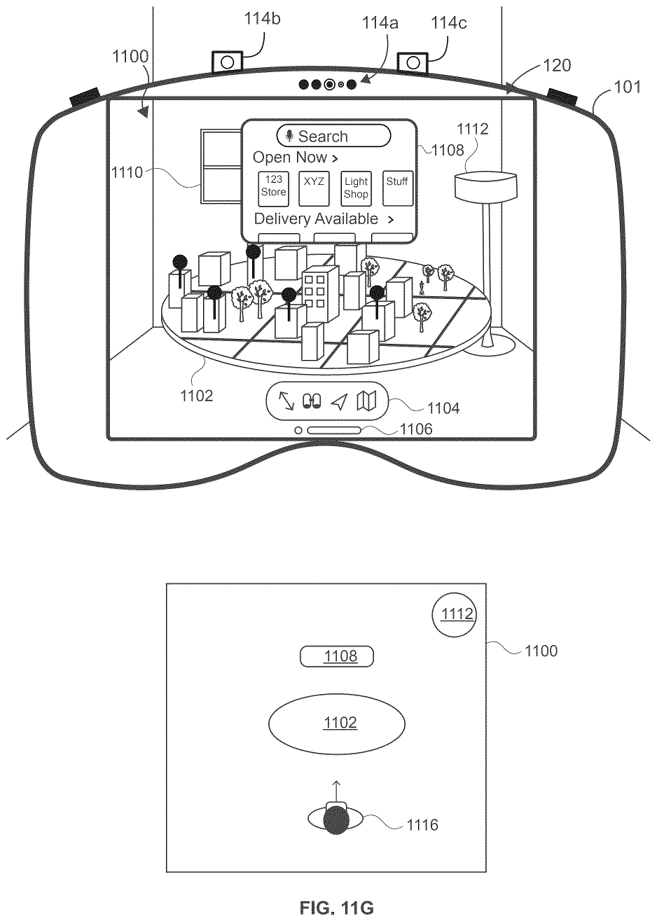

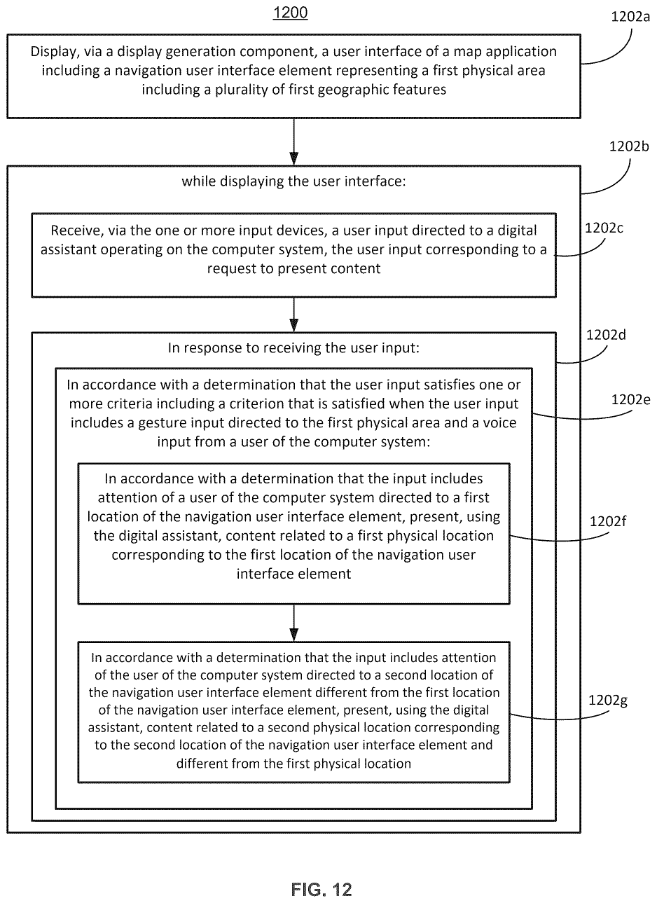

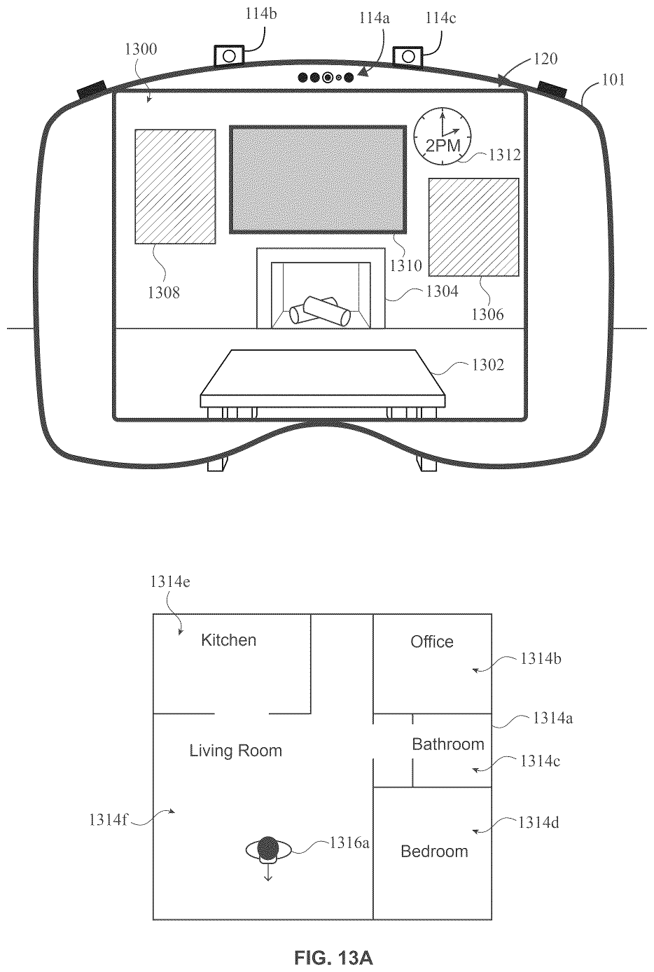

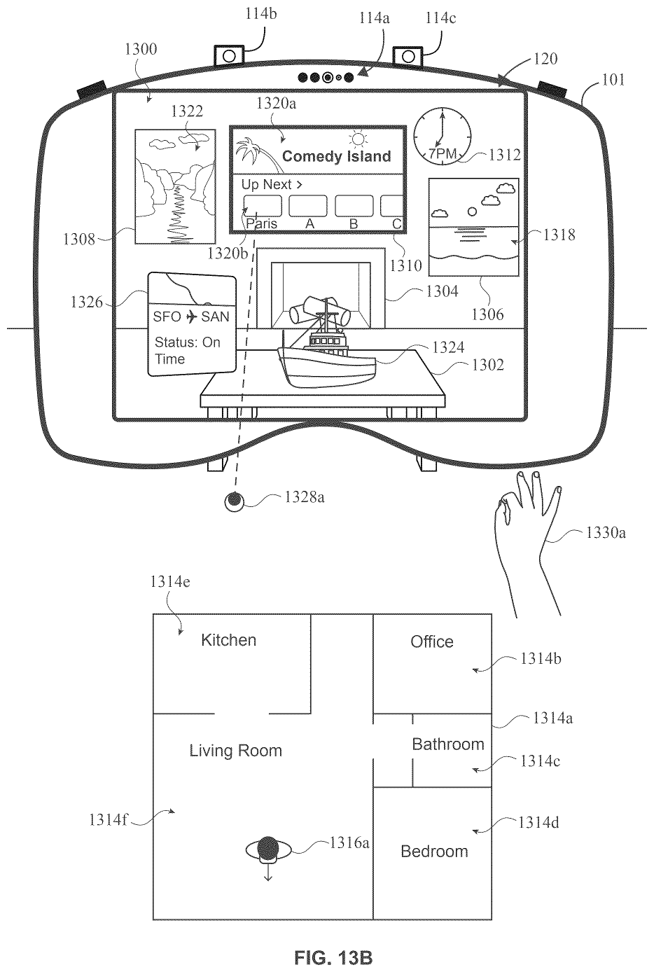

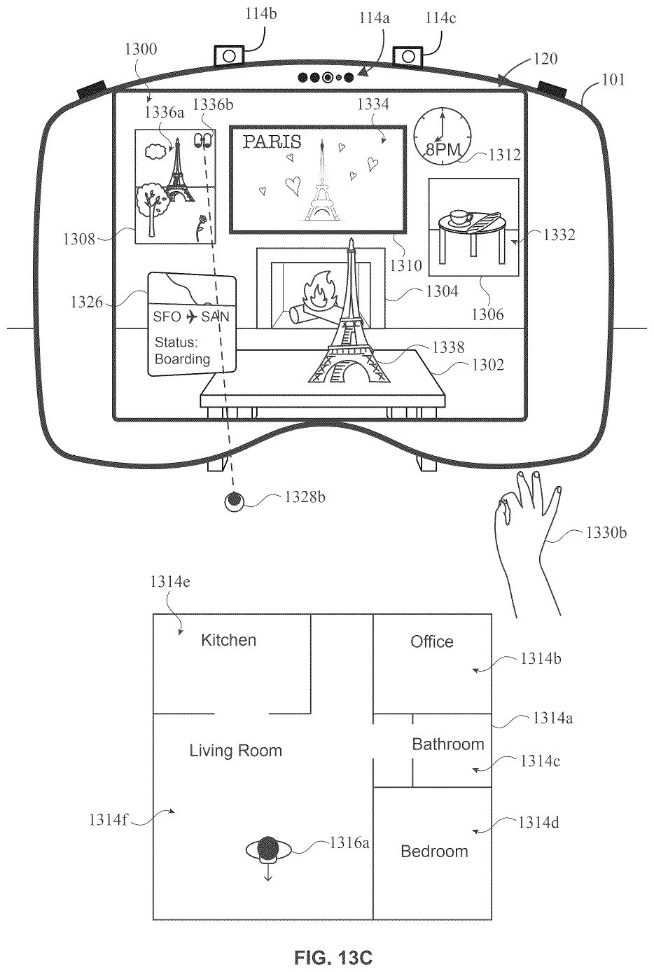

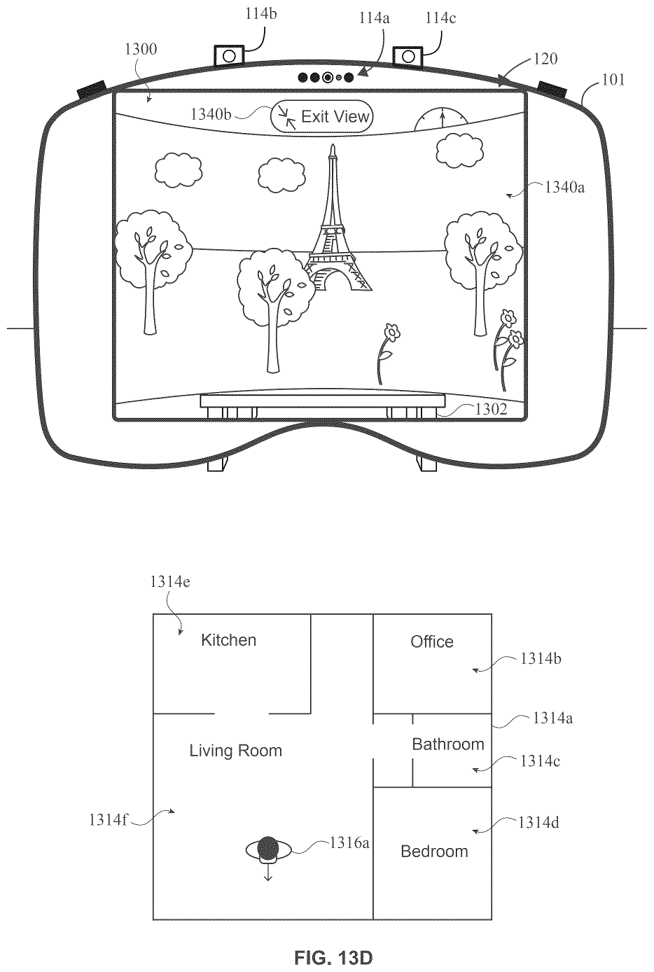

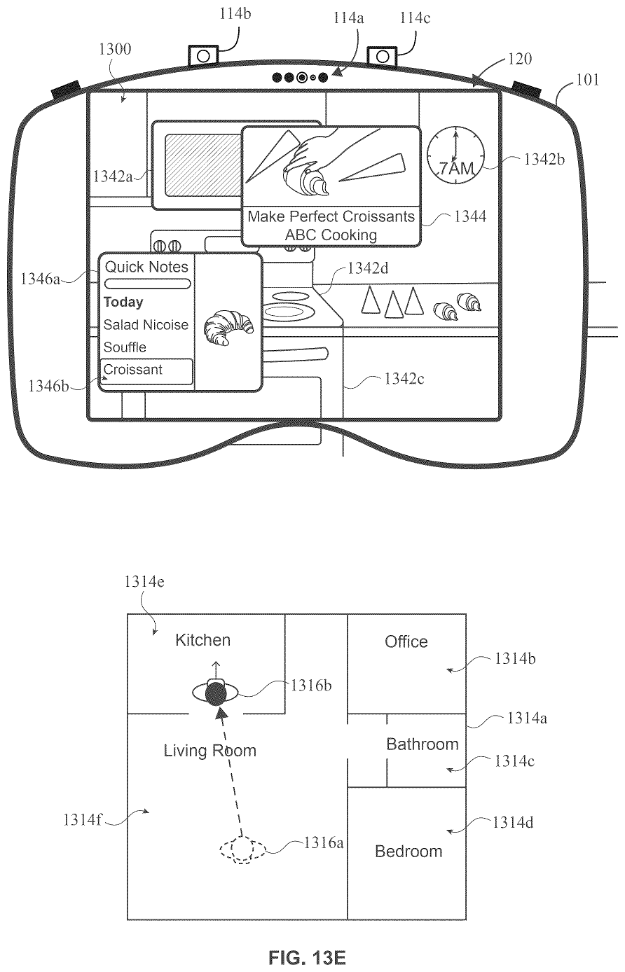

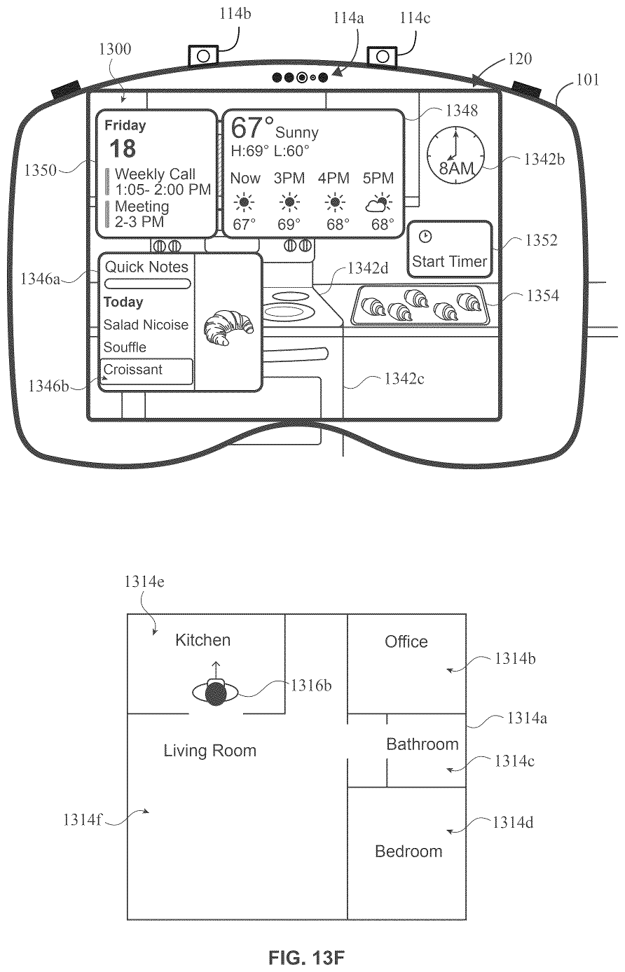

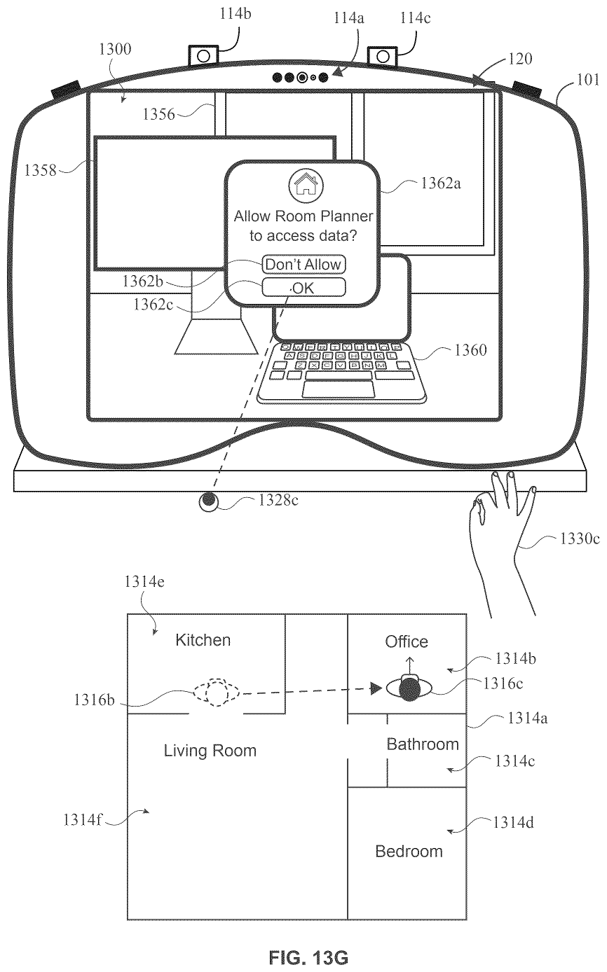

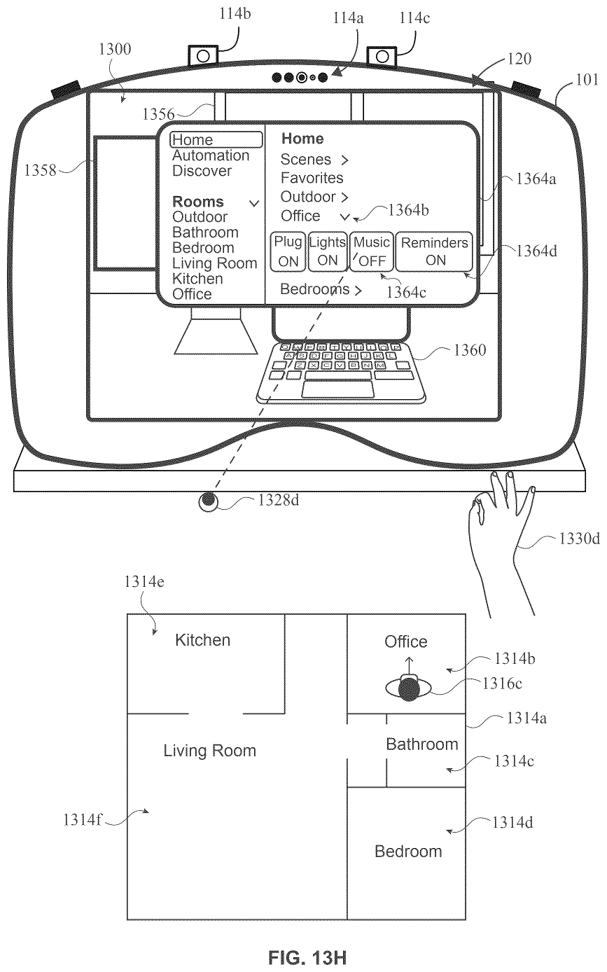

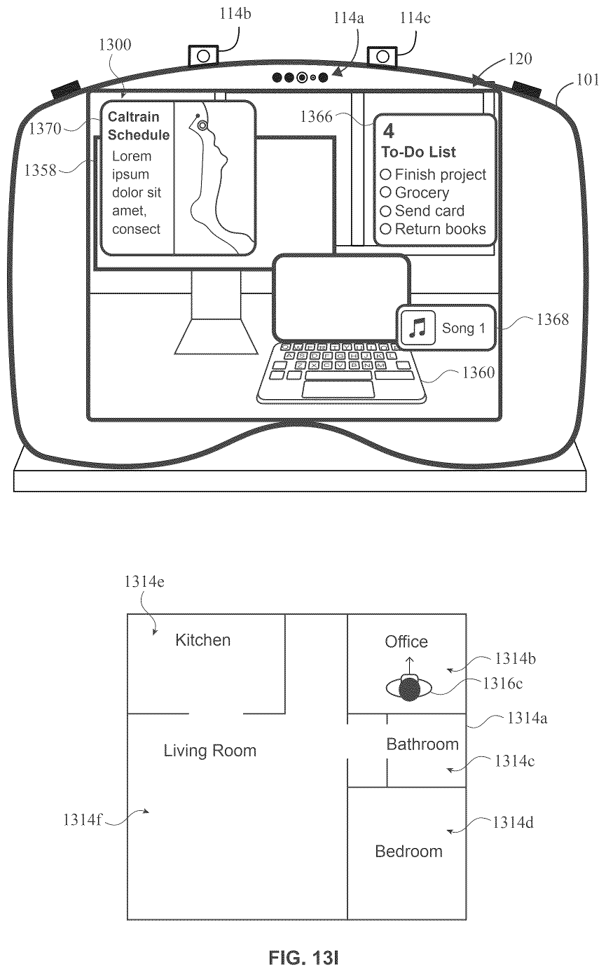

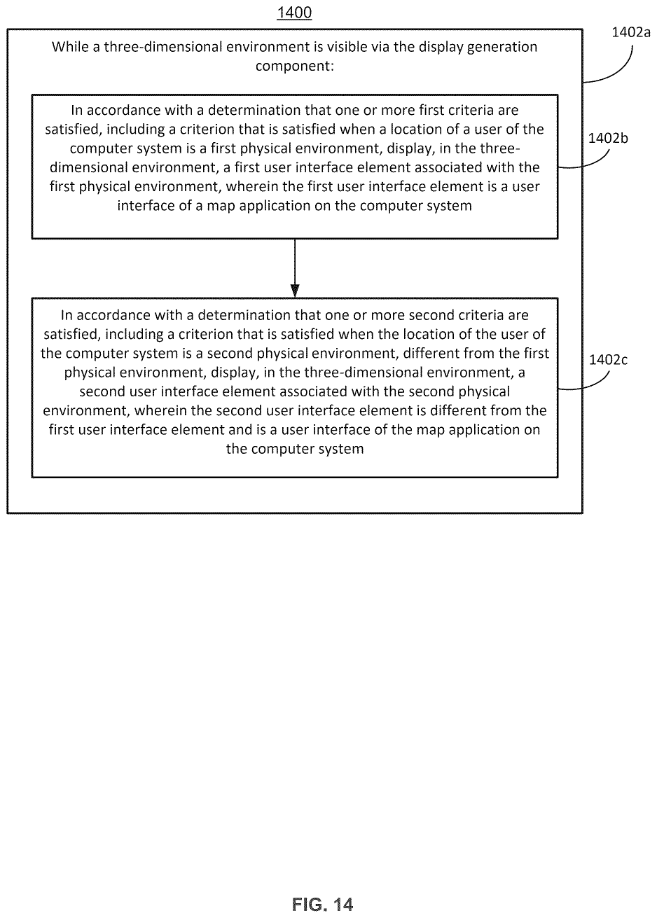

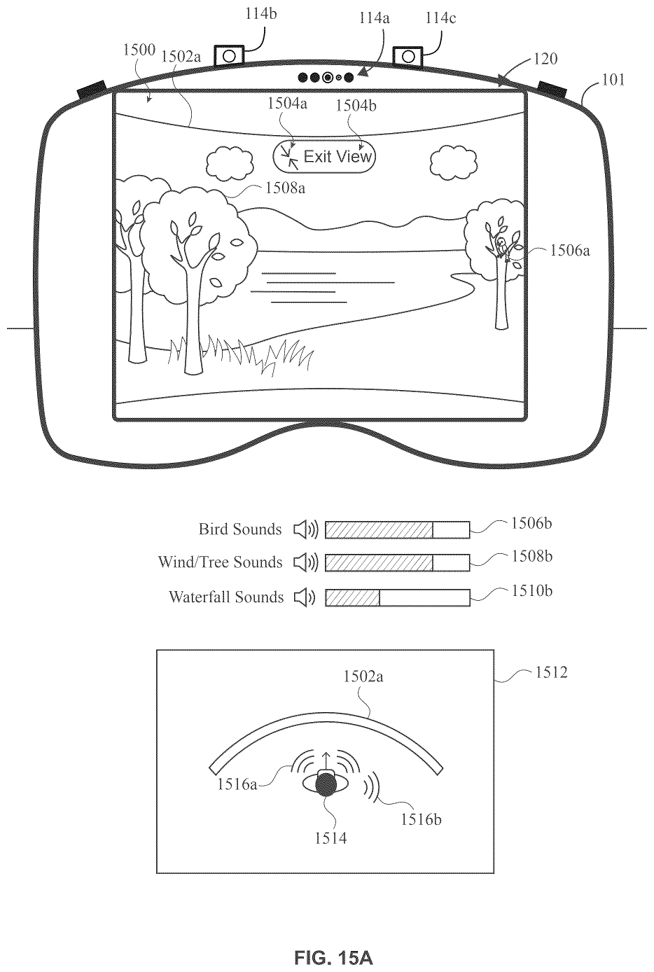

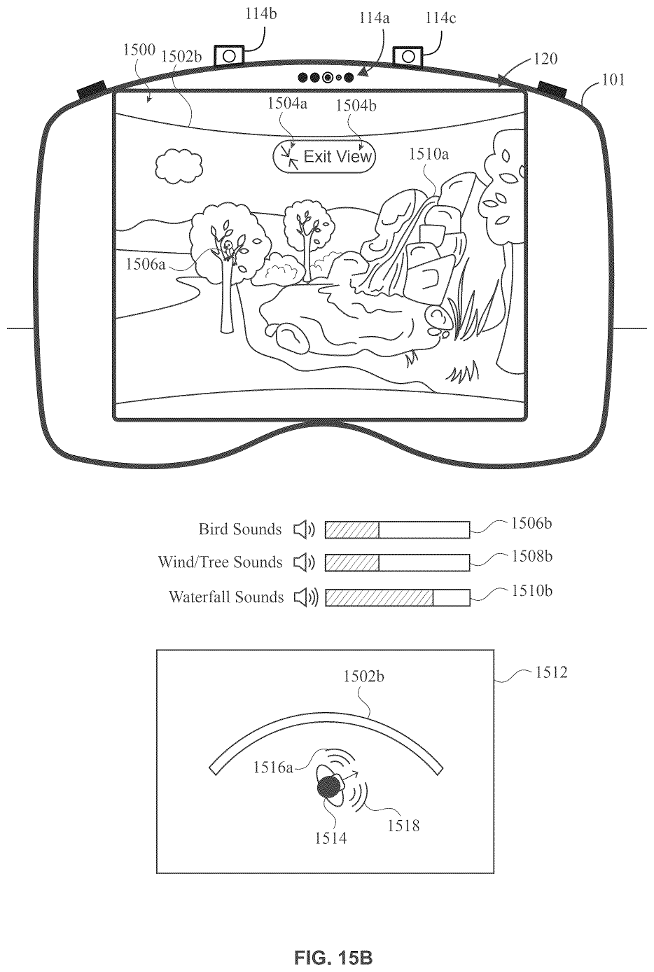

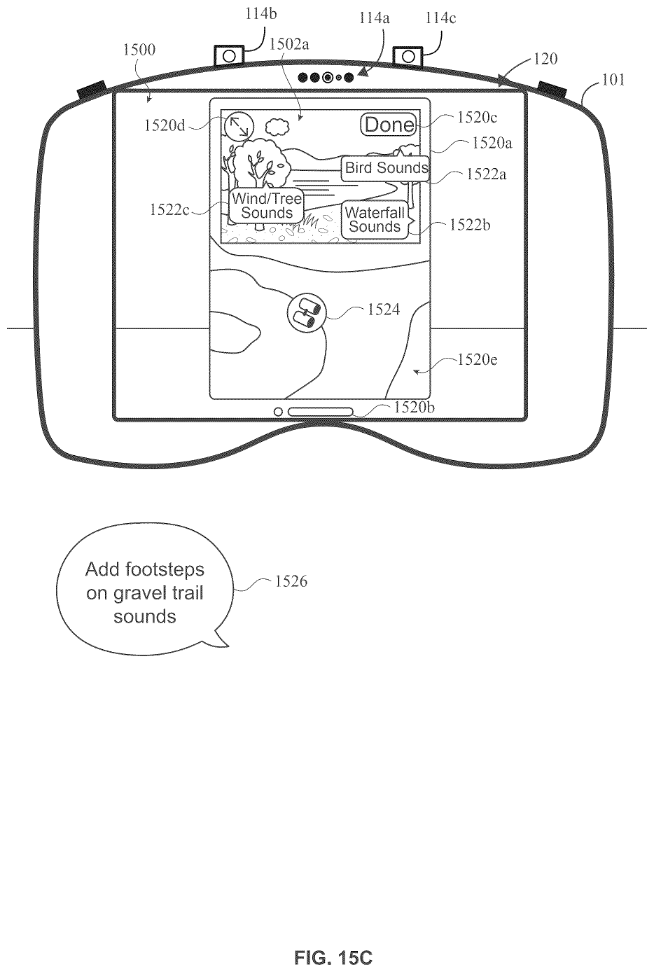

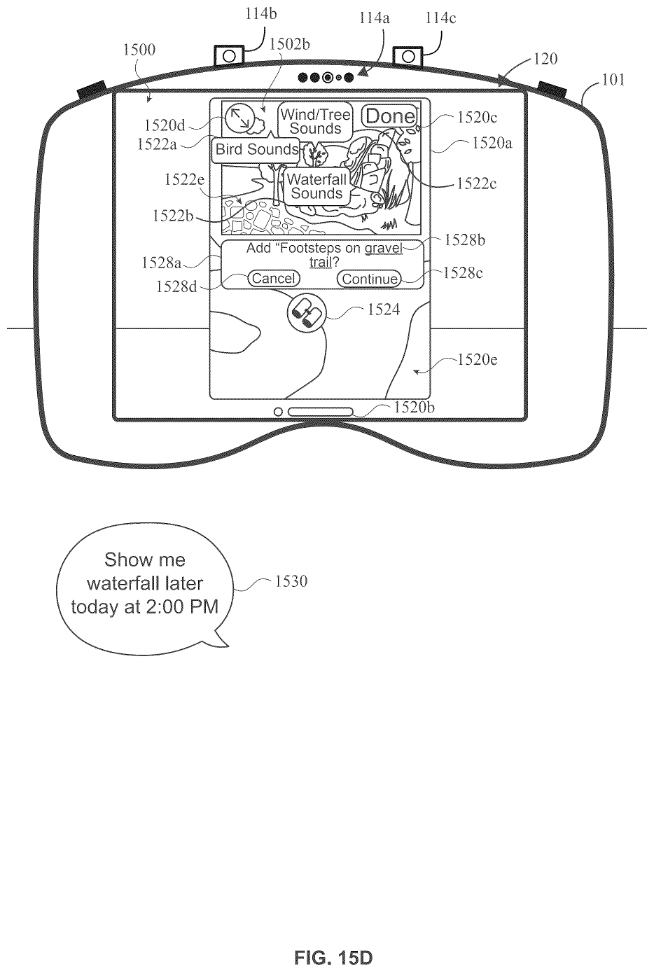

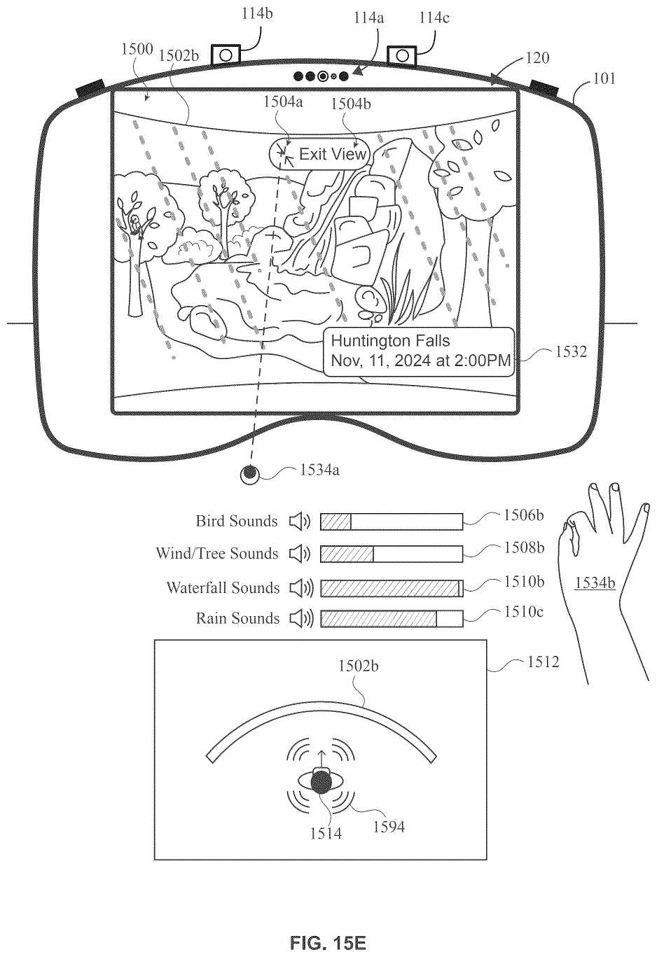

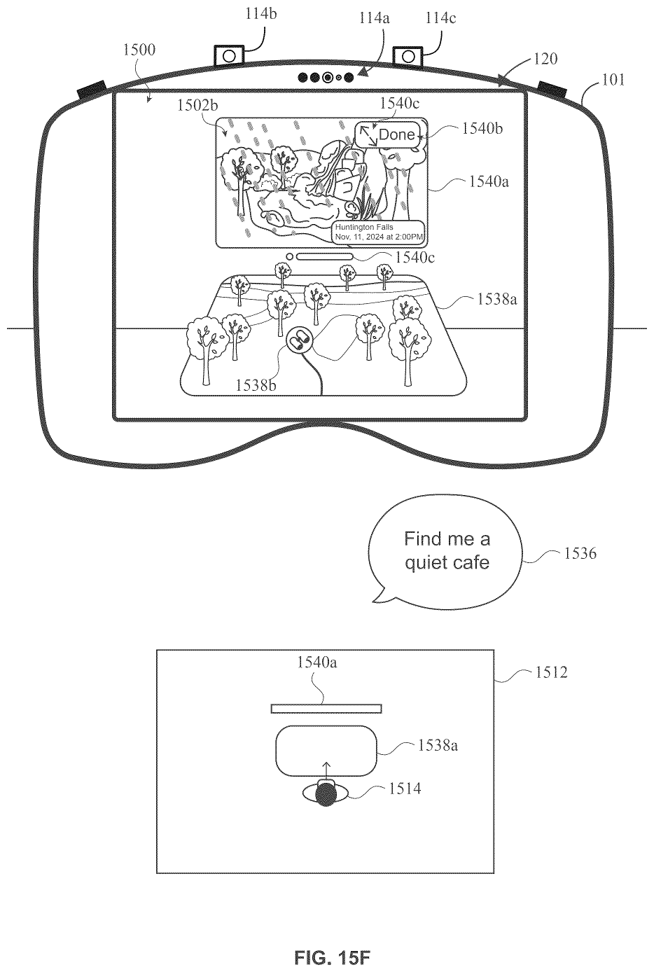

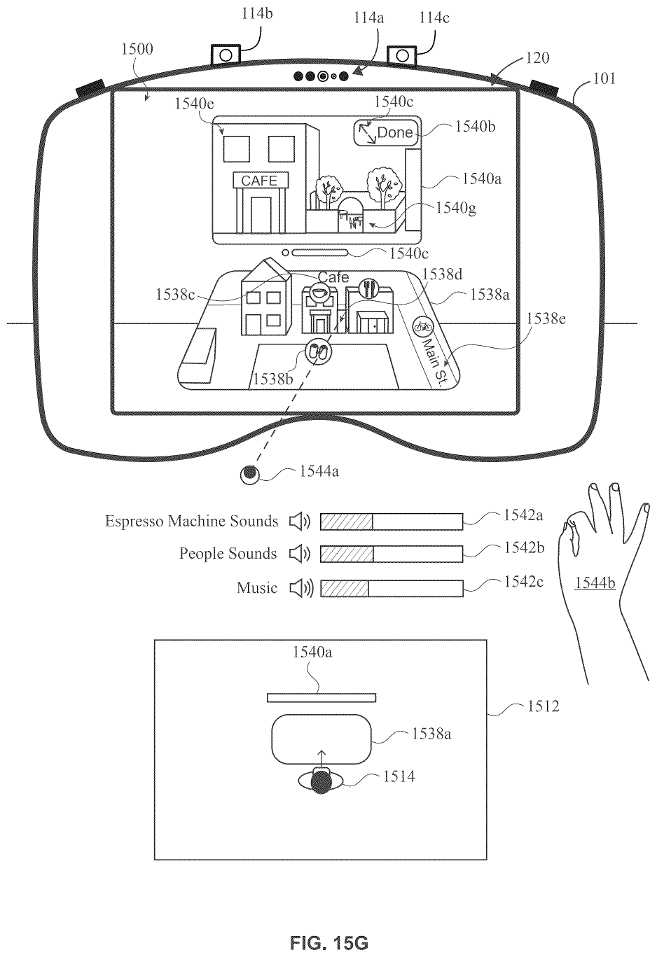

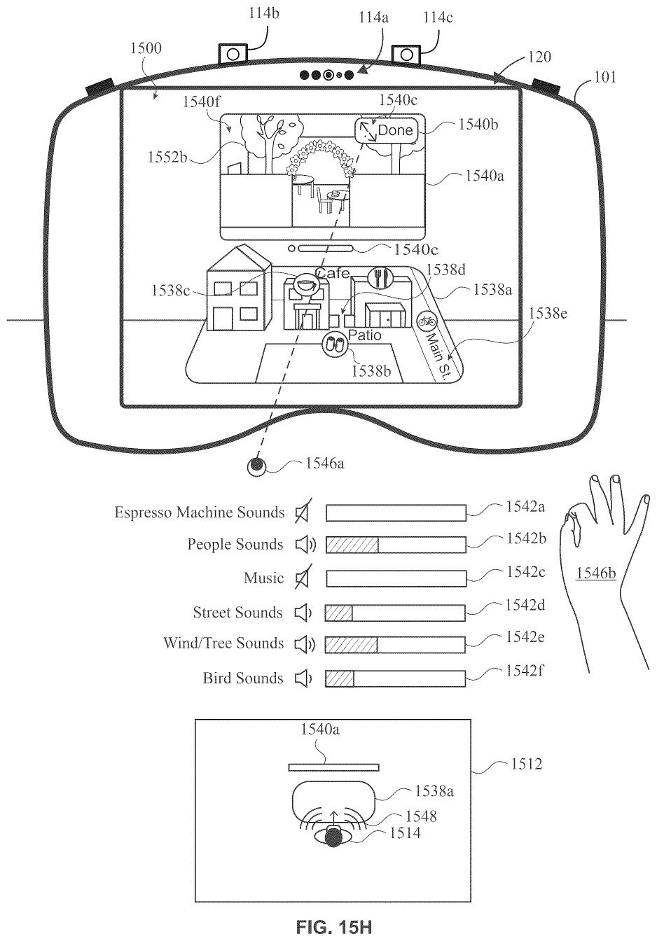

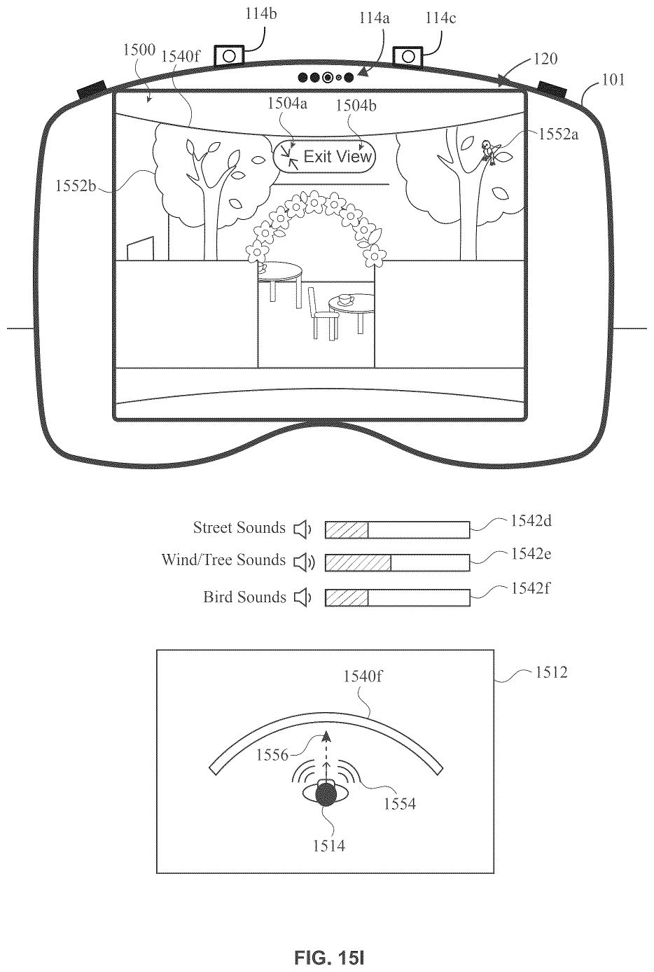

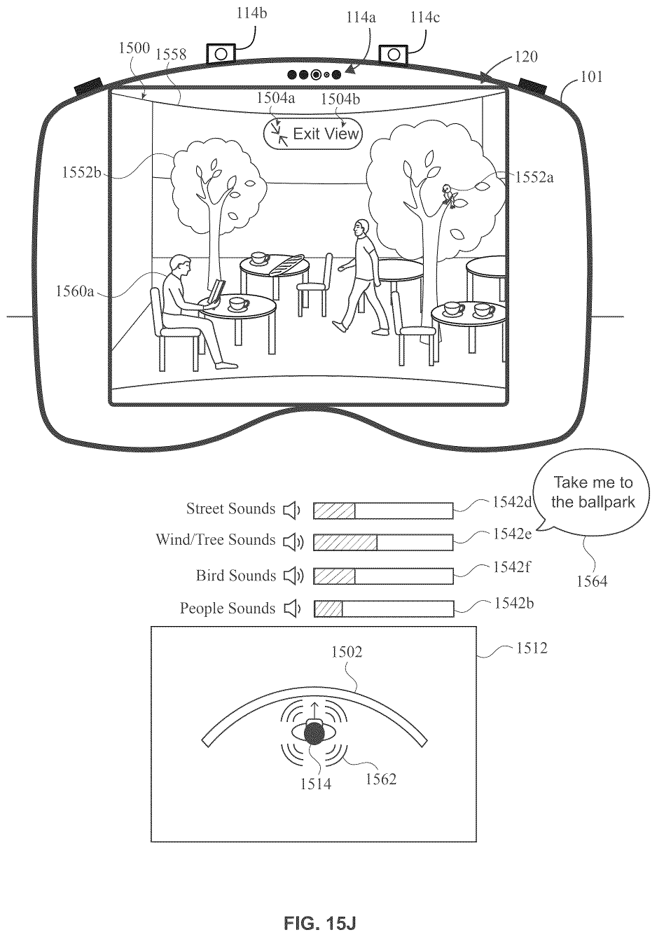

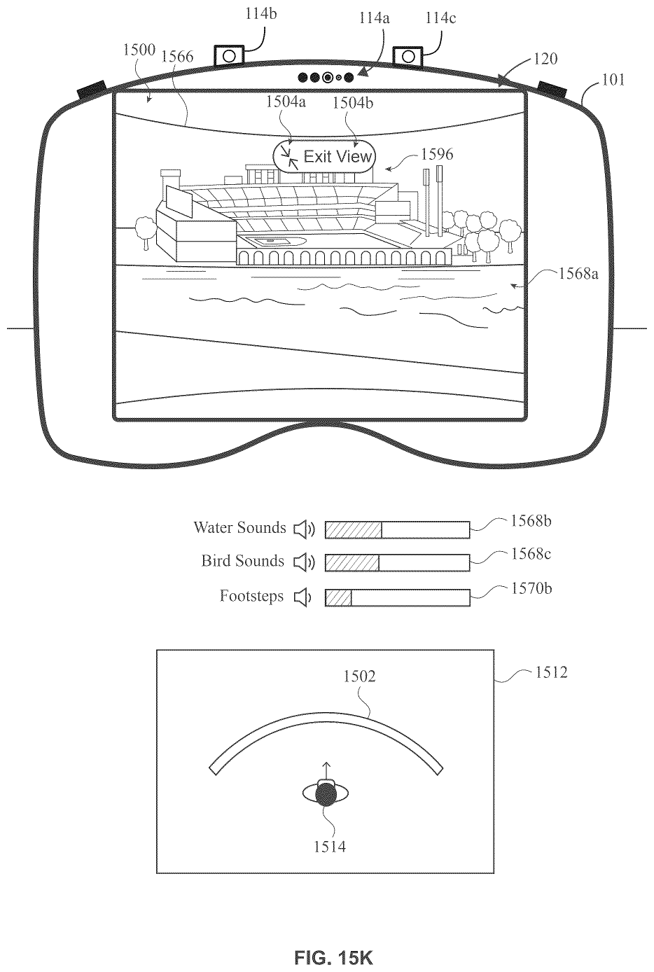

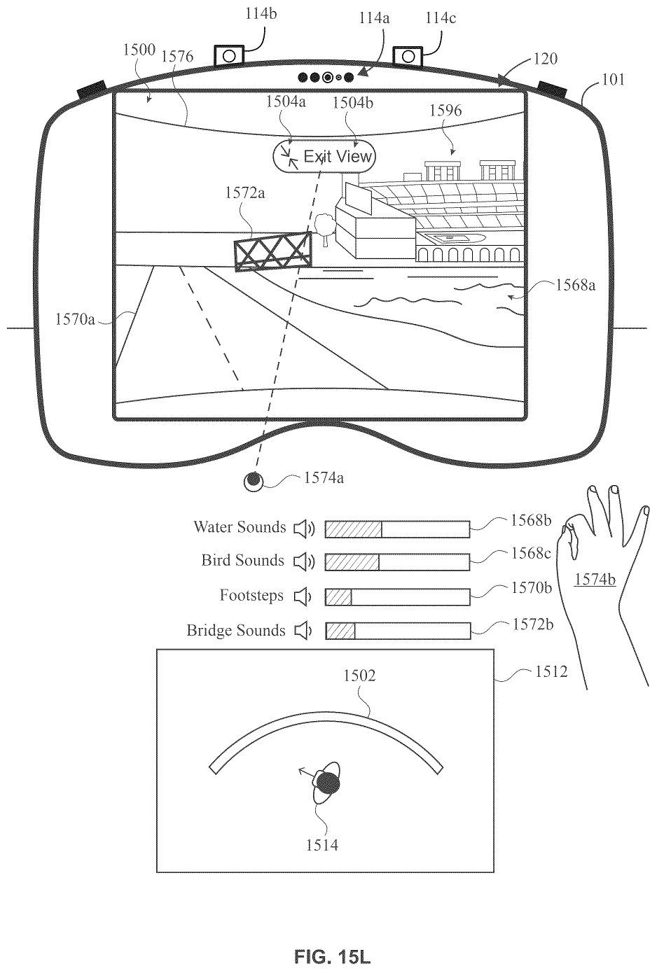

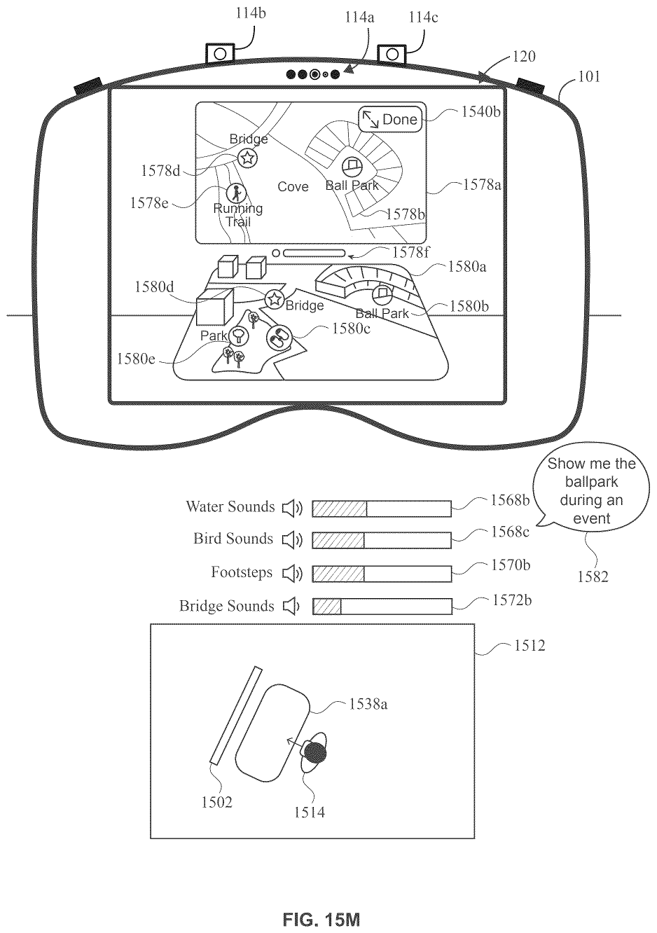

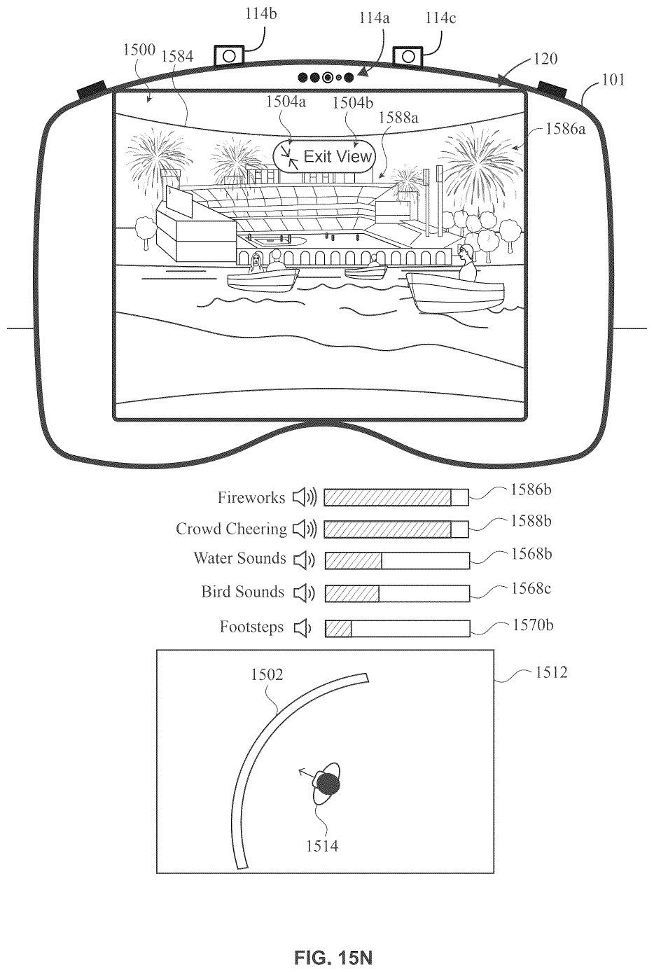

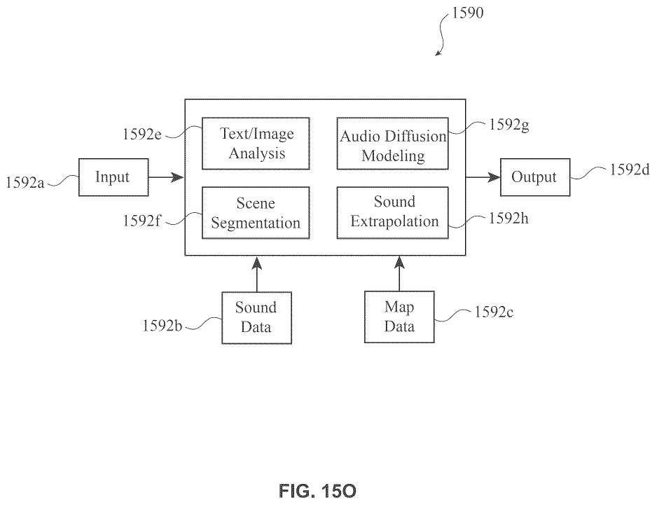

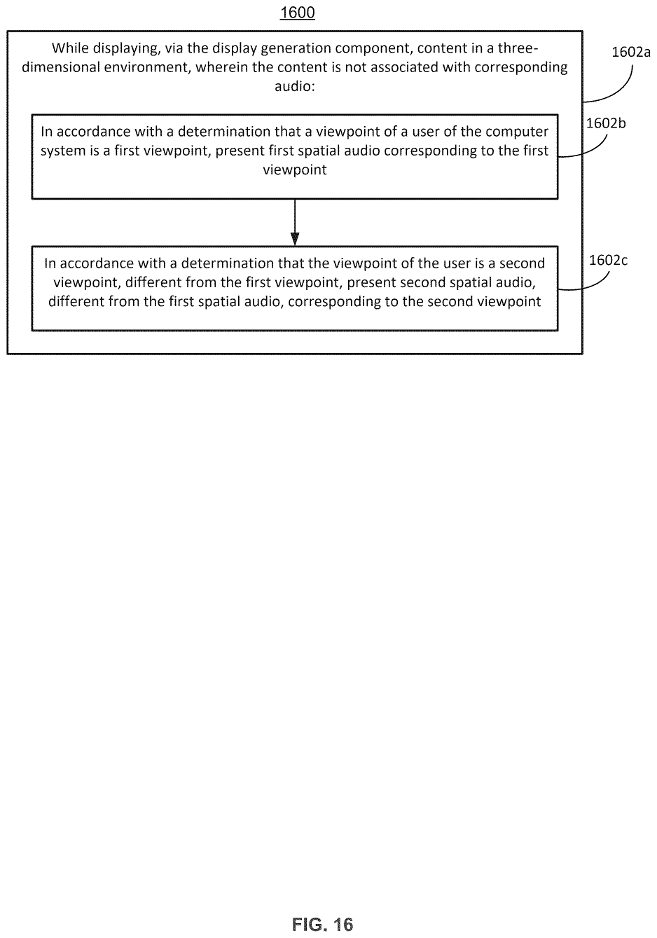

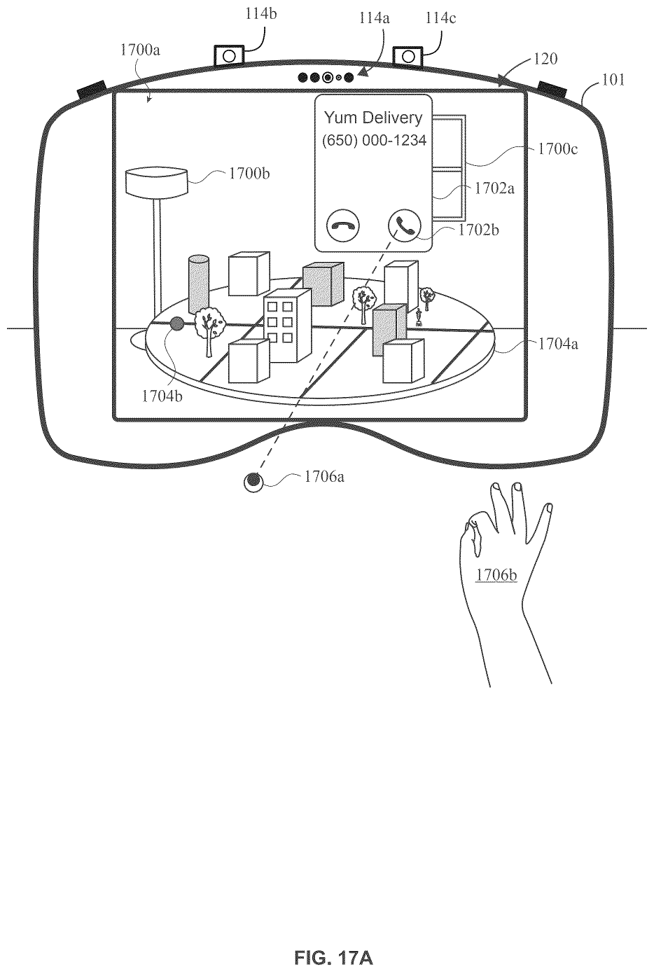

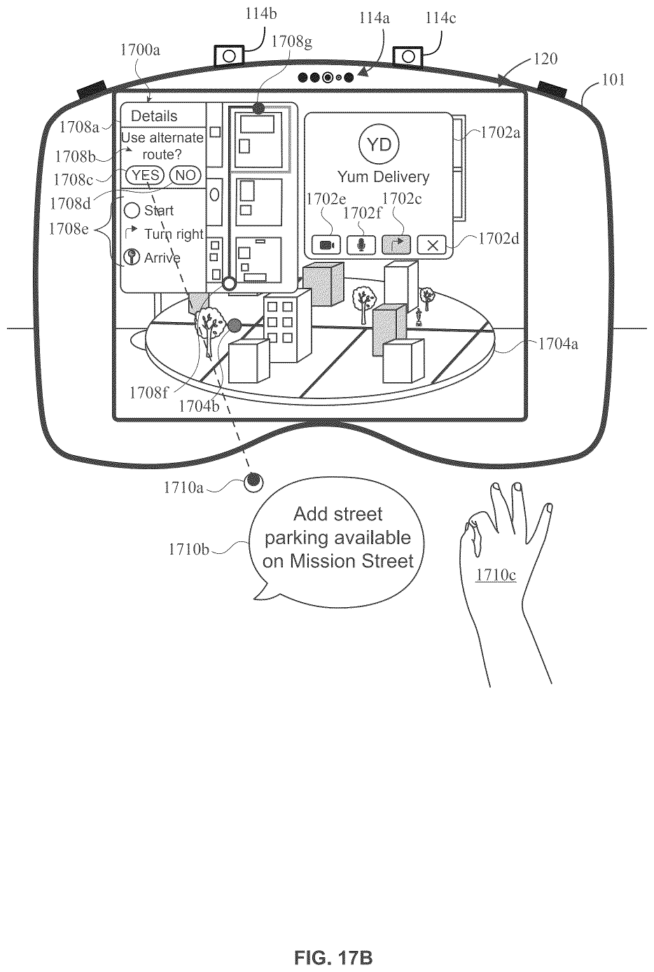

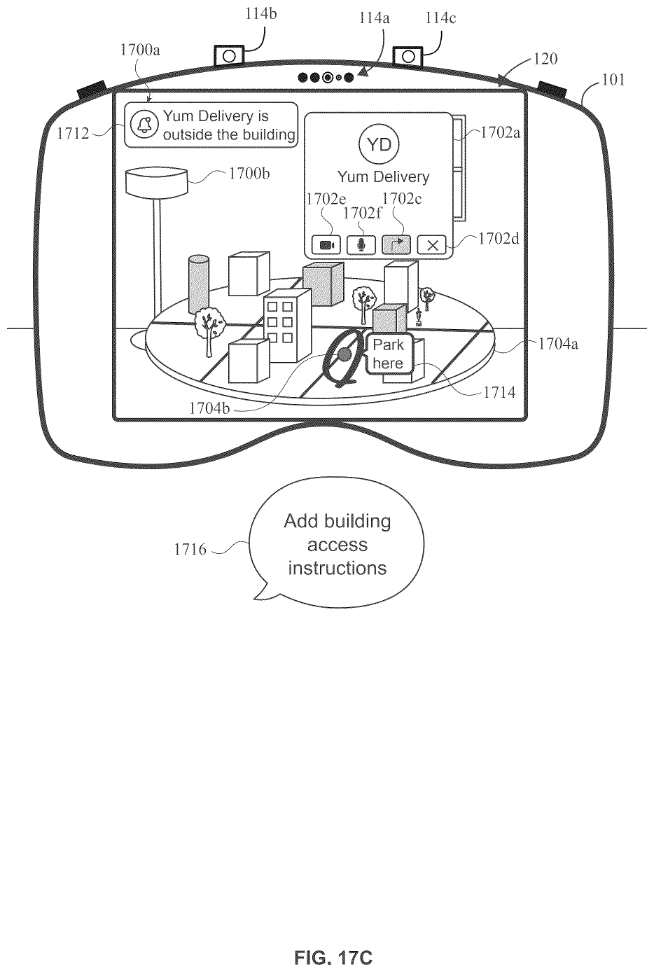

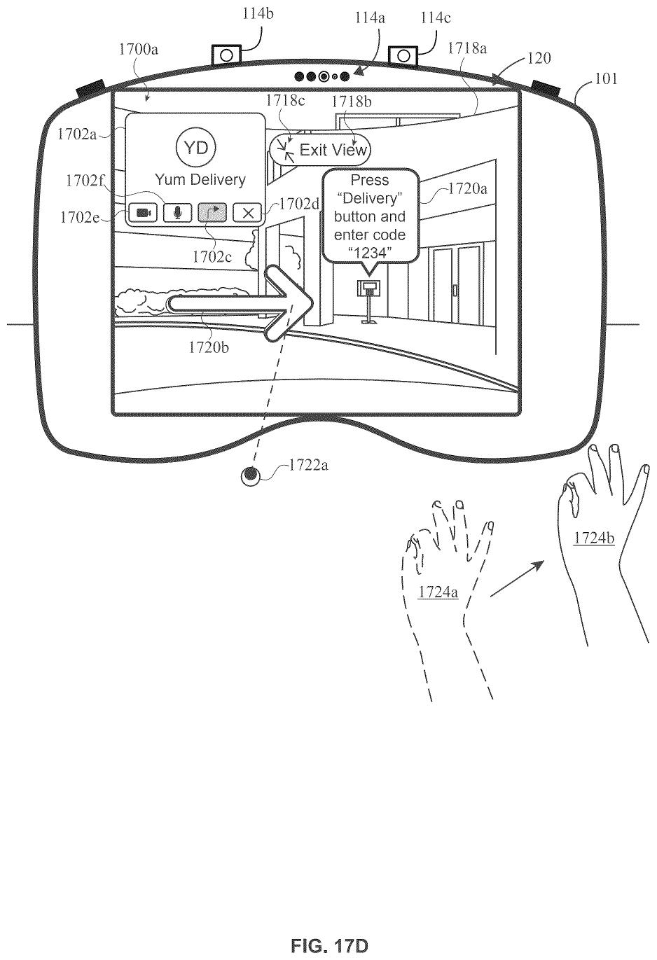

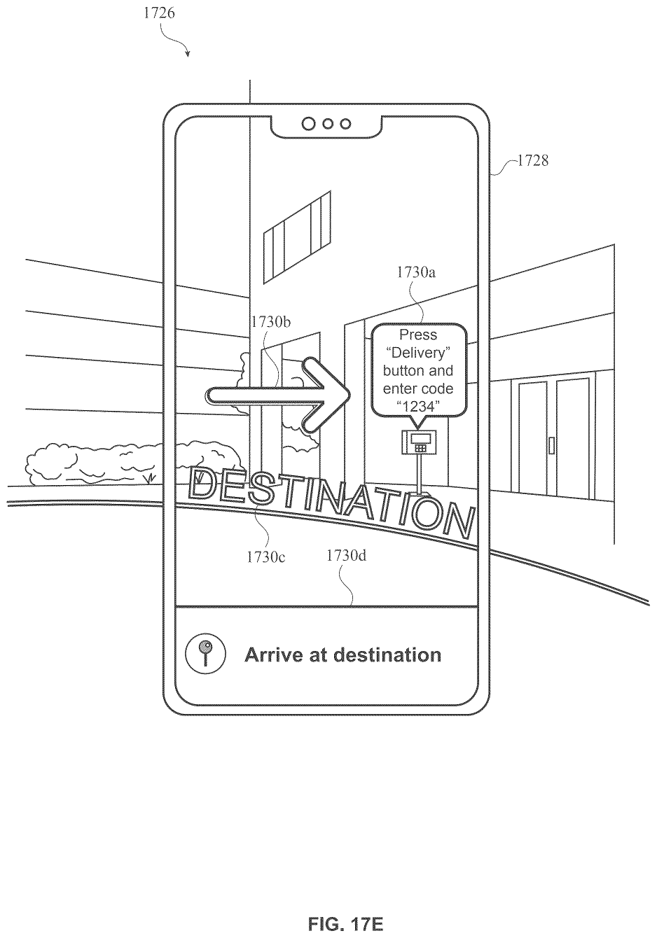

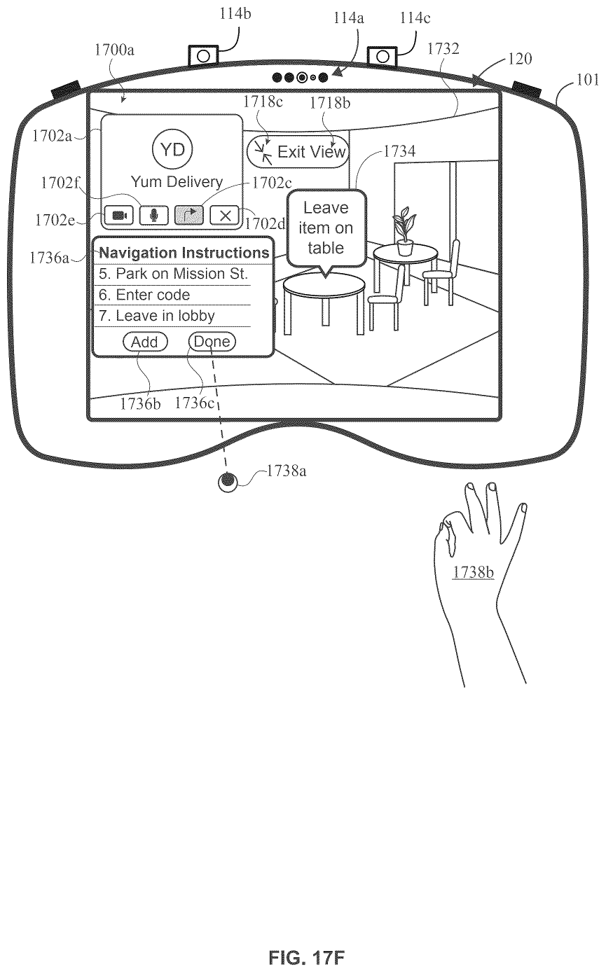

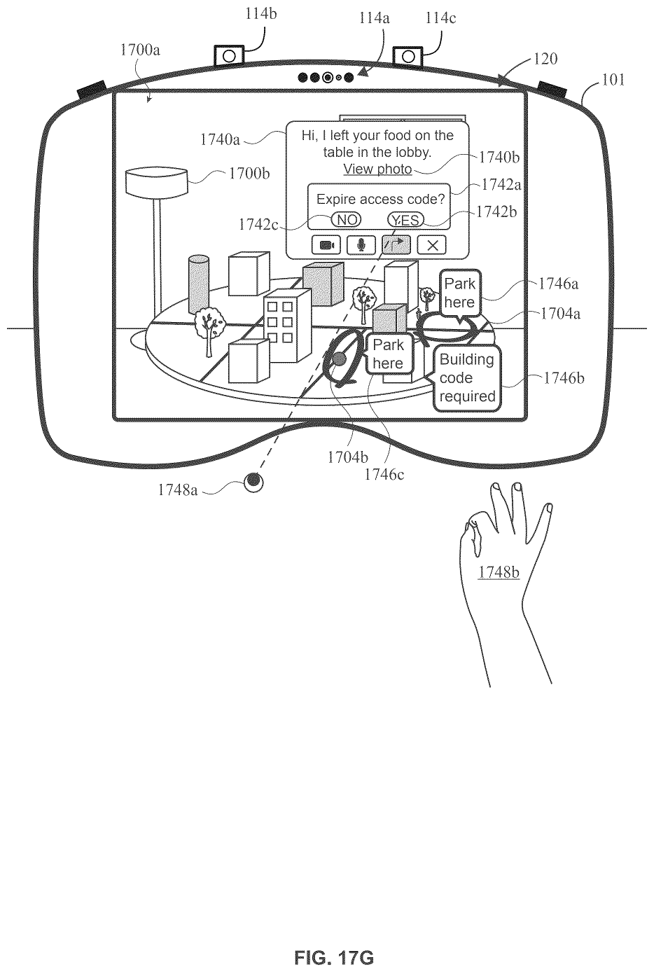

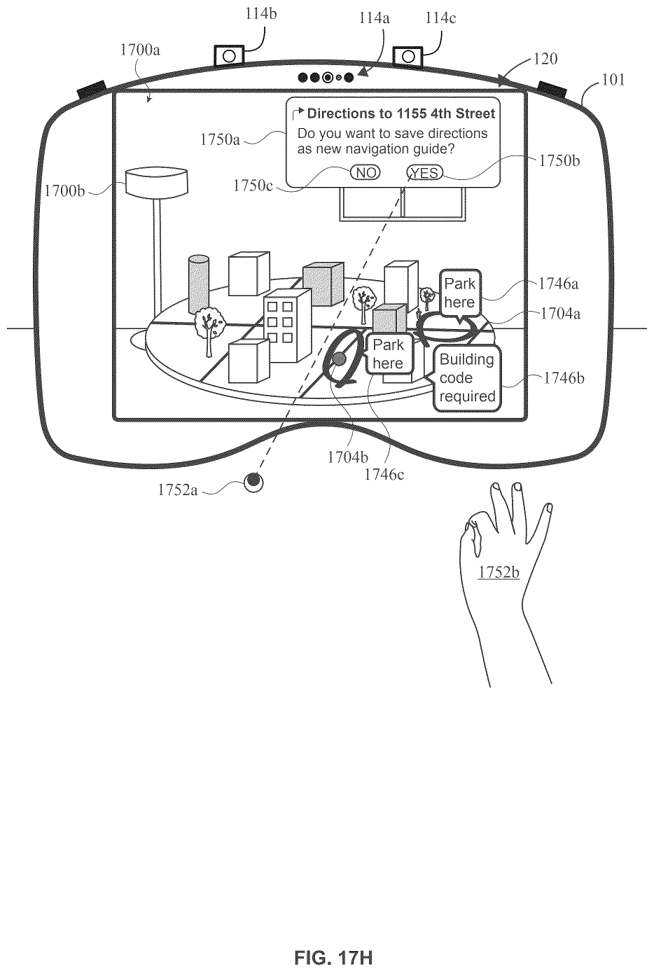

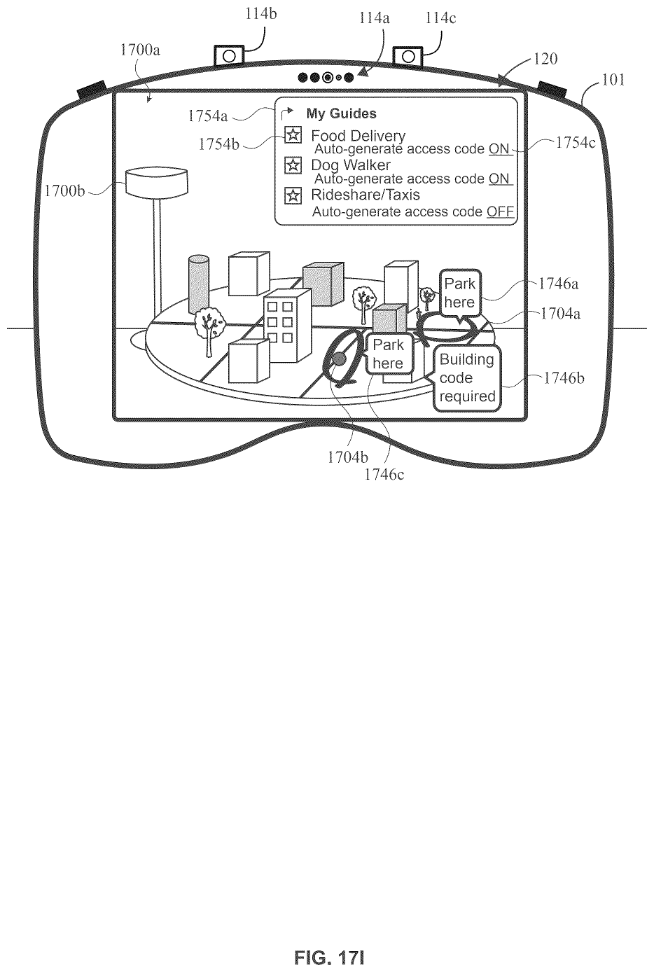

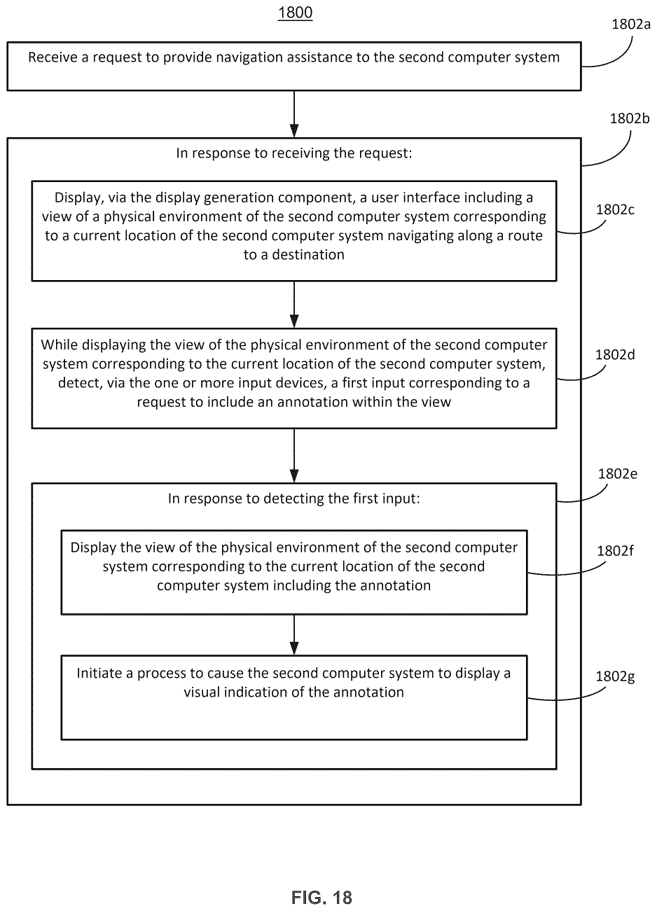

FIGS. 1A-6 provide a description of example computer systems for providing XR experiences to users (such as described below with respect to methods 800, 1000, and/or 1200). FIGS. 7A-7Q illustrate example techniques for dynamically presenting content in response to user input. FIG. 8 depicts a flow diagram of an exemplary method of dynamically presenting content in response to user input in accordance with some embodiments. FIGS. 9A-9F illustrate example techniques for dynamically presenting user interface elements. FIG. 10 depicts a flow diagram of an exemplary method of dynamically presenting user interface elements according to one or more appearance conditions in response to detecting an event in accordance with some embodiments. FIGS. 11A-11G illustrate example techniques for presenting relevant content in response to user input. FIG. 12 depicts a flow diagram of an exemplary method of presenting relevant content in response to user input in accordance with some embodiments. FIGS. 13A-13I illustrate example techniques for presenting user interface elements based on a location of a user of the computer system. FIG. 14 is a flow diagram of an exemplary method of presenting user interface elements based on a location of a user of the computer system in accordance with some embodiments. FIGS. 15A-150 illustrate example techniques for presenting spatial audio corresponding to content. FIG. 16 depicts a flow diagram of an exemplary method of presenting spatial audio corresponding to content in accordance with some embodiments. FIGS. 17A-17I illustrate example techniques for providing navigation assistance. FIG. 18 depicts a flow diagram of an exemplary method of providing navigation assistance in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

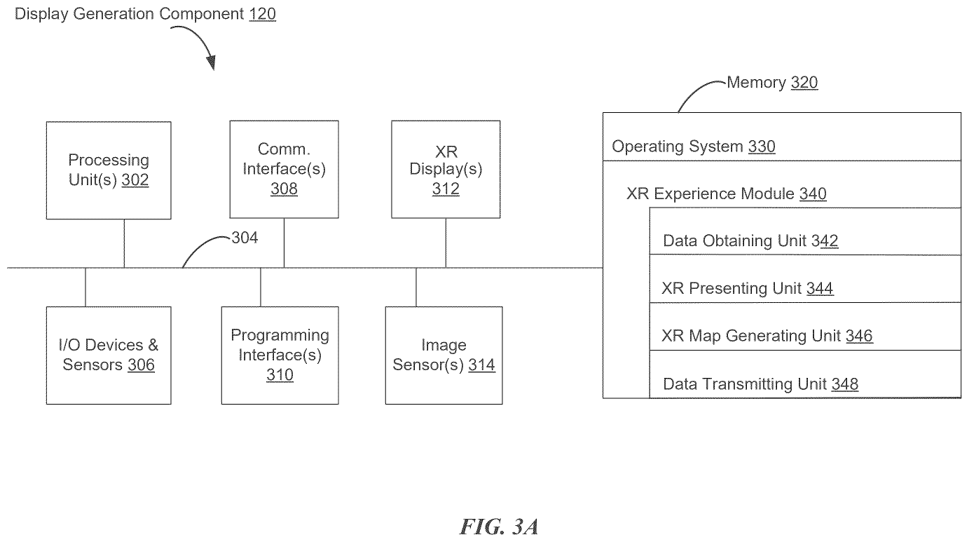

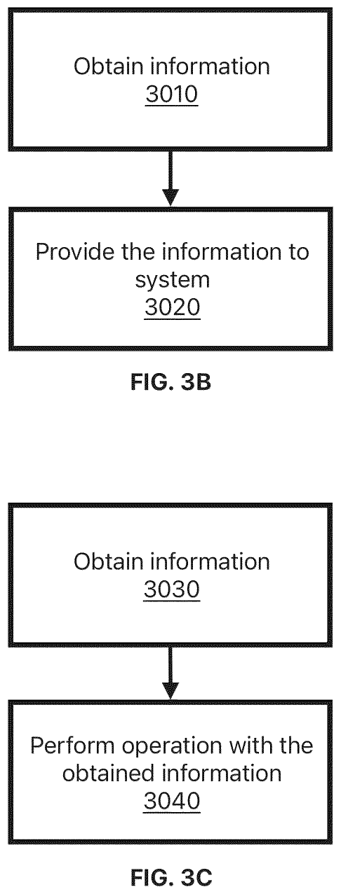

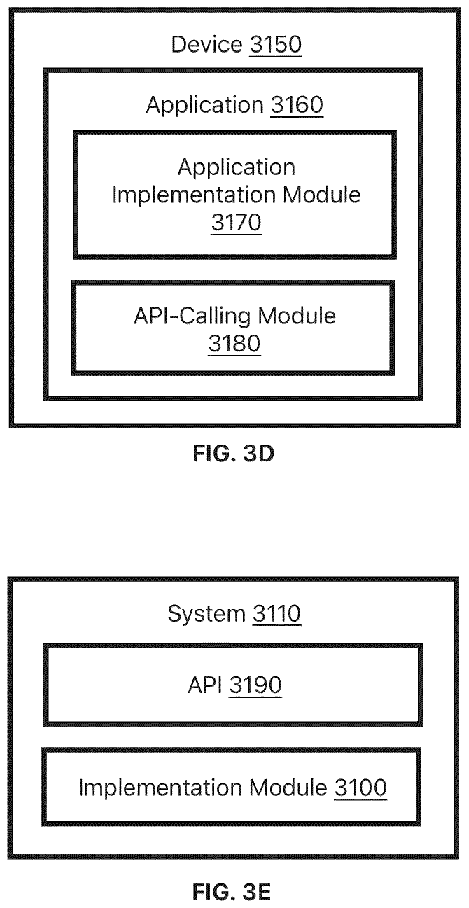

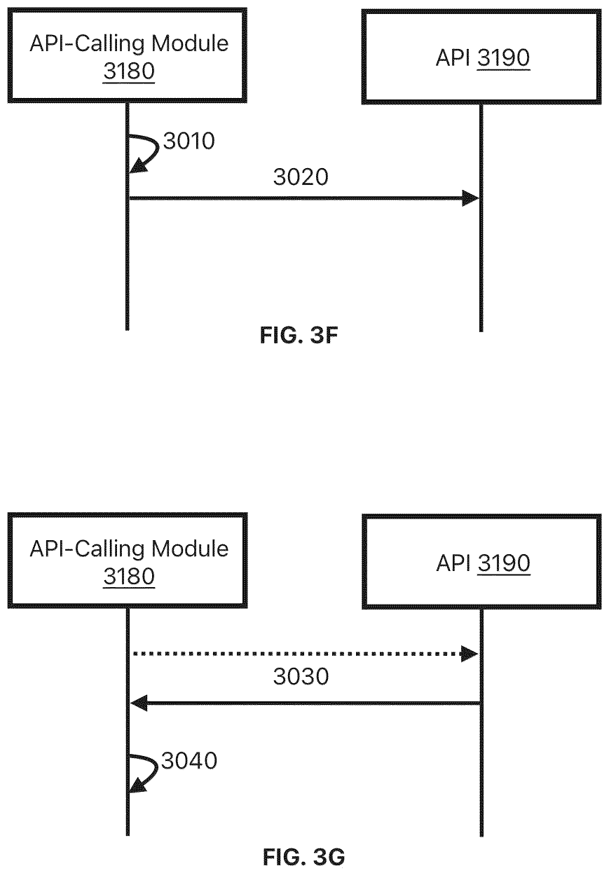

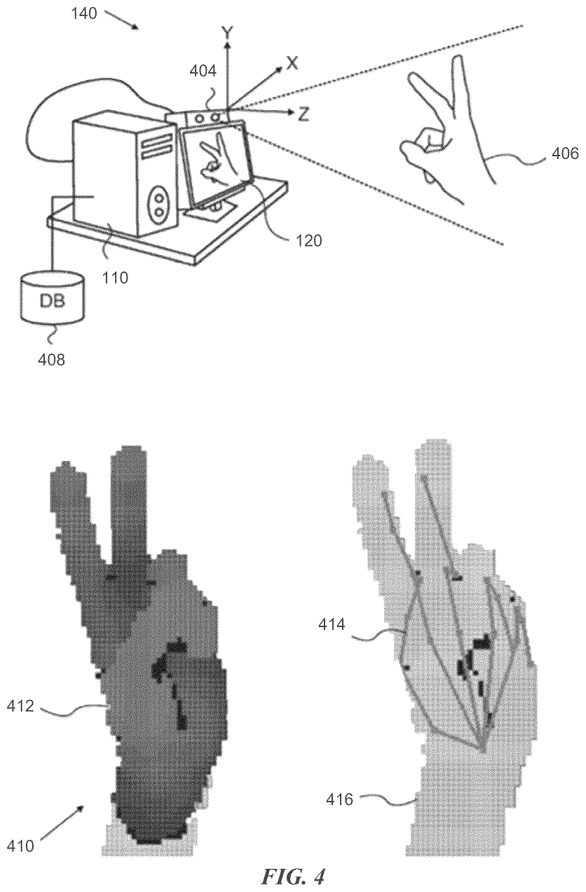

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation. In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

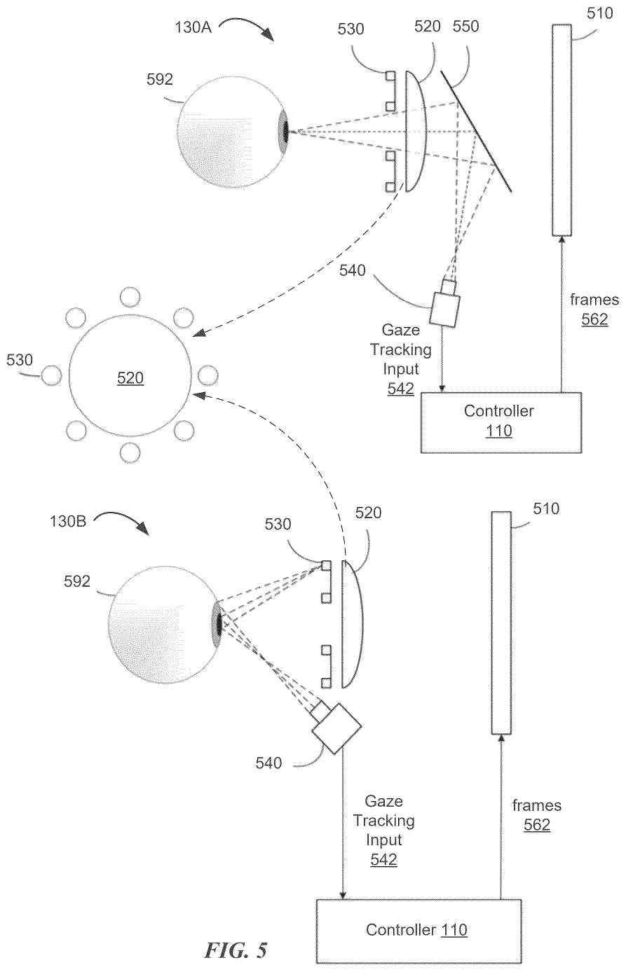

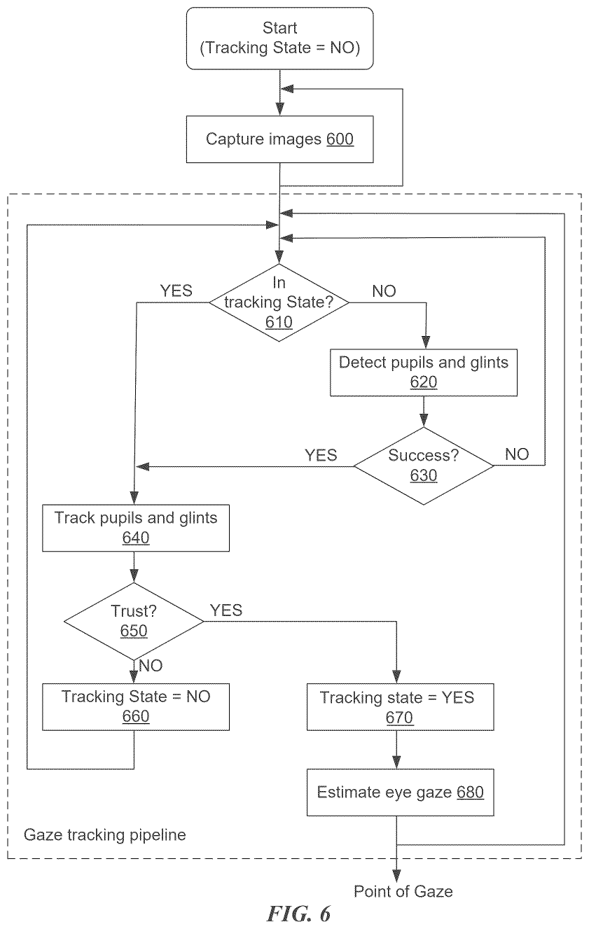

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 800, 1000, 1200, 1400, 1600, and 1800 (FIGS. 8, 10, 12, 14, 16, and 18) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

In some embodiments, a computer system displays one or more user interface elements including supplemental location-based content. The supplemental location-based content optionally include curated content of a respective physical area and/or representation(s) of the curated content, content captured by the user of the computer system while at or nearby the respective physical area and/or representation(s) of the content captured, representation(s) of points of interest at or nearby the respective physical area, representation(s) of points of interest at or nearby the respective physical area favorited by the user of the computer system, and/or other location-based content and/or representation(s) of other location-based content as discussed herein and in further detail below. In some embodiments, the computer system displays the one or more user interface elements in response to detecting that the user's attention is directed to the one or more user interface elements, thus providing confirmation that the user intends to interact with the one or more user interface elements without cluttering the user interface (e.g., by not always displaying the supplemental location-based content), which enhances operability of the computer system, reduces power usage of the computer system, reduces errors in the interaction between the user and the computer system, and reduces inputs needed to correct such errors.

FIGS. 7A-7Q illustrate examples of a computer system dynamically presenting content in response to user input in accordance with some embodiments.

FIG. 7A illustrates a computer system 101 (e.g., an electronic device) displaying, via a display generation component (e.g., display generation component 120 of FIG. 1A and/or display generation components 1-122a and 1-122b of FIG. 1C), a three-dimensional environment 700 from a viewpoint of a user of the computer system 101.

In FIG. 7A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100 of FIG. 1A), including one or more objects in the physical environment around computer system 101. In some embodiments, computer system 101 displays representations of the physical environment in three-dimensional environment 700. For example, three-dimensional environment 700 includes representations of a window 710, a lamp 712 in a room in which the computer system 101 is located. In some embodiments, the computer system 101 displays the three-dimensional environment 700 from a viewpoint of a user 716 (e.g., facing the back wall of the physical environment in which computer system 101 is located, as shown in overhead view 720 of the three-dimensional environment 700).

As discussed in more detail below, in FIG. 7A, display generation component 120 is illustrated as displaying one or more virtual objects in the three-dimensional environment 700. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 7A-7Q.

Display generation component 120 has a field of view (e.g., a field of view captured by external image sensors 114b and 114c and/or visible to the user via display generation component 120) that corresponds to the virtual objects shown in FIG. 7A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method(s) 800, 1000, and/or 1200), or via a trackpad from hand 406, and inputs described herein are optionally received via the trackpad or via air gestures/attention.

In FIG. 7A, three-dimensional environment 700 includes a plurality of virtual objects, such as graphical user interfaces and/or graphical user interface elements 702, 704, 706, and 708. In some embodiments, the virtual objects are optionally components of a graphical user interface or window of a map application as described with reference to method(s) 800, 1000 and/or 1200. For example, in FIG. 7A, the computer system 101 displays a first user interface element 708 (optionally, also referred to herein as a window or volume) at which the computer system 101 receives a text input defining a search query for performing a search operation as described with reference to method(s) 800 and/or 1000. In some embodiments, the text input identifies a respective physical area as search parameters for input to a request to present map content associated with the respective physical area.

In FIG. 7A, the computer system 101 also displays a navigation user interface element 702 representing a first physical area. The navigation user interface element 702 is analogous to and/or includes one or more characteristics of the navigation user interface element described in method(s) 800, 1000, and/or 1200. For example, the navigation user interface element 702 is a three-dimensional topographical map of the first physical area. In FIG. 7A, the navigation user interface element 702 includes three-dimensional representations of buildings, landmarks, points of interest, streets, trees, parks, bridges, bodies of water, and/or other geographical features in the first physical area. In FIG. 7A, the navigation user interface element 702 includes second navigation user interface element 704. In some embodiments, the second navigation user interface element 704 includes options that, when selected, cause the computer system 101 to: display the navigation user interface element 702 in a manner or style, different from the manner in which the computer system 101 displays the navigation user interface element 702 as shown in FIG. 7A; display the navigation user interface element 702 representing a second physical area, different from the first physical area as shown in FIG. 7A; or display the navigation user interface element 702 with a level of immersion, different from the level of immersion at which the computer system 101 displays the navigation user interface element 702 as shown in FIG. 7A. In some embodiments, the navigation user interface element includes a control element 706 that, when selected, causes the computer system 101 to perform respective operations associated with the navigation user interface element 702, such as close (e.g., cease to display) the navigation user interface element 702 or move (and/or resize) the navigation user interface element 702. In some embodiments, when the computer system 101 detects user input (e.g., described in more detail below) directed to control element 706 corresponding to a close operation, the computer system 101 closes the navigation user interface element 702, the second navigation user interface element 704, and/or the first user interface element 708.

In some embodiments, the computer system 101 changes a visual appearance of the first user interface element 708 and/or the navigation user interface element 702 in response to user input. For example, as shown in overhead view 720, the computer system 101 displays the first user interface element 708 with a first size and at a first distance relative to the viewpoint of the user 716 of the computer system 101. In some embodiments, the computer system 101 displays the navigation user interface element 702 with a second size greater than the first size of the first user interface element 708 as shown in overhead view 720. In some embodiments, the computer system 101 displays the navigation user interface element 702 at a second distance less than the first distance associated with the first user interface element 708 and relative to the viewpoint of the user 716 of the computer system 101. In some embodiments, the second distance at which the computer system 101 displays the navigation user interface element 702 is closer to the viewpoint of the user 716 of the computer system 101 than the first distance at which the computer system 101 displays the first user interface element 708.

In some embodiments, the computer system 101 detects user input 714 (e.g., gaze of the user of the computer system 101) directed to the first user interface element 708 for a period of time greater than a first time threshold 718b as shown by timer 718a indicative of gaze duration. In response to detecting user input 714, as shown in FIG. 7B, the computer system 101 displays, via display generation component 120, the first user interface element 708 with a second size greater than the first size of the first user interface element 708 prior to detecting user input 714. In FIG. 7B, the first user interface element 708 includes map content and/or graphical user interface elements. For example, the first user interface element 708 includes representations of respective collections of content, text, images, video, hyperlinks, and/or audio content associated with the first physical area. In some embodiments, the map content and/or graphical user interface elements of the first user interface element was not previously displayed prior to detecting user input 714.

In some embodiments, the computer system 101 changes a distance at which the first user interface element 708 is displayed relative to the viewpoint of the user 716 in response to user input. For example, in FIG. 7B, the computer system 101 detects user input 714 (e.g., gaze of the user of the computer system 101) directed to the first user interface element 708 for a period of time greater than a second time threshold 718c as shown by timer 718a. In some embodiments, the second time threshold 718c is greater than the first time threshold 718b. In response to detecting user input 714, as shown in FIG. 7C, the computer system 101 displays, via display generation component 120, the first user interface element 708 at a second distance from the viewpoint of the user, less than the first distance from the viewpoint of the user at which the computer system 101 displayed the first user interface element 708 prior to detecting user input 714. In some embodiments, the second distance relative to the viewpoint of the user 716 is closer to the viewpoint of the user 716 than the first distance. In some embodiments, displaying the first user interface element 708 at the second distance includes obscuring one or more portions of the navigation user interface element 702 as shown in FIG. 7C.

In some embodiments, the computer system 101 displays content related to a point of interest (e.g., a representation of a point of interest included in the first user interface element 708). For example, in FIG. 7C, the computer system 101 detects user input 714 (e.g., gaze of the user of the computer system 101) directed to a representation of a point of interest included in the first user interface element 708 for a period of time greater than a second time threshold 718c as shown by timer 718a. In response to detecting user input 714 in FIG. 7C, the computer system 101 displays, via display generation component 120, a point of interest user interface element 724, as shown in FIG. 7D. In some embodiments, the point of interest user interface element 724 includes photos, videos, media, and/or other content related to the point of interest as described in more detail below with reference to method 800.

In some embodiments, the computer system 101 presents a content viewing experience. For example, in FIG. 7D, the computer system 101 detects user input 714 (e.g., gaze of the user of the computer system 101) directed to a photo included in the point of interest user interface element 724 for a period of time greater than a second time threshold 718c as shown by timer 718a. In response to detecting user input 714 in FIG. 7D the computer system 101 displays, via display generation component 120, a representation of the physical environment with a visual appearance different from the visual appearance of the representation of the physical environment prior to detecting user input 714, as shown in FIG. 7E. In some embodiments, the visual appearance includes a degree of lighting, color, opacity, and/or other visual characteristic described in method(s) 800, 1000, and/or 1200. In FIG. 7E, the computer system 101 displays the representation of the physical environment with a degree of lighting that is less than the degree of lighting associated with displaying the point of interest user interface element 724. In some embodiments, in response to detecting user input 714, as shown in FIG. 7E, the computer system 101 displays the point of interest user interface element 724 with a size larger than the size of the point of interest user interface element 724 prior to detecting the user input 714. In some embodiments, displaying the point of interest user interface element 724 with a size larger includes displaying additional content related to the point of interest and/or additional features such a look around option 726 associated with a respective content item. For example, look around 726 is associated with “Photo A.”

In some embodiments, the computer system 101 displays map content with a respective degree of immersion in response to user input. For example, in FIG. 7E, the computer system 101 detects user input 714 (e.g., gaze of the user of the computer system 101) directed to the look around option 726 associated with “Photo A” for a period of time greater than a second time threshold 718c as shown by timer 718a. In response to detecting user input 714, as shown in FIG. 7F, the computer system 101 displays, via display generation component 120, the point of interest user interface element 728 including a representation of “Photo A” with a partial degree of immersion as described with reference to method(s) 800, 1000, and/or 1200. In FIG. 7F, the computer system 101 displays a semi-circular view of “Photo A” that includes 360 degrees camera views taken from and/or of a respective physical location of the point of interest location as illustrated in overhead view 720.

In another example, in FIG. 7F, the computer system 101 detects user input 715 (e.g., finger depression described in more detail in method 800) directed to a hardware input device (e.g., rotatable input device or digital crown) of the computer system 101. In response to detecting user input 715 in FIG. 7F, the computer system 101 displays, via display generation component 120, the point of interest user interface element 728 including a representation of “Photo A” with a full degree of immersion as described with reference to method(s) 800, 1000, and/or 1200, and as shown in FIG. 7G. In FIG. 7G, the computer system 101 displays a wraparound view of “Photo A” that includes 360 degrees camera views taken from and/or of a respective physical location of the point of interest location as illustrated in overhead view 720.

In some embodiments, the computer system 101 displays the navigation user interface element 702 and/or the first user interface element 708 having respective sizes. For example, in FIG. 7H, the computer system 101 detects user input 714 that includes an air pinch gesture 722 (e.g., described in more detail in method(s) 800, 1000, and/or 1200) while gaze of the user of the computer system 101 is directed to a representation of a building of the navigation user interface element 702. In response to detecting the user input 714, as shown in FIG. 7I, the computer system 101 displays, via display generation component 120, a point of interest content user interface element 730 associated with the representation of the building of the navigation user interface element 702. In FIG. 7I, the point of interest content user interface element 730 has a first size relative to the three-dimensional environment 700. In FIG. 7I, the computer system detects user input 714 that includes an air pinch gesture 722 including movement of the air pinch gesture 722 forwards along a z-axis (e.g., away from the viewpoint of the user) while gaze of the user of the computer system 101 is directed to control element 706. In response to detecting the user input 714 in FIG. 7I the computer system 101 moves the navigation user interface element 702 and the first user interface element 708 in accordance with movement of the air pinch gesture 722, as shown in FIG. 7J. In the overhead view 720, the navigation user interface element 702 and the first user interface element 708 moved to respective locations further from the viewpoint of the user 716 than the respective locations of the navigation user interface element 702 and the first user interface element 708 prior to detecting movement of air pinch gesture 722. In FIG. 7J, the size of the navigation user interface element 702 relative to the three-dimensional environment 700 is the same as the size of the navigation user interface element 702 prior to detecting movement of air pinch gesture 722. In some embodiments, the respective sizes of the point of interest content user interface element 730 and the first user interface element 708 are smaller than the respective sizes of the point of interest content user interface element 730 and the first user interface element 708 prior to detecting movement of air pinch gesture 722.

In another example, in FIG. 7J, the computer system 101 detects user input 714 that includes an air pinch gesture 722 including movement of the air pinch gesture 722 backwards along a z-axis (e.g., towards the viewpoint of the user) while gaze of the user of the computer system 101 is directed to control element 706. In response to detecting the user input 714, as shown in FIG. 7K, the computer system 101 moves the navigation user interface element 702 and the first user interface element 708 in accordance with movement of the air pinch gesture 722. In the overhead view 720, the navigation user interface element 702 and the first user interface element 708 moved to respective locations closer to the viewpoint of the user 716 than the respective locations of the navigation user interface element 702 and the first user interface element 708 prior to detecting movement of air pinch gesture 722. In FIG. 7K, the size of the navigation user interface element 702 relative to the three-dimensional environment 700 is the same as the size of the navigation user interface element 702 prior to detecting movement of air pinch gesture 722. In some embodiments, the respective sizes of the point of interest content user interface element 730 and the first user interface element 708 are larger than the respective sizes of the point of interest content user interface element 730 and the first user interface element 708 prior to detecting movement of air pinch gesture 722.

In some embodiments, the computer system 101 displays the navigation user interface element 702, the first user interface element 708, and/or the point of interest content user interface element 730 having respective orientations. For example, in FIG. 7K, the respective orientations of the navigation user interface element 702, the first user interface element 708, and the point of interest content user interface element 730 face towards the viewpoint of the user. In FIG. 7K, the computer system 101 detects movement of user 716 from a first location to a second location in the physical environment as shown in overhead view 720. In some embodiments, in response to detecting movement of user 716 to the second location, the computer system 101 displays the first user interface element 708 with an orientation facing the user as shown in FIG. 7L. In some embodiments, in response to detecting movement of user 716 to the second location, the computer system 101 maintains the respective orientations of the navigation user interface element 702 and the point of interest content user interface element 730 (e.g., the computer system 101 does not change the respective orientations of the navigation user interface element 702 and the point of interest content user interface element 730 to face the user).

In another example, in FIG. 7L, the computer system 101 detects user input 714 (e.g., gaze of the user of the computer system 101) directed to a representation of a building of the navigation user interface element 702 for a period of time greater than a second time threshold 718c as shown by timer 718a. In response to detecting the user input 714, as shown in FIG. 7M, the computer system 101 displays, via display generation component 120, a second point of interest content user interface element 732 associated with the representation of the building of the navigation user interface element 702. In FIG. 7M, the second point of interest content user interface element 732 has an orientation and size different from the orientation and size of the point of interest content user interface element 730. For example, the second point of interest content user interface element 732 is oriented towards the viewpoint of the user and is a size larger than the point of interest content user interface element 730. In some embodiments, in response to detecting the user input 714, the computer system 101 displays the first user interface element 708 with a second size, smaller than the size of the first user interface element 708 prior to detecting the user input 714. For example, the first user interface element 708 is analogous to and/or includes one or more characteristics of the first user interface element 708 illustrated and described in FIG. 7A.

In FIG. 7M, the computer system 101 detects user input 714 (e.g., gaze of the user of the computer system 101) directed to a representation of a building of the navigation user interface element 702 for a period of time greater than a second time threshold 718c as shown by timer 718a. In response to detecting the user input 714 in FIG. 7M, the computer system 101 displays, via display generation component 120, a third point of interest content user interface element 734 associated with the representation of the building of the navigation user interface element 702, as shown in FIG. 7N. In FIG. 7N, the third point of interest content user interface element 732 has an orientation facing the viewpoint of the user while the computer system 101 displays the point of interest content user interface element 730 and the second point of interest content user interface element 732 having respective orientations not facing the viewpoint of the user. In FIG. 7N, the computer system 101 displays the point of interest content user interface element 730 and the second point of interest content user interface element 732 at respective distances further from the viewpoint of the user. In some embodiments, when the computer system displays the second point of interest content user interface element 732 at respective distances further from the viewpoint of the user, such that other map content, such as label or representation 736 is fully displayed (e.g., no longer obscured by the second point of interest content user interface element 732). In some embodiments, the computer system 101 displays the third point of interest content user interface element 732 at a respective distance closer to the viewpoint of the user than the respective distances of the point of interest content user interface element 730 and the second point of interest content user interface element 732. Thus, in some embodiments, the third point of interest content user interface element 732 partially obscures one or more portions of the point of interest content user interface element 730 and the second point of interest content user interface element 732.

In FIG. 7N, the computer system detects user input 714 (e.g., gaze of the user of the computer system 101) directed to control element 706 for a period of time greater than a first time threshold 718b as shown by timer 718a. In response to detecting the user input 714, as shown in FIG. 7O, the computer system 101 displays the point of interest content user interface element 730, the second point of interest content user interface element 732, and the third point of interest content user interface element 734 at respective distances further from the viewpoint of the user, such that representations of building and/or other representations of geographical features of the navigation user interface element 702 are fully displayed (e.g., no longer obscured by the point of interest content user interface element 730, the second point of interest content user interface element 732, and the third point of interest 734). In FIG. 7O, label 736 is no longer in view as a result of displaying the second point of interest content user interface element 732 at the respective distance further from the viewpoint of the user. In FIG. 7N, the computer system 101 detects a user input directed to the control element 706, and corresponding to a request to tilt the navigation user interface element 702, such as, for example, a two-handed air pinch gesture 722 including movement of the two-handed air pinch gesture 722 corresponding to a request to tilt the navigation user interface element 702 (e.g., described in more detail with reference to method(s) 800, 1000, and/or 1200) while gaze of the user of the computer system 101 is directed to control element 706. In response to detecting the two-handed air pinch gesture 722 in FIG. 7O, the computer system 101 tilts the navigation user interface element 702 in accordance with movement of the two-handed air pinch gesture 722, as shown in FIG. 7P. In the overhead view 720, the navigation user interface element 702 is tilted at an angle relative to the ground of the physical environment. In FIG. 7P, the computer system 101 displays the point of interest content user interface element 730, the second point of interest content user interface element 732, and the third point of interest content user interface element 734 at respective angles normal to the ground of the physical environment.

In some embodiments, the computer system 101 presents the navigation user interface element 702 from different views. For example, in FIG. 7P, the computer system 101 detects user input 714 (e.g., gaze of the user of the computer system 101) directed to an option of the second navigation user interface element 704 that, when selected, causes the computer system 101 to display the navigation user interface element 702 in a predefined manner or style. In response to detecting the user input 714, as shown in FIG. 7Q, the computer system 101 displays, via display generation component 120, the navigation user interface element 702 from a second view, different from the view of the navigation user interface element 702 prior to detecting the user input 714. For example, in FIG. 7Q, the computer system 101 displays the navigation user interface element 702 from a birds-eye view. In some embodiments, the computer system 101 displays the navigation user interface element 702 from a plurality of different views as described in method(s) 800, 1000, and/or 1200.

FIG. 8 is a flowchart illustrating an exemplary method of dynamically presenting content in response to user input in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., 101) in communication with a display generation component (e.g., 120) and one or more input devices (e.g., 314). In some embodiments, method 800 is performed at a computer system in communication with a display generation component and one or more input devices. For example, the computer system includes a mobile device (e.g., a tablet, a smartphone, a media player, or a wearable device), or a computer or other electronic device. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, and/or detecting a user input.) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor), microphone for capturing voice commands or other audio input, etc. In some embodiments, the computer system is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus. In some embodiments, the computer system displays (802a), via the display generation component, a user interface of a map application including a first user interface element associated with a search operation and a navigation user interface element representing a first physical area, such as user interface element 708 and navigation user interface element 702 in FIG. 7A. In some embodiments, the computer system displays the user interface within a three-dimensional environment (e.g., in a manner similar to displaying a virtual object in a three-dimensional environment as described with reference to the scene 105 in FIG. 1A). For example, the three-dimensional environment is optionally generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). In some embodiments, a representation of the physical environment is displayed in the three-dimensional environment via the display generation component (e.g., virtual or video passthrough). In some embodiments, the computer system displays the user interface in the three-dimensional environment that is in the field of view of a user of the computer system from a viewpoint of the user of the three-dimensional environment. In some embodiments, the navigation user interface is a user interface of an application other than the map application, such as a travel guide application.

In some embodiments, the user interface includes a first user interface element that, when selected, causes the computer system to display a second user interface element as described herein. In some embodiments, the first user interface element is associated with a search operation. For example, the computer system optionally receives speech input from the user of the computer system while an attention (e.g., including gaze) of the user is directed to the first user interface element as described herein. In some embodiments, the first user interface element includes a dictation option that, when selected, causes the computer system to initiate dictation comprising receiving the speech input, converting into text, and causing the computer system to conduct a search using the text as search parameters for input into the map application. In some embodiments, the speech input is a dictation to be transcribed by a digital assistant (described in further detail with reference to method 1200) for input into the map application or an application of the computer system, different from the map application (e.g., web search). In some embodiments, the first user interface element optionally includes a text entry field, and/or a selectable option that, when selected, causes the computer system to conduct a search using text entered into the text entry field as search parameters. In some embodiments, the computer system receives the text via a hardware keyboard, a soft keyboard, and/or dictation as described herein. In some embodiments, the user interface incudes a navigation user interface element representing a first physical area. In some embodiments, the navigation user interface element includes a three-dimensional topographical map of the first physical area. For example, the navigation user interface element optionally includes a three-dimensional topographical map of a city including three-dimensional representations of buildings, streets, and other landmarks. In some embodiments, the navigation user interface element includes a visual indication (e.g., a flag, pin, or other visual indication) displayed at a respective location that corresponds to an address, landmark, or coordinates in the city. In some embodiments, the navigation user interface element is oriented along a horizontal surface in the three-dimensional environment or floating along a horizontal plane and the first user interface element associated with the search operation is oriented vertically. In some embodiments, the computer system will change the display of the navigation user interface element (e.g., rotate, re-size, and/or tilt) and/or render a respective portion of the navigation user interface element at a zoom level to focus on an area and/or location of the map that represents the first physical area. In some embodiments, the navigation user interface element is a two-dimensional map representing a first physical area. In some embodiments, the navigation user interface element includes one or more characteristics of the navigation user interface element described with reference to method(s) 800, 1000, and/or 1200. In some embodiments, while displaying, via the display generation component, the user interface (802b), the computer system detects (802c) via the one or more input devices, an attention of a user of the computer system directed to the first user interface element, such as user input 714 that includes gaze in FIG. 7A. In some embodiments, the attention of the user of the computer system corresponds to user gaze as described in more detail with reference to FIG. 6. In some embodiments, when user attention corresponds to gaze, a gaze tracking device optionally captures one or more images of the user's eyes and detects the pupils and glints in the one or more captured images to track the user's gaze, as described in more detail with reference to FIG. 6. In some embodiments, detecting the attention of the user includes detecting the gaze of the user directed at a location (or region) of the first user interface element for a period of time greater than a time threshold (e.g., 0.02, 0.05, 0.1, 0.2, 0.25, 0.3, 0.5, 1, 2, 3, or 5 seconds). In some embodiments, detecting the attention of the user includes detecting the gaze of the user directed at a location (or region) of the user interface element for any period of time.

In some embodiments, in response to detecting the attention of the user directed to the first user interface element (802d) (e.g., not including input from one or more portions of the user (e.g., a hand, arm, and/or finger) other than those portions (e.g., eyes) providing the attention input or an input received using another input device, such as a voice input or an input made with a hardware input device), the computer system displays (802e) the user interface including a second user interface element, wherein the second user interface element includes a text entry field and a plurality of first location user interface elements of a first type and a plurality of second location user interface elements of a second type different from the first type, grouped according to type and associated with the first physical area, such as user interface element 708 in FIG. 7B. In some embodiments, in response to detecting the attention of the user directed to the first user interface element, the computer system ceases to display the first user interface element. For example, the user interface includes a first user interface element that, when selected (e.g., the gaze of the user is directed at the first user interface element for the period of time greater than the time threshold), causes the computer system to display a second user interface element. In some embodiments, the second user interface element includes a text entry field and plurality of first location user interface elements and a plurality of second location user interface elements. In some embodiments, the second user interface is displayed in a same location of the first user interface element before the attention of the user was directed to the first user interface element. In some embodiments, the second user interface is displayed concurrently with, proximate to, and/or overlaid upon the navigation user interface element.

In some embodiments, the text entry field is interactable for initiating a search using text entered into the text entry field as search parameters. In some embodiments, the text entry field includes a dictation option that, when selected, causes the computer system to initiate dictation comprising receiving the speech input, converting into text, and causing the computer system to conduct a search using the text as search parameters. In some embodiments, the computer system receives a text entry input using a soft keyboard, hardware keyboard, or other input device. As used herein and throughout, location user interface elements including the plurality of first location user interface elements and the plurality of second location user interface elements optionally include curated content of the first physical area and/or representation(s) of the curated content, content captured by the user of the computer system while at or nearby the first physical area and/or representation(s) of the content captured, representation(s) of points of interest at or nearby the first physical area, representation(s) of points of interest at or nearby the first physical area favorited by the user of the computer system, and/or other location-based content and/or representation(s) of other location-based content as discussed herein and in further detail below. In some embodiments, in response to receiving an input selecting a location user interface element, the computer system displays a three-dimensional or panoramic representation of the first physical area. In another example, in response to receiving an input selecting the location user interface element, the computer system displays guides, aerial tours, panoramas, photos, videos, audio, notes, annotations, animations and/or other supplemental location-based content of the first physical area. In some embodiments, such content displayed is selected and/or arranged by a third party (e.g., travel guides, lifestyle magazines, and/or media and entertainment networks), individuals (e.g., family, friends, coworkers, and/or social media marketers), and/or an application on the computer system (e.g., photo management application, map application, and/or digital media player application). In some embodiments, the plurality of first location user interface elements and the plurality of second location user interface elements are grouped according to type, such as “Suggestions” (e.g., points of interest at or nearby the first physical area), “Best Interactive Panoramas” (e.g., 360° street-level imagery), “Guides” (e.g., best restaurants, best shopping, best museums, or other curated content of the first physical area), or “Favorites” (e.g., points of interest at or nearby the first physical area favorited by the user of the computer system). It is understood that other types of location-based content are optionally included, such as described above and below. In some embodiments, metadata associated with the location-based content (e.g., guides, aerial tours, panoramas, photos, videos, audio, notes, annotations, animations and/or other supplemental location-based content of the first physical area) indicate respective location-based content types.

In some embodiments, the plurality of first location user interface elements of the first type (e.g., 360° street-level imagery) are displayed as a list of location user interface elements with a type indicator (e.g., “Best Interactive Panoramas” indicating the first type) displayed near the list of location user interface elements. In some embodiments, the plurality of first location user interface elements of the first type are displayed within a visible or invisible user interface container object. For example, the user interface container object is optionally moveable and/or rotatable such as a virtual carousel, virtual scroll wheel, a virtual dial, a virtual slider, or a virtual picker configured to allow for presenting and navigating within a continuum or sequence of the plurality of first location user interface elements of the first type. It is understood that although the embodiments described herein are directed to the plurality of first location user interface elements of the first type, such functions and/or characteristics, optionally apply to other location user interface elements, such as the plurality of second location user interface elements of the second type.

Additionally and in some embodiments, the computer system displays the first user interface element with a first size, a first shape, and/or a first visual effect. In some embodiments, when the computer system detects the attention of the user directed at the first user interface element for the period of time greater than the time threshold, the computer displays the second user interface element which is an increased size (or expanded) version of the first user interface element. For example, the increased size of the second user interface element optionally accommodates the text entry field, the plurality of first location user interface elements, and/or the plurality of second location user interface elements not displayed before the attention of the user was directed to the first user interface element. Additionally and in some embodiments, the computer system receives a text entry input (e.g., search input) via any of the mechanisms described above (e.g., hardware keyboard, a soft keyboard, and/or dictation). The text entry input optionally corresponding to a request to conduct a search using the text entered into the text entry field as search parameters. In some embodiments, in response to the search request, the computer system displays a plurality of third location user interface elements corresponding to the search input, wherein corresponding location-based content (described above) of the one or more location user interface elements are related to the search input. In some embodiments, the one or more user interface objects corresponding to the search input are displayed in the second user interface. In some embodiments, the one or more user interface objects are arranged according to their relevance to the search input. For example, the third location user interface elements with a higher relevance are located closer to the top of the second user interface. In some embodiments, location user interface elements with corresponding location-based content not related to the search input are not displayed in the second user interface. In some embodiments, location user interface elements with corresponding location-based content not related to the search input (and optionally, the plurality of first location user interface elements, and/or the plurality of second location user interface elements) are displayed closer to bottom of the second user interface. In some embodiments, the plurality of third location user interface elements corresponding to the search input replaces the plurality of first location user interface elements. For example, the computer system ceases to display the plurality of first location user interface elements corresponding to “Suggestions” (e.g., points of interest at or nearby the first physical area) and displays the plurality of third location user interface elements corresponding to the search input. In some embodiments, the plurality of third location user interface elements are displayed with an indicator (e.g., “Search Results” indicating association with the search input) displayed near the plurality of third location user interface elements. Additionally and in some embodiments, in response to receiving the search request, the computer system changes the display of the navigation user interface element to correspond with the plurality of third location user interface elements. For example, changing the display of the navigation user interface element includes rotating, re-sizing, and/or tilting the navigation user interface element from the horizontal plane such that the navigation user interface element is centered on an area and/or location associated with the plurality of third location user interface elements (e.g., without changing the viewpoint of the user of the computer system).

In some embodiments, the navigation user interface element that includes the area associated with the plurality of third location user interface elements is displayed at a zoom level (e.g., greater or less) than the navigation user element representing the first physical area before receiving the search request. In some embodiments, the area associated with the plurality of third location user interface elements includes a larger or smaller area than the first physical area. In some embodiments, the navigation user interface element includes a visual indication (e.g., a flag, pin, or other visual indication) displayed at a respective location that corresponds to a point of interest associated with the plurality of third location user interface elements. In some embodiments, the computer system receives user input corresponding to a request to change the display of the navigation user interface element (e.g., rotate, re-size, pan, and/or tilt) and/or render a respective portion of the navigation user interface element at a zoom level to focus on an area and/or location of the map that is associated with the first physical area. In some embodiments, in response to receiving the user input corresponding to the request to change the display of the navigation user interface element, the computer system displays the second user interface element including a plurality of third location user interface elements, different from the first location user interface element and the second user interface elements, and associated with the changed display of the navigation user interface element (e.g., the respective area represented by the navigation user interface element). Displaying a second user interface element that includes supplemental location-based content in response to determining that the user's attention is directed to a first user interface element provides confirmation that the user intends to interact with the second user interface element without cluttering the user interface (e.g., by not always displaying the supplemental location-based content), which enhances operability of the computer system, reduces power usage of the computer system, reduces errors in the interaction between the user and the computer system, and reduces inputs needed to correct such errors. In some embodiments, displaying the second user interface element while the navigation user interface element represents the first physical area includes, in accordance with a determination that the first portion of the navigation user interface element representing a first portion of the first physical area is not positioned between a current viewpoint of the user and the second user interface element, displaying the first portion of the navigation user interface element with a first visual prominence relative to a three-dimensional environment, such as shown by user interface element 708 and navigation user interface element 702 in FIG. 7B. In some embodiments, and as will be described herein, the computer system changes a respective visual prominence of the navigation user interface element and/or the second user interface element in response to a determination of the respective positions of the navigation user interface element and the second user interface element relative to the viewpoint of the user.

In some embodiments, the computer system visually changes the respective visual prominence of the navigation user interface element and/or the second user interface element in response to user input, such as the attention of the user directed to the navigation user interface element or the second user interface element. In some embodiments, a first portion of the navigation user interface element includes one or more geographic features, such as representations of mountains, bridges, trees, buildings, or other object positioned between the current viewpoint of the user and the second user interface element. Thus, in some embodiments, the first portion of the navigation user interface element obscures at least a portion of the second user interface element. In some embodiments, the first portion of the navigation user interface element is not positioned between the viewpoint of the user and the second user interface element such that the computer system displays (or, optionally maintains) the first portion of the navigation user interface element with the first visual prominence relative to the three-dimensional environment (e.g., a normal or default visual prominence). In some embodiments, displaying the first portion of the navigation user interface element with the first visual prominence relative to the three-dimensional environment includes displaying the first portion of the navigation user interface element with a first size, first color, first degree of brightness, first degree of opacity, and/or first degree of emphasis. In some embodiments, the computer system changes a respective visual prominence of the navigation user interface element and/or the second user interface element automatically without detecting a change in the respective positions of the navigation user interface element and the second user interface element relative to the viewpoint of the user. In some embodiments, the computer system visually changes the respective visual prominence of the navigation user interface element and/or the second user interface element without detecting that the attention of the user is directed to the navigation user interface element or the second user interface element.

In some embodiments, in accordance with a determination that the first portion of the navigation user interface element is positioned between the current viewpoint of the user and the second user interface element, the computer system reduces a visual prominence of the first portion of the navigation user interface element to a second visual prominence relative to the three-dimensional environment to increase visibility of the second user interface element through the first portion of the navigation user interface element, such as shown in FIG. 7I where the visual prominence of the representations of buildings and trees are reduces increasing the visibility of user interface element 730. In some embodiments, the first portion of the navigation user interface element is changed from not being positioned between the current viewpoint of the user and the second user interface element to be being positioned between the current viewpoint of the user and the second user interface element. In some embodiments, the change is based on a viewing angle in which the user views the navigation user interface element and the second user interface element. In some embodiments, reducing the visual prominence of the first portion of the navigation user interface element to a second visual prominence relative to the three-dimensional environment includes displaying the first portion of the navigation user interface element with a second size, second color, second degree of brightness, second degree of opacity, and/or second degree of emphasis. In some embodiments, the second size is smaller is than the first size of the first portion of navigation user interface element when not positioned between the current viewpoint of the user and the second user interface element; the second color is more muted than the first color; the second degree of brightness is less than the first degree of brightness; the second degree of opacity is less than the first degree of opacity; and/or the second degree of emphasis is less than the first degree of emphasis. Thus, in some embodiments, the first portion of the navigation user interface element does not obscure the second user interface element. In some embodiments, reducing the visual prominence of the first portion of the navigation user interface element to a second visual prominence relative to the three-dimensional environment is performed without detecting a change in respective positions of the second user interface element and/or the first portion of the navigation user interface element relative to the current viewpoint of the user. In some embodiments, the current viewpoint of the user is based on a location of the user in the physical environment. For example, the computer system optionally determines that the user of the computer system is at a first location facing the second user interface element and the navigation user interface element (e.g., the second user interface element and the navigation user interface element are facing the viewpoint of the user at respective positions relative to the viewpoint of the user). In some embodiments, an imaginary perpendicular line extending from a surface of the second user interface element would align such that there is no difference between the angle of the viewpoint of the user and the perpendicular line such that the second user interface element is visible and not obscured by the first portion of the navigation user interface element when the first portion of the navigation is not positioned between the current viewpoint of the user and the second user interface element. In some embodiments, as long as this difference is within a first range of angles (e.g., 1, 2, 5, 7, 10, 15, 20, or 30 degrees), the second user interface element is visible.

In some embodiments, the computer system determines that the user of the computer system is at a second location, different from the first location, and that the difference between the angle of the viewpoint of the user and the imaginary perpendicular line extending from the surface of the second user interface element as described above is within a second range of angles (e.g., 30, 40, 50, 60, 70, or 80 degrees). Thus, in some embodiments, one or more portions of the second user interface are potentially obscured by the first portion of the navigation user interface element (or, optionally another portion of the navigation user interface element) even though the first portion of the navigation is not positioned between the current viewpoint of the user and the second user interface element. In some embodiments, the computer system displays the second user interface element at a shorter distance (e.g., closer) to the current viewpoint of the user than a respective distance associated with displaying the navigation user interface element which optionally gives an appearance of the second user interface element of being visible through at least a portion of the navigation user interface element (e.g., breakthrough visual effect). In some embodiments, the manner in which the computer system applies the breakthrough effect to the second user interface element and/or the navigation user interface element is based on the attention (e.g., gaze) of the user as will be described in more detail below. In some embodiments, the computer system optionally detects, via the one or more input devices, the attention of the user directed to the second user interface element. For example, the computer system detects that the attention of the user has moved from being directed to the navigation user interface element (or, optionally, a location within the three-dimensional environment other than the second user interface element) to being directed to the second user interface element. In some embodiments, in response to (and/or while) detecting that the attention of the user is directed to the second user interface element, the computer system reduces a visual prominence of one or more portions of the navigation user interface element as described herein (e.g., similarly to the first portion of the navigation user interface element) relative to the three-dimensional environment to increase visibility of the second user interface element through the one or more portions of the navigation user interface element.

In another example, the computer system optionally increases a visual prominence of the second user interface element relative to the navigation user interface element. For example, displaying the second user interface element having a third size, third color, third degree of brightness, third degree of opacity, and/or third degree of emphasis. In some embodiments, the third size is larger than the respective size associated with the navigation user interface element; the third color is more distinct than the respective color associated with the navigation user interface element; the third degree of brightness is brighter than the respective degree of brightness associated with the navigation user interface element; the third degree of opacity is greater than the respective degree of opacity associated with the navigation user interface element; and/or the third degree of emphasis is greater than the respective degree of emphasis associated with the navigation user interface element. In some embodiments, prior to reducing a visual prominence of the first portion of the navigation user interface element to a second visual prominence relative to the three-dimensional environment as described herein, the computer system determines that the first portion of the navigation user interface element satisfies one or more criteria including a criterion that is satisfied when the first portion of the navigation user interface element is associated with a significant point of interest. For example, a significant point of interest optionally includes a major landmark, geographic feature, building, and/or structure that is popular according to map data (e.g., a point of interest frequently visited by users). In some embodiments, the significant point of interest is associated with a historical, cultural, or social event based on map data. For example, the computer system optionally requests map data from a remote server in communication with the computer system and/or a local processor (e.g., maintained by the computer system optionally from a map application operating on the computer system) for retrieving map information including identifying significant points of interest within a respective physical area. In some embodiments, in accordance with a determination that the first portion of the navigation user interface element satisfies the one or more criteria including the criterion that is satisfied when the first portion of the navigation user interface element is associated with (or, optionally, corresponds to) a significant point of interest, the computer system optionally displays the second user interface element adjacent to (e.g., above, below, to the left, or to the right of) the first portion of the navigation user interface element without reducing the visual prominence of the first portion of the navigation user interface element and without obscuring the second user interface element.

In some embodiments, in response to detecting user input directed to the navigation user interface element corresponding to a request to manipulate the navigation user interface element, such as for example, move the navigation user interface element, the computer system moves the navigation user interface element in accordance with the user input. In some embodiments, moving the navigation user interface element includes changing a perspective or viewing angle of the viewpoint of the user of the computer system relative to the navigation user interface element and/or the second user interface element. In some embodiments, the computer system determines the viewing angle formed from a first vector extending normal from a respective portion (e.g., a center) of the navigation user interface element and a second vector, different from the first vector, extending a respective portion of the navigation user interface element toward the viewpoint of the user. For example, the viewing angle is between the viewpoint of the user and the navigation user interface element. In some embodiments, while the computer system displays the navigation user interface element representing the second physical area from a viewing angle (e.g., overhead view or top-down perspective), the computer system maintains an orientation of the second user interface element towards the viewpoint of the user (e.g., orienting the second user interface element in a manner where a front surface of the second user interface element that is presented in the viewport by default when the computer system initially displays the second user interface element). Changing a visual prominence of a portion of the navigation user interface element relative to the three-dimensional environment in accordance with a determination of respective positions of the portion of the navigation user interface element and the second user interface element provides an efficient way of viewing desired map content and without cluttering the user interface (e.g., by not always taking up display space for displaying map content), which enhances operability of the computer system, reduces power usage of the computer system, reduces errors in the interaction between the user and the computer system, and reduces inputs needed to correct such errors.

In some embodiments, displaying the second user interface element includes displaying the second interface element at a predefined spatial arrangement relative to (e.g., adjacent to) the navigation user interface element and at a distance greater than a distance at which the computer system displays (optionally at least a portion of) the navigation user interface element from a viewpoint of the user of the computer system, such as shown in overhead view 720 with the spatial arrangement of user interface element 708 and navigation user interface element 702 in FIG. 7A. In some embodiments, the computer system displays the second user interface element further back (e.g., at a distance, depth or z-height) from the viewpoint of the user of the computer system than a respective distance associated with displaying a center of the navigation user interface element. In some embodiments, while the second user interface element is displayed adjacent (e.g., above, below, to the left, and/or to the right of) the navigation user interface element, the computer system displays the second user interface element at a distance that is greater than a distance at which the computer system displays the navigation user interface element from the viewpoint of the user. For example, the second user interface element is displayed at a depth in the z-dimension that is greater than a respective depth of the navigation user interface element. Thus, in some embodiments, the navigation user interface element appears closer (or, optionally, larger) compared to the second user interface element from the viewpoint of the user. In some embodiments, the computer system displays the second user interface element at a distance less than the distance at which the computer system displays the navigation user interface element from the viewpoint of the user. For example, in response to detecting the attention of the user directed to the second user interface element, the computer system displays the second user interface element at a distance less than the distance at which the computer system displays the navigation user interface element from the viewpoint of the user. Thus, in some embodiments, the second user interface element appears closer (or, optionally, larger) compared to the navigation user interface element from the viewpoint of the user. In some embodiments, the computer system displays, via the display generation component, respective control elements associated with the second user interface element and the navigation user interface element that, when selected, causes the computer system to change a respective distance (e.g., depth or z-height) at which the computer system displays the second user interface element and the navigation user interface element. In some embodiments, the respective control elements include respective control element components that, when selected, causes the computer system to move the second user interface element and the navigation user interface element, respectively.

In some embodiments, the computer system displays, via the display generation component, a single control element that, when selected, causes the computer system to move (or, optionally, close/cease to display) all elements of the map application including the second user interface element and the navigation user interface element. For example, in response to detecting user input directed to a respective control element component, the computer system optionally moves the second user interface element to a location (e.g., to the right of the navigation user interface element) different from the location at which the computer system displayed the second user interface element (e.g., above the navigation user interface element) prior to detecting the input. In some embodiments, the user input includes a gaze of a user of the computer system, a contact on a touch-sensitive surface, actuation of a physical input device, a predefined gesture (e.g., pinch gesture or air tap gesture) and/or a voice input from the user directed to the respective control element or the respective control element component. In some embodiments, one or more portions of the navigation user interface element are closer to the viewpoint of the user than the second user interface element. Concurrently, in some embodiments, the one or more portions of the navigation user interface element are farther from the viewpoint of the user than the second user interface element. In some embodiments, the computer system displays the navigation user interface element having z-depth. Displaying the second user interface element adjacent to the navigation user interface element and at a distance greater than a distance at which the computer system displays the navigation user interface element from a viewpoint of the user of the computer system provides an efficient way of viewing desired map content, which enhances operability of the computer system, reduces power usage of the computer system, reduces errors in the interaction between the user and the computer system, and reduces inputs needed to correct such errors. In some embodiments, the navigation user interface element represents the first physical area and includes a plurality of points of interest indications displayed at a plurality of locations within the navigation user interface element corresponding to physical locations of corresponding points of interest, such as user interface element 724 in FIG. 7D. In some embodiments, the plurality of points of interest indications are displayed by the computer system as points of interest or location pins or icons or user interface elements. In some embodiments, the plurality of points of interest indications are a size smaller than a respective size of the collection of content that will be described in more detail herein. For example, the computer system optionally displays the plurality of points of interest indications as graphical icons and displays the collection of content as contained within a window (or, optionally volume) user interface element, such as a third user interface element described herein. In some embodiments, the plurality of points of interest indications are displayed at respective locations within the navigation user interface element corresponding to physical locations of corresponding points of interest. For example, the physical locations of corresponding points of interest include landmarks, buildings, structures, neighborhoods, cities, parks, restaurants, bars, geographic features, or other point of interest described above and/or below.

In some embodiments, while displaying the second user interface element and the navigation user interface element, the computer system detects a user input, via the one or more input devices, directed to a first point of interest indication of the plurality of point of interest indications, such as user input 714 including gaze directed to a point of interest indication of user interface element 724. In some embodiments, detecting the user input directed to the first point of interest indication is analogous to and/or includes one or more characteristics of user input(s) described above, such as for example, detecting user input directed to a respective control element.

In some embodiments, in response to detecting the user input, the computer system displays, via the display generation component, a third user interface element at a respective location within the navigation user interface element corresponding to a first physical location of a corresponding first point of interest, wherein the third user interface element includes a collection of content items that, when selected, causes the computer system to display a first content item of the collection and other content items in the collection adjacent to the first content item, such as the collection of content items included in user interface element 724 in FIG. 7E. In some embodiments, displaying the third user interface element includes displaying the first point of interest indication with a greater degree of visual emphasis (e.g., larger in size, and/or more distinct in color and/or visual appearance) than displaying the first point of interest indication prior to detecting the user input directed to the first point of interest indication. In some embodiments, the third user interface element is optionally a user interface content container-type user interface, such as a window that includes the collection of content items.

In some embodiments, the collection of content items include photos, videos, panoramas, three-dimensional models, representations of media items (e.g., music, podcasts, travel guides, news, events, and/or the like) and/or other content associated with the first point of interest. For example, when the first point of interest is a sports and entertainment area, such as Chase Center in San Francisco, California, the collection of content items optionally includes photos of the Chase Center building or photos of sports or entertainment events captured while at the Chase Center. In some embodiments, the computer system detects user input (e.g., as described above with reference to the user input directed to a respective control element), via the one or more input devices, directed to the third user interface element, such as for example, a first content item or representation of a first content item of the collection of content items, and in response to detecting the user input directed to the third user interface element, the computer system displays the third user interface element in a layout (e.g., album-type layout) where the first content item is displayed with a first size greater than respective sizes of the other content items in the collection. For example, the first content item is optionally displayed as full-size while the other content items are small representations of corresponding full-size content items.

In some embodiments, the other content items are optionally moveable and/or rotatable such as a virtual carousel, virtual scroll wheel, a virtual dial, a virtual slider, or a virtual picker configured to allow for presenting and navigating within a continuum or sequence of the collection. In some embodiments, the computer system displays the first content item above the other content items in the third user interface element. In some embodiments, in response to user input (e.g., as described above with reference to the user input directed to a respective control element), via the one or more input devices, directed to one of the other content items, the computer system displays the selected other content item in full-size (e.g., having the first size that is greater than respective sizes of the other content items in the collection). In some embodiments, the selected other content items replaces the first content item (e.g., the computer system ceases to display the first content item in full-size and/or the computer system displays a small representation of the first content item as part of the other content items in the collection). In some embodiments, while displaying the collection of content items as described herein, the computer system detects user input (e.g., as described above with reference to the user input directed to a respective control element), via the one or more input devices, directed to a second point of interest indication, different from the first point of interest indication, of the plurality of point of interest indications. In some embodiments, in response to detecting the user input directed to the second point of interest indication, the computer system displays a second third user interface element including a second collection of content items, different from the collection of content items at a second respective location within the navigation user interface element corresponding to a second physical location of a corresponding second point of interest, different from the first point of interest. In some embodiments, displaying the second third user interface element including the second collection of content items is analogous to and/or includes one or more characteristics of displaying the collection of content items as described herein. Displaying a third user interface element including a collection of content items in response to user input directed to a respective point of interest indication displayed within the navigation user interface element provides quick access to the respective collection of content items without requiring the user to provide further inputs to navigate away from the navigation user interface element and locate the respective collection of content items, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the first content item of the collection and other content items in the collection adjacent to the first content item includes ceasing displaying the navigation user interface element and reducing a visual prominence of a representation of a physical environment of the user of the computer system that is displayed concurrently with the first content item of the collection and other content items in the collection adjacent to the first content item, such as shown in FIG. 7E with the absence of navigation user interface element 702 and the reduced visual prominence of the physical environment. In some embodiments, displaying the representation of the physical environment is analogous to and/or includes one or more characteristics of displaying the representation of the physical environment described above with reference to XR experiences in FIG. 1A. In some embodiments, the computer system is configured to capture information about the physical environment around the user, such as real-world objects, a size and/or shape of the physical environment, and/or other characteristics of the physical environment (e.g., lighting, noise, temperature, and/or the like).

In some embodiments, the computer system is configured to display a representation of the physical environment based on the captured information. For example, the representation of the physical environment includes a photorealistic version of the originally captured physical environment, a simulated (e.g., enhanced and/or modified) version of the originally captured physical environment, or a mix of the two versions, such that one or more portions of the representation of the physical environment include photorealistic depictions and other one or more portions include enhanced depictions of the physical environment (e.g., increased lighting, mood lighting, visual effects, and/or the like). In some embodiments, the representation of the physical environment is presented by the computer system via the display generation component with virtual passthrough or optical passthrough as described in more detail with reference to XR experiences in FIG. 1A. In some embodiments, the computer system is configured to change the display of the representation of the physical environment (e.g., change a visual prominence or degree of visual emphasis of the representation of the physical environment). For example, while and/or in response to displaying the first content item of the collection and other content items in the collection adjacent to the first content item as described above, the computer system optionally displays the representation of the physical environment with a degree of visual prominence less than a respective degree of visual prominence of the representation of the physical environment prior to displaying the first content item of the collection and other content items in the collection. In some embodiments, reducing the visual prominence of the representation of the physical environment includes changing a degree of lighting, opacity, color, or visual effect of the representation of the physical environment. For example, the computer system optionally displays the representation of the physical environment with a degree of lighting less than a degree of lighting associated with the third user interface element including the first content item of the collection and other content items in the collection. In some embodiments, the computer system ceases displaying the navigation user interface element. Thus, in some embodiments, displaying the representation of the physical environment with a degree of lighting less than a degree of lighting associated with the third user interface element including the first content item of the collection and other content items in the collection and ceasing display of the navigation user interface element gives an appearance of the third user interface element including the first content item of the collection and other content items in the collection being visible in an environment in which the lighting is dimmed (e.g., a theater mode viewing effect). In some embodiments, the degree of lighting at which the computer system displays the representation of the physical environment relative to the degree of lighting associated with the third user interface element includes changing an intensity, luminance, and/or color temperature of one or more lights sources to facilitate a predetermined mood or experience, such as, example, a theater mode in which the representation of the physical environment is dimmed and focus is on the third user interface element.

In some embodiments, the computer system detects user input (e.g., as described above with reference to the user input directed to a respective control element), via the one or more input devices, corresponding to a request to change a respective degree of emphasis at which the representation of the physical environment, the third user interface element, and/or the navigation user interface element is displayed, and in response to detecting the user input corresponding to the request to change the respective degree of emphasis, the computer system displays the respective representation and/or user interface with a degree of emphasis based on the user request. In some embodiments, the amount of the representation of the physical environment that is displayed is based on an immersion level of the computer system as will be described in more detail below. For example, increasing the immersion level causes more of the representation of the physical environment to be displayed, replacing and/or obscuring more of the physical environment and reducing the immersion level causes less of the representation of the physical environment to be displayed, revealing portions of the physical environment that were previously not displayed and/or obscured. Ceasing displaying the navigation user interface element and reducing a visual prominence of a representation of a physical environment of the user of the computer system that is displayed concurrently with the first content item of the collection and other content items in the collection adjacent to the first content item provides enhanced viewing and operation of the third user interface element without requiring the user to provide further inputs to close the navigation user interface element, change the display of the first content item of the collection and other content items in the collection, and/or the representation of the physical environment, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, in accordance with a determination that the first content item of the collection of content is a first type, such as associated with a look around option 726 in FIG. 7E, the computer system displays, via the display generation component, in the third user interface element, the first content item with a first level of immersion corresponding to a first view of a respective physical location corresponding to the respective location, such as shown with user interface element 728 in FIG. 7F. For example, the first content of a first type optionally includes one or more images or video (or, optionally, including spatial video), such as street-level imagery, panoramas, and/or 360 degrees camera views taken from and/or of the respective physical location of the corresponding location (e.g., first point of interest as described above). In some embodiments, the computer system determines that the first content item of the collection content is a first type when the first content item includes said images and/or video described herein. In some embodiments, the computer system determines that the first content item of the collection content is the first type when map information (e.g., from a remote map server and/or a local processor described above), such tag(s) and/or metadata indicates the first type. In some embodiments, and as will be described herein, in accordance with a determination that the first content item is the first type, the computer system displays, via the display generation component, an option indicative of the first content item being the first type of content (e.g., the first content item includes the spatial video, street-level imagery, and/or the like described herein). In some embodiments, displaying the first content item with the first level of immersion in the navigation user interface element is analogous to and/or includes one or more characteristics of displaying the first content item adjacent to the other content items in the third user interface element as described above. For example, the third user interface element optionally contains the first content item and the other content items and is displayed in the navigation user interface element. In some embodiments, and as will be described in more detail below with reference to using a first or second display area to present the first content item, when the computer system determines that the first content item is the first type, the first content item is displayed separated from the third user interface element (and/or, optionally, the navigation user interface element and/or the representation of the physical environment) using a portal (e.g., user interface) into a scene of a 360-degree view of the respective location. For example, the computer system optionally presents the portal (e.g., the first content item contained within the portal) with a level of immersion, a size, a shape, a position, and/or an orientation relative to the three-dimensional environment and/or viewpoint of the user as will be described in more detail below. In some embodiments, the level of immersion, size, shape, position, and/or orientation is automatically (e.g., without detecting user input) determined by the computer system. In some embodiments, the computer system changes the level of immersion, size, shape, position, and/or orientation in response to detecting user input directed to changing the level of immersion, size, shape, position, and/or orientation as will be described herein and in more detail below with reference to using a first or second display area to present the first content item.

In some embodiments, the computer system is configured to increase or decrease a level of immersion of the first content item (e.g., increases or decreases a portion of which the first content item corresponding to the first view of the respective physical location occupies the three-dimensional environment). In some embodiments, a level of immersion includes an associated degree to which the first content item displayed by the computer system obscures background content (e.g., the three-dimensional environment including the representation of the physical environment) around/behind the first content item, optionally including respective visual characteristics (e.g., lighting, opacity, color, and/or visual effect) with which the representation of the physical environment is displayed, and/or the angular range of the content displayed via the display generation component (e.g., 60 degrees of content displayed at low immersion, 120 degrees of content displayed at medium immersion, and/or 180 degrees of content displayed at high immersion), and/or the proportion of the field of view displayed via the display generation consumed by the content (e.g., 33% of the field of view consumed by the content at low immersion, 66% of the field of view consumed by the content at medium immersion, and/or 100% of the field of view consumed by the content at high immersion). For example, the computer system optionally displays the first content item with the first level of immersion concurrently with the background content, which is optionally displayed with full brightness, color, opacity, and/or having a distinct visual effect compared to displaying the first content with a second level of immersion as will be described below. In some embodiments, in accordance with a determination that the first content item of the collection of content is a first type, the computer system displays an option associated with the first content item that, when selected causes the computer system to display, via the display generation component, the first content item at a second level of immersion, greater than the first level of immersion, the first content item corresponding to the first view of the respective physical location corresponding to the respective location, such displaying user interface element 728 in FIG. 7G in response to user input 715 as shown in FIG. 7F.

In some embodiments, the option is an icon or other representation indicating that the first content item is the first type of content. In some embodiments, the computer system detects user input (e.g., as described above with reference to the user input directed to a respective control element), via the one or more input devices, directed to the option, and in response, the computer system displays the first content item at the second level of immersion. For example, the computer system optionally displays the first content item using a portal separate from the third user interface element. In some embodiments, displaying the first content item at the second level of immersion includes displaying the portal including the first content item with a curved shape compared to a planar shape of the portal when the displaying the first content item at the first level of immersion. In some embodiments, the computer system displays the first content item at the second level of immersion curved spherically around the viewpoint of the user of the computer system. For example, at the second (e.g., higher) level of immersion, the background, the representation of the physical environment, virtual and/or real objects are displayed in an obscured manner. For example, the first content item is displayed with the second level of immersion without concurrently displaying the background content, the representation of the physical environment, virtual and/or real objects (e.g., in a full screen or fully immersive mode). Additionally or alternatively, the first content item is displayed with a third (e.g., medium) level of immersion between the first and second levels of immersion which includes the computer system optionally displaying the first content item concurrently with darkened, blurred, or otherwise de-emphasized background content. In some embodiments, while displaying the first content item at the second level of immersion, the computer system displays a second option or a representation (e.g., thumbnail) of the first content item at a third level of immersion, greater than the second level of immersion, and wherein the first content item corresponds to the first view of the respective physical location corresponding to the respective location. In some embodiments, displaying the first content item at the second level of immersion includes displaying more content or a larger portion of the view of the respective physical location corresponding to the respective location than when displaying the first content item at the first level of immersion. In some embodiments, displaying the first content item at the third level of immersion is analogous to and/or includes one or more characteristics of displaying the first content item at a high level of immersion as described herein.

In some embodiments, displaying the first content item at the third level of immersion includes displaying the portal with a larger size, different shape, different position, and/or different orientation than displaying the first content item at the second level of immersion as will be described in more detail below with reference to using a first or second display area. Displaying the first content item with varying levels of immersion occupying larger or smaller portions of the three-dimensional environment provides an efficient way of presenting a smaller or a greater view of the respective physical location, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, while displaying the first content item with the first level of immersion corresponding to the first view of the respective physical location corresponding to the respective location, the computer system detects, via the one or more input devices, a second user input directed to a hardware input device, such as user input 715 in FIG. 7F (e.g., rotatable input device, such as a digital crown described in more detail above with reference to first button 1-128, button 11.1.1-114, and/or dial or button 1-328 in FIGS. 1B, 1C, 1E and/or 1M.

In some embodiments, in response to detecting the second user input directed to the hardware input device, the computer system displays, via the display generation component, the first content item at a third level of immersion, greater than the first level of immersion, the first content item corresponding to the first view of the respective physical location corresponding to the respective location, such as shown by user interface element 728 in FIG. 7G. In some embodiments, the third level of immersion is the same as the first level of immersion, the second level of immersion, or other level of immersion described above and/or below. In some embodiments, the third level of immersion is based the amount of rotation of the hardware input device. For example, rotating the hardware input device a respective amount causes the computer system to display the first content item at a respective level of immersion corresponding to the first amount the hardware input device is rotated.

In some embodiments, the hardware input device is on the computer system or on another device that is in communication with the computer system, such as a remote control device or other handheld device. For example, detecting the second user input directed to the hardware input device optionally includes detecting manipulation (e.g., rotation and/or depression) of the hardware input device by a respective amount via a portion of the user (e.g., arm, hand, and/or finger) of the user of the computer system corresponding to a request to display the first content at a respective level of immersion. In some embodiments, the computer system detects the second user input including rotation of the hardware input device by a respective amount of rotation in a first direction (e.g., one increment or one rotation; or two increments or two rotations; or the like), and in response to detecting the second user input, the computer system displays the first content at the second level of immersion.

In some embodiments, while displaying the first content at the second level of immersion, the computer system detects a third input (e.g., analogous to and/or includes one or more characteristics of the second user input) including a respective amount of rotation in a second direction, opposite the first direction (e.g., corresponding to a request to decrease the respective level of immersion). In some embodiments, in response to detecting the third input, the computer system displays the first content item at the first level of immersion (e.g., transitions from displaying the first content item at the second level of immersion to the first level of immersion). Displaying the first content item with varying levels of immersion in response to detecting input directed to a hardware input device provides an efficient way of presenting a smaller or a greater view of the respective physical location, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors. In some embodiments, displaying the first content item with the first level of immersion in the navigation user interface element includes using a first display area to present the first content item, such as shown with user interface element 728 in FIG. 7F. In some embodiments, using the first display area to present the first content item optionally refers to using a portal (e.g., user interface) through which the user views a respective view of a respective physical location (e.g., sphere-based content). For example, the computer system projects the first content item to form a shape, such as, for example, a half-sphere and instead of presenting the first content at a high or fully immersive view of the first content item as described in more detail above, the computer system displays the first content item using a first display area (e.g., at a relatively smaller sized portal compared to providing fully immersive views of the first content item).

In some embodiments, and as described herein, the computer system is configured to change a size, shape, position, and/or orientation of the first display area (e.g., portal) automatically (e.g., without user input directed to the display area) or in response to user input directed to the first display area or, optionally, an option associated with the first content item described herein. For example, the computer system is configured to increase a size of the first display area so that more of the respective view of the respective physical location (e.g., panorama) is visible to the user. Thus, in some embodiments, the computer system resizes or expands the display area without manipulating the first content item. In some embodiments, the computer system is configured to present a shape of the first display area as planar or non-planar (e.g., curved) corresponding to angle of view of the first content item. In some embodiments, the computer system positions the first display area at a particular location within the three-dimensional environment and/or at a particular viewpoint of the user (e.g., when the user moves around in the three-dimensional environment, the computer system configures the first display area to stay at a same viewpoint and/or fixed position). In some embodiments, the computer system changes the orientation of the first display area (including the first content item presenting within the display area) to face the user as the user moves within the three-dimensional environment.

In some embodiments, while displaying the first content item with the first level of immersion in the navigation user interface element including using the first display area to present the first content item, the computer system detects a user input, via the one or more input devices, directed to the option associated with the first content item, such as input 715 in FIG. 7F. In some embodiments, detecting the user input directed to the option associated with the first content item is analogous to and/or includes one or more characteristics of detecting user input directed to the option (or, optionally, the second option) associated with the first content item described above.

In some embodiments, in response to detecting the user input directed to the option, the computer system displays, via the display generation component, the first content item with the second level of immersion including using a second display area, greater than the first display area, to present the first content item, such as shown by user interface element 728 in FIG. 7G. For example, the second display area is analogous to and/or includes one or more characteristics of the first display area. In some embodiments, the second display area is a size larger than the size of the first display area. In some embodiments, the second display area has a curved shape while the shape of the first display area is flat. In some embodiments, the computer presents the second display area positioned closer towards the viewpoint of the user (e.g., thus, in some embodiments, providing a higher immersive experience as if the first content item is all around the user) than a relatively father position of the first display area away from the viewpoint of the user which optionally provides a lower immersive experience.

Displaying the first content item using varying display areas provides an efficient way of presenting a smaller or a greater view of the respective physical location and without modifying the first content item, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the third user interface element includes displaying the third user interface element with an orientation in the three-dimensional environment that is based on a viewpoint of the user of the computer system, such as user interface element 732 oriented towards the viewpoint of the user in FIG. 7M. For example, the computer system optionally displays the third user interface element including the collection of content items (e.g., contained within the third user interface element) with an orientation directed towards the viewpoint of the user. In some embodiments, displaying the collection of content items with an orientation that is based on the viewpoint of the user includes orienting the collection of content items so that a front or side of the collection of content items that are presented to the user by default when the collection of content items are displayed are oriented towards the viewpoint of the user (e.g., the front or side of the collection of content items are facing or are perpendicular or normal to the viewpoint of the user). In some embodiments, the computer system changes the orientation of the collection of content items to face the viewpoint of the user as the viewpoint changes. For example, the orientation of the collection of content items change to constantly face the user as the user moves around the three-dimensional environment (e.g., as the viewpoint moves around the environment).

In some embodiments, displaying the navigation user interface element includes displaying the navigation user interface element with a fixed orientation independent of (e.g., not based on) the viewpoint of the user (e.g., the orientation of the navigation user interface element is maintained (e.g., the same orientation) as the user moves around the three-dimensional environment). In some embodiments, a degree of hysteresis (e.g., lag) is added in response to detecting a change in the viewpoint of the user of the computer system (e.g., once the navigation user interface element is displayed with the orientation that is based on the viewpoint of the user of the computer system, the computer system maintains displaying the navigation user interface element with the orientation until the computer system detects a change in the viewpoint of the user). In response to detecting the change in the viewpoint of the user, the computer system applies a degree of hysteresis including displaying the navigation user interface element with a respective orientation that is based on the changed viewpoint of the user. Displaying the collection of content items with an orientation that is based on a viewpoint of the user of the computer system provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the navigation user interface element representing the first physical area includes while the viewpoint of the user of the computer system is a first viewpoint, such as shown in overhead view 720 with the first viewpoint of user 716 in FIG. 7J, and while moving the navigation user interface element relative to the first viewpoint, such as shown in FIG. 7J with input 714 including movement of pinch gesture 722, the computer system displays first content of the navigation user interface element representing the first physical area with a first orientation relative to a three-dimensional environment (e.g., that is not based on the first viewpoint of the user of the computer system), and displaying, via the display generation component, one or more (or a plurality of) third user interface elements included in the navigation user interface element with one or more (or a plurality of) second orientations that are based on the first viewpoint of the user of the computer system, such as shown by respective orientations of navigation user interface element 702, user interface element 730, and user interface element 708 in FIG. 7K.

In some embodiments, the computer system moves the navigation user interface element relative to the first viewpoint in response to a user input that is analogous to and/or includes one or more characteristics of the user input corresponding to the request to move the navigation user interface element as described above. In some embodiments, the user input is directed to a control element that, when selected, causes the computer system to move the navigation user interface element as described above. In some embodiments, the first content of the navigation user interface element includes one or more geographics features, such as buildings, mountains, hills, trees, bridges, and/or other geographic features described above. In some embodiments, while the viewpoint of the user of the computer system is a second viewpoint, such as the second viewpoint as shown in overhead view 720 of the user 716 in FIG. 7K, different from the first viewpoint, and while moving the navigation user interface element relative to the second viewpoint, the computer system displays the first content of the navigation user interface element representing the first physical area with the first orientation relative to the three-dimensional environment (e.g., that is not based on the second viewpoint of the user of the computer system), and displaying the one or more third user interface elements with one or more third orientations that are based on the second viewpoint of the user of the computer system, such as shown by respective orientations of navigation user interface element 702, user interface element 730, and user interface element 708 in FIG. 7L. In some embodiments, the computer system determines that the viewpoint of the user changed from the first viewpoint to the second viewpoint. In some embodiments, the computer system detects user input corresponding to the request to move the navigation user interface element as described above and/or below. For example, while moving the navigation user interface element relative to the second viewpoint, the computer system maintains the orientation of the first content of the navigation user interface element (e.g., does not reorient the first content of the navigation user interface element to face towards the second viewpoint). In some embodiments, while moving the navigation user interface element relative to the second viewpoint, the computer system reorients the one or more orientations of the one or more third user interface element to face towards the second viewpoint. Displaying the third user interface elements with orientations that are based on a respective viewpoint of the user of the computer system while moving the navigation user interface element relative to the respective viewpoint provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the navigation user interface element representing the first physical area includes while the navigation user interface element is a first distance from a viewpoint of the user of the computer system, such as the distance shown in the overhead view 720 of the navigation user interface element 702 from the viewpoint of the user 716 in FIG. 7J, the computer system displays the navigation user interface element representing the first physical area with a first size relative to a three-dimensional environment (e.g., the first size is optionally not based on the first distance from the viewpoint), and displaying, via the display generation component, one or more (or a plurality of) third user interface elements included in the navigation user interface element with second sizes relative to the three-dimensional environment that are based on the first distance, such as shown with the relative sizes of the navigation user interface element 702 and the user interface element 730 in FIG. 7J. For example, the first size of the navigation user interface element optionally refers to a true scale or intended scale of the navigation user interface element as it would exist in the real-world with physical dimensions. In some embodiments, the scale of the navigation user interface element including the one or more geographic features is a fixed size in the three-dimensional environment. In some embodiments, when the navigation user interface element is displayed closer the viewpoint of the user, the navigation user interface element appears bigger than when the navigation user interface element is displayed farther from the viewpoint of the user (e.g., the navigation user interface element appears smaller). In some embodiments, the first size of the navigation user interface element includes the geographic features of the navigation user interface element. In some embodiments, while displaying the navigation user interface element, the navigation user interface element includes one or more third user interface elements that are dynamically scaled relative to the three-dimensional environment and dependent on the first distance from the viewpoint of the user. For example, the one or more third user interface elements are not a fixed size in the three-dimensional environment. In some embodiments, the one or more sizes of the one or more third user interface elements change based on the distance from the viewpoint. For example, when the one or more third user interface elements are displayed closer to the viewpoint of the user, the one or more third user interface elements are smaller in the three-dimensional environment, and when the one or more third user interface elements are displayed farther from the viewpoint of the user, the one or more third user interface element are larger in the environment. Thus, in some embodiments, the user perception of the one or more third user interface elements is that they are the same size (or close to the same size).

In some embodiments, while the navigation user interface element is a second distance from the viewpoint of the user, such as the distance shown in the overhead view 720 of the navigation user interface element 702 from the viewpoint of the user 716 in FIG. 7K, different from the first distance, the computer system displays the navigation user interface element representing the first physical area with the first size relative to the three-dimensional environment, and displaying, the one or more third user interface elements included in the navigation user interface element with third sizes relative to the three-dimensional environment that are based on the second distance, such as shown with the relative sizes of the navigation user interface element 702 and the user interface element 730 in FIG. 7K.

For example, the second distance from the viewpoint of the user is greater than or less than the first distance from the viewpoint of the user. In some embodiments, displaying the navigation user interface element at the second distance from the viewpoint of the user is in response to the computer system detecting user input corresponding to a request to move the navigation user interface element as described above. In some embodiments, displaying the navigation user interface element at the second distance from the viewpoint of the user is in response to the computer system detecting movement of the viewpoint of the user (e.g., the user moving the physical environment). In some embodiments, the navigation user interface element has a fixed size in the three-dimensional environment independent from the distance from the viewpoint. In some embodiments, when the distance between navigation user interface element and the viewpoint of the user changes from the first distance to the second distance, wherein the second distance is greater than the first distance (e.g., the navigation user interface element moves farther away from the viewpoint of the user), the navigation user interface element appears smaller to the user compared to the first distance. In another example, wherein the second distance is less than the first distance (e.g., the navigation user interface element moves closer to the viewpoint of the user), the navigation user interface element appears larger to the user compared to the first distance.

In some embodiments, conversely, the one or more third user interface elements included in the navigation user interface element appear the same size at the first distance and the second distance, wherein the first distance is greater than or less than the second distance. Displaying the third user interface elements with sizes relative to the three-dimensional environment that are based on a distance from the viewpoint of the user of the computer system while the size of the navigation user interface element is independent of the distance from the viewpoint of the user provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the navigation user interface element including the one or more third user interface elements includes, in accordance with a determination that a respective user interface element of the one or more third user interface elements is the first distance from the viewpoint of the user, such as the distance shown in the overhead view 720 of the user interface element 730 from the viewpoint of the user 716 in FIG. 7I, displaying content associated with the respective user interface element with the second size relative to the viewpoint of the user, such as the size of the content included in the user interface element 730 in FIG. 7I.

In some embodiments, displaying the navigation user interface element including the one or more third user interface elements includes, in accordance with a determination that the respective user interface element of the one or more third user interface elements is the second distance from the viewpoint of the user, such as the distance shown in the overhead view 720 of the user interface element 730 from the viewpoint of the user 716 in FIG. 7J, different from the first distance, displaying content associated with the respective user interface element with the second size relative to the viewpoint of the user, such as, for example, the size of the content included in the user interface element 730 in FIG. 7I. For example, when the respective user interface element is a first distance from the viewpoint of the user or a second distance from the viewpoint of the user, the computer system displays the content associated with the respective user interface element with a same simulated size. In some embodiments, the computer system changes the size of the content associated with the respective user interface element relative to the three-dimensional environment as the distance from the viewpoint of the user changes from the first distance to the second distance. In some embodiments, the respective user interface element is a dynamically scaled virtual object similar to the one or more third user interface elements described above. For example, the size of the content associated with the respective user interface element appears from the viewpoint of the user as the same size from a first distance and from a second distance.

In some embodiments, the content associated with the respective user interface element includes text, images, and/or graphics describing the respective physical location corresponding to the respective location within the navigation user interface element of the respective user interface element. Displaying content associated with the respective user interface element with a same size relative to the viewpoint of the user regardless of the distance from the viewpoint of the user provides an efficient way of presenting content and enables the user to clearly view the content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors. In some embodiments, the one or more third user interface elements include representations of points of interest, indications of respective physical locations associated with the third user interface elements, and/or respective content associated with the third user interface elements, such as user interface elements 730 and 732 in FIG. 7M. In some embodiments, the representations of points of interest are analogous to and/or include one or more characteristics of the third user interface element(s) including the collection of content items described above described above. For example, the representation of points of interest optionally include user interface elements (e.g., location content cards) that, when selected, cause the computer system to display the collection of content items of the respective third user interface element as described above. In some embodiments, the indications of respective physical locations associated with the third user interface elements are analogous to and/or include one or more characteristics of the one or more points of interest indications described above. For example, the indications of respective physical locations associated with the third user interface elements optionally include location pins or icons or user interface elements identifying a respective physical point of interest that, when selected, cause the computer system to display more information about the respective physical point of interest. In some embodiments, the respective content associated with the third user interface elements are analogous to and/or include one or more characteristics of the collection of content items described above. For example, the respective content associated with the third user interface elements optionally include text, images, and/or graphics describing the collection of content items and/or the respective physical location corresponding to the respective location within the navigation user interface element of the third user interface element.

Displaying the one or more third user interface elements in the navigation user interface element provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors. In some embodiments, displaying the one or more third user interface elements is while the attention of the user is directed to the navigation user interface element, such as user input 714 including gaze directed to the navigation user interface element 702 in FIG. 7L. For example, while displaying the navigation user interface element, the computer system detects, via the one or more input devices, the attention (e.g., including gaze) of the user directed to the navigation user interface element, and in response to detecting the attention of the user directed to the navigation user interface element, the computer system optionally displays the one or more third user interface elements. In some embodiments, the computer system does not display the one or more third user interface elements prior to detecting the attention of the user directed to the navigation user interface element.

In some embodiments, in accordance with a determination that the attention of the user is directed to a respective user interface element of the one or more third user interface elements and that a portion of the navigation user interface element is located in between the viewpoint of the user and the respective user interface element, the computer system reduces a visual prominence of the portion of the navigation user interface element, such as shown by user interface element 732 in FIG. 7M, where the portion of the navigation user interface element visually reduced. In some embodiments, the respective user interface element is analogous to and/or includes one or more characteristics of the representations of points of interest, indications of respective physical locations associated with the third user interface elements, and/or respective content associated with the third user interface elements as described above. In some embodiments, when the computer system reduces the visual prominence of the portion of the navigation user interface element, the respective user interface element appears more visible through the portion of the navigation user interface element. In some embodiments, reducing the visual prominence of the portion of the navigation user interface element gives an appearance of the respective user interface element of being visible through at least the portion of the navigation user interface element (e.g., breakthrough visual effect). In some embodiments, prior to detecting that the attention of the user is directed to the respective user interface element, the computer system does not display the navigation user interface element with a reduced visual prominence. In some embodiments, prior to detecting that the attention of the user is directed to the respective user interface element, the computer system displays the portion of the navigation user interface element eclipsing or obscuring the respective user interface element. In some embodiments, reducing the visual prominence of the portion of the navigation user interface element is analogous to and/or includes one or more characteristics of reducing the visual prominence of the first portion of the navigation user interface element described above.

In some embodiments, in accordance with a determination that the attention of the user is directed away from the respective user interface element, the computer system increases the visual prominence of the portion of the navigation user interface element, such as for example, in FIG. 7L where the portion of the navigation user interface element that includes the representation of the building is displayed having increased visual prominence. For example, increasing the visual prominence of the portion of the navigation user interface element causes the respective user interface element to be less visible. The portion of the navigation user interface element eclipses or obscures at least a portion of the respective user interface element. In some embodiments, increasing the visual prominence of the portion of the navigation user interface element is analogous to and/or includes one or more characteristics of increasing the visual prominence of the first portion of the navigation user interface element described above. Reducing or increasing the visual prominence of the navigation user interface element in response to determining that the user's attention is directed to the respective user interface element provides confirmation that the user intends to interact with the respective user interface element without cluttering the user interface (e.g., by not always displaying the respective user interface element), which enhances operability of the computer system, reduces power usage of the computer system, reduces errors in the interaction between the user and the computer system, and reduces inputs needed to correct such errors. In some embodiments, displaying the one or more third user interface elements of a first type includes in accordance with a determination that a spatial arrangement (e.g., relative position and/or orientation) between a current viewpoint of the user and the navigation user interface element is a first spatial arrangement, displaying the one or more third user interface elements with a first orientation relative to the current viewpoint of the user (e.g., the first orientation is based on the current viewpoint of the user), such as shown by the spatial arrangement in overhead view 720 in which navigation user interface element 702 and user interface element 708 face the user in FIG. 7K.

In some embodiments, displaying the one or more third user interface elements of a first type includes, in accordance with a determination that the spatial arrangement (e.g., relative position and/or orientation) between the current viewpoint of the user and the navigation user interface element is a second spatial arrangement, such as the spatial arrangement in overhead view 720 in FIG. 7K, different from the first spatial arrangement, displaying the one or more third user interface elements with the first orientation relative to the current viewpoint of the user, such as the user interface element 708 oriented to face the user in FIG. 7L. For example, the computer system displays the one or more third user interface elements with first orientations relative to the current viewpoint of the user (e.g., oriented towards the current viewpoint of the user). In some embodiments, the computer system detects that the viewpoint of the user changed from a first viewpoint to a second viewpoint, and in response, the computer system reorients the one or more third user interface elements to face towards the second viewpoint of the user (e.g., the computer system changes the orientations of the one or more third user interface elements to be oriented towards the second viewpoint of the user). In some embodiments, the one or more third user interface elements of the first type include text labels and/or representations of location pins. In some embodiments, the computer system does not change the orientation of the navigation user interface element based on the second viewpoint of the user. Thus, in some embodiments the navigation user interface element is independent of (e.g., not based on) the viewpoint of the user. Displaying one or more third user interface elements with orientations that are based on a viewpoint of the user of the computer system provides an efficient way of presenting content and enables the user to clearly view the content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the one or more third user interface elements of a second type, such as user interface elements 730 and 708 includes displaying the one or more third user interface elements of the second type with the first orientation relative to the current viewpoint of the user when the one or more third user interface elements are first displayed and while the spatial arrangement (e.g., relative position and/or orientation) between the current viewpoint of the user and the navigation user interface element is the first spatial arrangement, such as user interface elements 730, 734, and 732 in FIG. 7N. In some embodiments, displaying the one or more third user interface elements of a second type includes after the one or more third user interface elements are first displayed and while the spatial arrangement (e.g., relative position and/or orientation) between the current viewpoint of the user and the navigation user interface element is the second spatial arrangement, displaying the one or more third user interface elements of the second type with a second orientation relative to the current viewpoint of the user, wherein the second orientation is based on the second spatial arrangement, such as shown in FIG. 7M where user interface element 732 is oriented towards the viewpoint of user 716. In some embodiments, the one or more third user interface elements of the second type include location cards or user interface elements different from the text labels and/or representations of location pins. In some embodiments, the location cards are analogous to and/or include the user interface elements that include collection(s) of content items described above. In some embodiments, when the computer system first displays the one or more third user interface elements of the second type, the computer system displays the one or more third user interface elements oriented towards the current viewpoint of the user. In some embodiments, the computer system detects that the viewpoint of the user changed from the first viewpoint (e.g., the viewpoint of the user when the computer system initially displayed the one or more third user interface elements) to the second viewpoint, and in response, the computer system maintains the current orientation of the one or more third user interface elements (e.g., the computer system does not update the orientation of the one or more third user interface elements to face the second viewpoint). Maintaining the orientation of the respective user interface element provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, while displaying the navigation user interface element, the electronic device displays a control element for the navigation user interface element, such as user interface element 704 and control element 706 in FIG. 7M, including displaying the control element with a first orientation (e.g., that is based on the current viewpoint of the user) relative to the current viewpoint of the user when the control element is first displayed and while a spatial arrangement (e.g., relative position and/or orientation) between a current viewpoint of the user and the navigation user interface element is a first spatial arrangement, such as shown by the spatial arrangement of user interface element 704 and control element 706 in FIG. 7M. In some embodiments, when the computer system first displays the control element, the computer system displays the control element oriented towards the current viewpoint of the user. In some embodiments, the control element is analogous to and/or includes one or more characteristics of the control element associated with the navigation user interface element as described above. For example, the computer system optionally displays the control element adjacent to and below the navigation user interface element. In some embodiments, the computer system displays the control element at a same distance from the viewpoint of the user as the navigation user interface element.

In some embodiments, while displaying the navigation user interface element, the electronic device displays a control element for the navigation user interface element, including after the control element is first displayed and while the spatial arrangement (e.g., relative position and/or orientation) between the current viewpoint of the user and the navigation user interface element is a second spatial arrangement, different from the first spatial arrangement, in accordance with a determination that a difference between the first spatial arrangement and the second spatial arrangement satisfies a difference threshold (e.g., 20.0, 20.5, 22.0, 22.5, 23.0, 23.5, 24.0, or 24.5 degrees), the computer system displays the control element with the first orientation relative to the current viewpoint of the user, such as shown by user interface element 704 and control element 706 in FIG. 7N.

In some embodiments, while displaying the navigation user interface element, the electronic device displays a control element for the navigation user interface element, including after the control element is first displayed and while the spatial arrangement between the current viewpoint of the user and the navigation user interface element is a second spatial arrangement, such as similarly to the orientation show by user interface element 730 in FIG. 7L, in accordance with a determination that the difference between the first spatial arrangement and the second spatial arrangement does not satisfy the difference threshold, displaying the control element with a second orientation, different from the first orientation, relative to the current viewpoint of the user, such as shown by user interface element 704 and control element 706 in FIG. 7M. In some embodiments, the computer system detects that the viewpoint of the user changed from a first viewpoint (e.g., the viewpoint of the user when the computer system initially displayed the control element) to a second viewpoint, and in response, in accordance with a determination that the amount of change from the first viewpoint to the second viewpoint is at least a predefined difference threshold (e.g., 20.0, 20.5, 22.0, 22.5, 23.0, 23.5, 24.0, or 24.5 degrees), the computer system displays the control element with second orientations that are based on the second viewpoint of the user (e.g., the computer system reorients the control element to face towards the second viewpoint). In some embodiments, when the computer system determines that the amount of change from the first viewpoint to the second viewpoint is less than the predefined difference threshold, the computer system does not reorient the control element to face towards the second viewpoint. In some embodiments, the computer system reorients, or does not reorient other user interface elements such as the search user interface element (e.g., described above) similarly to the control element described herein Displaying a control element with an orientation that is based relative to the current viewpoint of the user provides an efficient way of presenting content and enables the user to clearly view the content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors. In some embodiments, the navigation user interface element represents the first physical area and includes a one or more points of interest indications, such as the navigation user interface element 702 in FIG. 7N. In some embodiments, the one or more points of interest indications are analogous to and/or include one or more characteristics of the one or more points of interest indications described above.

In some embodiments, while displaying the navigation user interface element including the one or more points of interest indications, the computer system detects the attention of the user directed to a respective point of interest indication of the one or more points of interest indications, such as user input that includes gaze directed to a representation of point of interest corresponding to representation 736 in FIG. 7N.

In some embodiments, in response to detecting the attention of the user directed to the respective point of interest indication, in accordance with a determination that the attention of the user is directed to the respective point of interest indication for longer than a threshold period of time, the computer system displays, via the display generation component, content associated with the respective point of interest indication, such as displaying representation 736 in FIG. 7N, In some embodiments, in response to detecting the attention of the user directed to the respective point of interest indication, in accordance with a determination that the attention of the user is not directed to the respective point of interest indication for longer than the threshold period of time, the computer system foregoes displaying the content associated with the respective point of interest indication, such as not displaying representation 736 in FIG. 7N. For example, the computer system displays the one or more points of interest indications with first sizes in the navigation user interface element. In some embodiments, the computer system detects that the attention (e.g., gaze) of the user is directed to a respective point of interest indication for longer than a threshold period of time (e.g., 2, 3, 5, 10, 15, 20, or 30 seconds), and in response to detecting that the attention of the user is directed to the respective point of interest indication for longer than the threshold period of time, the computer system displays content associated with the respective point of interest indication, such as a text, a label, and/or an image describing the respective physical point of interest corresponding to the respective point of interest indication. In some embodiments, in accordance with a determination that the attention of the user is not directed to the respective point of interest indication (or, optionally, the content associated with the respective point of interest indication) for longer than the threshold period of time (e.g., as described herein), the computer system forgoes displaying the content associated with the respective point of interest indication. In some embodiments, the computer system detects that the attention of the user is directed to the respective point of interest indication for less than a threshold period of time, and in response to detecting that the attention is directed to the respective point for less than the threshold period of time, the computer system forgoes displaying the content associated with the respective point of interest indication.

Displaying content associated with a respective point of interest indication when the attention of the user is directed to the respective point of interest indication provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors. In some embodiments, while displaying the navigation user interface element representing the first physical area, the computer system concurrently displays, via the display generation component, a tool bar user interface element including one or more options that, when selected, cause the computer system to perform an operation associated with the navigation user interface element, such as an option of the user interface element 704 in FIG. 7P that is selectable to cause the operation shown in FIG. 7Q. For example, the tool bar user interface element includes a first option that, when selected, causes the computer system to display the navigation user interface element in a size larger (e.g., occupying a larger portion of the display generation component) than a size of the navigation user interface element prior to detecting user input (e.g., as described above with reference to the user input directed to a respective control element), via the one or more input devices, directed to the first option. In some embodiments, the tool bar user interface element includes a second option that, when selected, causes the computer system to display a content item with a level of immersion corresponding to a view of a respective physical location as described above with reference to displaying a first content item with a first level of immersion (or, optionally, a second level of immersion or other level of immersion) corresponding to a first view of a respective physical location as described in more detail above and with reference to method(s) 1000 and/or 1200. In some embodiments, the tool bar user interface element includes a third option that, when selected, causes the computer system to display an indication of current physical location of the computer system within the navigation user interface element. In some embodiments, displaying the indication of the current physical location of the computer system causes the computer system to manipulate (e.g., resize, pan, tilt, and/or rotate) the navigation user interface element and/or display the navigation user interface element to represent a second physical area, different from the first physical area, and corresponding to the current physical location of the computer system. In some embodiments, the tool bar user interface element includes a fourth option that, when selected, causes the computer system to display the navigation user interface element in a different manner or view, such as a map view, a driving view with live traffic, a transit view for public transportation, and/or a satellite view from a satellite. In some embodiments, the computer system displays the toolbar user interface element with an orientation that is based on the viewpoint of the user (e.g., the orientation of the toolbar user interface element is directed towards the viewpoint of the user regardless or independent of the orientation and/or location of the navigation user interface element relative to the viewpoint of the user and/or relative to the three-dimensional environment).

Displaying a toolbar user interface element that is selectable to perform one or more actions and/or display more information associated with the navigation user interface element provides an efficient way of performing an action associated with the navigation user interface element and/or presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors. In some embodiments, while displaying the tool bar user interface element, the computer system concurrently displays, via the display generation component, a control element adjacent to the tool bar user interface element that, when selected, initiates a process to move (or, optionally, resize or close) the navigation user interface element, such as control element 706 in FIG. 7P. In some embodiments, the control element is analogous to and/or includes one or more characteristics of the respective control element and/or the respective control element component described in more detail above. For example, in response to the computer system detecting user input (e.g., as described above with reference to the user input directed to a respective control element) directed to the control element, the computer system moves (or, optionally, resizes or closes) the navigation user interface element in accordance with the user input (e.g., if the user input includes movement). Displaying a control element adjacent to the toolbar user interface element that is selectable to move the navigation user interface element provides an efficient way moving the navigation user interface element, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, while displaying the navigation user interface element with a first level of immersion in a three-dimensional environment and the tool bar user interface element including the one or more options, wherein the navigation user interface element is oriented along (e.g., aligned with and/or parallel to) a first axis relative to the three-dimensional environment, the computer system detects, via the one or more input devices, a user input directed to a first option of the one or more options, such an option described with reference to the user interface element 704 in FIG. 7P.

In some embodiments, in response to detecting the user input directed to the first option, such as user input 714 that includes gaze directed to the option of the user interface element 704 in FIG. 7P, the computer system displays the navigation user interface element with a second level of immersion, different from the first level of immersion, in the three-dimensional environment, and along (e.g., aligned with and/or parallel to) a horizontal axis, different from the first axis, relative to the three-dimensional environment, wherein the horizontal axis is aligned with (e.g., parallel to) a ground plane of a physical environment of the user of the computer system, such as the navigation user interface element 702 in FIG. 7Q.

In some embodiments, in response to detecting the user input directed to the first option, the computer system ceases to display the first user interface element and the second user interface element, such ceasing to display, for example, user interface element 708 in FIG. 7Q. In some embodiments, the first axis is based on user input, such user input to move and/or tilt the navigation user interface element; and/or a location (x, y and/or z) of the navigation user interface element relative to the viewpoint of the user. In some embodiments, the horizontal axis is not based on user input and is not based on the location of the navigation user interface element relative to the viewpoint of the user. In some embodiments, the first option is analogous to and/or includes one or more characteristics of the first option of the tool bar user interface element that, when selected, causes the computer system to display the navigation user interface element in a larger size as described in more detail above. In some embodiments, displaying the navigation user interface element with the second level of immersion includes displaying the navigation user interface element with a high level of immersion as described in more detail above with reference to displaying a first content item with a high level of immersion (e.g., expanding the boundaries of the navigation user interface element to cover a larger portion of the three-dimensional environment). In some embodiments, displaying the navigation user interface element with the second level of immersion includes displaying the navigation user interface element at a perspective from a simulated camera that is optionally above street level (e.g., “Godzilla view,” on a roof, balcony, or other overhead view). In some embodiments, while the computer system displays the navigation user interface element with the second level of immersion, the computer system displays one or more visual indications of a weather condition (e.g., a representation of a rain cloud) corresponding to the weather condition at the first physical area (e.g., the first physical location experiencing rainfall) that is being represented by the navigation user interface element, and in some embodiments, such visual indication of weather were not displayed when the user input directed to the first option was detected.

In some embodiments, in response to (and/or while) displaying the navigation user interface element with the second level of immersion and along the horizontal axis as described herein, the computer system moves the navigation user interface element down or closer to the ground plane of the physical environment. Displaying a first option that is selectable to display the navigation user interface element with a second level of immersion and along a horizontal axis provides an efficient way of displaying the navigation user interface element, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the navigation user interface element with the second size includes displaying the tool bar user interface element overlaid on the navigation user interface element, such as shown, for example, by overhead view 720 with the user interface element 708 overlaid on navigation user interface element 702 in FIG. 7C. In some embodiments, the computer system displays the tool bar user interface element in front of (or, optionally, overlaid over) the navigation user interface element. Thus, in some embodiments, prior to detecting the user input as described above, the tool bar user interface was displayed below the navigation user interface element and after or in response to the input, the tool bar user interface element is displayed in front of (and/or overlaid on) the navigation user interface element. In some embodiments, the tool bar user interface element is analogous to and/or includes one or more characteristics of the tool bar user interface element described above. Displaying the tool bar user interface element provides an efficient way of performing an action associated with the navigation user interface element via the displayed tool bar user interface element, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the second user interface element includes displaying a stereoscopic representation of content that is constrained to appear within a portal of a three-dimensional environment of the user of the computer system, such as user interface element 728 displayed as a portal in FIG. 7F. In some embodiments, the stereoscopic representation of content includes a (e.g., partial) view of a stereoscopic 360 degree rendering of three-dimensional map content of a particular scene (e.g., physical location), wherein the computer system displays a three-dimensional visual display of the particular scene via a portal as described in more detail above with reference to using a first or second display area to present content. For example, the particular scene includes one or more images or video (or, optionally, including spatial video), such as street-level imagery, panoramas, and/or 360 degrees camera views taken from and/or of a respective physical location as described above with reference to collections of map content. In some embodiments, in accordance with a determination that the angle of the viewpoint of the user is a first angle relative to the portal (e.g., right side of the portal), the computer system displays one or more first portions of the stereoscopic representation of content through the portal. In some embodiments, in accordance with a determination that the angle of the viewpoint of the user is a second angle relative to the portal (e.g., left side of the portal), different from the first angle, the computer system displays one or more second portions of the stereoscopic representation of content through the portal, different from the one or more first portions of the stereoscopic representation of content. Displaying a stereoscopic representation of content provides an efficient way surfacing three-dimensional map content via a portal, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, displaying the navigation user interface element representing the first physical area includes, while the navigation user interface element is displayed at a first angle relative to a viewpoint of the user of the computer system (and/or relative to a three-dimensional environment), the computer system displays, via the display generation component, a one or more third user interface elements included in the navigation user interface element with first orientations, such as shown by the respective orientations of user interface elements 730, 734, and 732; and navigation user interface element 702 in FIG. 7O, (e.g., relative to the three-dimensional environment and/or relative to the viewpoint of the user); and For example, the first orientations are optionally predefined orientations relative to a reference in the three-dimensional environment (e.g., a floor/ground of the physical environment or virtual object of the virtual environment). In another example, the first orientations optionally include a predefined angle (e.g., 75, 80, 85, or 90 degrees) relative to the reference.

In some embodiments, displaying the navigation user interface element representing the first physical area includes, while the navigation user interface element is displayed at a second angle, different from the first angle, relative to the viewpoint of the user of the computer system (and/or relative to a three-dimensional environment), displaying the one or more third user interface elements included in the navigation user interface element with the first orientations, such as an angle indicated in the overhead view 720 of the navigation user interface element 702 and the displayed respective orientations of user interface elements 730, 734, and 732; and navigation user interface element 702 in FIG. 7P, (e.g., relative to the three-dimensional environment and/or relative to the viewpoint of the user).

For example, while the navigation user interface element is displayed at a first angle relative to the viewpoint of the user, the computer system displays the one or more third user interface elements with first orientations to view the display of the navigation user interface element and the one or more third user interface elements. In some embodiments, the computer system detects that the angle at which the navigation user interface element is changed from the first angle to the second angle relative to the viewpoint of the user, and in response, the computer system displays the one or more third user interface elements with the first orientations (e.g., the computer system does not change the orientations of the one or more third user interface elements). Thus, in some embodiments the orientations of the one or more third user interface elements is independent of (e.g., not based on) the angle at which the navigation user interface element is displayed relative to the viewpoint of the user. Displaying the third user interface elements with orientations that are independent of the angle at which the navigation user interface element is displayed relative to the viewpoint of the user provides an efficient way of presenting content and enables the user to clearly view the content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, a computer system automatically displays a navigation user interface element according to a respective appearance condition in response to an event. In some embodiments, the navigation user interface element includes a three-dimensional topographical map of a respective physical area. In some embodiments, the computer system optionally displays representations of a weather condition (e.g., rain clouds, rain, lightning, and/or fog) at an area and/or location in the navigation user interface element corresponding to the area and/or the location of the physical area experiencing the weather condition. In some embodiments, displaying the navigation user interface element according to a respective appearance condition provides an increased level of detail about the first physical area and provides information and/or indications of what the device knows about the first physical area, which avoids additional interaction between the user and the computer system associated with the user performing additional inputs to look up the weather condition in the first physical area and/or change the appearance condition of the navigation user interface element to what is appropriate for the weather condition while avoiding unnecessary use of resources (e.g., by not displaying appearance condition elements unless necessary or appropriate as defined by the event), thereby reducing errors in the interaction between the user and the computer system and reducing inputs needed to correct such errors.

FIGS. 9A-9F illustrate examples of a computer system dynamically presenting user interface elements according to one or more appearance conditions in response to detecting an event in accordance with some embodiments.

FIG. 9A illustrates a computer system 101 displaying, via a display generation component 120 (e.g., display generation components 1-122a and 1-122b of FIG. 1), a three-dimensional environment 900 from a viewpoint of a user of the computer system 101. In some embodiments, the computer system 101 in FIG. 9A is analogous to and/or includes one or more characteristics, provides one or more features, and/or includes one or more components as the computer system 101 described with reference to FIGS. 7A-7Q. In FIG. 9A, the display generation component 120 is analogous to and/or includes one or more characteristics and/or one or more components (e.g., sensors 114a through 114c) as the display generation component 120 described with reference to FIG. 7A.

As shown in FIG. 9A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 900. For example, three-dimensional environment 900 includes representations of walls, window 910, and a lamp 912 of the room in which the computer system 101 is located.

In FIG. 9A, three-dimensional environment 900 includes a plurality of virtual objects, such as graphical user interfaces and/or graphical user interface elements 902, 904, 906, and 908. In some embodiments, the virtual objects are optionally components of a graphical user interface or window of a map application as described with reference to method(s) 800, 1000 and/or 1200. For example, in FIG. 9A, the computer system 101 displays a first user interface element 908 (optionally, also referred to herein as a window or volume) at which the computer system 101 receives a text input defining a search query for performing a search operation as described with reference to method(s) 800 and/or 1000. In some embodiments, the first user interface element 908 is analogous to and/or includes one or more characteristics of the first user interface element 708 in FIG. 7A.

In FIG. 9A, the computer system 101 also displays a navigation user interface element 902 representing a first physical area. In some embodiments, the navigation user interface element 902 is analogous to and/or includes one or more characteristics of the navigation user interface element 702 in FIG. 7A. In FIG. 9A, the navigation user interface element 902 includes a second navigation user interface element 904 and a control element 906. In some embodiments, the second navigation user interface element 904 and the control element 906 are analogous to and/or include one or more characteristics of the second navigation user interface element 704 and the control element 706, respectively in FIG. 7A. FIG. 9A also illustrates an overhead view of the three-dimensional environment 900 which depicts the three-dimensional environment 900 visible from a viewpoint of a user 916 of the computer system 101. In the overhead view of the three-dimensional environment 900, the user 916 is facing the navigation user interface element 902 and the first user interface element 908. The lamp 912 is located in a right corner of the physical environment in which the user 916 is located.

In FIG. 9A, clock 918 indicates a date and time associated with the navigation user interface element 902. In some embodiments, the computer system 101 sets or obtains the time of clock 918 and in response to setting or obtaining the date and/or time, the computer system 101 displays the navigation user interface element 902 representing the date and time of clock 918. Obtaining and/or setting the date and/or time is described in more detail in method 1000. For example, in FIG. 9A, the computer system 101 determines the date and time of the clock 918 is “Sep. 4, 2024 at 7:00 PM,” and in response to determining the date and time, the computer system 101 displays, via the display generation component 120, the navigation user interface element 902 according to a respective appearance condition corresponding to the date and time. In FIG. 9A, displaying the navigation user interface element 902 according to the respective appearance condition corresponding to the date and time “Sep. 4, 2024 at 7:00 PM” includes displaying a representation of the sun 920.

In FIG. 9B, the computer system 101 detects an event, such as time change from “Sep. 4, 2024 at 7:00 PM” in FIG. 9A to “Sep. 4, 2024 at 7:20 PM” as shown in FIG. 9B. In some embodiments, and as described in more detail with reference to method 1000, the computer system 101 determines that the event indicates a change from displaying the navigation user interface element 902 according to the respective appearance condition in FIG. 9A to displaying the navigation user interface element according to a second appearance condition. For example, in FIG. 9B, the computer system 101 determines based on the time of clock 918 a change from daytime to nighttime, and in response, the computer system 101 displays a representation of the sun 920 setting or at a location below a horizon line of the navigation user interface element 902. In some embodiments, the computer system 101 displays an animation or visual effect of the representation of the sun 920 disappearing or moving below the horizon line.

In some embodiments, the computer system 101 presents the navigation user interface element 902 with a different visual appearance or style than shown in FIG. 9B. For example, in FIG. 9B, the computer system detects a user input including an air pinch gesture with two hands 932 (e.g., described in more detail in method(s) 800, 1000, and/or 1200) and movement to pull the hands together to zoom out while gaze (e.g., user input 914) of the user of the computer system 101 is directed to the navigation user interface element 902, as shown in FIG. 9B. In response to detecting the user input in FIG. 9B, the computer system 101 zooms out of the navigation user interface element 902 to display the navigation user interface element 902 according to a second (e.g., globe) appearance condition, as shown in FIG. 9C. In some embodiments, displaying the navigation user interface element 902 according to the second appearance condition includes land masses, bodies of water, and/or other topographic features. In some embodiments, displaying the navigation user interface element 902 according to the second appearance condition includes displaying one or more virtual objects indicative of a time and/or day.

For example, in FIG. 9C, the computer system 101, displays, via the display generation component 120, representations of stars 922 indicative of the time and day as shown by clock 918. In some embodiments, displaying the navigation user interface element 902 according to the second appearance condition includes displaying the navigation user interface element 902 and/or the one or more virtual objects indicative of a time and/or day with a predetermined level of immersion as described in more detail with reference to method 1000. For example, in FIG. 9C, displaying the navigation user interface element 902 according to the second appearance condition includes displaying, via display generation component 120, a representation of the physical environment with a visual appearance different from the visual appearance of the representation of the physical environment prior to detecting the user input in FIG. 9B. In some embodiments, the visual appearance includes a degree of lighting, color, opacity, and/or other visual characteristic described in method(s) 800, 1000, and/or 1200. In FIG. 9C, the computer system 101 displays the representation of the physical environment with a degree of lighting that is less than the degree of lighting associated with displaying the navigation user interface element according to the respective appearance condition in FIG. 9B. In some embodiments, and as shown in FIG. 9C, displaying the navigation user interface element 902 according to the second appearance condition includes displaying the one or more virtual objects (e.g., representations of stars 922) in a larger portion of the three-dimensional environment as will be described in FIGS. 9D and 9E below. In FIG. 9C, the representations of stars 922 are not limited to being displayed proximate to the navigation user interface element 902 and are displayed all around the user of the computer system 101.

In some embodiments, the computer system 101 presents the navigation user interface element 902 including an indication of a weather condition. For example, in FIG. 9C, the computer system 101 detects voice input 936 from the user corresponding to a request to zoom in on a physical location (e.g., Crissy Field) at a particular date and time (e.g., tomorrow at 10:00 AM). In response to receiving the voice input 936 in FIG. 9C, the computer system 101 displays, via display generation component 120, the navigation user interface element 902 representing the physical location at the particular date and time (e.g., Crissy Field at 10:00 AM as also indicated by clock 918) as shown in FIG. 9D. In some embodiments, the computer system 101 displays an indication of the weather condition based on the date and time at the physical location as described in more detail with reference to method 1000. For example, displaying the navigation user interface element 902 representing the physical location at the particular date and time includes displaying representations of fog 924 as shown in FIG. 9D without receiving from the user a request for the weather condition and/or to display the weather condition.

In another example, in FIG. 9D, the computer system 101 detects voice input 938 from the user corresponding to a request to display the weather in the afternoon (e.g., without specifying the location and/or time). In response to receiving the voice input 938, the computer system 101 displays the navigation user interface element 902 representing the physical location at a respective date and time corresponding to the user's request (e.g., Crissy Field at 2:00 PM as also indicated by clock 918) as shown in FIG. 9E. Displaying the navigation user interface element 902 corresponding to the user's request includes displaying representations of rain and lighting 926 as shown in FIG. 9E without receiving from the user a specific location and/or a specific time. In some embodiments, the computer system 101 utilizes a currently displayed physical location of the navigation user interface element 902 and a window of time corresponding to keyword “afternoon” when responding to the user request as discussed in more detail with reference to method(s) 1000 and/or 1200.

In some embodiments, displaying an indication of the weather condition includes displaying one or more virtual objects occupying an amount of the three-dimensional environment 700. For example, in FIG. 9E, the computer system displays representations of rain and lightning 926 occupying a larger amount of the three-dimensional environment 700 than when displaying the representation of fog 924 in FIG. 9D. In some embodiments, the computer system displays the indication of the weather condition (e.g., representations of rain, lighting, fog, snow, or smoke) in varying amounts (e.g., levels of immersion) as described in more detail with reference to method 1000.

In some embodiments, the second navigation user interface element 904 in FIG. 9E includes an option that, when selected, causes the computer system 101 to display the navigation user interface element 902 representing a second physical location, different from the physical location as shown in FIG. 9E. For example, in FIG. 9E, the computer system 101 detects user input 914 that includes an air pinch gesture 934 (e.g., described in more detail in method(s) 800, 1000, and/or 1200) while gaze of the user of the computer system 101 is directed to a the option of the second navigation user interface element 904. In response to detecting the user input 914 in FIG. 9E, the computer system 101 displays the navigation user interface element 902 representing the second physical location as shown in FIG. 9F. In some embodiments, the second physical location corresponding to the physical location of the computer system 101. In FIG. 9F, displaying the navigation user interface element 902 representing the second physical location includes displaying the navigation user interface element 902 according to a respective appearance condition as described in method 1000. For example, in FIG. 9F, the computer system 101 displays, via the display generation component 120, representations of a moon 928 and stars 930. In some embodiments, the respective appearance condition corresponds to a current date and time of the computer system 101 as shown by clock 918 in FIG. 9F.

In some embodiments, the respective appearance condition corresponds to a current data and time at a physical location of the computer system 101 as described in method 1000. For example, and as described above with reference to FIG. 9E, in response to detecting the user input 914 in FIG. 9E, the computer system 101 displays the navigation user interface element 902 representing the second physical location which corresponds to the physical location of the computer system 101 as shown in FIG. 9F. In some embodiments, in response to (and/or while) the computer system 101 displays the navigation user interface element 902 representing the second physical location corresponding to the physical location of the computer system 101, the computer system 101 displays the navigation user interface element 902 according to a respective appearance condition that is based on the time of day at the physical location of the computer system 101. In some embodiments, the respective appearance condition corresponds to a time of day at a location other than the physical location of the computer system 101 as described in method 1000. For example, the location is obtained or received using user input, such as the location Crissy Field derived from voice input 936 in FIG. 9C. In some embodiments, displaying the navigation user interface element according to a respective appearance condition is based on a current time of day of a system virtual environment of the computer system (e.g., light mode, dark mode, or other lighting mode) as described in more detail with reference to method 1000.

FIG. 10 is a flowchart illustrating an exemplary method of dynamically presenting user interface elements according to one or more appearance conditions in response to detecting an event in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 1000 are, optionally, combined and/or the order of some operations is, optionally, changed.

In some embodiments, method 1000 is performed at a computer system (e.g., 101) in communication with a display generation component (e.g., 120) and one or more input devices (e.g., 314). In some embodiments, the computer system has one or more of the characteristics of the computer system of method 800. In some embodiments, the one or more input devices have one or more of the characteristics of the one or more input devices of method 800. In some embodiments, the display generation component has one or more of the characteristics of the display generation component of method 800. In some embodiments, while displaying, via the display generation component, a user interface of a map application including a navigation user interface element representing a first physical area according to a first appearance condition, such as navigation user interface element 902 including a representation of the sun 920 in FIG. 9A, the computer system detects (1002a), via the one or more input devices, an event, such as a change in the time of day as indicated by clock 918 in FIG. 9B.

In some embodiments, the user interface of the map application has one or more of the characteristics of the user interface of the map application of method 800. In some embodiments, the navigation user interface element has one or more of the characteristics of the navigation user interface element of method(s) 800, 1000, and/or 1200. In some embodiments, the computer system displays the user interface including the navigation user interface element within a three-dimensional environment as described in method 800. In some embodiments, the first appearance condition is based on a particular time of day and/or weather condition at the first physical area as described in more detail below. In some embodiments, displaying the navigation user interface element representing the first physical area according to the first appearance condition includes displaying additional content and/or virtual objects. For example, the computer system optionally displays representations of the weather condition (e.g., rain clouds, rain, lightning, and/or fog) at an area and/or location in the navigation user interface element corresponding to the area and/or the location of the physical area experiencing the weather condition. In some embodiments, the computer system displays the first appearance condition and other appearance condition(s) within the three-dimensional environment as described in method 800. Examples of displaying the navigation user interface element according to other appearance conditions will be described in more detail below.

In some embodiments, detecting the event includes detecting information provided by an application installed and/or operating on the computer system, such as a weather application, a clock application, a maps application, a camera application, or other application installed and/or operating on the computer system. In some embodiments, the computer system detects the event provided by the application automatically (e.g., without detecting or receiving user input). Exemplary information includes a current weather condition corresponding to the first physical area, a current time of day at the first physical area, and/or other information as described in more detail below. In some embodiments, detecting the event includes detecting, receiving, or capturing a user input corresponding to a request to display the navigation user interface element according to the first appearance condition or other appearance condition as will be described in more detail below. In some embodiments, in response to detecting the event (1002b), in accordance with a determination that one or more criteria are satisfied, including a criterion that is satisfied when the event indicates a change from displaying the navigation user interface element according to the first appearance condition to displaying the navigation user interface element according to a second appearance condition (1002c), the computer system ceases (1002d) display of the navigation user interface element according to the first appearance condition and displays (1002e) the navigation user interface element according to the second appearance condition, such as the navigation user interface element 902 and a representation of the sun 920 setting in FIG. 9B. For example, the computer system detects the change from displaying the navigation user interface element according to the first appearance condition to displaying the navigation user interface element according to the second appearance condition based on detecting the information provided by an application installed and/or operating on the computer system as described above and/or receiving user input corresponding to a request to display the navigation user interface element according to the second appearance condition or other appearance condition. For example, events that include rain stopping or starting, sunset to sunrise, wind speeds increasing or decreasing, light levels increasing or decreasing, and/or time/date change (e.g., time is after 7:00 μm) optionally indicate a change in appearance condition with respect to the first physical area.

For example, the computer system optionally detects a weather condition change from a first weather condition (e.g., cloudy) to a second weather condition (e.g., rain). In some embodiments, in response to the change from the first weather condition to the second weather condition, the computer system changes the display of the navigation user interface element to correspond to the changed weather condition. For example, ceasing displaying of the navigation user interface element as including a representation of a cloud and sun to displaying the navigation user interface element as including a rain cloud and rain at a location within the navigation user interface element corresponding to a location of the first physical area experiencing the rain. In another example, the computer system optionally detects a time change from daytime to nighttime indicative of displaying the navigation user interface element according to the first appearance condition including a first light level to displaying the navigation user interface element according to the second appearance condition including a second light level, wherein the first light level is higher than the second light level. Other examples of events or conditions that cause a change of displaying the navigation user interface element according to a particular appearance condition will be described in more detail below.

In some embodiments, in response to detecting the event, in accordance with a determination that the one or more criteria are not satisfied, the computer system continues (1002f) to display the navigation user interface element according to the first appearance condition, such as the navigation user interface element 902 and the representation of the sun 920 in FIG. 9A. For example, the event is determined not to trigger or cause ceasing display of the navigation user interface element according to the first appearance condition and/or changing the navigation user interface element to be displayed according to the second appearance condition or other appearance condition, different from the first appearance condition. In some embodiments, in accordance with a determination that the one or more criteria are not satisfied, the computer system displays, via the display generation component, a representation of acknowledgement of the event. For example, if the computer system receives user input corresponding to a request to display the navigation user interface element according to the first appearance condition that is already being displayed, the computer system displays a representation of acknowledgement of the request and optionally an indication of the event (e.g., “Weather in downtown Los Angeles is 76 degrees and sunny” or “Light rain continuing until 4 pm today”).

Automatically displaying the navigation user interface element according to the second appearance condition in response to an event indicative of a change from displaying the navigation user interface element according to the first appearance condition to displaying the navigation user interface element according to the second appearance condition provides an increased level of detail about the first physical area (e.g., by including virtual objects and/or modifying the lighting associated with the navigation user interface element to simulate weather conditions and/or lighting that is appropriate for the context of the event) and provides information and/or indications of what the device knows about the first physical area, which avoids additional interaction between the user and the computer system associated with the user performing additional inputs to look up the weather condition in the first physical area and/or change the appearance condition of the navigation user interface element to what is appropriate for the weather condition while avoiding unnecessary use of resources (e.g., by not displaying appearance condition elements unless necessary or appropriate as defined by the event), thereby reducing errors in the interaction between the user and the computer system and reducing inputs needed to correct such errors.

In some embodiments, the one or more criteria are not satisfied when the event indicates a first time of day corresponding to the first appearance condition, such as the time of day indicated by clock 918 in FIG. 9A. In some embodiments, the first time of day is based on a location. In some embodiments, the location refers to a physical location of the computer system. In some embodiments, the location is a predefined location, different from the physical location of the computer system. In some embodiments, the predefined location is selected by the user. In some embodiments, the first time of day includes the morning, afternoon, evening, nighttime, or other time of day. In some embodiments, detecting the event includes detecting a current time of day. In some embodiments, the computer system determines that the current time of day is associated with a same appearance condition that the computer system is currently presenting or using. In some embodiments, various times of day or periods of time throughout the day are associated with various respective appearance conditions. For example, the first time of day is optionally during a first time period associated with the first appearance condition and a second time of day is optionally during a second time period associated with a second appearance condition. In some embodiments, the computer system determines a current time passing within one of these various periods of time (e.g., between a first period of time and second period of time both within a respective time period associated with the first appearance condition), and in response, the computer system does not update the appearance condition. In some embodiments, the event is a change in the time of day at the computer system and change in the time of day occurs and/or changes without user input.

In some embodiments, the one or more criteria include a requirement that the event indicates a second time of day, different from the first time of day, corresponding to the second appearance condition in order for the one or more criteria to be satisfied, such as the time of day indicated by clock 918 in FIG. 9B. In some embodiments, the computer system determines a current time passing within one of these various periods of time (e.g., between a first period of time associated with the first appearance condition and second period of time both associated with the second appearance condition), and in response, the computer system updates the appearance condition from the first appearance condition to the second appearance condition. For example, in accordance with a determination that the current time of day corresponds to a first appearance condition (e.g., sunny, bright appearance), the computer system displays the navigation user interface element according to the first appearance condition, such has having a high degree of lighting and/or high degree of bright coloring. In another example, in accordance with a determination that the current time of day corresponds to a second appearance condition (e.g., overcast, dark appearance), the computer system displays the navigation user interface element according to the first appearance condition, such has having a low degree of lighting, and/or low degree of bright coloring. Automatically displaying the navigation user interface element according to the second appearance condition in response to satisfying a requirement that an event indicates a second time of day, different from a first time of day provides a visual appearance that matches the respective time of day without requiring additional input requesting to update the visual appearance, which avoids additional interaction between the user and the computer system associated with the user performing additional inputs to look up the time of day in the first physical area and/or change the appearance condition of the navigation user interface element to what is appropriate for the time of day while avoiding unnecessary use of resources (e.g., by not displaying appearance condition elements unless necessary or appropriate as defined by the time of day), thereby reducing errors in the interaction between the user and the computer system, reducing inputs needed to correct such errors, reducing potential user error with such inputs, saving time, battery, and power consumption.

In some embodiments, satisfying the one or more criteria is based on a current time of day of a system virtual environment of the computer system, such as the time of day of a cityscape scene in FIG. 9F. In some embodiments, the system virtual environment refers to a simulated scene configured within the computer system for a three-dimensional environment. For example, the system virtual environment optionally includes a range of virtual landscapes, interior settings, or abstract spaces that may be generated by the computer system to provide a contextual backdrop for a three-dimensional environment. In some embodiments, the system virtual environment includes a time of day setting. For example, the computer system optionally transforms the three-dimensional environment into Yosemite at sunset, at night, during the day, or other time of day. In some embodiments, the computer system determines the current time of day of the system virtual environment of the computer system by identifying which of a predefined list of available system virtual environments is currently active and the time of day setting the system virtual environment is set to.

In some embodiments, displaying the navigation user interface element according to the first appearance condition optionally includes displaying one or more virtual objects, such as representations of the sun and/or clouds to indicate a daytime system virtual environment of the computer system. In another example, displaying the navigation user interface element according to the second appearance condition optionally includes displaying a representation of the moon to indicate a nighttime system virtual environment of the computer system. In another example, displaying the navigation user interface element according to the second appearance condition optionally includes a change in the system virtual environment, such as displaying the system virtual environment change from a light mode to a dark mode, or vice versa as described in more detail below. In some embodiments, the system virtual environment is selected by the user of the computer system. In some embodiments, the system virtual environment of the computer system is associated with a respective time of day irrespective of the time of day at the computer system. For example, the computer system determines that the system virtual environment of the computer system is always a day or night appearance, and in accordance with the determination that the system virtual environment of the computer system is always a day or night appearance, the computer system does not change the appearance condition between the day or night).

In some embodiments, the computer system changes the system virtual environment of the computer system based on the time of day in a time zone of a current location of the computer system. In some embodiments, the computer system changes the system virtual environment of the computer system based on the time of day in a time zone of a selected (e.g., by the user of the computer system) location, different from the current location of the computer system. In some embodiments, the respective appearance condition presented or used by the computer system is associated with different times of day. For example, the computer system presents a respective appearance condition that matches the time of day of the system virtual environment. In another example, the computer system presents a respective appearance condition based on whether the time of day of the system virtual environment changes or does not change. In some embodiments, the computer system determines system virtual environment changes based on a time at a current location of the computer system or another time at a respective location, different from the current location.

In some embodiments, the computer system displays the navigation user interface element while the computer system presents the system virtual environment discussed herein (e.g., within the system virtual environment). In some embodiments, when the computer system does not display the system virtual environment, a dark or light operating mode does not affect the appearance condition of the navigation user interface element. Automatically displaying the navigation user interface element according to a respective appearance condition that is based on a current time of day of an system virtual environment of the computer system provides a visual appearance that matches the current time of day of the system virtual environment of the computer system without requiring additional input requesting to update the visual appearance, which avoids additional interaction between the user and the computer system associated with the user performing additional inputs to look up the time of day of the system virtual environment and/or change the appearance condition of the navigation user interface element to what is appropriate for the time of day of the system virtual environment while avoiding unnecessary use of resources (e.g., by not displaying appearance condition elements unless necessary or appropriate as defined by the time of day), thereby reducing errors in the interaction between the user and the computer system, reducing inputs needed to correct such errors, reducing potential user error with such inputs, saving time, battery, and power consumption.

In some embodiments, satisfying the one or more criteria is based on a current time of day at the computer system, such as a current time of day indicated by clock 918 in FIG. 9F. In some embodiments, various times of day or periods of time throughout the day are associated with various respective appearance conditions. For example, the first time of day is optionally during a first time period associated with the first appearance condition and a second time of day is optionally during a second time period associated with a second appearance condition. In some embodiments, the computer system determines a current time passing within one of these various periods of time as described above. For example, the current time of day at the computer system optionally refers to an exact time at the computer system that is based on a physical location of the computer system or a predefined location of the computer system. In some embodiments, the predefined location is set by the user of the computer system. For example, displaying the navigation user interface element according to a current time of day (e.g., 6 AM PST) includes a respective appearance condition in which the navigation user interface element includes at least a partial representation of the sun indicative of a beginning of daylight. In another example, displaying the navigation user interface element according to a current time of day (e.g., 8 PM PST) includes a respective appearance condition in which the navigation user interface element ceases to display the representation of the sun indicative of an end of daylight and/or a beginning of twilight or nighttime.

In some embodiments, the computer system detects user input corresponding to a request to select a time setting (e.g., user-selected time setting). In some embodiments, the user input includes a gaze of a user of the computer system, a contact on a touch-sensitive surface, actuation of a physical input device, a predefined gesture (e.g., pinch gesture or air tap gesture) and/or a voice input from the user directed to a respective option or user interface element described herein. In some embodiments, the time setting refers to a current time of day at the computer system as described herein, a current time of day of an environment of the computer system as described above, or other time of day described above and/or below. In some embodiments, the computer system displays a user interface element that includes one or more options that, when selected, causes the computer system to display the navigation user interface element according to a respective appearance condition. In some embodiments, detecting user input corresponding to the request to select the time setting includes detecting the user input directed to the one or more options described herein. For example, the computer system optionally detects user input directed to an option that, when selected, causes the computer system to display the navigation user interface element having a daytime appearance condition and/or other appearance condition described above and/or below. Automatically displaying the navigation user interface element according to a respective appearance condition that is based on a current time of day at the computer system provides a visual appearance that matches the current time of day at the computer system without requiring additional input requesting to update the visual appearance, which avoids additional interaction between the user and the computer system associated with the user performing additional inputs to look up the current time of day at the computer system and/or change the appearance condition of the navigation user interface element to what is appropriate for the current time of day at the computer system while avoiding unnecessary use of resources (e.g., by not displaying appearance condition elements unless necessary or appropriate as defined by the current time of day), thereby reducing errors in the interaction between the user and the computer system, reducing inputs needed to correct such errors, reducing potential user error with such inputs, saving time, battery, and power consumption.

In some embodiments, satisfying the one or more criteria includes in accordance with a user-defined system appearance setting being a respective user-selected setting, such as voice input 938 in FIG. 9D, the computer system displaying the navigation user interface element according to a third appearance condition, such as the navigation user interface element 902 and the representation of rain and lightning 926 in FIG. 9E. In some embodiments, the computer system detects user input corresponding to a request to select a system appearance setting (e.g., user-selected setting). The system appearance setting is optionally different from an application appearance setting. For example, the system appearance setting refers to a display setting or color scheme of the computer system, such as a light mode where the computer system displays user interfaces (e.g., content windows or volumes) having darker colored text against a lighter colored background; or a dark mode where the computer system displays the user interfaces having lighted colored text against a darker colored background. The application appearance optionally applies to application specific user interface elements, and thus, in response to the computer system detecting user input corresponding to a request to select an application appearance setting, the computer system displays user interface elements of the application with the selected display setting or color scheme described herein.

In some embodiments, applying the selected application appearance setting does not include applying such appearance setting system-wide (e.g., does not include changing other user interface elements that are not associated with the selected application). In some embodiments, detecting user input corresponding to the request to select the brightness setting includes detecting the user input directed to the one or more options described herein. For example, the computer system optionally detects user input directed to an option that, when selected, causes the computer system to display the navigation user interface element in light mode, dark mode, and/or other appearance condition described above and/or below. In some embodiments, applying the user-defined system appearance setting described herein is irrespective of a current time of day at the computer system, a current time of day of an environment of the computer system as described above, or other time of day described above and/or below. Adjusting the appearance condition based on a user-defined system appearance setting based on a respective user-selected setting provides an efficient method for adjusting the appearance condition of the navigation user interface element, thereby reducing errors in the interaction between the user and the computer system and facilitating more efficient user interaction with the navigation user interface element, thereby reducing errors in the interaction between the user and the computer system and reducing inputs needed to correct such errors.

In some embodiments, the one or more criteria are not satisfied when the event indicates a first weather condition while the computer system displays the navigation user interface element according to the first appearance condition, such as a sunny weather condition while displaying the representation of the sun 920 in FIG. 9A. For example, the computer system determines that the event that indicates the first weather condition does not cause (or, optionally does not trigger) a change from displaying the navigation user interface element according to the first appearance condition. In some embodiments, the computer system determines that the event that includes the first weather condition indicates continuing to display or maintaining the display of the navigation user interface element according to the first appearance condition. For example, the first weather condition is associated with the first appearance condition, or is associated with using an appearance based on other criteria described herein. In some embodiments, the first weather condition optionally refers to a state of the atmosphere at a physical location of the computer system. In some embodiments, the computer system includes or is in communication with GPS or other positioning circuitry for capturing the physical location of the computer system. In some embodiments, the computer system determines that the event indicates the following examples of weather conditions: sunny, rainy, cloudy, foggy, snowy, and/or windy.

In some embodiments, the one or more criteria include a requirement that the event indicates a second weather condition, different from the first weather condition while the computer system displays the navigation user interface element according to the first appearance condition in order for the one or more criteria to be satisfied, such as the representation of rain and lightning 926 in FIG. 9E. For example, the second weather condition is optionally rainy and the first weather condition is a weather condition other than rainy, such as sunny, cloudy, foggy, snowy, or windy. In some embodiments, the second weather condition is associated with the second appearance condition. Alternatively and in some embodiments, the first weather condition is associated with the first appearance condition and the second weather condition is not associated with an appearance condition. In some embodiments, the second weather condition is associated with different criterion described herein. For example, in accordance with a determination that the weather condition is a first weather condition at the location of the computer system (e.g., cloudy), the computer system displays the navigation user interface element according to an appearance condition corresponding to the first weather condition, such as displaying the navigation user interface element with a lower level of lighting and/or darker coloring.

In another example, in accordance with a determination that the weather condition is a second weather condition at the location of the computer system (e.g., sunny), the computer system displays the navigation user interface element according to an appearance condition corresponding to the second weather condition, such as displaying the navigation user interface element with a higher level of lighting and/or brighter coloring. Automatically displaying the navigation user interface element according to a respective appearance condition in response to satisfying a requirement that an event indicates a second weather condition, different from a first weather condition provides a visual appearance that matches a respective weather condition without requiring additional input requesting to update the visual appearance, which avoids additional interaction between the user and the computer system associated with the user performing additional inputs to look up the weather condition in the physical area and/or change the appearance condition of the navigation user interface element to what is appropriate for the weather condition while avoiding unnecessary use of resources (e.g., by not displaying appearance condition elements unless necessary or appropriate as defined by the weather condition), thereby reducing errors in the interaction between the user and the computer system, reducing inputs needed to correct such errors, reducing potential user error with such inputs, saving time, battery, and power consumption.

In some embodiments, in response to detecting the event, in accordance with a determination that the event satisfies the one or more criteria (e.g., described in more detail above), the computer system displays, via the display generation component, a visual indication of the second weather condition, such as the representation of rain and lightning 926 in FIG. 9E (e.g., displaying additional virtual elements included in and/or with the navigation user interface element corresponding to the weather condition). In some embodiments, displaying the visual indication of the second weather condition is analogous to and/or includes one or more characteristics of displaying additional content, virtual objects, and/or representations of a respective weather condition described above. For example, when the computer system determines that the second weather condition indicates fog, the computer system optionally displays a visual indication including a representation of fog (e.g., simulated foggy visual effects) that give an appearance of fog. In some embodiments, the computer system displays the visual indication adjacent to (or, optionally, within the navigation user interface element). In some embodiments, and as described in more detail with reference to method 800, the computer system displays the visual indication with a level of immersion such that less of the physical environment surrounding the computer system is displayed (or, optionally, displaying more of the visual indication, and thus, obscuring the physical environment surrounding the computer system).

In some embodiments, the visual indication of the second weather condition includes one or more virtual objects (e.g., representations of a sun, one or more clouds, and/or a rainbow). In some embodiments, when the computer system maintains the visual indication of the first weather condition, the one or more criteria are not satisfied, and the visual indication of the second weather condition is not displayed. In some embodiments, the computer system displays different indications of the first weather condition. Automatically displaying a visual indication of a respective weather condition in response to satisfying one or more criteria provides a visual appearance that matches a respective weather condition without requiring additional input requesting to update the visual appearance, which avoids additional interaction between the user and the computer system associated with the user performing additional inputs to look up the weather condition in the physical area and/or change the visual indication of the respective weather condition to what is appropriate for the respective weather condition while avoiding unnecessary use of resources (e.g., by not displaying visual indications unless necessary or appropriate as defined by the respective weather condition), thereby reducing errors in the interaction between the user and the computer system, reducing inputs needed to correct such errors, reducing potential user error with such inputs, saving time, battery, and power consumption.

In some embodiments, the visual indication of the second weather condition includes particle effects, such as the representation of fog 924 in FIG. 9D (e.g., mist, fog, rain, clouds, smoke, snow, ash, and/or pollen). In some embodiments, the visual indication of a respective weather condition (e.g., the first weather condition, the second weather condition, or other weather condition described above and/or below) does not include particle effects. Automatically displaying a visual indication of a respective weather condition that includes particle effects in response to satisfying one or more criteria provides a visual appearance that matches a respective weather condition without requiring additional input requesting to update the visual appearance, which avoids additional interaction between the user and the computer system associated with the user performing additional inputs to look up the weather condition in the physical area and/or change the visual indication of the respective weather condition to what is appropriate for the respective weather condition while avoiding unnecessary use of resources (e.g., by not displaying visual indications unless necessary or appropriate as defined by the respective weather condition), thereby reducing errors in the interaction between the user and the computer system, reducing inputs needed to correct such errors, reducing potential user error with such inputs, saving time, battery, and power consumption.

In some embodiments, the visual indication of the second weather condition includes virtual lighting effects, such as lighting effects associated with displaying the representation of the sun 920 in FIG. 9A (e.g., light rays, sunbeams, lights halos, rainbows, and/or auroras). In some embodiments, the visual indication of a respective weather condition (e.g., the first weather condition, the second weather condition, or other weather condition described above and/or below) does not include lighting effects. Automatically displaying a visual indication of a respective weather condition that includes lighting effects in response to satisfying one or more criteria provides a visual appearance that matches a respective weather condition without requiring additional input requesting to update the visual appearance, which avoids additional interaction between the user and the computer system associated with the user performing additional inputs to look up the weather condition in the physical area and/or change the visual indication of the respective weather condition to what is appropriate for the respective weather condition while avoiding unnecessary use of resources (e.g., by not displaying visual indications unless necessary or appropriate as defined by the respective weather condition), thereby reducing errors in the interaction between the user and the computer system, reducing inputs needed to correct such errors, reducing potential user error with such inputs, saving time, battery, and power consumption.

In some embodiments, the visual indication of the second weather condition includes virtual atmospheric characteristics, such as the representations of lightning 926 and rain in FIG. 9E (e.g., temperature, wind, precipitation, cloud coverage, and/or visibility). In some embodiments, when the computer system presents the atmospheric characteristics, the computer system includes graphs, charts, totals, and/or other numerical descriptions of the atmospheric characteristics. In some embodiments, the atmospheric characteristics optionally refer to atmospheric environments of the computer system, such as virtual lighting effects or coloring applied to a true or real passthrough environment described in method 800. For example, when the computer system presents the atmospheric characteristics, the computer system presents a change in light levels or coloring of the true or real passthrough environment. In some embodiments, the visual indication of a respective weather condition (e.g., the first weather condition, the second weather condition, or other weather condition described above and/or below) does not include atmospheric characteristics. Automatically displaying a visual indication of a respective weather condition that includes atmospheric characteristics in response to satisfying one or more criteria provides a visual appearance that matches a respective weather condition without requiring additional input requesting to update the visual appearance, which avoids additional interaction between the user and the computer system associated with the user performing additional inputs to look up the weather condition in the physical area and/or change the visual indication of the respective weather condition to what is appropriate for the respective weather condition while avoiding unnecessary use of resources (e.g., by not displaying visual indications unless necessary or appropriate as defined by the respective weather condition), thereby reducing errors in the interaction between the user and the computer system, reducing inputs needed to correct such errors, reducing potential user error with such inputs, saving time, battery, and power consumption.

In some embodiments, displaying the navigation user interface element according to the first appearance condition includes presenting, via the display generation component, a representation of a physical environment of the user of the computer system with a first visual effect based on the first appearance condition, such as the visual effect of the representation of the physical environment including representations of stars 922 in FIG. 9C. In some embodiments, presenting the representation of the physical environment with the first visual effect based on the first appearance condition is analogous to and/or includes one or more characteristics of displaying the navigation user interface element with a respective level of immersion as described in more detail with reference to method 800. In some embodiments, the amount of the representation of the physical environment that is displayed by the computer system is based on an immersion level of the computer system as described in method 800. In some embodiments, the navigation user interface element and the physical environment are concurrently visible in the three-dimensional environment. In some embodiments, the physical environment is presented via digital/active passthrough or passive passthrough (e.g., having the respective visual effect applied to the passthrough). For example, presenting the representation of the physical environment with the first visual effect based on the first appearance condition optionally includes replacing and/or obscuring more of the physical environment with the visual indications of weather conditions described above. In another example, presenting the representation of the physical environment with the first visual effect based on the first appearance condition optionally includes concurrently displaying the physical environment and the visual indications of weather conditions in a manner that does not obscures the physical environment. In another example, presenting the representation of the physical environment with the first visual effect based on the first appearance condition includes applying virtual lighting effects or coloring to the representation of the physical environment. In some embodiments, the first visual effect and/or the second visual effect described below includes one or more characteristics of the any of the visual effects described herein.

In some embodiments, displaying the navigation user interface element according to the second appearance condition includes presenting, via the display generation component, the representation of the physical environment of the user of the computer system with a second visual effect, different from the first visual effect, based on the second appearance condition, such as the visual effect of the representation of the physical environment including representations of rain and lightning 926 in FIG. 9E. For example, presenting the representation of the physical environment with the second visual effect based on the second appearance condition optionally includes revealing portions of the physical environment that were previously not displayed and/or obscured when displaying the navigation user interface element according to the first appearance condition. In another example, presenting the representation of the physical environment with the second visual effect based on the second appearance condition optionally includes replacing and/or obscuring more of the physical environment with the visual indications of weather conditions compared to when the computer system displayed the representation of the physical environment with the first appearance condition. In some embodiments, presenting the representation of the physical environment with the second visual effect based on the second appearance condition includes increasing, decreasing, and/or maintaining a level of immersion as the respective level of immersion associated with displaying the representation of the physical environment with the first visual effect based on the first appearance condition. In another example, presenting the representation of the physical environment with the second visual effect based on the second appearance condition includes applying virtual lighting effects or coloring to the representation of the physical environment.

Automatically displaying the representation of the physical environment with a respective visual effect based on a respective appearance condition provides a visual appearance that matches a respective weather condition or other condition associated with the physical environment without requiring additional input requesting to update the visual appearance, which avoids additional interaction between the user and the computer system associated with the user performing additional inputs to look up the weather condition in the physical area and/or change the display of the representation of the physical environment to what is appropriate for the respective weather condition while avoiding unnecessary use of resources, thereby reducing errors in the interaction between the user and the computer system, reducing inputs needed to correct such errors, reducing potential user error with such inputs, saving time, battery, and power consumption.

In some embodiments, while displaying the navigation user interface element according to the second appearance condition, the computer system detects a user input, via the one or more inputs devices, that corresponds to a request to change a zoom level of the navigation user interface element, such as user input 914 including the air pinch gesture with two hands while gaze is directed to the navigation user interface element 902 in FIG. 9B. In some embodiments, the user input that corresponds to the request to change the zoom level of the navigation user interface element includes a gaze of a user of the computer system, a contact on a touch-sensitive surface, actuation of a physical input device, a predefined gesture (e.g., pinch gesture or air tap gesture) and/or a voice input from the user directed to the navigation user interface element. In some embodiments, the user input is directed to an option or user interface element that, when selected, causes a change to the zoom level of navigation user interface element.

In some embodiments, in response to detecting the user input, in accordance with a determination that changing the zoom level of the navigation user interface element in accordance with the user input satisfies one or more second criteria, the computer system displays, via the display generation component, a second navigation user interface element different from the navigation user interface element, wherein the second navigation user interface element represents the first physical area and presents the representation of the physical environment of the user of the computer system with the visual effect based on the second appearance condition, such as the navigation user interface element 902 and the representation of the physical environment including representations of stars 922 in FIG. 9C. In some embodiments, the one or more second criteria include a criterion that is satisfied when the computer system determines that, in response to detecting the user input, a level of zoom (e.g., amount of zoom) of the navigation user interface is less than a predefined level of zoom (e.g., 5%, 10%, 20%, 30%, 40%, 50%, or 60%). In some embodiments, changing the zoom level of the navigation user interface element optionally includes displaying a second navigation user interface element that represents the first physical area.

In some embodiments, the second navigation user interface element representing the first physical area is a three-dimensional virtual globe centered on the first physical area (e.g., without changing the viewpoint of the user of the computer system). For example, the second navigation user interface element is optionally a curved, spherical representation of the first physical area while the first navigation user interface element is optionally a flat or planar representation of the first physical area. In some embodiments, the computer system ceases displaying the navigation user interface element in accordance with the determination that changing the zoom level of the navigation user interface element in accordance with the user input satisfies the one or more second criteria. For example, the computer system optionally receives the user input to change the zoom level while the computer system displays the second navigation user interface element representing the first physical area optionally including a view of North America or South America. In some embodiments, the computer system receives the user input to change the zoom level while the computer system orients the second navigation user interface element relative to the view of the user of the computer system in a manner such that a respective region presented by the second navigation user interface element is visible.

In some embodiments, the computer system maintains displaying the visual effect based on the second appearance condition. For example, when the computer system changes from displaying the navigation user interface element to displaying the second navigation user interface element, the computer system optionally continues to apply the visual effect based on the second appearance condition to the second navigation user interface element. In some embodiments, in accordance with a determination that the user input was received while displaying the navigation user interface element having the first appearance condition, the computer system displays the second navigation user interface element with the first appearance condition. In some embodiments, in accordance with a determination that the one or more second criteria are not satisfied (e.g., the level of zoom of the navigation user interface is greater than the predefined level of zoom described above), the computer system presents the computer system presents the physical environment without the visual effect based on the second appearance condition. Automatically displaying the representation of the physical environment with a respective visual effect based on a respective appearance condition in response to changing the zoom level of the navigation user interface element maintains continuity between displaying the navigation user interface element at different zoom levels, which avoids additional interaction between the user and the computer system associated with the user performing additional inputs to change the display of the representation of the physical environment to match the appearance condition of the respective navigation user interface element while avoiding unnecessary use of resources, thereby reducing errors in the interaction between the user and the computer system and reducing inputs needed to correct such errors.

In some embodiments, in response to detecting the user input, in accordance with a determination that changing the zoom level of the navigation user interface element in accordance with the user input does not satisfy the one or more second criteria (e.g., described above), the computer system displays the navigation user interface element at a respective zoom level without displaying the second navigation user interface element and continues to display the navigation user interface element according to a respective appearance condition, such as the navigation user interface element in FIG. 9B, (and/or continuing to present the representation of the physical environment without the visual effect based on the respective appearance condition). For example, the computer system determines that the level of zoom (e.g., amount of zoom) of the navigation user interface is a zoom level other than the predefined level of zoom described above. For example, the computer system displays the navigation user interface element at a changed zoom level corresponding to the user input. In some embodiments, the respective zoom level at which the computer system displays the navigation user interface element is based on a magnitude (e.g., of speed, distance, and/or duration) of the user input. For example, the user input is optionally a pinch to zoom gesture while attention of the user is directed to the navigation user interface element (e.g., a predetermined portion of the navigation user interface element and/or an option or user interface element selectable to change the zoom level) while a hand of the user performs a pinch air gesture that includes the tips of the thumb and index fingers of the hand coming together and touching, or the index finger in direct interaction with the virtual object within the first respective content selectable to change the zoom level (e.g., air tapping or air touching), or while two hands of the user come together towards each other (e.g., to zoom out of the first respective content) or away from each other (e.g., to zoom into the first respective content). For example, the computer system displays the navigation user interface element with a first zoom level appropriate for the first physical area, such that the navigation user interface element is centered on the first physical area (e.g., without changing the viewpoint of the user of the computer system).

In some embodiments, the computer system optionally receives the user input to change the zoom level while the computer system displays the navigation user interface element according to the respective appearance condition. In some embodiments, in response to receiving the user input, the computer system maintains displaying the navigation user interface element according to the respective appearance condition. For example, when the computer system changes the zoom level of the navigation user interface element, the computer system optionally continues to display the navigation user interface element according to a same respective appearance condition. In some embodiments, changing the zoom level of the navigation user interface element includes displaying the navigation user interface element at a different scale prior to receiving the input to change the zoom level. For example, the navigation user interface element is a different size and/or includes a different level of detail (e.g., representations of geographic features as described above and/or with reference to method 800). In another example, changing the zoom level of the navigation user interface element includes displaying the navigation user interface element with a different level of detail with or without changing the size of the navigation user interface element including a bounding box that contains the navigation user interface element. Continuing to display the navigation user interface element in accordance with a respective appearance condition in response to changing the zoom level of the navigation user interface element provides display continuity, which avoids additional interaction between the user and the computer system associated with the user performing additional inputs to change the display of the representation of the physical environment to match the appearance condition of the respective navigation user interface element while avoiding unnecessary use of resources, thereby reducing errors in the interaction between the user and the computer system and reducing inputs needed to correct such errors.

In some embodiments, in response to detecting the event, in accordance with the determination that the one or more second criteria are satisfied and independent of a zoom level of the navigation user interface element, the computer system presents the representation of the physical environment of the user of the computer system with the visual effect based on the second appearance condition, such as the navigation user interface element 902 and the representation of the physical environment including representations of the moon 928 and stars 930. For example, the computer system optionally receives the user input to change the zoom level while the computer system displays the navigation user interface element according to the second appearance condition. In some embodiments, in response to receiving the user input, the computer system optionally applies the visual effect based on the second appearance condition to the navigation user interface element. In another example, the computer system optionally receives the user input to change the zoom level while the computer system displays the navigation user interface element according to the first appearance condition. In some embodiments, in response to receiving the user input, and in accordance with a determination that the one or more criteria are not satisfied, the computer system optionally applies the visual effect based on the first appearance condition to the navigation user interface element. Automatically displaying the representation of the physical environment with a respective visual effect based on a respective appearance condition independent of the zoom level of the navigation user interface element provides display continuity, which avoids additional interaction between the user and the computer system associated with the user performing additional inputs to change the display of the representation of the physical environment to match the appearance condition of the respective navigation user interface element while avoiding unnecessary use of resources, thereby reducing errors in the interaction between the user and the computer system and reducing inputs needed to correct such errors.

In some embodiments, presenting the representation of the physical environment with a respective visual effect based on a respective appearance condition includes displaying, via the display generation component, a simulated lighting effect within a portion of the representation of the physical environment corresponding to the respective appearance condition, such as the representation of the physical environment including stars 922 in FIG. 9C. In some embodiments, displaying the simulated lighting effect within the portion of the representation of the physical environment includes displaying the representation of the physical environment with a degree of lighting different from a degree of lighting associated with displaying the navigation user interface element. In some embodiments, the degree of lighting optionally gives an appearance of the navigation user interface element being visible in an environment in which the representation of the physical environment is dimmed (e.g., a theater mode viewing effect). In some embodiments, the simulated lighting effect includes changing an intensity, luminance, and/or color temperature of one or more virtual lights sources to facilitate a predetermined mood or experience, such as, example, a theater mode in which the representation of the physical environment is dimmed and focus is on the navigation interface element. In some embodiments, displaying the navigation user interface element according to the first appearance condition described above includes displaying a first simulated lighting effect and displaying the navigation user interface element according to the second appearance condition described above includes displaying a second simulated lighting effect, different from the first simulated lighting effect. Displaying a respective simulated lighting effect is analogous to and/or includes one or more characteristics of applying light levels and/or degrees of lighting described above. Displaying a portion of the representation of the physical environment of the user of the computer system with a simulated light effect provides enhanced viewing and operation of the navigation interface element without requiring the user to provide further inputs to change the simulating light effect of the representation of the physical environment, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, presenting the representation of the physical environment includes displaying, via the display generation component, a particle effect (e.g., representations of mist, fog, rain, clouds, smoke, snow, ash, and/or pollen) within a portion of the representation of the physical environment, such as the representation of rain and lightning 926 in the representation of the physical environment in FIG. 9E. For example, displaying the particle effect within the portion of the representation of the physical environment optionally includes replacing and/or obscuring portions of the physical environment with the particle effects (e.g., visual indications of weather conditions described above). In another example, displaying the particle effect within the portion of the representation of the physical environment optionally includes concurrently displaying the physical environment and the particle effects in a manner that does not obscure the physical environment. In some embodiments, displaying the navigation user interface element according to the first appearance condition described above includes displaying a first particle effect and displaying the navigation user interface element according to the second appearance condition described above includes displaying a second particle effect, different from the first particle effect. Automatically displaying particle effects within a portion of the physical environment provides an increased level of detail about the atmosphere of the physical location associated with the computer system, which avoids additional interaction between the user and the computer system associated with the user performing additional inputs to change the visual indication of the respective weather condition to match the appearance condition of the respective navigation user interface element while avoiding unnecessary use of resources, thereby reducing errors in the interaction between the user and the computer system and reducing inputs needed to correct such errors.

In some embodiments, displaying the representation of the physical environment includes displaying, via the display generation component, one or more simulated atmospheric characteristics (e.g., visual indications of temperature, wind, precipitation, cloud coverage, and/or visibility) within a portion of the representation of the physical environment, such as the representations of stars 922 in the representation of the physical environment in FIG. 9D. In some embodiments, when the computer system presents the one or more simulated atmospheric characteristics within the portion of the representation of the physical environment, the computer system displays one or more visual indications of the atmospheric characteristics as described above. In some embodiments, the simulated atmospheric characteristics optionally refer to atmospheric environments of the computer system as described above, such as virtual lighting effects or coloring applied to a true or real passthrough environment described in method 800. For example, when the computer system presents the atmospheric characteristics, the computer system presents a change in light levels or coloring of the true or real passthrough environment. In some embodiments, displaying the navigation user interface element according to the first appearance condition described above includes displaying first simulated atmospheric characteristics in the representation of the physical environment, and displaying the navigation user interface element according to the second appearance condition described above includes displaying second simulated atmospheric characteristics, different from the first simulated atmospheric characteristics, in the representation of the physical environment. Automatically displaying one or more simulated atmospheric characteristics provides an increased level of detail about the atmosphere of the physical location associated with the computer system, which avoids additional interaction between the user and the computer system associated with the user performing additional inputs to change the visual indication of the respective weather condition to match the appearance condition of the respective navigation user interface element while avoiding unnecessary use of resources, thereby reducing errors in the interaction between the user and the computer system and reducing inputs needed to correct such errors.

In some embodiments, while displaying the user interface including the navigation user interface element representing the first physical area according to a respective appearance condition, the computer system detects, via the one or more input devices, a second event, different from the event, such as voice input 938 in FIG. 9D. In some embodiments, the second event is analogous to and/or includes one or more characteristics of the event described above. In some embodiments, the respective appearance condition includes the first appearance condition, the second appearance condition, or other appearance condition described above and/or below.

In some embodiments, in response to detecting the second event, in accordance with a determination that one or more second criteria are satisfied (e.g., described above), including a criterion that is satisfied when the second event indicates a change from displaying the navigation user interface element according to the respective appearance condition to displaying the navigation user interface element according to a third appearance condition, different from the first appearance condition and the second appearance condition, the computer system ceases display of the navigation user interface element according to the respective appearance condition, such as the navigation user interface element 902 including the representation of fog 924 in FIG. 9D, (e.g., described above with reference to the first appearance condition) and displays the navigation user interface element according to the third appearance condition, such as the navigation user interface element 902 including the representation of rain and lightning 926 in FIG. 9E. In some embodiments, the third appearance condition is analogous to and/or includes one or more characteristics of the first appearance condition and/or the second appearance condition described above. In some embodiments, displaying the navigation user interface element according to the third appearance condition is analogous to and/or includes one or more characteristics of displaying the navigation user interface element according to the first appearance condition and/or the second appearance condition described above.

In some embodiments, in response to detecting the second event, in accordance with a determination that the one or more second criteria are not satisfied, the computer system continues to display the navigation user interface element according to the respective appearance condition, such as, for example, and appearance condition similar to what is shown in FIG. 9A (e.g., described above with reference to the first appearance condition). Automatically displaying the navigation user interface element according to the third appearance condition in response to an event indicative of a change from displaying the navigation user interface element according to a respective appearance condition to displaying the navigation user interface element according to the third appearance condition provides an increased level of detail about the first physical area (e.g., by including virtual objects and/or modifying the lighting associated with the navigation user interface element to simulate weather conditions and/or lighting that is appropriate for the context of the event) and provides information and/or indications of what the device knows about the first physical area, which avoids additional interaction between the user and the computer system associated with the user performing additional inputs to look up the weather condition in the first physical area and/or change the appearance condition of the navigation user interface element to what is appropriate for the weather condition while avoiding unnecessary use of resources (e.g., by not displaying appearance condition elements unless necessary or appropriate as defined by the event), thereby reducing errors in the interaction between the user and the computer system and reducing inputs needed to correct such errors.

In some embodiments, a computer system automatically surfaces content related to a physical location corresponding to the location of the navigation user interface element in response to user input directed to a digital assistant and doing so when the attention of the user is directed to the location of the navigation user interface element, thus providing an efficient way of obtaining content related to the physical location without leaving the user interface of the map application, thereby reducing the need for subsequent inputs to locate content related to the physical location which simplifies the interaction between the user and the computer system and enhances the operability of the computer system and makes the user-computer system interface more efficient.

FIGS. 11A-11G illustrate examples of a computer system presenting relevant content in response to user input in accordance with some embodiments.

FIG. 11A illustrates a computer system 101 displaying, via a display generation component 120 (e.g., display generation components 1-122a and 1-122b of FIG. 1), a three-dimensional environment 1100 from a viewpoint of a user of the computer system 101. In some embodiments, the computer system 101 in FIG. 11A is analogous to and/or includes one or more characteristics, provides one or more features, and/or includes one or more components as the computer system 101 described with reference to FIGS. 7A-7Q. In FIG. 11A, the display generation component 120 is analogous to and/or includes one or more characteristics and/or one or more components (e.g., sensors 114a through 114c) as the display generation component 120 described with reference to FIG. 7A.

As shown in FIG. 11A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1100. For example, three-dimensional environment 900 includes representations of walls, window 1110, and a lamp 1112 of the room in which the computer system 101 is located.

In FIG. 11A, three-dimensional environment 1100 includes a plurality of virtual objects, such as graphical user interfaces and/or graphical user interface elements 1102, 1104, 1106, and 1108. In some embodiments, the virtual objects are optionally components of a graphical user interface or window of a map application as described with reference to method(s) 800, 1000 and/or 1200. For example, in FIG. 11A, the computer system 101 displays a first user interface element 1108 (optionally, also referred to herein as a window or volume) at which the computer system 101 receives a text input defining a search query for performing a search operation as described with reference to method(s) 800 and/or 1000. In some embodiments, the first user interface element 1108 is analogous to and/or includes one or more characteristics of the first user interface element 708 in FIG. 7A.

In FIG. 11A, the computer system 101 also displays a navigation user interface element 1102 representing a first physical area. In some embodiments, the navigation user interface element 1102 is analogous to and/or includes one or more characteristics of the navigation user interface element 702 in FIG. 7A. In FIG. 11A, the navigation user interface element 1102 includes a second navigation user interface element 1104 and a control element 1106. In some embodiments, the second navigation user interface element 1104 and the control element 1106 are analogous to and/or include one or more characteristics of the second navigation user interface element 704 and the control element 706, respectively in FIG. 7A. FIG. 11A also illustrates an overhead view of the three-dimensional environment 1100 which depicts the three-dimensional environment 1100 visible from a viewpoint of a user 1116 of the computer system 101. In the overhead view of the three-dimensional environment 1100, the user 1116 is facing the navigation user interface element 1102 and the first user interface element 1108. The lamp 1112 is located in a right corner of the physical environment in which the user 1116 is located.

In FIG. 11A, the computer system detects user input 1114 that includes a voice input 1132 from the user of the computer system 101 corresponding to a request to display information about a building and an air pinch gesture 1120a (e.g., described in more detail in method(s) 800, 1000, and/or 1200) while gaze of the user of the computer system 101 is directed to a representation of a building 1124 of the navigation user interface element 1102. The voice input 1132 does not specify the building (e.g., the name of the building or a location or address of the building). In response to detecting the user input 1114 in FIG. 11A, the computer system 101 displays, via display generation component 120, a first content user interface element 1134a, a control element 1134b, and a second content user interface element 1134c. The first content user interface element 1134a includes a transcript of a respective content item displayed in synchrony with the respective content item being played. The respective content item relates to a building (e.g., San Francisco Museum of Modern Art) corresponding to the representation 1124 in the navigation user interface element 1102. In some embodiments, the respective content item includes a description of the building. In some embodiments, the control element 1134 is analogous to and/or includes one or more characteristics of the control element 706 in FIG. 7A. For example, the control element 1134, when selected, causes the computer system 500 to close (e.g., cease to display) the first content user interface element 1134a (and optionally, the second content user interface element 1134c) or move (and/or resize) the first content user interface element 1134a (and optionally, the second content user interface element 1134c). The second control user interface element includes representations of content, such as text, images, video, hyperlinks, and/or audio content associated with the building. Displaying the first content user interface element 1134a and the second content user interface element 1134c that includes content related to the building in response to the user input 1114 in FIG. 11A is performed by the computer system 101 without detecting specific information identifying the building (e.g., name and/or address). In some embodiments, the computer system 101 utilizes a location of the gaze of the user directed to the representation 1122 of the building of the navigation user interface element 1102 when presenting a response to the user request as discussed in more detail with reference to method 1200.

In some embodiments, the computer system 101 presents relevant content in response to a user request that includes gaze-only input (e.g., without a voice input and/or an air pinch gesture). For example, in FIG. 11B, the computer system detects user input 1114 (e.g., gaze of the user of the computer system 101) directed to a representation 1122 (e.g., pin) of a point of interest for a period of time greater than a time threshold 1118b as shown by timer 1118a indicative of gaze duration. In response to detecting user input 1114 in FIG. 11B, the computer system 101 displays, via display generation component 120, a first point of interest content user interface element 1136a, a control element 1136b, and a second point of interest content user interface element 1136c. In some embodiments, the first point of interest content user interface element 1136a, the control element 1136b, and the second point of interest content user interface element 1136c are analogous to and/or include one or more characteristics of the first content user interface element 1134a, the control element 1134b, and the second content user interface element 1134c in FIG. 11B, respectively. In FIG. 11C, the first point of interest content user interface element 1136a and the second point of interest content include content related to the point of interest (e.g., Yerba Buena Garden) corresponding to the location of the gaze of the user and/or the representation 1122 of the point of interest.

In some embodiments, the computer system 101 presents relevant content in response to a user request that includes gaze and air pinch gesture inputs (e.g., without a voice input). For example, in FIG. 11C, the computer system 101 detects user input 1114 that includes an air pinch gesture 1120c (e.g., described in more detail in method(s) 800, 1000, and/or 1200) while gaze of the user of the computer system 101 is directed to a first location of the navigation user interface element 1102. In response to detecting user input 1114 in FIG. 11C, the computer system 101 displays, via display generation component 120, a first location content user interface element 1138a, a control element 1138b, and the first user interface element 1108 including content associated with a first physical location corresponding to the first location of the navigation user interface element 1102. In some embodiments, the first location content user interface element 1138a and the control element 1138b are analogous to and/or include one or more characteristics of the first content user interface element 1134a and the control element 1134b in FIG. 11B, respectively. In FIG. 11D, the first location content user interface element 1138a includes content related to first physical location (e.g., South of Market neighborhood) corresponding to the location of the gaze of the user. In some embodiments, the content included in the first location content user interface element 1138a has a lower degree of specificity than the content included in the first content user interface element 1134a and/or the first point of interest content user interface element 1136a. For example, the content included in the first location content user interface element 1138a includes general information about the area “South of Market” without presenting particular information, such content related to a specific building, such as in the first content user interface element 1134a and/or content related to a specific point of interest, such in the first point of interest content user interface element 1136a. In some embodiments, the degree of specificity is based on information included in and/or derived from the user input as described in more detail with reference to method 1200.

In some embodiments, the computer system 101 presents relevant content in response to a user request that includes a voice input (e.g., without gaze and air pinch gesture inputs). For example, the computer system 101 detects a voice input 1126 from the user of the computer system 101 corresponding to a request to display food recommendations. The voice input 1132 does not specify a specific location of the navigation user interface element 1102. In response to detecting the voice input 1126 in FIG. 11D, the computer system 101 displays the first user interface element 1108 including content related to restaurants, cafes, bars, markets, and/or grocery stores located within a first physical location corresponding to the first location of the navigation user interface element 1102. In response to detecting the voice input 1126 in FIG. 11D, the computer system 101 displays in the navigation user interface element 1102 a plurality of representations (e.g., pins) of the restaurants, cafes, bars, markets, and/or grocery stores. Displaying the first user interface element 1108 and the navigation user interface element 1102 including content related to restaurants, cafes, bars, markets, and/or grocery stores located within a first physical location in response to the voice input 1126 in FIG. 11D is performed by the computer system 101 without detecting specific information identifying the first physical location. In some embodiments, the computer system 101 utilizes a currently displayed physical location of the navigation user interface element 1102 when presenting a response to the user request as discussed in more detail with reference to method 1200.

In some embodiments, the computer system 101 presents relevant content in response to additional information provided via a user input. For example, in FIG. 11E, the computer system 101 detects a voice input 1128 from the user of the computer system 101 corresponding to a request to display vegan friendly food recommendations. The voice input 1128 does not specify a specific location of the navigation user interface element 1102. In response to detecting the voice input 1128 in FIG. 11E, the computer system 101 displays the first user interface element 1108 including content related to vegan-friendly restaurants, cafes, bars, markets, and/or grocery stores located within the first physical location corresponding to the first location of the navigation user interface element 1102. In response to detecting the voice input 1128 in FIG. 11E, the computer system 101 displays in the navigation user interface element 1102 a plurality of representations (e.g., pins) of the vegan restaurants, cafes, bars, markets, and/or grocery stores (e.g., and ceases to display restaurants, cafes, bars, markets, and/or grocery stores that do not satisfy the user request/are not vegan-friendly).

In some embodiments, the computer system 500 presents relevant content in response to user input directed to a real-world object. For example, in FIG. 11F, the computer system detects user input 1114 that includes a voice input 1130 from the user of the computer system 101 corresponding to a request to purchase an item similar to lamp 1112 in the physical environment of the computer system 101. The user input 1114 also includes an air pinch gesture 1120f (e.g., described in more detail in method(s) 800, 1000, and/or 1200) while gaze of the user of the computer system 101 is directed to the lamp 1112. The voice input 1132 does not identify the lamp 1112. In response to detecting the user input 1114 in FIG. 11F, the computer system 101 displays, via display generation component 120, the first user interface element 1108 including content related to stores, markets, and/or furniture showrooms located within the first physical location corresponding to the first location of the navigation user interface element 1102. In some embodiments, the first user interface element 1108 includes a description of the lamp 1112 (e.g., color, dimensions, and/or other visual characteristics) recognized by the computer system 101 described with reference to method 1200. In response to detecting the user input 1114 in FIG. 11F, the computer system 101 displays in the navigation user interface element 1102 a plurality of representations (e.g., pins) of the stores, markets, and/or furniture showrooms as shown in FIG. 11G. Displaying the first user interface element 1108 and the navigation user interface element 1102 including content related to stores, markets, and/or furniture showrooms located within the first physical location corresponding to the first location of the navigation user interface element 1102 in response to the user input 1114 in FIG. 11F is performed by the computer system 101 without detecting specific information identifying the lamp 1112 and/or the first physical location. In some embodiments, the computer system 101 utilizes an object recognition approach or other artificial intelligence-based approach to identify the lamp 1112 and a currently displayed physical location of the navigation user interface element 1102 when presenting a response to the user request as discussed in more detail with reference to method 1200.

FIG. 12 is a flowchart illustrating an exemplary method of presenting relevant content in response to user input in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 1200 are, optionally, combined and/or the order of some operations is, optionally, changed.

In some embodiments, method 1200 is performed at a computer system (e.g., 101) in communication with a display generation component (e.g., 120) and one or more input devices (e.g., 314). In some embodiments, the computer system has one or more of the characteristics of the computer system of method 800. In some embodiments, the one or more input devices have one or more of the characteristics of the one or more input devices of method 800. In some embodiments, the display generation component has one or more of the characteristics of the display generation component of method 800. In some embodiments, the computer system displays (1202a), via the display generation component, a user interface of a map application including a navigation user interface element representing a first physical area including a plurality of first geographic features, such as user interface element 1108 and navigation user interface element 1102 in FIG. 11A. In some embodiments, the user interface of the map application has one or more of the characteristics of the user interface of the map application of method(s) 800 and/or 1000. In some embodiments, the navigation user interface element has one or more of the characteristics of the navigation user interface element of method(s) 800 and/or 1000 and/or as described in more detail below. In some embodiments, the computer system displays the user interface including the navigation user interface element within a three-dimensional environment as described in method(s) 800 and/or 1000.

In some embodiments, the plurality of first geographic features include representations of points of interest, landmarks, roads, state parks, natural features (e.g., mountains, hills, bodies of water, coastline, and/or the like), man-made structures (e.g., buildings, bridges, and/or the like), geographic regions (e.g., cities, towns, neighborhoods, and/or the like) and/or other significant geographic features located within the first physical area. In some embodiments, the other significant geographic features are identified as significant based on map data provided by the map application and/or a server or map service provider in communication with the computer system.

In some embodiments, while displaying the user interface (1202b), such as user interface element 1108 in FIG. 11A, the computer system receives (1202c), via the one or more input devices, a user input directed to a digital assistant operating on the computer system, the user input corresponding to a request to present content, such as user input 1114 that includes air pinch gesture 1120a while gaze is directed to the navigation user interface element 1102 in FIG. 11A. In some embodiments, the user input includes a voice input, a text input, an attention-based input (e.g., as described with reference to method 800), and/or a gesture input as will be described in more detail below.

In some embodiments, the computer system determines that voice-based criteria for initiating the digital assistant is satisfied. For example, the voice-based criteria optionally includes a criterion that is satisfied when the voice input includes a predetermined word or phrase. In some embodiments, the computer system implements the digital assistant. The terms “digital assistant,” “virtual assistant,” “intelligent automated assistant,” or “automatic digital assistant” optionally refer to any information processing system that interprets natural language input in spoken and/or textual form to infer user intent, and performs actions based on the inferred user intent. For example, to act on an inferred user intent, the digital assistant optionally performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form. Specifically, a digital assistant is optionally capable of accepting a user request at least partially in the form of a natural language command, request, statement, narrative, and/or inquiry. Typically, the user request optionally seeks either an informational answer or performance of a task by the digital assistant. A satisfactory response to the user request optionally includes a provision of the requested informational answer, a performance of the requested task, or a combination of the two. For example, a user asks the digital assistant a question, such as “Where am I right now?” Based on the user's current location, the digital assistant optionally answers, “You are in Central Park near the west gate.” The user optionally also requests the performance of a task, for example, “Please invite my friends to my girlfriend's birthday party next week.” In response, the digital assistant can acknowledge the request by optionally saying “Yes, right away,” and then optionally send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also optionally provides responses in other visual or audio forms, e.g., as text, alerts, music, videos, animations, etc. In some embodiments, a digital assistant is optionally implemented according to a client-server model. The digital assistant optionally includes a client-side portion executed on the computer system and server-side portion executed on a server system in communication with the computer system through one or more networks.

In some embodiments, in response to receiving the user input (1202d), in accordance with a determination that the user input satisfies one or more criteria including a criterion that is satisfied when the user input includes a gesture input directed to the first physical area and a voice input from a user of the computer system (1202e), such as user input 1114 that includes air pinch gesture 1120a while gaze is directed to the navigation user interface element 1102 in FIG. 11A, and in accordance with a determination that the input includes attention of a user of the computer system directed to a first location of the navigation user interface element, such as gaze directed to a location of the representation of building 1124 of the navigation user interface element 1102 in FIG. 11A, the computer system presents (1202f), using the digital assistant, content related to a first physical location corresponding to the first location of the navigation user interface element, such as content included in user interface elements 1134a and 1134c in FIG. 11B. In some embodiments, the criterion is satisfied when the voice input is detected while the gesture input is directed to the first physical area. In some embodiments, the computer system automatically (e.g., without detecting or receiving additional user input) provides map information (e.g., associated with a first physical location as will be described herein) along with the user input to the digital assistant to define the request to present content and generate a response that satisfies the request. For example, the request to present content is optionally inferred by the computer system based on the user input as will be described herein.

In some embodiments, the criterion is satisfied when the computer system detects that the gesture input maintains (or holds) a particular gesture (e.g., an air pinch gesture described herein) for a period of time greater than a threshold period of time (e.g., 0.01, 0.03, 0.05, 0.1, 0.5, 1, 2, 3, 5, or 10 seconds) and the voice input from the user is received while the air pinch gesture is held for the period of time greater than the threshold period of time.

For example, the user input includes a gesture input, such as an air gesture (e.g., an air pinch gesture, such as two or more fingers of a user's hand such as the thumb and index finger moving together and touching each other) while an attention (e.g., gaze) of the user is directed to the first physical area represented by the navigation user interface element, followed by a voice input from the user of the computer system. In some embodiments, the computer system detects a gesture other than an air pinch gesture, such as a forward pointing gesture (e.g., a forward movement of a user's hand while one or more fingers of the user's hand are extended towards the first physical area represented by the navigation user interface element) or a tap gesture with a finger of the user's hand (e.g., a forward movement by a finger of the user's hand such that the finger touches the first physical area represented by the navigation user interface element or approaches within a threshold distance (e.g., 0.01, 0.1, 0.5, 1, 2, 3, 4, 5, or 10 cm) of the first physical area represented by the navigation user interface element) while the attention of the user is directed to the first physical area represented by the navigation user interface element, followed by a voice input from the user of the computer system. In some embodiments, the voice input is a request for information, such as “Tell me more about this building” or “What time does this restaurant open?” In some embodiments, the computer system automatically generates a response that satisfies the request without receiving additional user input to specify the building and/or a location of the building, for example. Thus, in some embodiments, the computer system does not require that user input (e.g., the voice input) specify a particular physical area. In some embodiments, the computer system automatically initiates generation of a response (e.g., presents content related to a particular area) based on an attention (e.g., gaze) direction and/or location to the navigation user interface element. For example, the computer system optionally detects the input including the following voice input “What are things to do here?” while the attention of the user is directed to a first location of the navigation user interface element. In response to the input, the computer system optionally presents content related to, for example, points of interest, attractions, landmarks, geographic features, and/or the like at a first physical location corresponding to the first location of the navigation user interface to which the gaze of the user is directed to when receiving the voice input without the voice input specifying the first physical location. In some embodiments, in accordance with a determination that the input does not satisfy the one or more criteria, the computer system initiates additional conversation with the user, using the digital assistant, to obtain more information and/or clarify the request to present content. For example, the computer system optionally generates a response to the user input corresponding to the request to present content based on a determination that the attention of the user is directed to a first location of the navigation user interface element. The response optionally includes presenting content related to a first physical location optionally including one or more of the plurality of first geographic features corresponding to the first location of the navigation user interface element. In some embodiments, the computer system correlates the gaze point of the user to the first location of the navigation user interface element that corresponds to the first physical location in the physical world. In some embodiments, the plurality of first geographic features described above are defined in terms of coordinates (e.g., latitude, longitude, altitude) that correlate the respective locations of the geographic features to locations in the physical world as described in more detail below.

In some embodiments, content related to the first physical location includes text, media (e.g., video, audio, and/or images), representations (or models) of physical objects related to the first physical location and/or one or more geographic features within a threshold distance (e.g., 1, 5, 10, 50, 100, 200, 500, 1000, or 10,000 meters) of the first physical location. In some embodiments, the content related to a first physical location is provided by the computer system, the internet, an application operating on the computer system, a service provider, a server, and/or some combination thereof. Examples and descriptions of the content related to a first physical location will be described in more detail below. In some embodiments, the computer system displays the content related to a first physical location within a three-dimensional environment as described in method 800.

In some embodiments, in response to receiving the user input, in accordance with a determination that the user input satisfies one or more criteria including a criterion that is satisfied when the user input includes a gesture input directed to the first physical area and a voice input from a user of the computer system, such as user input 1114 that includes air pinch gesture 1120a while gaze is directed to the navigation user interface element 1102 in FIG. 11A, in accordance with a determination that the input includes attention of the user of the computer system directed to a second location of the navigation user interface element different from the first location of the navigation user interface element, such as gaze directed to a location of representation 1122 in FIG. 11B, the computer system presents (1202g), using the digital assistant, content related to a second physical location corresponding to the second location of the navigation user interface element and different from the first physical location, such as content included in user interface elements 1136a and 1136c in FIG. 11C.

Similarly to and/or as described with reference to the attention of the user directed to the first location of the navigation user interface element, the computer system optionally correlates the gaze point of the user to the second location of the navigation user interface element that corresponds to the second physical location in the physical world. In some embodiments, the content related to the second physical location is optionally analogous to and/or has one or more of the characteristics of the content related to the first physical location. In some embodiments, the content related to the second physical location is different from the content related to the first physical location. For example, content related to the second physical location optionally includes restaurants in the Mission Bay neighborhood of San Francisco and content related to the first physical location optionally includes restaurants in the Dogpatch neighborhood of San Francisco. More examples and details about the content that is presented by the computer system will be discussed below. Automatically surfacing content related to a physical location corresponding to the location of the navigation user interface element in response to user input directed to a digital assistant and doing so when the attention of the user is directed to the location of the navigation user interface element provides an efficient way of obtaining content related to the physical location without leaving the user interface of the map application, thereby reducing the need for subsequent inputs to locate content related to the physical location which simplifies the interaction between the user and the computer system and enhances the operability of the computer system and makes the user-computer system interface more efficient.

In some embodiments, in response to receiving the user input, in accordance with a determination that the user input satisfies one or more second criteria, different from the one or more criteria, including a criterion that is satisfied when the user input includes the gesture input directed to the first physical area without the voice input, such as input 1114 that includes gaze directed to the representation 1122 in FIG. 11B, in response to receiving the user input, in accordance with a determination that the gesture input includes the attention of the user of the computer system directed to the first location of the navigation user interface element, the computer system presents second content related to the first physical location corresponding to the first location of the navigation user interface element, different from the content related to the first physical location corresponding to the first location of the navigation user interface element, such as content included in user interface elements 1126a and 1136c in FIG. 11C. In some embodiments, the user input is a gesture input. In some embodiments, the gesture input is analogous to and/or includes one or more characteristics of the gesture input described above.

In some embodiments, the gesture input is the same gesture input described above. For example, the gesture input optionally includes the attention of the user of the computer system directed to the navigation user interface element as described herein and/or the air pinch gesture described above. In some embodiments, the computer system determines that the one or more second criteria are satisfied when the user input includes the attention of the user directed to the navigation user interface element without the air pinch gesture and the voice input (e.g., gaze-only input). For example, the computer system optionally determines that the one or more second criteria are satisfied when the computer system detects the attention of the user directed to the navigation user interface element for greater than a time threshold as described with reference to method 800. In some embodiments, the computer system determines that the one or more second criteria are satisfied when the user input includes the air pinch gesture while the attention of the user is directed to the navigation user interface element. In some embodiments, the one or more second criteria do not require that the attention of the user be directed to the navigation user interface element for greater than the time threshold when the computer system detects the air pinch gesture in order for the one or more second criteria to be satisfied.

In some embodiments, the computer system presents the second content using the digital assistant as described above. In some embodiments, the second content related to the first physical location has a degree of specificity less than (or, optionally, greater than) a respective degree of specificity associated with the content related to the first physical location. In some embodiments, a respective degree of specificity refers to how detailed information about a respective location is. For example, the information about the respective location optionally ranges from low (e.g., general) to high (e.g., specific). In some embodiments, the computer system determines that the user input includes the attention of the user directed to the first location without voice input optionally specifying data, preferences, and/or requirements. For example, the voice input optionally includes first data, such as “Show me vegan restaurants at this location.” In this case, in response to receiving the user input that includes the voice input, the computer system presents content that includes information related to the first data, such as information about vegan restaurants located within the threshold distance of the first physical location.

In another example, in response to receiving the user input that includes the attention of the user directed to the first location without the voice input including the first data, the computer system presents second content that includes general information about the first physical location that is broad and is optionally less focused on particular information including said information related to the first data, such as, for example, the second content optionally includes all points of interest within the threshold distance of the first physical location including attractions, landmarks, museums, restaurants, grocery stores, and/or bars. In some embodiments, the second content is analogous to and/or includes one or more characteristics of the content related to the first physical location. For example, the second content optionally includes text, media, representations of physical objects related to the first physical location and/or one or more geographic features within the threshold distance of the first physical location. In some embodiments, the computer system performs an operation related to the first physical location other than presenting content related to the first physical location described above.

In some embodiments, in response to receiving the user input, in accordance with a determination that the gesture input includes the attention of the user of the computer system directed to the second location of the navigation user interface element, such as user input 1114 that includes gaze directed to the representation 1124 of the building in FIG. 11A, the computer system presents third content related to the second physical location corresponding to the second location of the navigation user interface element, different from the content related to the second physical location corresponding to the second location of the navigation user interface element, such as content included in user interface elements 1134a and 1134c in FIG. 11B. Similarly to and/or as described with reference to the attention of the user directed to the first location of the navigation user interface element, the computer system optionally correlates the gaze point of the user to the second location of the navigation user interface element that corresponds to the second physical location in the physical world. In some embodiments, the third content related to the second physical location is optionally analogous to and/or has one or more of the characteristics of the second content related to the first physical location. In some embodiments, the third content related to the second physical location is different from the second content related to the first physical location. More examples and details about the content that is presented by the computer system will be discussed below. In some embodiments, the computer system performs an operation related to the second physical location other than presenting content related to the second physical location described above. Automatically surfacing content related to a physical location corresponding to the location of the navigation user interface element in response to user input directed to a digital assistant and doing so when the attention of the user is directed to the location of the navigation user interface element without voice input provides an efficient way of obtaining content related to the physical location, thereby reducing the need for subsequent inputs to locate content related to the physical location which simplifies the interaction between the user and the computer system and enhances the operability of the computer system and makes the user-computer system interface more efficient.

In some embodiments, in response to receiving the user input, in accordance with a determination that the user input satisfies one or more second criteria, different from the one or more criteria, including a criterion that is satisfied when the user input includes the voice input from the user of the computer system without the gesture input directed to the first physical area, such as voice input 1126 in FIG. 11D. In some embodiments, the one or more second criteria do not include a requirement that the user input includes a gesture input directed to a physical area in order for the one or more second criteria to be satisfied. In some embodiments, the gesture input includes the attention of the user of the computer system directed to the navigation user interface element as described herein and/or the air pinch gesture described above. In some embodiments, the voice input is the same as the voice input described above. As described above, the voice input optionally requests map information and specifies data, preferences, and/or requirements. In some embodiments, the one or more second criteria do not require that the voice input include data specifying a physical area of the navigation user interface element in order for the one or more second criteria to be satisfied. In some embodiments, the computer system utilizes the respective physical area currently being presented by the navigation user interface element for presenting content in response to receiving the user input as described herein. In some embodiments, the computer system determines that the one or more second criteria are satisfied when the navigation user interface element represents a respective physical area while the computer system receives the voice input from the user of the computer system.

In some embodiments, in response to receiving the user input, in accordance with a determination that the navigation user interface element represents the first physical area including the plurality of first geographic features, such as navigation user interface element 1102 in FIG. 11D, the computer system presents, using the digital assistant, second content related to the first physical area including the plurality of first geographic features, such as content included in user interface element 1108 and the navigation user interface element 1102 in FIG. 11E. For example, and as described above, the plurality of first geographic features include representations of points of interest, landmarks, roads, state parks, natural features, man-made structures, geographic regions, and/or other significant geographic features located within the first physical area. In some embodiments, the second content related to the first physical location including the plurality of first geographic features has a degree of specificity less than (or, optionally, greater than) a respective degree of specificity associated with the content related to the first physical location described above. For example, the computer system determines that the user input includes the voice input including first data: “What are some things to do here?” In some embodiments, the user input does not include the attention of the user directed to the first location and/or an air gesture as described above. In some embodiments, in response to receiving the user input including the voice input, the computer system presents second content that includes information related to the first data, such as the plurality of first geographic features including a listing of the first geographic features. In some embodiments, the second content includes a summary and/or general information about the plurality of first geographic features. In some embodiments, the second content is analogous to and/or includes one or more characteristics of the content related to the first physical location described above. For example, the second content optionally includes text, media, and/or representations of the first geographic features. In some embodiments, information provided by the digital assistant relates to the first physical area shown by a map area, rather than a particular location and/or feature targeted by the gesture input as described above and herein. In some embodiments, information provided by the digital assistant is based on a zoom level of the navigation user interface element as described in more detail below. For example, when the navigation user interface element represents a first area or portion of the map, the computer system optionally generates content that includes information provided by the digital assistant corresponding to the first area or portion of the map. In another example, when the navigation user interface element presents a second area of the map, greater than the first area, the computer system optionally generates content that includes information provided by the digital assistant corresponding to the second area (e.g., larger area) of the map. In some embodiments, the computer system performs an operation related to the first physical area other than presenting content related to the first physical location described above.

In some embodiments, in response to receiving the user input, in accordance with a determination that the navigation user interface element represents a second physical area including a plurality of second geographic features, different from the first physical area including the plurality of first geographic features, such as the navigation user interface element 1102 in FIG. 11A, the computer system presents, using the digital assistant, third content related to the second physical area including the plurality of second geographic features, such as content included in user interface elements 1134a and 1134c in FIG. 11B. In some embodiments, the plurality of second geographic features is analogous to and/or includes one or more characteristics of the plurality of first geographic features. In some embodiments, the plurality of second geographic features includes the plurality of first geographic features and one or more additional geographic features. In some embodiments, the plurality of second geographic features include a subset of the plurality of first geographic features. In some embodiments, the third content is analogous to and/or includes one or more characteristics of the second content related to the first physical area including the plurality of first geographic features. In some embodiments, the computer system presents the navigation user interface element representing the second physical area in response to user input corresponding to a request to zoom in, zoom out, and/or pan to the second physical area as described with reference to method(s) 800 and/or 1000. In some embodiments, the computer system presents the navigation user interface element representing the second physical area automatically (e.g., without detecting the user input corresponding to the request to presenting the navigation user interface element representing the second physical area). In some embodiments, the computer system performs an operation related to the second physical area other than presenting content related to the second physical location described above. Automatically surfacing content related to a respective physical area including a plurality of respective geographic features in response to user input including voice input from the user of the computer system without a gesture input directed to the respective physical area provides an efficient way of obtaining content related to the physical location, thereby reducing the need for subsequent inputs to locate content related to the physical location which simplifies the interaction between the user and the computer system and enhances the operability of the computer system and makes the user-computer system interface more efficient.

In some embodiments, after (and/or in response to and/or while) presenting, using the digital assistant, content related to a respective physical location corresponding to a respective location of the navigation user interface element, such as content included in user interface element 1108 and the navigation user interface element 1102 in FIG. 11E, the computer system receives, via the one or more input devices, a second user input directed to the digital assistant corresponding to a request to present additional content, such as voice input 1128 in FIG. 11E. In some embodiments, the content related to the respective physical location is analogous to and/or includes one or more characteristics of the first content, the second content, the third content, or other content described above and/or below. In some embodiments, the request to present additional content refers to a request to present supplemental information to the content related to the respective physical location. In some embodiments, the second user input is analogous to and/or includes one or more characteristics of the voice input described above. In some embodiments, in response to receiving the second user input, in accordance with a determination that the second user input satisfies one or more second criteria, different from the one or more criteria, including a criterion that is satisfied when the second user input includes a second voice input from the user of the computer system without the attention of the user directed to the respective location of the navigation user interface element, such as voice input 1128 in FIG. 11E, the computer system presents using the digital assistant, second content related to the respective physical location corresponding to the respective location of the navigation user interface element, such as content included in user interface element 1108 and navigation user interface element 1102 in FIG. 11F. In some embodiments, the second content is analogous to and/or includes one or more characteristics of the content described above. For example, the second content optionally includes photos, videos, and/or media content related to the respective physical location. In some embodiments, the second voice input is analogous to and/or includes one or more characteristics of the voice input described above. For example, the second voice input optionally includes a request for additional information and/or details about a particular topic related to the respective physical location. In some embodiments, the computer system presents the second content related to the respective physical location corresponding to the respective location of the navigation user interface element without requiring that the second user input include the attention of the user directed to the respective location of the navigation user interface element. In some embodiments, the computer system presents the second content without requiring that the second voice input indicate the respective location of the navigation user interface element. In some embodiments, the computer system determines that the one or more second criteria are satisfied when the computer system detected that the attention of the user directed to the respective location of the navigation user interface element occurred within a first time threshold (e.g., 0.1, 0.2, 0.5, 1, 2, 5, 10, 100, 500, or 1000 seconds) of when the computer system receives the voice input from the user of the computer system.

For example, in accordance with a determination that the attention of the user was directed to the respective location of the navigation user interface element within the first time threshold from when the voice input was detected, the computer system represents content related to the respective physical location corresponding to the respective location of the navigation user interface element as long as the computer system does not detect the attention of the user directed to a second respective location of the navigation user interface element, different from the respective location of the navigation user interface element. In some embodiments, the second content is analogous to and/or includes one or more characteristics of the content related to the respective physical location described herein, the third content, or other content described above and/or below. In some embodiments, the second content related has a degree of specificity different from a respective degree of specificity associated with the content related to the respective physical location. In some embodiments, in accordance with a determination that the attention of the user is directed to a second location of the navigation user interface element when the user input directed to the digital assistant that satisfies the one or more criteria was detected, the second content presented by the computer system in response to the user input described herein includes information about a second respective physical location corresponding to the second location of the navigation user interface element, different from the respective physical location associated with the content previously presented by the computer system. Automatically surfacing content related to a respective physical area in response to user input including voice input from the user of the computer system without a gesture input directed to the respective physical area provides an efficient way of obtaining content related to the physical location, thereby reducing the need for subsequent inputs to locate content related to the physical location which simplifies the interaction between the user and the computer system and enhances the operability of the computer system and makes the user-computer system interface more efficient.

In some embodiments, presenting the content related to a respective physical location corresponding to a respective location of the navigation user interface element includes presenting the content in an audible form, such as content included in user interface element 1136a associated with an audible form in FIG. 11C (e.g., spoken word). In some embodiments, while presenting the content in the audible form, the computer system presents a transcript of the content in synchrony with the content being output/spoken. In some embodiments, while presenting the content in the audible form, the computer system presents options that, when selected, cause the computer system to control a speed of the audio, a volume of the audio, and/or navigate backwards or forwards in the audio and/or transcript. In some embodiments, the content presented in the audible form is provided by the digital assistant described above. Presenting content in an audible form provides a quick way of outputting content information and an efficient way of obtaining content related to the physical location, thereby reducing the need for subsequent inputs to locate content related to the physical location which simplifies the interaction between the user and the computer system and enhances the operability of the computer system and makes the user-computer system interface more efficient.

In some embodiments, presenting the content related to a respective physical location corresponding to a respective location of the navigation user interface element includes displaying, via the display generation component, a content user interface element associated with the content, such as user interface element 1136c in FIG. 11C. In some embodiments, the content user interface element includes a window or volume that contains text, media (e.g., video, audio, and/or images), representations (or models) of physical objects related to the respective physical location. In some embodiments, the content user interface element optionally includes content related to other information in the user input, such as, in response to a spoken query of the voice input. In some embodiments, the content user interface element is presented at a location that is adjacent to the respective location of the navigation user interface element. In some embodiments, the content user interface element is analogous to and/or includes one or more characteristics of the content user interface elements and/or the collection of content items described with reference to method(s) 800 and/or 1000. Presenting a content user interface element associated with the content provides a quick way of outputting content information and an efficient way of obtaining content related to the physical location, thereby reducing the need for subsequent inputs to locate content related to the physical location which simplifies the interaction between the user and the computer system and enhances the operability of the computer system and makes the user-computer system interface more efficient.

In some embodiments, displaying the navigation user interface element representing the first physical area is at a first zoom level, such as the navigation user interface element 1102 displayed at a first zoom level in FIG. 11A. In some embodiments, displaying the navigation user interface element representing the first physical area at the first zoom level includes displaying a first portion of the first physical area. In some embodiments, the computer system will change the display of the navigation user interface element as described herein to represent a respective portion of the first physical area that is larger or smaller than the first portion of the first physical area. For example, the computer system will change the display of the navigation user interface element in response the user input described above that satisfies the one or more criteria, and without the user input (and/or without any input) corresponding to a request to pan and/or zoom the navigation user interface element.

In some embodiments, while presenting the content related to the first physical location corresponding to the first location of the navigation user interface element, displaying the navigation user interface element at a second zoom level, different from the first zoom level, and panned to present (centered on) the first location of the navigation user interface element, such the navigation user interface element 1102 displayed at a second zoom level in FIG. 11B. For example, the computer system optionally displays the navigation user interface element at a second zoom level to focus on the first location of the navigation user interface element that represents the first physical location. In some embodiments, displaying the navigation user interface element panned to present the first location of the navigation user interface element includes displaying a second portion of the first physical area smaller than the first portion of the first physical area.

In some embodiments, while presenting the content related to the second physical location corresponding to the first location of the navigation user interface element, displaying the navigation user interface element at a third zoom level, different from the first zoom level, and panned to present (centered on) the second location of the navigation user interface element, such as the navigation user interface element 1102 displayed at a third zoom level in FIG. 11G. In some embodiments, displaying the navigation user interface element at the third zoom level is analogous to and/or includes one or more characteristics of displaying the navigation user interface element at the second zoom level. In some embodiments, displaying the navigation user interface element panned to present the second location of the navigation user interface element is analogous to and/or includes one or more characteristics of displaying the navigation user interface element panned to present the first location of the navigation user interface element. Displaying the navigation user interface element at a respective zoom level and panned to present a respective location of the navigation user interface element provides an efficient way of displaying the navigation user interface element, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, presenting the content related to a respective physical location corresponding to a respective location of the navigation user interface element is while the attention of the user is directed to the respective location of the navigation user interface element, such as user input 1114 including gaze directed to the navigation user interface element 1102 in FIG. 11B. In some embodiments, the computer system presents the content related to the first respective physical location while the attention of the user is directed to the respective location of the navigation user interface element without detecting a voice input and/or an air pinch gesture as described above. In some embodiments, the computer system presents the content related to the first respective physical location while the attention of the user is directed to the respective location of the navigation user interface element and while the computer system detects the voice input and/or the air pinch gesture as described above.

In some embodiments, in response to receiving the user input, and in accordance with a determination that the attention of the user is directed to a third location of the navigation user interface element, different from the respective location of the navigation user interface element, such as the user input 1114 including gaze directed to representation 1122 in FIG. 11B, the computer system presents, using the digital assistant, content related to a third physical location corresponding to the third location of the navigation user interface element and different from the respective physical location, such as content included in user interface elements 1136a and 1136c in FIG. 11C. For example, the computer system detects movement of the attention of the user from being directed to the respective location of the navigation user interface element to being directed to the third location of the navigation user interface element.

In some embodiments, the computer system determines that the attention of the user is directed to the third user interface element for greater than the time threshold as described with reference to method 800, and in response to the determination that the attention of the user is directed to the third user interface element for greater than the time threshold, the computer system presents the content related to the third physical location corresponding to the third location of the navigation user interface element. In some embodiments, the content related to the third physical location corresponding to the third location of the navigation user interface element is analogous to and/or includes one or more characteristics of the content related to the respective physical location corresponding to a respective location of the navigation user interface element. Displaying respective content related to a respective physical location corresponding to a respective location of the navigation user interface element in response to the determination that the attention of the user is directed to the respective location of the navigation user interface element provides an efficient way of presented related content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, a respective physical location corresponding to a respective location of the navigation user interface element includes a point of interest, such as representation 1122 in FIG. 11B. In some embodiments, the navigation user interface element includes a representation of the point of interest. In some embodiments, the computer system updates the user input to include or be directed to the representation of the point of interest. In some embodiments, the user input that satisfies the one or more criteria described above is directed to the representation of the point of interest. Thus, in some embodiments, the computer system provides the digital assistant with the point of interest for generating a response. In some embodiments, the point of interest is analogous to and/or includes one or more characteristics of a significant point of interest described in more detail with reference to method 800. For example, the point of interest optionally includes a major landmark, geographic feature, building, and/or structure that is popular according to map data (e.g., a point of interest frequently visited by users) described in more detail with reference to method 800. Displaying respective content related to a point of interest provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, a respective physical location corresponding to a respective location of the navigation user interface element includes a building, such as representation 1124 of a building in FIG. 11A (e.g., structure). In some embodiments, the navigation user interface element includes a representation of the building. In some embodiments, the computer system updates the user input to include or be directed to the representation of the building. In some embodiments, the user input that satisfies the one or more criteria described above is directed to the representation of the building. Thus, in some embodiments, the computer system provides the digital assistant with the building for generating a response. In some embodiments, the building is analogous to and/or includes one or more characteristics of a significant building, structure, and/or landmark described in more detail with reference to method 800. Displaying respective content related to a building provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, a respective physical location corresponding to a respective location of the navigation user interface element includes a city, such as the representation of the city included in FIG. 11B (or, optionally, neighborhood, region, state, country, or continent). In some embodiments, the navigation user interface element includes a representation of the city. In some embodiments, the user input that satisfies the one or more criteria described above is directed to the representation of the city. In some embodiments, the computer system updates the user input to include or be directed to the representation of the city. Thus, in some embodiments, the computer system provides the digital assistant with the city for generating a response. In some embodiments, the city is analogous to and/or includes one or more characteristics of a significant city described in more detail with reference to method 800. Displaying respective content related to a city provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, a respective physical location corresponding to a respective location of the navigation user interface element includes a geographic feature, such as neighborhood area of the navigation user interface element 1102 in FIG. 11C (e.g., mountains, rivers, lakes, oceans, forests, parks, bridges, and/or dams). In some embodiments, the navigation user interface element includes a representation of the geographic feature. In some embodiments, the computer system updates the user input to include or be directed to the representation of the geographic feature. In some embodiments, the user input that satisfies the one or more criteria described above is directed to the geographic feature. Thus, in some embodiments, the computer system provides the digital assistant with the geographic feature for generating a response. In some embodiments, the geographic feature is analogous to and/or includes one or more characteristics of a significant geographic feature described in more detail with reference to method 800. Displaying respective content related to a geographic feature provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, presenting the content related to a respective physical location corresponding to a respective location of the navigation user interface element includes presenting information identifying the respective physical location, such as information included in user interface elements 1134a and 1134c in FIG. 11B. In some embodiments, the information identifying the respective physical location includes historical information, geographical information, economic information, cultural information, points of interests located within the predetermined distance from the respective physical location as described above. In some embodiments, the information includes media content as described in method 800, such as photos, videos, panoramas, three-dimensional models, representations of media items (e.g., music, podcasts, travel guides, news, and/or events) and/or other information associated with the respective physical location. Displaying respective information identifying a respective physical location provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, presenting the content related to a respective physical location corresponding to a respective location of the navigation user interface element includes presenting information identifying a respective physical region associated with (e.g. including, but outside of) the respective physical location, such as a particular neighborhood identified in the user interface element 1138 in FIG. 11D. In some embodiments, the respective physical region is analogous to and/or includes one or more characteristics of a significant region, area, neighborhood associated with the respective physical location described in more detail with reference to method 800. In some embodiments, information identifying the respective physical region includes information identifying one or more points interest, landmarks, buildings, geographic features, and/or other map features described above and/or with reference to method(s) 800 and/or 1000. Displaying respective information identifying a respective physical region associated with the respective physical location provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, in accordance with the determination that the attention of the user is directed to the first location of the navigation user interface element, the content related to the first physical location corresponding to the first location of the navigation user interface element is based on first latitude and/or longitude coordinates corresponding to the first physical location, such as coordinates corresponding to the gaze of the user depicted by user input 1114 in FIG. 11C and the content included in user interface element 1138a. For example, the computer system optionally obtains (e.g., receives or estimates) the first physical location corresponding to the first location of the navigation user interface element to which the attention of the user is determined to be directed to. In some embodiments, the first physical location is represented by a latitude and longitude (and, optionally, altitude). For example, the computer system obtains that the first location of the navigation user interface element is associated with first latitude and longitude coordinates optionally indicating that the attention of the user is directed to the first physical location. In some embodiments, the computer system obtains one or more significant points of interest as described in method 800 within the predetermined distance of the first physical location. Thus, in some embodiments, the content related to the first physical location includes information identifying the one or more significant points of interest.

In some embodiments, in accordance with the determination that the attention of the user is directed to the second location of the navigation user interface element, the content related to the second physical location corresponding to the second location of the navigation user interface element is based on second latitude and/or longitude coordinates corresponding to the second physical location, different from the first latitude and longitude coordinates such as coordinates corresponding to the gaze of the user depicted by user input 1114 in FIG. 11B and the content included in user interface elements 1136a and 1136c. In some embodiments, presenting content related to the second physical location based on the second latitude and longitude coordinates corresponding to the second physical location is analogous to and/or includes one or more characteristics of presenting content related to the first physical location based on the first latitude and longitude coordinates corresponding to the first physical location described herein. In some embodiments, the computer system utilizes the first latitude and longitude coordinates to obtain or retrieve (e.g., via an internet connection) information related to the respective physical location. Displaying respective content based on respective latitude and longitude coordinates in response to the determination that the attention of the user is directed to a respective location of the navigation user interface element provides an efficient way of presenting related content without requiring additional input from the user, such as exact coordinates, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, presenting the content related to a respective physical location corresponding to a respective location of the navigation user interface element includes in accordance with a determination that first metadata associated with a respective latitude and/or longitude coordinates corresponding to the attention of the user indicates a first ranking, the content is associated with the first metadata, such as metadata associated with coordinates corresponding to the gaze of the user depicted by user input 1114 in FIG. 11B. In some embodiments, the first metadata associated with the respective latitude and longitude coordinates includes tags, labels, and/or text for significant points of interest within the predetermined distance from the latitude and longitude coordinates. In some embodiments, the first metadata includes information on neighborhoods, cities, or regions within the predetermined distance from the latitude and longitude coordinates. In some embodiments, the computer system determines (e.g., receives or calculates) the first ranking based on the first metadata. In some embodiments, the first ranking indicates a high level of interest to the user of the computer system (e.g. level of interest associated with the information from the first metadata). Thus, in some embodiments, the content presented to the user includes information from the first metadata.

In some embodiments, in accordance with a determination that second metadata associated with the respective latitude and/or longitude coordinates corresponding to the attention of the user indicates a second ranking, less than the first ranking, the content is not associated with the second metadata, such as metadata not associated with the coordinates corresponding to the gaze of the user depicted by user input 1114 in FIG. 11B. In some embodiments, the second metadata is analogous to and/or includes one or more characteristics of the first metadata described herein. In some embodiments, the computer system determines (e.g., receives or calculates) the second ranking based on the second metadata. In some embodiments, the second ranking indicates a level of interest lower than a respective level of interest associated with the first ranking. Thus, in some embodiments, the content presented to the user does not include information from the second metadata. Displaying respective content based on a ranking of metadata associated with a respective latitude and longitude coordinates corresponding to the attention of the user provides an efficient way of presenting related content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, the computer system inputs the first metadata into a large language model, such as coordinate information corresponding to the gaze of the user depicted by user input 1114 in FIG. 11A (or, optionally, other artificial intelligence-based and/or natural-language-based approach). For example, the computer system optionally analyzes the first metadata described above and/or the user input (e.g., voice input, the latitude and longitude coordinates corresponding to the attention of the user, and/or other input inputted by the user or automatically obtained from the computer system) using the large language model to generate for presentation the content related to the respective physical location corresponding to the respective location of the navigation user interface element described above. Additionally and/or alternatively, and in some embodiments, the computer system generates for presentation one or more follow-on prompts requesting additional information from the user of the computer system. Utilizing a large language model to generate content related to the respective physical location reduces the cognitive burden on a user when interacting with the navigation user interface element and provides an efficient way of presenting related content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, while displaying the navigation user interface element representing the first physical area at a first zoom level, and including a plurality of first representations of points of interest at the first location of the navigation user interface element, such as the navigation user interface element 1120 displayed at a first zoom level in FIG. 11F, the computer system receives via the one or more input devices, a second user input corresponding to a request to perform a search in the navigation user interface element, such as voice input 1130 in FIG. 11F. In some embodiments, displaying the navigation user interface element representing the first physical area at the first zoom level includes displaying a first portion of the first physical area. In some embodiments, the computer system will change the display of the navigation user interface element as described herein to display a respective portion of the first physical area that is larger or smaller than the first portion of the first physical area. In some embodiments, in response to receiving the second user input, the computer system updates display of the navigation user interface element to represent a respective physical area corresponding to the search, including displaying the navigation user interface at a second zoom level, different from the first zoom level, and including displaying a plurality of second representation of points of interest corresponding to the search and located in the respective physical area, such as the navigation user interface element displayed at a second zoom level in FIG. 11G. For example the plurality of second representations of points of interest are results from a searching operation as described in method 800.

In some embodiments, the computer system optionally displays the navigation user interface element at a second zoom level to focus on a portion of the navigation user interface element that includes (e.g., centers on) the plurality of second representations of points of interest such that the plurality of second representations of points of interest are displayed within the navigation user interface element. In some embodiments, displaying the navigation user interface element centered on the plurality of second representations of points of interest includes displaying a second portion of the first physical area that is larger than the first portion of the first physical area. In some embodiments, the plurality of second representations of points of interest are different from the plurality of first representations of points of interest. For example the plurality of second representations of points of interest include more or less respective representations of points of interest than the plurality of first representations of points of interest. In another example the plurality of second representations of points of interest are a subset of the plurality of first representations of points of interest. Changing the navigation user interface element to represent a respective physical area at a respective zoom level and centered on a respective plurality of representations of points of interest corresponding to a search operation provides an efficient way of displaying the navigation user interface element, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, presenting the content related to a respective physical location corresponding to a respective location of the navigation user interface element includes presenting supplemental information associated with the respective physical location, such as supplemental information included in the user interface element 1134c that optionally includes museum maps or three-dimensional models of sculptures found in the museum in FIG. 11B. In some embodiments, the supplemental information includes photos, videos, panoramas, three-dimensional models, representations of media items (e.g., music, podcasts, travel guides, news, events, and/or supplemental maps) and/or other content associated with the respective physical location. In some embodiments, the supplemental information is not displayed in the original or nominal map information shown in the navigation user interface element. In some embodiments, the supplemental information is obtained and/or received from one or more second computer system(s) other than the computer system. In some embodiments, the supplemental information includes user-created content, such as photos, drawings, journal entries related to the respective physical location. Displaying supplemental information associated with the respective physical location provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

In some embodiments, in response to receiving the user input and in accordance with a determination that the user input satisfies one or more second criteria including a criterion that is satisfied when the user input includes the gesture input directed to a representation of a physical area of the user of the computer system and the voice input from the user of the computer system, such as the user input 1114 that includes hand pinch gesture 1120f while gaze is directed to lamp 112 and voice input 1130 in FIG. 11F. In some embodiments, the computer system determines that the one or more second criteria are satisfied when the user input includes the attention of the user directed to the representation of the physical area and the voice input. For example, the computer system optionally determines that the one or more second criteria are satisfied when the computer system detects the attention of the user directed to the navigation user interface element for greater than a time threshold as described with reference to method 800 while the computer system receives the voice input. In some embodiments, the one or more second criteria do not include a requirement that the user input include an air pinch gesture while the attention of the user is directed to the representation of the physical area in order for the one or more second criteria to be satisfied. In some embodiments, the computer system determines that the one or more second criteria are satisfied when the user input includes the air pinch gesture while the attention of the user is directed to the navigation user interface element. In some embodiments, the gesture input is the same gesture input described above. In some embodiments, the voice input is the same voice input described above.

In some embodiments, in accordance with a determination that the input includes the attention of the user of the computer system directed to a first portion of the representation of the physical area, such as gaze directed to lamp 1112 in FIG. 11F, the computer system presents, using the digital assistant, content related to the first portion of the representation of the physical area, such as content included in the user interface element 1108 in FIG. 11G. In some embodiments, the first portion of the representation of the physical area includes a real-world object that is identified by the computer system. In some embodiments, the real-world object is a piece of furniture, a clothing item, an electronic device, a building, a landmark, or other object found in the physical area of the user. In some embodiments, the computer system optionally identifies the real-world object using an object recognition approach or other artificial intelligence-based approach to generate for presentation the content related to the first portion of the representation of the physical area. In some embodiments, the content related to the first portion of the representation of the physical area includes information about the real-world object that is identified by the computer system. In some embodiments, the content includes map information related to the real world object and/or the first portion of the representation of the physical area. For example, the map information optionally includes points of interest related to the real world object and/or the first portion of the representation of the physical area (e.g., shops or businesses where the user can purchase the real-world object and/or receive services or repairs related to the real-world object). In some embodiments, the user input described herein is detected while at least a portion of the physical environment and the navigation user interface element are visible in the three-dimensional environment, and the user input is directed to the at least the portion of the physical environment in the three-dimensional environment (e.g., and is not directed to the navigation user interface element). In some embodiments, the representation of the physical area is optionally passive passthrough or active/digital passthrough of the physical environment as described in method(s) 800 and/or 1000.

In some embodiments, in accordance with a determination that the input includes the attention of the user of the computer system directed to a second portion of the representation of the physical area, different from the first portion, such as another piece of furniture (e.g., rug, table, or chair) the computer system presents, using the digital assistant, content related to the second portion of the representation of the physical area, such as content similar to the content included in the user interface element 1108 in FIG. 11G. In some embodiments, presenting content related to the second portion of the representation of the physical area is analogous to and/or includes one or more characteristics of presenting content related to the first portion of the representation of the physical area. Displaying content related to a respective portion of the representation of the physical area provides an efficient way of presenting content, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

FIGS. 13A-13I illustrate examples of a computer system presenting user interface elements based on a location of a user of the computer system in accordance with some embodiments.

FIG. 13A illustrates a computer system 101 displaying, via a display generation component 120 (e.g., display generation components 1-122a and 1-122b of FIG. 1), a three-dimensional environment 1300 from a viewpoint of a user of the computer system 101. In some embodiments, the computer system 101 in FIG. 13A is analogous to and/or includes one or more characteristics, provides one or more features, and/or includes one or more components as the computer system 101 described with reference to FIGS. 7A-7Q. In FIG. 13A, the display generation component 120 is analogous to and/or includes one or more characteristics and/or one or more components (e.g., sensors 114a through 114c) as the display generation component 120 described with reference to FIG. 7A.

In some embodiments, and as described in method 1400, the computer system 101 performs one or more actions based on a location of the user of the computer system 101. For example, the one or more actions optionally include displaying, via the display generation component 120, one or more virtual objects or widgets or user interface elements; configuring one or more output devices, such as smart home devices and/or Internet of things (IOT) devices; and/or initiating one or more processes associated with one or more applications, such as playing a media item of a media content application, activating a timer associated with a timekeeping application, performing a search for navigation directions, and/or any of the other actions described in method 1400. As shown in FIG. 13A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1300. For example, three-dimensional environment 1300 includes representations of a first picture frame 1308, a second picture frame 1306, a television display 1310, a fireplace 1304, and a table 1302 of the room in which the computer system 101 is located. In some embodiments, the computer system 101 displays the three-dimensional environment 1300 from a viewpoint of a user at a first location 1316a (e.g., facing the back wall of a living room 1314f in which computer system 101 is located), as shown in overhead view 1314a of a home layout.

In some embodiments, the computer system 101 displays, via display generation component 120, one or more virtual objects in the three-dimensional environment 1300 based on a current time of day at the computer system 101 and/or a state of the user of the computer system 101 as described in more detail with reference to method 1400. In some embodiments, the one or more virtual objects include widgets. For example, a widget is configured as a special purpose component of an application configured to provide one or more particular functions described in more detail below and with reference to method 1400. For example, in contrast to a user interface element of a same application, the widget utilizes less processing power and memory compared to a user interface element of the same application and/or running the same application fully (e.g., rather than running only the widget). In some embodiments, the widget provides quick access to specific information and/or performs a particular action associated with the same application via a smaller and/or simpler user interface than the user interface element of the same application. In FIG. 13A, virtual clock 1312 indicates a current time at the computer system 101 is 2:00 PM. In some embodiments, the computer system 101 displays, via the display generation component 120, one or more virtual objects when the computer system determines that the current time at the computer system 101 is a predetermined time. For example, because the computer system 101 determines that the current time at the computer system 101 is 2:00 PM, the computer system 101 does not display any virtual objects in the three-dimensional environment 1300 other than virtual clock 1312. In some embodiments, this is irrespective of the current location of the user of the computer system 101. In FIG. 13B, the computer system 101 determines that the current time at the computer system 101 is 7:00 PM, and in response to the determination that the current time of day at the computer system 101 is 7:00 PM, the computer system 101 performs one or more actions based on a determination that the location of the user of the computer system is determined to be in the living room 1314f. For example, the one or more actions include displaying, via the display generation component 120, one or more virtual objects, activating one or more applications, and/or performing any of the other actions associated with the one or more applications as described herein and/or in method 1400. For example, in FIG. 13B, the computer system 101 activates (e.g., turns on) a media content streaming application to present, via the television display 1310, a first recommended media content 1320a and a second recommended media content 1320b. For example, the computer system 101 optionally turns on the television display 1310 and displays, via the media steaming user interface element, the first recommended media content 1320a and the second recommended media content 1320b. Additionally and/or alternatively, in some embodiments, the computer system 101 displays the first recommended media content 1320a and the second recommended media content 1320b in a manner that simulates the television display 1310. For example, the computer system 101 optionally replaces the representation of the television display 1310 with the media streaming user interface element that includes the first recommended media content 1320a and the second recommended media content 1320b. Thus, in some embodiments, the computer system 101 replaces portions of the representation of the physical environment with one or more virtual objects such that the three-dimensional environment 1300 that is presented to the user of the computer system 101 is partially the real world physical environment and partially a virtual simulated environment as described in method 1400.

In some embodiments, the one or more virtual objects the computer system 101 displays are widgets or user interface elements of a map application or another application, different from the map application as described in method 1400. For example, and as shown in FIG. 13B, the computer system displays, via a photos widget, one or more photos and/or videos In some embodiments, the computer system 101 determines that one or more criteria are satisfied, including a first criterion that is satisfied when the current time is 7:00 PM and a second criterion that is satisfied when the location of the user of the computer system 101 is determined to be in the living room 1314f. In some embodiments, in determining that the one or more criteria are satisfied, the computer system 101 makes an inference that the user of the computer system 101 intends to view media content via the television display 1310. In some embodiments, the computer system 101 makes this inference based on historical information and/or one or more predetermined user settings as described in more detail with reference to method 1400. In FIG. 13B, the first recommended media content 1320a includes an island theme television series titled “Comedy Island.” In some embodiments, the computer system 101 recommends media content based on a state of the user and/or a recent event associated with the user as described in more detail in method 1400. For example, the computer system 101 determines that the user of the computer system 101 recently traveled to the Philippines based on location information. In FIG. 13B, the second recommended media content 1320b includes a movie about Paris which corresponds to a recently searched destination made by the user of the computer system 101 via a map application, different from the media streaming application.

In FIG. 13B, the computer system 101 displays, via the display generation component 120, one or more virtual objects in response to a determination that the one or more criteria (e.g., described above) are satisfied. The one or more virtual objects are optionally referred to as widgets or user interface elements of a map application or another application, different from the map application, as described in more detail with reference to method 1400. For example, the one or more virtual objects optionally include text, photos, videos, media content, or other content related to a particular location associated with the map application. In some embodiments, the computer system 101 changes the content included in the one or more virtual objects based on satisfying one or more criteria described in more detail in method 1400. For example, the one or more criteria are optionally based on a location of the user of the computer system, a context of the user and/or the computer system, a state of the user and/or the computer system, historical information, map information, and/or any of the other information described in more detail in method 1400. In some embodiments, the computer system 101 displays, ceases to display, or moves the one or more virtual objects based on the one or more criteria.

In FIG. 13A, and as described above, the computer system 101 displays, via display generation component 120, representations of the physical environment, such as the first picture frame 1308, the second picture frame 1306, the television display 1310, the fireplace 1304, and the table 1302 of the room in which the computer system 101 is located. As shown in FIG. 13A, the computer system 101 displays, via display generation component 120, a virtual object, such as the virtual clock 1312 indicative of a current time at the computer system 101. In some embodiments, the computer system changes the virtual clock 1312 to correspond to the current time at the computer system 101. In FIG. 13A, the current time at the computer system is 2:00 PM, and as such, the computer system 101 displays the virtual clock to indicate the 2:00 PM time.

In some embodiments, and as shown in FIG. 13B, the computer system displays, via the display generation component 120, virtual objects 1322, 1318, 1324, and 1326. Virtual objects 1322 and 1318 are photos from the user's recent travel to the Philippines and obtained from a photo management application. In some embodiments, the computer system 101 displays virtual objects 1322 and 1318 in response to a determination that the current time at the computer system 101 is a predetermined time. In FIG. 13B, the computer system 101 displays virtual objects 1322 and 1318 overlaid over the first picture frame 1308 and the second picture frame 1306 in the three-dimensional environment 1300, respectively. In another example, in FIG. 13B, the computer system 101 displays, via the display generation component 120, virtual object 1324 in response to a determination that the one or more criteria (e.g., described above) are satisfied. Virtual object 1324 is a three-dimensional model corresponding to a boat the user rode during their Philippines travel. For example, the computer system 101 displays virtual object 1324 in accordance with a determination of a recent activity associated with the user of the computer system 101. In FIG. 13B, the computer system displays the virtual object 1324 on top of table 1302 in the three-dimensional environment 1300. In some embodiments, the computer system 101 presents a variety of virtual objects. In some embodiments, the computer system 101 displays, via the display generation component 120, virtual objects associated with recently viewed/opened applications. For example, in FIG. 13B, the computer system 101 determined that the user recently viewed and/or interacted with a flight tracking application, and in accordance with this determination, the computer system 101 displays, via the display generation component 120, virtual object 1326 of the flight tracking application that includes a subset or targeted information, such as flight status information without displaying an entire user interface for the flight tracking application.

In some embodiments, the computer system 101 removes, adds, and/or replaces one or more virtual objects displayed in the three-dimensional environment 1300. For example, in FIG. 13B, the computer system 101 detects user input that includes an air pinch gesture 1330a (e.g., described in more detail in method(s) 800, 1000, 1200, and/or 1400) while attention 1328a (e.g., gaze) of the user of the computer system 101 is directed to the second recommended media content 1320b that includes a movie about Paris. In response to detecting this user input, the computer system 101 performs an action to play the media item 1334 associated with the second recommended media content 1320 via the television display 1310, as shown in FIG. 13C. In some embodiments, while and/or in response to playing the media item 1334, the computer system 101 replaces the one or more virtual objects displayed prior to performing the action to play the media item 1334. For example, and as shown in FIG. 13C, in response to detecting the input requesting to play the media item 1334, the computer system 101 replaces virtual objects 1322 and 1318 of FIG. 13B with virtual objects 1336a and 1332, respectively. Virtual objects 1336a and 1332 are images from the web related to media item 1334, such as images of Paris and/or images depicting French culture. In another example, the computer system 101 replaces virtual object 1324 of FIG. 13B with virtual object 1338, as shown in FIG. 13C. Virtual object 1338 is a three-dimensional model of the Eiffel Tower. In some embodiments, the computer system 101 activates and/or configures one or more output devices, such as a smart home device and/or IoT device based on a current time of day at the computer system 101 and/or a location of the user of the computer system 101 as described in more detail with reference to method 1400. For example, in FIG. 13C, virtual clock 1312 indicates a current time at the computer system 101 is 8:00 PM. In FIG. 13C, when the computer system 101 determines that the current time at the computer system 101 is 8:00 PM and that the location of the user of the computer system 101 is in the living room 1314f, the computer system 101 configures a fireplace 1304 to turn on.

In some embodiments, the computer system 101 updates the one or more virtual objects to display information in response to detecting an event as described in method 1400. For example, in FIG. 13C, the computer system 101 detects an event, such as a flight status update from the flight tracking application, and in response to this event, the computer system 101 updates virtual object 1326 to include updated flight status information. In some embodiments, the one or more virtual objects displayed by the computer system is or includes a portal into a simulated view of a respective physical location. For example, in FIG. 13C, the computer system 101 detects user input that includes an air pinch gesture 1330b (e.g., described in more detail in method(s) 800, 1000, 1200, and/or 1400) while attention 1328b (e.g., gaze) of the user of the computer system 101 is directed to a selectable option 1336b that, when selected, causes the computer system 101 to display a portal into a simulated view of a physical location. In response to detecting this user input directed to the selectable option 1336b, the computer system 101 displays, via the display generation component 120, a portal into a view 1340a of a physical location that includes the Eiffel Tower as shown in FIG. 13D. In some embodiments, the computer system 101 displays the portal with a respective level of immersion as described in method(s) 1400, 1600, and/or 1800. For example, the computer system 101 optionally displays the portal with a low, medium, or high level of immersion as described in method(s) 1400, 1600, and/or 1800. For example, in FIG. 13D, the computer system 101 displays the portal with a degree of immersion such that the one or more representations of physical objects in the three-dimensional environment are obscured, such as displaying the portal partially obscuring table 1302. In some embodiments, the portal includes a control user interface element 1340b that, when selected, causes the computer system 101 to cease displaying the portal. In some embodiments, the computer system 101 displays the portal with a degree of immersion less than the respective degree of immersion at which the computer system currently displays the portal into the view of the physical location that includes the Eiffel Tower as shown in FIG. 13D and described with reference to method(s) 1400, 1600, and/or 1800.

In some embodiments, the computer system 101 displays, via display generation component 120, one or more virtual objects in the three-dimensional environment 1300 based on a location of the user of the computer system. For example, in FIG. 13E, the computer system 101 detects movement of the user from the first location 1316a corresponding to the living room 1314f to a second location 1316b corresponding to the kitchen 1314e as shown in the overhead view 1314a of the home layout. In some embodiments, and as shown in FIG. 13E, in response to detecting the user 1316 in the second location 1316b corresponding to the kitchen 1314e, the computer system 101 displays, via the display generation component 120, one or more virtual objects, different from the one or more virtual objects displayed when the user of the computer system 101 was located in the living room 1314f. Additionally and/or alternatively, the computer system determines that the user is located in the kitchen 1314e based on one or more recognized objects in the three-dimensional environment. For example, in FIG. 13E, the computer system 101 recognizes a microwave 1342a, a stove 1342d, and an oven 1342c. In some embodiments, the computer system 101 recognizes these objects using one or more object recognition techniques described in more detail with reference to method(s) 1400 and/or 1600. In some embodiments, upon recognizing such objects, the computer system 101 determines and/or confirms that the user is located in the kitchen 1314e.

In some embodiments, the computer system 101 displays, via the display generation component 120, one or more virtual objects based on the determination that the user is located in the kitchen 1314e. In some embodiments, the one or more virtual objects displayed while the user is located in the kitchen 1314e are different from the one or more virtual objects displayed while the user was located in the living room 1314f. For example, in FIG. 13E, the one or more virtual objects displayed by the computer system 101 while the user is located in the kitchen 1314e include virtual objects 1346a and 1344. Virtual object 1344 is optionally a video player of a video application. In some embodiments, the computer system 101 displays virtual object 1344 and automatically plays the video displayed by virtual object 1344. Virtual object 1346a is a widget or user interface element of a notetaking application. In some embodiments, the computer system 101 displays one or more virtual objects based on a state of the user of the computer system. For example, in FIG. 13E, the computer system 101 determines that the user is making croissants. In some embodiments, the computer system 101 determines that the user is making croissants based on croissant objects detected within the three-dimensional environment 1300. In some embodiments, the computer system 101 determines that the user is making croissants based on the video of shaping croissants currently displayed by virtual object 1344. For example, the computer system 101 optionally uses text and/or character recognition to determine the subject matter of the video. In some embodiments, in accordance with the determination that a state of the user is making croissants, the computer system 101 highlights and/or visually emphasizes note 1346b related to croissants, such as shown in FIG. 13E.

Additionally and/or alternatively, and in some embodiments, the computer system 101 displays, via display generation component 120, one or more virtual objects in the three-dimensional environment 1300 based on a current time of day at the computer system 101 as described in more detail with reference to method 1400. For example, in FIG. 13E, virtual clock 1342b indicates a current time at the computer system 101 is 7:00 AM. In FIG. 13E, when the computer system 101 determines that the current time at the computer system 101 is 7:00 AM, the computer system 101 displays, via the display generation component 120, virtual objects 1346a and 1344. In FIG. 13F, the computer system 101 determines that the current time at the computer system 101 is 8:00 AM, and in response to the determination that the current time of day at the computer system 101 is 8:00 AM, the computer system 101 removes, adds, and/or replaces one or more virtual objects displayed in the three-dimensional environment 1300. For example, in FIG. 13F, the computer system 101 ceases to display virtual object 1344, maintains the display of virtual object 1346a, and displays virtual objects 1350 and 1348 that were not previously displayed prior to determining that the current at the computer system 101 is 8:00 AM. Virtual object 1350 is a widget or user interface element of a calendar application and virtual object 1348 is a widget or user interface element of a weather application. In some embodiments, the computer system 101 displays virtual objects 1350 and 1348 irrespective of the current location of the user of the computer system 101. In some embodiments, the computer system 101 updates the virtual clock 1342b continuously or optionally, at pre-determined time intervals other than an hour, such as each second or minute.

In some embodiments, the computer system 101 displays, via the display generation component 120, one or more virtual objects in response to one or more recognized objects in the three-dimensional environment 1300. For example, in FIG. 13F, the computer system 101 recognizes formed croissants 1354 in the three-dimensional environment, in response to detecting the formed croissants 1354, the computer system 101 displays, via the display generation component 120, virtual object 1352 that includes a timer. In some embodiments, the computer system displays the virtual object 1352 based on the virtual object 1346a of the notetaking application. For example, the computer system optionally obtains information from the virtual object 1346 related to starting a timer after forming the croissants. Thus, in some embodiments, the computer system displays virtual object 1352 that includes a timer in response to detecting the formed croissants 1354 and based on information from virtual object 1346. Additionally and/or alternatively, the computer system 101 displays virtual object 1352 in response to user input (e.g., as described above and/or with reference to method 1400) corresponding to a request display virtual object 1352. In some embodiments, the user input does not expressly instruct the computer system 101 to display virtual object 1352. For example, the user input optionally includes a voice command to “start timer” and in response to this user input, the computer system 101 displays virtual object 1352, as shown in FIG. 13F.

In some embodiments, the computer system 101 displays, via the display generation component 120, one or more virtual objects based on one or more user defined settings and/or specifications as described in more detail with reference to method 1400. For example, in FIG. 13G, the computer system 101 detects movement of the user from the second location 1316b corresponding to the kitchen 1314e to a third location 1316c corresponding to the office 1314b as shown in the overhead view 1314a of the home layout. In some embodiments, and as shown in FIG. 13G, in response to detecting the user in the third location 1316c corresponding to the office 1314b, the computer system 101 determines that the location of the user corresponds to the office 1314b. In some embodiments, the computer system 101 determines that the location of the user corresponds to the office based on one or more recognized objects within the three-dimensional environment 1300 of the office 1314b. For example, the computer system 101 detects, using any of the one or more object recognition techniques described in method(s) 1400 and/or 1600, a window 1356, a computer monitor 1358, and a laptop 1360. In some embodiments, and as shown in FIG. 13G, in response to detecting the user in the third location 1316c corresponding to the office 1314b, the computer system 101 displays, via display generation component 120, virtual object 1362a. In some embodiments, the computer system 101 displays virtual object 1362a in accordance with a determination that the environment (e.g., office 1314b) is not configured to display one or more widgets. In some embodiments, the computer system 101 displays virtual object 1362a in response to a user input (e.g., as described above) corresponding to a request to configure the environment to display one or more widgets. In some embodiments, the computer system displays virtual object 1362a irrespective of the location of the user of the computer system 101 (e.g., a determination that the current location of the user of the computer system is the office 1314b). Virtual object 1362a is a widget or user interface element of a room planning application as described in more detail with reference to method 1400. In FIG. 13G, the virtual object 1362a includes content requesting permission from the user of the computer system 101 to access information associated with the office 1314b, such as information associated with one or more configurable output devices (e.g., IoT devices and/or smart devices) as described in method 1400. The virtual object 1362a also includes a first selectable option 1362b that, when selected, causes the computer system 101 to prevent computer system 101's access to the information; and a second selectable option 1362c that, when selected, causes the computer system 101 to allow access to the information. In FIG. 13G, the computer system 101 detects user input that includes an air pinch gesture 1330c (e.g., described in more detail in method(s) 800, 1000, 1200, and/or 1400) while attention 1328c (e.g., gaze) of the user of the computer system 101 is directed to the second selectable option 1362c. In response to detecting this user input, the computer system 101 displays, via the display generation component 120, virtual object or user interface element 1364a, as shown in FIG. 13H.

Virtual object 1362a is a widget or user interface element of the room planning application. In FIG. 13H, virtual object 1362a is interactable to configure one or more output devices within the office 1314b. For example, virtual object 1362a includes content 1364b indicating the one or more devices and/or applications are configurable in the office 1314b. In FIG. 13H, the virtual object 1362a includes a music affordance or user interface element 1364c that, when selected, causes the computer system 101 to toggle between activating and deactivating a music user interface element of the music application. In another example, the music affordance 1354c is selectable to optionally control one or more output devices (e.g., speakers) in the environment via the music application. In yet another example, the music affordance 1354c is selectable to optionally control the music application running on computer system 101 or running on another device within the environment 1300, such as the laptop 1360. The virtual object 1362a also includes a reminders affordance 1364d that, when selected, causes the computer system 101 to toggle activating and deactivating a reminder user interface element of a task management application. In another example, the reminders affordance 1364d is selectable to optionally present reminders on via another device within the environment 1300 other than computer system 101, such as the laptop 1360. In FIG. 13H, the computer system 101 detects user input that includes an air pinch gesture 1330d (e.g., described in more detail in method(s) 800, 1000, 1200, and/or 1400) while attention 1328d (e.g., gaze) of the user of the computer system 101 is directed to the music affordance 1364c. In response to detecting this user input, the computer system 101 ceases to display the virtual object 1362 and displays, via the display generation component 120, a music user interface element 1368, as shown in FIG. 13I. In another example, in response to detecting this user input, the computer system 101 optionally controls playback of a media item (e.g., Song 1) associated with the music user interface element 1368. In some embodiments, the computer system 101 controls playback of the media item at the computer system 101. In some embodiments, the computer system controls playback of the media item via one or more output devices (e.g., speakers) within the environment 1300. In some embodiments, the computer system controls playback of the media item via another device within the environment 1300, such as the laptop 1360. In some embodiments, the computer system 101 ceases to display or displays (e.g., activates or deactivates) one or more virtual objects in accordance with user selected and/or computer configured settings of the room planning application. For example, the computer system 101 determines that the reminders affordance 1364d includes an on/activate value, and in response to this determination, the computer system 101 displays, via the display generation component, a reminder user interface element 1366, as shown in FIG. 13I. In some embodiments, the computer system presents the reminder user interface element 1366 via another device within the environment 1300 other than the computer system 101, such as the laptop 1360.

In some embodiments, the computer system 101 displays, via the display generation component 120, one or more virtual objects, based on information from one or more applications, different from the room planning application or any of the applications with user interface elements or widgets currently displayed and/or activated by the computer system 101. For example, in FIG. 13I, the computer system 101 determines, based on scheduling information from a calendar application, the user of the computer system 101 is scheduled to travel to a location different from the user's current location. In some embodiments, in accordance with this determination, the computer system 101 displays, via the display generation component 120, virtual object 1370, as shown in FIG. 13I. Virtual object 1370 is a widget or user interface element of a train scheduling application or the map application. Additionally and/or alternatively, and in some embodiments, the computer system 101 performs an action associated with the respective widget, such as playing a content item, displaying navigation directions to a destination, and/or other action associated with the respective application.

In some embodiments, method 1400 is performed at a computer system in communication with a display generation component and one or more input devices. In some embodiments, the computer system has one or more of the characteristics of the computer system of method(s) 800, 1000, and/or 1200. In some embodiments, the one or more input devices have one or more of the characteristics of the one or more input devices of method(s) 800, 1000, and/or 1200. In some embodiments, the display generation component has one or more of the characteristics of the display generation component of method(s) 800, 1000, and/or 1200.

In some embodiments, while a three-dimensional environment is visible via the display generation component (1402a), such as three-dimensional environment 1300 visible via display generation component 120 in FIG. 13A, in accordance with a determination that one or more first criteria are satisfied, including a criterion that is satisfied when a location of a user of the computer system is a first physical environment, such as the living room 1314f as shown in the overhead view 1314a in FIG. 13B, the computer system displays (1402b), in the three-dimensional environment, a first user interface element associated with the first physical environment, wherein the first user interface element is a user interface of a map application on the computer system, such as virtual object 1326 in FIG. 13B. In some embodiments, the user interface of the map application has one or more of the characteristics of the user interface of the map application of method(s) 800, 1000, and/or 1200. In some embodiments, the computer system displays the user interface within a three-dimensional environment (e.g., in a manner similar to displaying a virtual object in a three-dimensional environment as described with reference to the scene 105 in FIG. 1A). For example, the three-dimensional environment is optionally generated, displayed, or otherwise caused to be viewable by the computer system (e.g., an extended reality (XR) environment such as a virtual reality (VR) environment, a mixed reality (MR) environment, or an augmented reality (AR) environment). In some embodiments, the three-dimensional environment is visible to a user of the computer system via the display generation component. In some embodiments, the computer system controls how much of the three-dimensional environment is visible as described in more detail with reference to method(s) 800, 1000, and/or 1200. In some embodiments, a physical environment surrounding the display generation component is visible through a transparent portion of the display generation component (e.g., true or real passthrough). In some embodiments, a representation of the physical environment is displayed in the three-dimensional environment via the display generation component (e.g., virtual or video passthrough). In some embodiments, the computer system displays the user interface in the three-dimensional environment that is in the field of view of a user of the computer system from a viewpoint of the user of the three-dimensional environment.

In some embodiments, the criterion is based on a location identifier that represents a physical location of the computer system. For example, a location identifier optionally includes room identifiers associated with a home of the user of the computer system, such as “Living Room,” “Kitchen”, “Bedroom”, “Garage”, “Bathroom”, or other room. In another example, the location identifier optionally includes identifiers associated with a place other than the home of the user, such as a workplace, shopping center, airport, museum, or amusement park. Thus, in some embodiments, the location identifiers include “grocery store,” “work office”, “airport gate”, or “museum exhibit A”. In some embodiments, the computer system detects or determines the location identifier based on Wi-Fi, image recognition, GPS, or other positioning technologies. In some embodiments, the location identifier is used to provide a respective user interface element (e.g., the first user interface element, the second user interface element, or other user interface element described herein or below) associated with the physical environment (e.g., physical location of the computer system). In some embodiments, the first user interface element or optionally, referred to as “widget” is interactable to perform an operation relevant to the physical environment (e.g., to interact with the map application via the widget). Example operations optionally include presenting visual, audible, and/or three-dimensional content or virtual objects, playing a media content item (e.g., music, podcast, video, or other media content item), initiating a communication session with a second user of a second computer system, controlling how much of the representation of the physical environment is displayed to the user of the computer system, and/or other operations as described in more detail below. In some embodiments, the location identifier indicates the user interface element to be displayed (or, optionally, the operation to be performed). For example, a first physical environment (e.g., “Living Room) is optionally an environment for a first type of user activity, such as entertainment, relaxation, and/or socializing. Thus, in some embodiments, the computer system performs an operation that is entertaining, relaxing, and/or facilitates socializing, such as displaying content, playing a movie or music, or other operation. In some embodiments, the computer system determines that the location of the user of the computer system indicates the first physical environment, and in response to determining that the location of the user of the computer system indicates the first physical environment, the computer system displays a first user interface element, such as a photo that is associated with the first physical environment. In some embodiments, the computer system displays the first user interface element automatically (e.g., without detecting or receiving user input).

In some embodiments, the computer system suggests to display the first user interface element based on map information from the map application. For example, in accordance with a determination of first user map activity (e.g., as will be discussed in more detail below), the computer system optionally displays the first user interface element associated with the first user map activity. In another example, in accordance with a determination of second user map activity, different from the first user map activity, the computer system optionally displays a second user interface element associated with the user map activity. In another example, displaying the respective user interface element includes an option that, when selected, causes the computer system to perform an operation as will be described in more detail below, such as play media content (e.g., move, music, podcast, or other media content item) related to the respective user map activity. Other examples of displaying the first user interface element or performing an operation associated with the first user interface element in response to determining that the location of the user of the computer system indicates a respective physical environment is described below. In some embodiments, the user interface element is a user interface element of the map application or an application different from the map application, such as a messaging application, a photo application, a media content application, a fitness application, a notes application, or other application. In another example, the computer system suggests to display the first user interface element based on information from an application, different from the map application, such as a media content application. For example, in accordance with a determination of first user media content activity (e.g., as will be discussed in more detail below), the computer system optionally displays the first user interface element associated with the first user media content activity. In another example, in accordance with a determination of second user media content activity, different from the first user media content activity, the computer system optionally displays a second user interface element associated with the user media content activity.

In some embodiments, while the three-dimensional environment is visible via the display generation component (1402a), in accordance with a determination that one or more second criteria are satisfied, including a criterion that is satisfied when the location of the user of the computer system is a second physical environment, different from the first physical environment, such as office 1314b in FIG. 13I, the computer system displays (1402c), in the three-dimensional environment, a second user interface element associated with the second physical environment, wherein the second user interface element is different from the first user interface element and is a user interface of the map application on the computer system, such as virtual object 1370 in FIG. 13I. It is understood that although the embodiments described herein are directed to the first user interface element, such functions and/or characteristics, optionally apply to other user interface elements including the second user interface element. In some embodiments, the second physical environment is optionally an environment for a second type of user activity, different from the first type of user activity associated with the first physical environment (e.g., “Living Room) described above. In some embodiments, and as will be described in more detail below, the computer system displays a respective user interface element based on one or more inferred user activities derived from the environment (e.g., “Kitchen,” “Bedroom”, “Bathroom”, “Office”, “Nursery” or other predetermined room). For example, in accordance with a determination that the second physical environment (e.g. “Kitchen”) is optionally an environment for a second type of user activity (e.g., preparing, cooking, and/or storing food), the computer system displays the second user interface element associated with the second type of user activity as will be described in more detail below. In another example, in accordance with a determination the second physical environment is optionally an environment for a third type of user activity (e.g., eating and/or socializing), different from the second type of user activity, the computer system displays a third user interface element associated with the third type of user activity as will be described in more detail below. In some embodiments, the computer system determines that the one or more respective criteria are satisfied in response to a change in the physical location of the user as will be described in more detail below. In some embodiments, the computer system determines that the one or more respective criteria are satisfied in response to detecting a physical object in the environment that corresponds to the respective physical environment. For example, the computer system captures and recognizes a stove, microwave, refrigerator, or other appliance found in the “Kitchen”, and determines that the location of the user of the computer system indicates the “Kitchen”. In some embodiments, the computer system determines that the one or more respective criteria are satisfied in response to detecting user input setting the location of the user of the computer system to the “Kitchen”. In some embodiments, the computer system displays a same user interface element independent of the respective physical environment. For example, the computer system optionally plays a video tutorial related to cooking in the “Kitchen” and “Living Room”. Automatically displaying a respective user interface element based on one or more respective criteria that is based on a determined physical environment of the user of the computer system provides an efficient way of presenting supplemental content and/or relevant functionality, which avoids additional interaction between the user and the computer system associated with the user performing additional inputs to locate and present such user interface elements associated with the physical environment, which enhances operability of the computer system, reduces power usage of the computer system, reduces errors in the interaction between the user and the computer system, and reduces inputs needed to correct such errors.

In some embodiments, the computer system displays a respective user interface element (of the first and/or second user interface elements) at a location corresponding to a physical object within the three-dimensional environment, such as virtual object 1322 displayed at a location corresponding to the first picture frame 1308 in FIG. 13B. In some embodiments, the respective user interface element includes three-dimensional content (e.g., representations of buildings, transportation vehicles, boardgames, volumetric maps, or other models optionally contained within a volume user interface element) and/or two-dimensional content (e.g., photos, webpages, notes, calendars, or other content optionally contained within a window user interface element). In some embodiments, the physical object includes a flat plane and when displaying the respective user interface element, the computer system utilizes the flat plane of the physical object (e.g., aligns the respective user interface element with the flat plane of the physical object). For example, the physical object is optionally a wall, a picture frame, a whiteboard, a physical display (e.g., television display or computer monitor), a window, a table, or other physical object with a flat plane. In some embodiments, the respective user interface element is overlaid on the physical object. In some embodiments, the computer system anchors the respective user interface element to the physical object. In some embodiments, the computer system displays the respective user interface element having a size and/or scale corresponding to the physical object. In some embodiments, the computer system detects that the physical object has moved from a first location to a second location. In some embodiments, in response to detecting that the physical object has moved from the first location to the second location, the computer system moves the respective user interface element to a location corresponding to the second location of the physical object. In some embodiments, the computer system displays the respective user interface element at the location corresponding to the physical object within the three-dimensional environment automatically, without detecting user input to display the respective user interface element at the location. In some embodiments, the computer system displays the respective user interface element at location that does not correspond to a physical object. For example, the computer system displays the respective user interface element at a location or area within the three-dimensional environment not occupied by other user interface elements. Automatically displaying a respective user interface element at a location corresponding to a physical object within the three-dimensional environment seamlessly blends the respective user interface element into the three-dimensional environment in a less disruptive way and without cluttering the three-dimensional environment (e.g., by not taking up limited display space for displaying the respective user interface element), which enhances operability of the computer system, reduces power usage of the computer system, provides a more intuitive user experience which reduces errors in the interaction between the user and the computer system, reduces inputs needed to correct such errors, and provides more efficient interactions between the user and the computer system.

In some embodiments, displaying a respective user interface element (of the first and/or second user interface elements) includes in accordance with a determination that a respective physical environment includes a first layout, such as the layout in FIG. 13B that includes a first picture frame 1308 and a second picture frame 1306 on the wall of living room 1314f, displaying the respective user interface element with a first spatial arrangement relative to the respective physical environment that is based on the first layout, such the spatial arrangement in which the computer system displays virtual objects 1322 and 1318 at locations corresponding to the first picture frame 1308 and the second picture frame 1306 in FIG. 13B, respectively. In some embodiments, the first layout of the respective physical environment refers to a configuration of the respective physical environment (e.g., a manner in which walls, furniture, or other physical objects are positioned in the respective physical environment). In some embodiments, displaying the respective user interface element with the first spatial arrangement relative to the respective physical environment that is based on the first layout includes displaying the respective user interface element at a first location and/or with a first orientation relative to a physical object or frame of reference (optionally, other than the viewpoint of the user) in the respective physical environment (e.g., wall, horizon, ceiling, furniture, or other physical object described above in the respective physical environment). In some embodiments, the first layout includes an amount of display space for displaying one or more respective user interface elements. In some embodiments, displaying the respective user interface element with the first spatial arrangement includes displaying the respective user interface element at a first location and/or with a first orientation that does not obscure another user interface element and/or a physical object in the respective physical environment. In some embodiments, the first location and/or the first orientation of the respective user interface element partially obscures another user interface element and/or the physical object. In some embodiments, when displaying the respective user interface element with the first spatial arrangement, the computer system considers one or more of the factors mentioned herein, such as the configuration, amount of display space, and/or the mood of the respective physical environment as will be described in more detail below. In some embodiments, the respective user interface element includes the first layout and one or more other layouts, such as the second layout or other layout described below. In some embodiments, the first layout (optionally, including the second layout or other layout described below) includes a respective specification that includes information related to the configuration, amount of display space, and/or the mood of the respective physical environment. In some embodiments, the specification includes one or more control settings information for configuring one or more output devices (e.g., lights, locks, cameras, thermostats, or other output device described in more detail below). In some embodiments, the specification is associated with a home automation application (e.g., described in more detail below), different from the respective application associated with the respective user interface element and/or the application associated with displaying the respective user interface element with the first spatial arrangement. In some embodiments, the computer system displays the respective user interface element with the first spatial arrangement relative to the respective physical environment that is based on the first layout automatically, without detecting user input to display the respective user interface element with the first spatial arrangement. In some embodiments, the computer system displays the respective user interface element with a spatial arrangement other than the first spatial arrangement, such as a second spatial arrangement described below or another spatial arrangement. For example, the computer system optionally displays the respective user interface element with another spatial arrangement relative to the viewpoint of the user, such as a location centered in front of the user of the computer system and/or with an orientation facing towards the user. In some embodiments, the computer system displays the respective user interface element with a different spatial arrangement in response to a change in contextual information (e.g., location, position, and/or orientation of the user of the computer system; time of day; attention of the user; presence of one or more other user interface elements; display space; or another factor described below).

In some embodiments, displaying the respective user interface element includes in accordance with a determination that the respective physical environment includes a second layout, different from the first layout, such as the layout in FIG. 13I that includes laptop 1360 in the office 1314b, displaying the respective user interface element with a second spatial arrangement relative to the respective physical environment that is based on the second layout, such the spatial arrangement in which the computer system displays virtual objects or user interface elements 1370, 1366, and 1368 at respective locations that do not obstruct a view of the laptop 1360 in FIG. 13I. In some embodiments, the second layout is associated with a second configuration, different from the respective configuration associated with the first layout, a second amount of display space larger or smaller than the respective amount of display space associated with the first layout, and/or a second mood or theme, different from the respective mood or theme associated with the first layout. In some embodiments, the second layout is associated with a physical environment that is different from a respective physical environment associated with the first layout. In some embodiments, the first layout and the second layout are associate with a same physical environment. It is understood that although the embodiments described herein are directed to displaying the respective user interface element with the first spatial arrangement, such functions and/or characteristics optionally apply to other spatial arrangements, such as the second spatial arrangement. For example, the second spatial arrangement optionally includes displaying the respective user interface element at a second location, with a second orientation, with a second color, second amount of lighting, second degree of opacity, or other second visual effect, different from the respective location, orientation, color, lighting, opacity, or visual effect associated with displaying the respective user interface element with the first spatial arrangement. In some embodiments, the computer system detects user input corresponding to a request to display the respective physical environment with the first spatial arrangement, the second spatial arrangement, or other spatial arrangement described herein or below. In some embodiments, the user input includes a gaze of a user of the computer system, a contact on a touch-sensitive surface, actuation of a physical input device, a predefined gesture (e.g., pinch gesture or air tap gesture) and/or a voice input from the user directed to a respective user interface element that is interactable to display the respective user interface element with the respective spatial arrangement. For example, while the computer system displays the respective user interface element with the second spatial arrangement, the computer system optionally detects user input corresponding to a request to display the respective user interface element with the first spatial arrangement. In some embodiments, in response to the request, the computer system changes the display of the respective user interface element from the second spatial arrangement to displaying the respective user interface element with the first spatial arrangement. In some embodiments, the computer system automatically selects a respective spatial arrangement based on detecting the respective physical environment automatically, without detecting or requiring user input to select the spatial arrangement and/or identify the respective physical environment. Automatically displaying a respective user interface element with a respective spatial arrangement relative to a respective physical environment that is based on a respective layout in accordance with a determination that the respective physical environment includes a respective layout provides automatic display of the respective user interface element that aligns with the respective physical environment, enhancing the spatial characteristics of the respective physical environment without requiring additional input requesting to display the respective user interface element with the respective spatial arrangement, which avoids additional interaction between the user and the computer system associated with the user performing additional inputs to spatially arrange the respective user interface element, thereby reducing errors in the interaction between the user and the computer system, reducing inputs needed to correct such errors, reducing potential user error with such inputs, saving time, battery, and power consumption.

In some embodiments, displaying a respective user interface element (of the first and/or second user interface elements) includes in accordance with a determination that a current time of day at the computer system is a first time of day, such as the time of day indicated by virtual clock 1312 in FIG. 13B, the respective user interface element includes first content, such as the content included in virtual object 1326 in FIG. 13B. In some embodiments, displaying a respective user interface element includes in accordance with a determination that the current time of day at the computer system is a second time of day, such as the time of day indicated by virtual clock 1312 in FIG. 13C, the respective user interface element includes second content, such as content included in virtual object 1326 in FIG. 13C. In some embodiments, the first time of day, the second time of day, or other time of day described herein and/or below is set at the computer system automatically based on a physical location of the computer system. In some embodiments, the respective time of day is set at the computer system automatically based on a predefined location, different from the physical location of the computer system. In some embodiments, the predefined location is set by the user of the computer system. In some embodiments, the respective time of day includes the morning, afternoon, evening, nighttime, or other time of day. In some embodiments, various times of day or periods of time throughout the day are associated with various content. In some embodiments, the first content includes one or more first events from a calendar application corresponding to the first time of day. In some embodiments, the second content includes one or more second event, different from the one or more first events, and corresponding to the second time of day. In some embodiments, the first content includes a first color, first style, or first visual effect, different from a second color, second style, or second visual effect associated with the second content. In some embodiments, the computer system determines a current time passing within one of these various periods of time. For example, the current time of day at the computer system optionally refers to a time at the computer system that is optionally based on the physical location of the computer system or the predefined location of the computer system. For example, the first time of day is optionally during a first time period associated with the first content and a second time of day is optionally during a second time period associated with second content. In some embodiments, the computer system determines a current time passing within one of these various periods of time (e.g., between a first period of time and second period of time both within a respective time period associated with the first content), and in response, the computer system does not update the respective user interface element that includes the first content. In some embodiments, the computer system determines a current time passing within one of these various periods of time (e.g., between a first period of time associated with the first content and second period of time both associated with the second content), and in response, the computer system updates the respective user interface element to include the second content. In some embodiments, the computer system displays the respective user interface element including the first content or the second content automatically, without detecting user input to display the respective user interface element including the first content or the second content. In some embodiments, the computer system detects user input corresponding to a request to select the first time of day, the second time of day, or other time of day described herein and/or below. In some embodiments, the user input includes one or more characteristics of other user inputs described above and/or below. In some embodiments, a respective time of day corresponds to a system appearance setting, such as a display setting or color scheme of the computer system. For example, the system appearance setting includes a light mode where the computer system displays the respective user interface element including respective content having darker colored text against a lighter colored background. In some embodiments, the system appearance setting includes a dark mode where the computer system displays the respective user interface element including respective content having lighter colored text against a darker colored background. In some embodiments, applying the system appearance setting described herein is irrespective of the current time of day at the computer system. Automatically displaying the respective user interface element including respective content according to a current time of day at the computer system provides content that matches the current time of day without requiring additional input requesting to update the content, which avoids additional interaction between the user and the computer system associated with the user performing additional inputs to look up the time of day and/or change the respective user interface element to include content what is appropriate for the time of day while avoiding unnecessary use of resources (e.g., by not displaying content unless necessary or appropriate as defined by the time of day), thereby reducing errors in the interaction between the user and the computer system, reducing inputs needed to correct such errors, reducing potential user error with such inputs, saving time, battery, and power consumption.

In some embodiments, while the three-dimensional environment is visible via the display generation component, such as three-dimensional environment 1300 displayed via the display generation component 120 in FIG. 13E, in accordance with a determination that one or more third criteria are satisfied, including a criterion that is satisfied when a current time of day at the computer system is a first time of day, such as the time of day indicated by virtual clock 1342b in FIG. 13E, the computer system displays, in the three-dimensional environment, a third user interface element associated with the first time of day without displaying a fourth user interface element associated with a second time of day, such as displaying virtual object 1344 in FIG. 13E without displaying virtual object 1350 shown in FIG. 13F.

In some embodiments, while the three-dimensional environment is visible via the display generation component, in accordance with a determination that one or more fourth criteria are satisfied, including a criterion that is satisfied when the current time of day at the computer system is a second time of day, different from the first time of day, such as the time of day indicated by virtual clock 1342b in FIG. 13F, the computer system displays, in the three-dimensional environment, the fourth user interface element associated with the second time of day without displaying the third user interface element associated with the first time of day, such as displaying virtual object 1350 in FIG. 13F without displaying virtual object 1344 in FIG. 13E. In some embodiments, in accordance with the determination that one or more respective criteria (of the third and/or fourth criteria) are satisfied as described herein, the computer system forgoes displaying the respective user interface element (of the third and/or fourth user interface element) associated with the respective time of day (of the first time of day and/or the second time of day). For example, when the current time is within a predetermined time range, the electronic device forgoes presenting the third user interface element and forgoes presenting the fourth user interface element. Optionally, when the current time is within the predetermined time range, the electronic device forgoes presenting any widget elements. In some embodiments, various times of day or periods of time throughout the day are associated with various respective user interface elements. For example, the first time of day is optionally during a first time period associated with the third user interface element and a second time of day is optionally during a second time period associated with a second user interface element. In some embodiments, the computer system determines a current time passing within one of these various periods of time as described above. In some embodiments, determining that a current time of day at the computer system is a first time of day has one or more characteristics of determining that a current time of day at the computer system is a first time of day, a second time of day, or other time of day described above. In some embodiments, the third user interface element and/or the fourth user interface element includes one or more characteristics of the first user interface element, the second user interface element and/or another user interface element as described above and/or below. In some embodiments, the third user interface element is a user interface element of a first application. In some embodiments, the fourth user interface element is a user interface element of a second application, different from the first application. In some embodiments, the fourth user interface element is a user interface element of the first application. In some embodiments, the first application and/or the second application is a map application or other application described above and/or below. In some embodiments, in accordance with a determination that the current time of day is a third time of day, different from the first time of day and the second time of day, the computer system ceases to display the second user interface element and the third user interface element. In some embodiments, the computer system displays the third user interface element associated with the first time of day without displaying the fourth user interface element associated with the second time of day automatically, without detecting user input to display the third user interface element associated with the first time of day (and optionally, without detecting user input to cease displaying the fourth user interface element associated with the second time of day). In some embodiments, the computer system displays the fourth user interface element associated with the second time of day without displaying the third user interface element associated with the first time of day automatically, without detecting user input to display the fourth user interface element associated with the second time of day (and optionally, without detecting user input to cease displaying the third user interface element associated with the first time of day). In some embodiments, the computer system detects user input (e.g., as described above) corresponding to a request to display the third user interface element when the current time of day at the computer system is the second time of day. In some embodiments, in response to detecting the user input, and in accordance with a determination that the current time of day at the computer system is the second time of day, the computer system displays the third user interface element. In some embodiments, displaying the third user interface element includes displaying the fourth user interface element associated with the second time of day. In some embodiments, displaying the third user interface element includes ceasing to display the fourth user interface element. Thus, in some embodiments, the computer system receives user input to display a respective user interface element at a respective time of day, different from an associated (or, optionally, predefined) time of day at which the computer system is configured to display the respective user interface element. Automatically displaying a respective user interface element associated with a respective time of day according to a current time of day at the computer system provides a respective user interface element that matches the current time of day without requiring additional input requesting to display the respective user interface element, which avoids additional interaction between the user and the computer system associated with the user performing additional inputs to look up the time of day and/or change the respective user interface element to what is appropriate for the time of day while avoiding unnecessary use of resources (e.g., by not displaying the respective user interface element unless necessary or appropriate as defined by the time of day), thereby reducing errors in the interaction between the user and the computer system, reducing inputs needed to correct such errors, reducing potential user error with such inputs, saving time, battery, and power consumption.

In some embodiments, while displaying a respective user interface element (of the first and/or second user interface elements) including first content, such as the content included in the virtual object 1326 in FIG. 13B, the computer system detects, via the one or more input devices, an event, such as a flight status updated associated with virtual object 1326 in FIG. 13B. In some embodiments, displaying the respective user interface element including first content has one or more characteristics of displaying the respective user interface element including first content described above. In some embodiments, the event optionally includes new or updated information associated with an application operating on the computer system. In some embodiments, the event is associated with a respective user interface element including respective content as described herein. In some embodiments, the computer system displays the first content without displaying the second described below. In some embodiments, the application operating on the computer system is a map application, a flight tracking application, a public transit navigation application, or other application described above and/or below.

In some embodiments, in response to detecting the event, in accordance with a determination that the event indicates displaying second content, the computer system displays the respective user interface element including the second content without displaying the first content, such as the content included in virtual object 1326 in FIG. 13C without displaying the content included in the virtual object 1326 in FIG. 13B.

In some embodiments, in response to detecting the event, in accordance with a determination that the event does not indicate displaying the second content, the computer system maintains the display of the first content without displaying the second content, such as maintaining the display of the content included in the virtual object 1326 in FIG. 13B without displaying the content included in the virtual object 1326 in FIG. 13C. In some embodiments, the second content is different from the first content. In some embodiments, the second content is more recent than the first content. In some embodiments, displaying the respective user interface element including the second content includes one or more characteristics of displaying the respective user interface element including the first content or other content described above and/or below. In some embodiments, the computer system displays the second content without displaying the first content in accordance with a determination that the event indicates displaying the second content automatically, without detecting user input to display the second content (and optionally, without detecting user input to cease displaying the first content). In some embodiments, the computer system does not display the respective user interface element including the second content until the computer system detects the event that indicates displaying the second content. In some embodiments, the event including information about the event and associated content is retrieved from a remote server in communication with the computer system and/or a local processor (e.g., maintained by the computer system optionally from an application operating on the computer system) for retrieving information including events indicative of displaying respective content. In some embodiments, the event is received from another computer system, different from the computer system. In some embodiments, the event is caused or triggered based on one or more criteria evaluated by the computer system and optionally independent from communication from other computer systems. In some embodiments, the one or more criteria includes criterion that is satisfied based on the time of day; screentime; location; or other user interface element, content, and/or application being displayed by or operating on the computer system; or one or more settings of the computer system. Automatically displaying a respective user interface element including respective content according to an event indicative of displaying the respective content provides a respective user interface element that matches the event without requiring additional input requesting to display the respective user interface element including the respective content, which avoids additional interaction between the user and the computer system associated with the user performing additional inputs to look up the event or a status of the event and/or change the respective user interface element to what is appropriate for the status of the event while avoiding unnecessary use of resources (e.g., by not displaying the respective user interface element including respective content unless necessary or appropriate as defined by the event), thereby reducing errors in the interaction between the user and the computer system, reducing inputs needed to correct such errors, reducing potential user error with such inputs, saving time, battery, and power consumption.

In some embodiments, while the three-dimensional environment is visible via the display generation component, such as the three-dimensional environment 1300 displayed with the display generation component 120 in FIG. 13C, in accordance with a determination that one or more third criteria are satisfied, including a criterion that is satisfied when a user state indicates a first user state, such as a state of the user relaxing in living room 1314 and viewing content in FIG. 13C, the computer system displays, in the three-dimensional environment, a third user interface element associated with the first user state without displaying, in the three-dimensional environment, a fourth user interface element associated with a second user state, such as displaying media item 1334 in FIG. 13C without displaying virtual object 1350 related to a calendar application as shown in FIG. 13F. In some embodiments, the user state includes an activity of a user; a location of a user; a level of engagement or interaction of the user with the computer system, a second computer system, different from the computer system, a user in the three-dimensional environment, or an object in the three-dimensional environment; an intention of the user as inferred by the computer system; and/or an attention (e.g., gaze) of the user. In some embodiments, the user state includes a state of the computer system that is based on one or more functions and/or applications being performed and/or running at the computer system. In some embodiments, various states of the user are associated with various respective user interface elements. In some embodiments, the computer system determines the user state using one or more the input devices described above. In some embodiments, the computer system determines the user state based on the attention of the user, a location of the user, a schedule of the user, one or more applications operating on the computer system, one or more output devices or recognized objects in the three-dimensional environment, and/or one or more physiological characteristics of the user. In some embodiments, the computer system determines the location of the user based on Wi-Fi, image recognition, GPS, or other positioning technologies described above.

In some embodiments, while the three-dimensional environment is visible via the display generation component, in accordance with a determination that one or more fourth criteria are satisfied, including a criterion that is satisfied when the user state is the second user state, different from the first user state, such as a state of the user cooking in the kitchen 1314e in FIG. 13F, the computer system displays, in the three-dimensional environment, the fourth user interface element associated with the second user state without displaying, in the three-dimensional environment, the third user interface element associated with a first user state, such as displaying virtual object 1352 related to a timer without displaying media item 1334 shown in FIG. 13C. In some embodiments, the fourth user interface element is different from the third user interface element. In some embodiments, the fourth user interface element is associated with a first application. In some embodiments, the third user interface element is associated with a second application that is the same or different from the first application. In some embodiments, displaying the fourth user interface element or the third user interface element includes one or more characteristics of displaying the first user interface element or other user interface element described above and/or below. In some embodiments, the computer system displays the third user interface element without displaying the fourth user interface element in accordance with a determination that the user state is the first user state automatically, without detecting user input to display the third user interface element (and optionally, without detecting user input to cease displaying the fourth user interface element). In some embodiments, the computer system displays the fourth user interface element without displaying the third user interface element in accordance with a determination that the user state is the second user state automatically, without detecting user input to display the fourth user interface element (and optionally, without detecting user input to cease displaying the third user interface element). In some embodiments, the computer system detects user input (e.g., as described above) corresponding to a request to display the fourth user interface element when the user state is the first user state. In some embodiments, in response to detecting the user input, and in accordance with a determination that the user state is the first user state, the computer system displays the fourth user interface element. In some embodiments, displaying the fourth user interface element includes displaying the third user interface element associated with the first user state. In some embodiments, displaying the fourth user interface element includes ceasing to display the third user interface element. Thus, in some embodiments, the computer system receives user input to display a respective user interface element when the user state is a respective user state, different from an associated (or, optionally, predefined) user state at which the computer system is configured to display the respective user interface element. Automatically displaying a respective user interface element associated with a respective user state according to a determined user state provides a respective user interface element that matches the user state without requiring additional input requesting to display the respective user interface element, which avoids additional interaction between the user and the computer system associated with the user performing additional inputs to change the respective user interface element to what is appropriate for the user state while avoiding unnecessary use of resources (e.g., by not displaying the respective user interface element unless necessary or appropriate as defined by the user state), thereby reducing errors in the interaction between the user and the computer system, reducing inputs needed to correct such errors, reducing potential user error with such inputs, saving time, battery, and power consumption.

In some embodiments, while the three-dimensional environment is visible via the display generation component, the computer system detects, via the one or more input devices, user input corresponding to a request to activate a third user interface element, such as user input including air pinch gesture 1330c while attention 1328c of the user of the computer system 101 is directed to selectable option 1362c in FIG. 13G. In some embodiments, the third user interface element is associated with a map applications or a home automation application. In some examples, one or more second computer systems, different form the computer system, that are in communication with the computer system and/or are proximate to the computer system are predetermined based on information accessed from the home automation application. In some embodiments and as will be described in more detail below, the computer system displays a respective user interface element to control the one or more second computer systems or electronic devices. In some embodiments, the user input corresponding to the request to activate the third user interface element has one or more characteristics of any of the user inputs described above and/or below. In some embodiments, the request to activate the third user interface element includes initiating or running the respective application associated with the third user interface element, displaying the third user interface element and/or one or more respective user interface elements associated with the third user interface element, and/or other action as described below.

In some embodiments, in response to detecting the user input, the computer system displays, via the display generation component, a fourth user interface element, such as user interface element 1364a in FIG. 13H, that, when selected, causes the computer system to identify the location of the user of the computer system, such as the location of the user corresponding to the office 1314b as shown in overhead view 1314a in FIG. 13H and display one or more fifth user interface elements associated with a respective physical environment corresponding to the location of the user of the computer system, such as user interface elements (e.g., music affordances 1364c and 1364d) in FIG. 13H and/or virtual objects (e.g., user interface elements 1370, 1366, and 1368) in FIG. 13I. In some embodiments, the fourth user interface element has one or more characteristics of the third user interface element or other user interface element described above and/or below. For example, the fourth user interface element is optionally a user interface element of a home automation application. In some embodiments, identifying the location of the user is based on detection of the one or more second computer systems or electronic devices described above. In some embodiments, identifying the location of the user is based on Wi-Fi, image recognition, GPS, or other positioning technologies described above. In some embodiments, the one or more fifth user interface elements include one or more characteristics of any of the user interface elements described above and/or below. In some embodiments, displaying the one or more fifth user interface elements include one or more characteristics of displaying any of the user interface elements described above and/or below. For example, the one or more fifth user interface elements are spatially placed within the three-dimensional environment, anchored to one or more physical objects within the three-dimensional environment, and/or presented in a manner (e.g., degree of lighting, size, color, position, orientation, and/or visual effect described above) complementary to the respective physical environment as described above. In some embodiments, the manner in which the computer system displays the one or more fifth user interface elements is based on a mood or theme of the respective physical environment (e.g., design, colors, and/or lighting). In some embodiments, the computer system displays the one or more fifth user interface elements with a first color, first amount of lighting, first degree of opacity, or other first visual effect that complements the mood of the respective physical environment as described herein and above. In some embodiments, in accordance with a determination that one or more respective criteria are not satisfied including a criterion that is satisfied when the computer system identifies the location of the user, the computer system forgoes displaying the one or more fifth user interface elements associated with the respective physical environment corresponding to the location of the user of the computer system. In some embodiments, the computer system does not initiate the process to identify the location of the user without detecting the user input corresponding to the request to activate the third user interface element. In some embodiments, the computer system identifies the location of the user and/or displays the one or more fifth user interface elements associated with the respective physical environment corresponding to the location of the user of the computer system automatically, without detecting user input to identify the location of the user (and optionally, without detecting user input to display the one or more fifth user interface elements). Automatically identifying the location of the user and/or displaying the one or more fifth user interface elements associated with the respective physical environment corresponding to the location of the user of the computer system in response to detecting user input corresponding to a request to activate a third user interface element provides respective user interface elements that match the location of the user without requiring additional input requesting to display the respective user interface elements, which avoids additional interaction between the user and the computer system associated with the user performing additional inputs to set the location of the user and/or change the respective user interface elements to what is appropriate for the location while avoiding unnecessary use of resources (e.g., by not displaying the respective user interface elements unless necessary or appropriate as defined by the location), thereby reducing errors in the interaction between the user and the computer system, reducing inputs needed to correct such errors, reducing potential user error with such inputs, saving time, battery, and power consumption.

In some embodiments, displaying a respective user interface element (of the first and/or second user interface elements) includes in accordance with a determination that the respective user interface element is a first type of user interface element, ceasing to display the respective user interface element after a predetermined period of time, such as virtual object 1344 in FIG. 13E that is no longer displayed after the predetermined period of time. In some embodiments, the first type of user interface element is an ephemeral user interface element (e.g., the user interface element is displayed for a predetermined period of time (e.g., 1 minute, 5 minutes, 10 minutes, 20 minutes, 30 minutes, 60 minutes, 8 hours, 24 hours, or 48 hours) before being removed)). In some embodiments, the predetermined period of time is set by the user. In some embodiments, the computer system ceases to display the respective user interface element after the predetermined period of time automatically, without detecting user input to cease displaying the respective user interface element. In some embodiments, the computer system detects user input (e.g., as described above) corresponding to a request to turn off the computer system or remove the computer system or disengage with the computer system and in response, the computer system ceases to display the respective user interface element. In some embodiments, the computer system detects a second user input (e.g., as described above) corresponding to a request to turn on the computer system, put on the computer system, or engage with the computer system, deactivate the computer system, and in response, the computer system displays the respective user interface element at the same position (e.g., location, orientation, and/or spatial arrangement) prior to receiving the user input corresponding to the request to turn off the computer system. In some embodiments, user interface elements other than the respective user interface element are not redisplayed by the computer system when the computer system is turned back on or reactivated.

In some embodiments, displaying a respective user interface element includes in accordance with a determination that the respective user interface element is a second type of user interface element, different from the first type of user interface element, forging ceasing to display the respective user interface element after the predetermined period of time, such as virtual object 1326 in FIG. 13B that the computer system continues to display after the predetermined period of time. In some embodiments, the second type of user interface element is a persistent user interface element (e.g., the user interface element is persistently displayed and is independent of the location of the user). In some embodiments, the computer system maintains the display of the respective user interface element until the computer system detects user input corresponding to or requesting the removal of the respective user interface element. In some embodiments, even if the location of the user changes, the respective user interface element is displayed. In some embodiments, the computer system changes the respective user interface element from the first type of user interface element to the second type of user interface element or vice versa in response to user input. Providing different types of user interface elements that are removed after a predetermined period of time reduces the number of user interface elements that are displayed which saves display space, increases performance, and enhances operability of the computer system.

In some embodiments, while the three-dimensional environment is visible via the display generation component, such as the three-dimensional environment 1300 displayed via the display generation component 120 in 13B, in accordance with a determination that one or more third criteria are satisfied, including a criterion that is satisfied when the location of the user of the computer system is a third physical environment, such as the living room 1314f as shown in the overhead view 1314a in FIG. 13B, the computer system displays, in the three-dimensional environment, a third user interface element associated with the third physical environment, wherein the third user interface element is a user interface of an application on the computer system, different from the map application, such as displaying virtual objects 1322 and 1318 of a photo management application in FIG. 13B. In some embodiments, the third physical environment has one or more characteristics of the first physical environment, the second physical environment, or other physical environment described above and/or below. In some embodiments, the user interface of the application on the computer system, different from the map application, is a media content (e.g., photos, videos, podcasts, electronic books, and/or music) application, a task management application, a calendar application, a videotelephony application, a gaming application, a content sharing application, and/or other application described above and/or below. In some embodiments, the third user interface element has one or more characteristics of any of the user interface elements described above and/or below. In some embodiments, displaying the third user interface element includes one or more characteristics of displaying any of the user interface elements described above and/or below. In some embodiments, while the computer system displays the third user interface element, the computer system displays a fourth user interface element that is associated with the third physical environment. In some embodiments, the fourth user interface element is a user interface element of a second application, different from the application associated with the third user interface element and the map application. In some embodiments, the computer system automatically displays the third user interface element and/or the fourth user interface element without detecting user input to display the third user interface element and/or the fourth user interface element (and optionally, without detecting user input to initiate or run the respective application(s) associated with the third user interface element and the fourth user interface element). In some embodiments, in accordance with a determination that the one or more criteria are not satisfied, the computer system forgoes displaying the third user interface element. In some embodiments, the third user interface element is a user interface of the map application and includes content associated with an application different from the map application as described herein. Thus, in some embodiments, the third user interface element of the map application includes content other than map-specific content. Automatically displaying a respective user interface element based on one or more respective criteria that is based on a determined physical environment of the user of the computer system provides an efficient way of presenting supplemental content and/or relevant functionality, which avoids additional interaction between the user and the computer system associated with the user performing additional inputs to locate and present such user interface elements associated with the physical environment, which enhances operability of the computer system, reduces power usage of the computer system, reduces errors in the interaction between the user and the computer system, and reduces inputs needed to correct such errors.

In some embodiments, while displaying a respective user interface element (of the first and/or second user interface elements), the computer system detects, via the one or more input devices, user input directed to the respective user interface element, such as user interface element 1364a in FIG. 13H. In some embodiments, in response to detecting the user input directed to the respective user interface element, in accordance with a determination that one or more third criteria are satisfied, including a criterion that is satisfied when the respective user interface element is in communication with an output device, the computer system causes an adjustment, via the output device, to the respective physical environment, such turning on the fireplace 1304 in FIG. 13C. In some embodiments, the respective user interface element is a user interface element of a home automation application as described in more detail below. In some embodiments, the output device includes smart home devices and/or Internet of things (IoT) devices, such as air conditioners, air purifiers, cameras, doorbells, humidifiers, doors, fans, faucets, lights, locks, outlets, security systems, sensors, alarms, speakers, televisions, thermostats, windows, switches, and/or other programmable devices. In some embodiments, the respective user interface element is configured to control the output device. In some embodiments, when the respective user interface element is in communication with the output device, the output device is registered with the home automation application, such that while the home automation application is running on the computer system, the computer system controls the output device via the respective user interface element. In some embodiments, the computer system is in communication with the output device via Wi-Fi, Bluetooth, and/or other networking technology. In some embodiments, the adjustment to the respective physical environment refers to a degree, level, or manner in which the output device presents light, sound, air, a particular capability (e.g., locking and unlocking doors), and/or other controllable output or result. In some embodiments, detecting the user input directed to the respective user interface element has one or more characteristics of detecting any of the user inputs described above and/or below. In some embodiments, the user input directed to the respective user interface element includes interaction with a digital assistant as described in method(s) 800, 1000, and/or 1200. In some embodiments, the computer system automatically causes the adjustment, via the output device, to the respective physical environment without detecting user input to the output device to cause the adjustment. In some embodiments, in accordance with a determination that the one or more third criteria are not satisfied, the computer system forgoes causing the adjustment, via the output device, to the respective physical environment. Causing the adjustment, via the output device, to the respective physical environment in response to detecting user input directed to the respective user interface element and in accordance with a determination that the respective user interface element is in communication with an output device provides control of output devices in the respective physical environment without requiring additional input to control the output device directly, which avoids additional interaction between the user and the output device associated with the user performing additional inputs to locate and interact with the output device, thereby providing remote control over the output device, which enhances operability of the computer system, reduces power usage of the computer system, reduces errors in the interaction between the user and the computer system, and reduces inputs needed to correct such errors.

In some embodiments, while the three-dimensional environment is visible via the display generation component, such as the three-dimensional environment 1300 visible via the display generation component 120 in FIG. 13F, the computer system detects, via the one or more input devices, a change in contextual information, such as user movement from the living room 1314f to the kitchen 1314e, as shown in the overhead view 1314a in FIG. 13E. In some embodiments, in response to detecting the change in contextual information, in accordance with a determination that the change in contextual information indicates a third physical environment, such as the kitchen 1314e as shown in the overhead view 1314a in FIG. 13F, the computer system displays, via the display generation component, a third user interface element associated with the third physical environment, such as virtual objects 1350, 1348, 1346a, and/or 1352 in FIG. 13F. In some embodiments, the change in contextual information indicates a change in location of the computer system, a change in motion (e.g., position and/or orientation) of the computer system, a change in user engagement with the computer system, and/or a change in user engagement with one or more physical objects and/or virtual objects within the three-dimensional environment. In some embodiments, the third physical environment has one or more characteristics of the first physical environment, the second physical environment, or other physical environment described above and/or below. In some embodiments, the third user interface element has one or more characteristics of any of the user interface elements described above and/or below. In some embodiments, displaying the third user interface element has one or more characteristics of displaying any of the user interface element described above and/or below. In some embodiments, the computer system automatically displays the third user interface element in response to the change in contextual information and in accordance with a determination that the change in contextual information indicates a third physical environment without detecting user input to display the third user interface element. In some embodiments, in accordance with a determination that the change in contextual information indicates the first physical environment, the computer system forgoes (or optionally, ceases) displaying the third user interface element associated with the third physical environment. In some embodiments, in accordance with a determination that the change in contextual information indicates the first physical environment, the computer system displays a respective user interface element associated with the first physical environment. Automatically displaying a respective user interface element based on one or more respective criteria that is based on a determined change in contextual information and determined physical environment of the user of the computer system provides an efficient way of presenting supplemental content and/or relevant functionality, which avoids additional interaction between the user and the computer system associated with the user performing additional inputs to locate and present such user interface elements associated with the physical environment, which enhances operability of the computer system, reduces power usage of the computer system, reduces errors in the interaction between the user and the computer system, and reduces inputs needed to correct such errors.

In some embodiments, displaying the respective user interface element (of the first and/or second user interface elements) includes providing a portal into a view (a virtual environment view) of a respective physical location, such as a portal into a view 1340a of a physical location in FIG. 13D. In some embodiments, the portal into the view of the respective physical location has one or more characteristics of presenting the portal with a respective level of immersion described in method(s) 800, 1000, and/or 1200. For example, the portal optionally provides a scene of a 360-degree view of the respective physical location. In some embodiments, the scene includes one or more images or video (or, optionally, including spatial video), such as street-level imagery, panoramas, and/or 360 degrees camera views taken from and/or of a respective physical location, different from a current location of the computer system. In some embodiments, the computer system presents the portal with a level of immersion, a size, a shape, a position, and/or an orientation relative to the three-dimensional environment and/or viewpoint of the user as will be described in more detail in method(s) 800, 1000, and/or 1200. In some embodiments, the level of immersion, size, shape, position, and/or orientation is automatically (e.g., without detecting user input) determined by the computer system. In some embodiments, the computer system changes the level of immersion, size, shape, position, and/or orientation in response to detecting user input directed to changing the level of immersion, size, shape, position, and/or orientation as will be described in method(s) 800, 1000, and/or 1200. In some embodiments, the respective user interface element is the portal into the view of the respective physical location. For example, the portal is optionally a user interface element or virtual window or virtual volume. In some embodiments, while displaying the portal relative to a first viewpoint of the user, the portal includes one or more first portions of the virtual environment simulating a view of the respective physical location. In some embodiments, while displaying the portal relative to a second viewpoint of the user, different from the first viewpoint, the portal includes one or more second portions of the virtual environment (different and/or overlapping the one or more first portions) and simulating a second view of the respective physical location. Displaying a portal into a view of a respective physical location provides an efficient way surfacing three-dimensional map content via a portal, thereby reducing the number of inputs and providing more efficient interactions between the user and the computer system, which enhances operability of the computer system, reduces power usage of the computer system, reduces errors in the interaction between the user and the computer system, and reduces inputs needed to correct such errors.

FIGS. 15A-150 illustrate examples of a computer system presenting spatial audio corresponding to content in accordance with some embodiments.

FIG. 15A illustrates a computer system 101 displaying, via a display generation component 120 (e.g., display generation components 1-122a and 1-122b of FIG. 1), a three-dimensional environment 1500 from a viewpoint of a user of the computer system 101. In some embodiments, the computer system 101 in FIG. 15A is analogous to and/or includes one or more characteristics, provides one or more features, and/or includes one or more components as the computer system 101 described with reference to FIGS. 7A-7Q. In FIG. 15A, the display generation component 120 is analogous to and/or includes one or more characteristics and/or one or more components (e.g., sensors 114a through 114c) as the display generation component 120 described with reference to FIG. 7A.

In some embodiments, and as described in method 1600, the computer system 101 generates spatial audio corresponding to content displayed within the three-dimensional environment 1500. In some embodiments, the computer system 101 presents the generated spatial audio via one or more speakers of the computer system 101, in communication with the computer system 101, and/or within the three-dimensional environment 1500 of the computer system 101 (e.g., one or more physical speakers in the environment 1500). In some embodiments, the generated spatial audio optionally refers to a generated soundscape encompassing one or more first sound components (e.g., environmental noises, man-made noises, urban acoustic noises, geophysical noises, animal noises, and/or traffic noises). In some embodiments, the computer system presents the generated spatial audio in a manner that simulates sources of various portions of audio (e.g., the one or more first sound components) having positions relative to the viewpoint of the user that correspond to the positions of the sources of the audio in a recorded environment as described in more detail with reference to method 1600.

In some embodiments, the generated spatial audio corresponds to content, such as street-level imagery, panoramas, and/or 360 degrees camera views taken from and/or of a physical location as described in more detail in method 1600. For example, in FIG. 13A, the computer system 101 displays the three-dimensional environment 1500 from a viewpoint of a user 1514 at a first position (e.g., location and/or orientation facing a back wall of a room in which computer system 101 is located), as shown in overhead view 1512. In some embodiments, the computer system 101 displays, via display generation component 120, one or more virtual objects in the three-dimensional environment 1500. For example, in FIG. 15A, the virtual object is and/or includes content 1502a. Content 1502a is a panorama of a first physical location. In some embodiments, the computer system 101 displays the content 1502a with a level of immersion as described in method(s) 1400, 1600, and/or 1800. In some embodiments, the computer system 101 optionally displays the content 1502a with a low, medium, or high level of immersion as described in method(s) 1400, 1600, and/or 1800. For example, in FIG. 15A and as depicted by the overhead view 1512, the computer system 101 displays the content 1502a with a medium level of immersion such that the content 1502a is presented as partially curved around the user to simulate a user experience of being surrounded by the content 1502a. In some embodiments, the content 1502a includes a first selectable option 1504a that, when selected, causes the computer system 101 to change the respective level of immersion in which the computer system 101 displays the content 1502a (e.g., to a higher or lower level of immersion). In some embodiments, the content 1502a includes a second selectable option 1504b that, when selected, causes the computer system 101 to cease displaying content 1502a.

In some embodiments, the computer system 101 generates the spatial audio based on one or more objects within the content 1502a recognized by the computer system 101 as described in more detail in method 1600. For example, in FIG. 15A, content 1502a includes a bird 1506a and in accordance with a determination that the content 1502a includes a bird 1506a, the computer system 101 generates spatial audio including bird sounds 1506b and presents the bird sounds 1506b as though they are emanating from the location of the bird 1506a. In another example, content 1502a includes trees 1508a and in accordance with a determination that the content 1502a includes trees 1508a, the computer system 101 generates spatial audio including tree sounds 1508b and presents the tree sounds 1508b as though they are emanating from the respective locations of the trees 1508a. In some embodiments, the computer system 101 generates the spatial audio based on one or more objects that are not visible within the content 1502a from the viewpoint of the user in the three-dimensional environment 1500 as described in method 1600. For example, in FIG. 15A, the content 1502a optionally corresponds to a first physical location. In some embodiments, the computer system 101 determines that the first physical location is within a view of second content. The second content is for a second physical location, such as second content 1502b in FIG. 15B. In some embodiments, the computer system 101 presents spatial audio based on the second content corresponding to the second physical location in accordance with the determination that the first physical location within the view of the second content. For example, the second content 1502b includes a waterfall 1510a, and in accordance with a determination that the second content 1502 includes a waterfall 1510a, the computer system 101 generates spatial audio including waterfall sounds 1510b despite waterfall 1510a not displayed within content 1502a in FIG. 15A.

In some embodiments, the computer system 101 virtually positions the one or more audio components (e.g., bird sounds 1506b, wind/tree sounds 1508b, and/or waterfall sounds 1510b) in a respective spatial arrangement relative to a respective viewpoint of the user 1514 in the three-dimensional environment 1500 as described in method 1600. In some embodiments, the computer system 101 virtually positions the one or more audio components to correspond to one or more portions (e.g., identified sound sources) of the content (e.g., content 1502a) such that the user of the computer system perceives sounds in the respective spatial audio (e.g., the one or more audio components) just as the user would experience the sounds at the respective physical location (e.g., in the real world). For example, in FIG. 15A, and as shown in the overhead view 1512, the computer system 101 presents the generated spatial audio such that a first audio component (e.g., wind/tree sounds 1508b) has a first position and/or first orientation 1516a (e.g., corresponding to the position and/or orientation of the tree 1508a) and a second audio component (e.g., waterfall sounds 1510b) has a second position and/or second orientation 1516b (e.g., corresponding to the position and/or orientation of the waterfall 1510a illustrated in FIG. 15B) relative to a location (e.g., position and/or orientation) of the head of the user (e.g., the location of the spatial audio as perceived by the user while the spatial audio is presented via the computer system 101). The first position and/or first orientation 1516a of the first audio component corresponds to a portion of the content 1502a that includes trees 1508a, and this portion is in front of the user 1514 (e.g., relative to the viewpoint of the user), as shown in overhead view 1512.

In some embodiments, the computer system 101 virtually positions the one or more audio components to correspond to a location of the identified sound sources such that the user of the computer system perceives sounds in the respective spatial audio (e.g., the one or more audio components) just as the user would experience the sounds at the respective physical location (e.g., in the real world) irrespective of the identified sound sources being visible within the content. For example, in FIG. 15A, the computer system 101 presents the second audio component at the second position and/or second orientation 1516b corresponding to a location of the waterfall that is not visible within content 1502a. In some embodiments, in accordance with a determination that the location of the waterfall is within a predetermined distance from the respective physical location associated with the content 1502a, the computer system 101 presents waterfall sounds 1510b. Additionally or alternatively, in accordance with a determination that the location of the waterfall is beyond the predetermined distance from the respective physical location associated with the content 1502a, the computer system 101 does not present waterfall sounds 1510b. In FIG. 15A, the second position and/or second orientation 1516b of the second audio component corresponds to the location of the waterfall, and this location is to the right of the user 1514 (e.g., relative to the viewpoint of the user), as shown in overhead view 1512.

In some embodiments, the computer system 101 changes a respective audio characteristic (e.g., volume, direction, position and/or orientation, movement, echo, reverb, and/or other characteristic described in more detail in method 1600) of the one or more audio components in response to detecting a change in the viewpoint of the user of the computer system 101. For example, in FIG. 15A, while the viewpoint of the user 1514 is a first viewpoint as shown in overhead view 1512, the computer system 101 presents generated spatial audio including the first audio component (e.g., wind/tree sounds 1508b) with a first volume level; the second audio component (e.g., waterfall sounds 1510b) with a second volume level that is less than the first volume level; and a third audio component (e.g., bird sounds 1506b) with the first volume. In some embodiments, the computer system 101 presents the second audio component with the second volume in accordance with a determination that the identified sound source (e.g., waterfall) corresponding to the second audio component is within a predetermined distance from the respective physical location associated with the content 1502a irrespective of the identified sound source being visible within the content 1502a.

In some embodiments, the computer system 101 detects a change in the viewpoint of the user of the computer system. For example, in FIG. 15B, the computer system 101 detects movement of the user 1514 from a first respective position and/or first orientation corresponding to the first viewpoint to a second position and/or second orientation corresponding to a second viewpoint. In response to detecting this movement, the computer system 101 presents, via the display generation component 120, the second content 1502b and changes the generated spatial audio that is presented by the computer system 101. In some embodiments, content 1502b includes the first selectable option 1504a and the second selectable option 1504b as described above with reference to FIG. 15A. As shown in FIG. 15B, the second content 1502b includes the bird 1506a and waterfall 1510a. In some embodiments, while the computer system 101 presents the second content 1502b, the computer system 101 generates spatial audio for presentation. For example, in FIG. 15B, the computer system 101 presents the generated spatial audio including the first audio component (e.g., wind/tree sounds 1508b) with a third volume level; the second audio component (e.g., waterfall sounds 1510b) with a fourth volume level that is greater than the third volume level; and the third audio component (e.g., bird sounds 1506b) with the third volume level. In some embodiments, the computer system 101 changes (e.g., increases) the volume level of the second audio component in accordance with a determination that the waterfall 1510a is visible within the content 1502b, as shown in FIG. 15B. For example, in FIG. 15A, the computer system 101 presents the second audio component (e.g., waterfall sounds 1510b) with a fifth volume level that is less than the fourth volume level at which the computer system 101 presents the second audio component in FIG. 15B.

In some embodiments, the computer system 101 changes the spatial arrangement of the one or more audio components in response to the change in the viewpoint of the user of the computer system 101. For example, in FIG. 15B, the computer system 101 presents the generated spatial audio such that the second audio component (e.g., waterfall sounds 1510b) has a third position and/or third orientation 1518 relative to a location (e.g., position and/or orientation) of the head of the user (e.g., the location of the spatial audio as perceived by the user while the spatial audio is presented via the computer system 101), and the third audio component (e.g., bird sounds 1506b) has a fourth position and/or fourth orientation 1516a relative to the location of the head of the user. The third position and/or third orientation 1518 of the second audio component corresponds to a portion of the content 1502b that includes waterfall 1510a, and this portion is to the right of the user 1514 (e.g., relative to the viewpoint of the user), as shown in overhead view 1512 in FIG. 15B. The fourth position and/or fourth orientation 1516a of the third audio component corresponds to a portion of the content 1502b that includes the bird 1506a and this portion is to the left of the user 1514 (e.g., relative to the viewpoint of the user), as shown in overhead view 1512 in FIG. 15B.

In some embodiments, and as described in more detail with reference to method 1600, the computer system 101 automatically generates the spatial audio that is presented to the user based on the content (e.g., the first content 1502a and/or the second content 1502b) and/or map information (e.g., location information) associated with the content. In some embodiments, the computer system 101 automatically generates the spatial audio without detecting user input to generate the spatial audio and/or user input to identify the content and/or map information. In some embodiments, the computer system 101 is configured to generate the spatial audio and/or change the computer-generated spatial audio based on user input. For example, in FIG. 15C, the computer system 101 displays, via the display generation component 120, a user interface element 1520a of a map application or other application described in method 1600. In some embodiments, the user interface element 1520a includes the first content 1502a described above with reference to FIG. 15A and map content 1520e corresponding to a physical map region that includes the physical location associated with the content 1502a. The map content 1520e includes a visual indication 1524 of a respective navigation viewpoint corresponding to a respective viewpoint at which the respective spatial audio is presented by the computer system 101. In FIG. 15A, the user interface element 1520a includes a selectable control element 1520b that, when selected, causes the computer system 101 to move and/or resize the user interface element 1520a or close (e.g., cease to display) the user interface element 1520a. In FIG. 15C, the user interface element 1520a also includes a first selectable option 1520d that, when selected, causes the computer system 101 to change the respective level of immersion in which the computer system 101 displays the first content 1502a (e.g., to a higher or lower level of immersion). In some embodiments, the user interface element 1520a includes a second selectable option 1520c that, when selected, causes the computer system 101 to cease displaying the first content 1502a.

In some embodiments, and as described in more detail with reference to method 1600, the computer system 101 is configured to select and/or assign audio classifiers or tags to the objects identified within the content or associated with the physical location of the content. For example, in FIG. 15C, the user interface element 1520a includes a first tag 1522c (e.g., wind/tree sounds), a second tag 1522a (e.g., bird sounds), and a third tag 1522b (e.g., waterfall sounds). In some embodiments, the computer system 101 utilizes these tags in generating the spatial audio as described in more detail in method 1600. In FIG. 15C, the computer system 101 detects a user input, such as voice input 1526 corresponding to a request to add a new tag (e.g., footstep sounds) to the generated spatial audio. In response to this voice input 1526, the computer system 101 displays, via the display generation component 120, a prompt 1528a, as shown in FIG. 15D. In some embodiments, the prompt 1528a includes an indication 1528b of the identified audio tag (e.g., footsteps on stone trail), a first selectable option 1528d that, when selected, causes the computer system 101 to cancel adding the new tag, and a second selectable option 1528c that, when selected, causes the computer system 101 to continue with adding the new tag. In some embodiments, while and/or in response to adding the new tag, the computer system 101 regenerates the spatial audio to include an audio component associated with the new tag as described in more detail in method 1600.

In some embodiments, the computer system 101 is configured to change the navigation viewpoint corresponding to the respective viewpoint at which the respective spatial audio is presented by the computer system 101. For example, and as shown in the previous figure, FIG. 15C, while displaying content 1502a corresponding to a first navigation viewpoint as indicated by visual indication 1524 of the map content 1520e, the computer system 101 detects user input (e.g., as described in FIGS. 13A-13I and/or with reference to method 1600) corresponding to a request change from the first navigation viewpoint to a second navigation viewpoint. In response to this user input, the computer system 101 changes (e.g., rotates) the visual indication 1524 in accordance with the user input to correspond to the second navigation viewpoint as shown in FIG. 15D. The computer system 101 also displays the second content 1502b corresponding to the second navigation viewpoint in the user interface element 1520a.

In some embodiments, the generated spatial audio is based on a time of day as described in method 1600. For example, in FIG. 15D, the computer system 101 detects user input, such as voice input 1530 corresponding to a request to display the second content 1502b at a particular time (e.g., 2:00 PM). In response to this user input, the computer system 101 displays the second content 1502b at the user-requested time and displays a visual indication 1532 of the time of day. In some embodiments, the computer system 101 displays the second content 1502b at a different level of immersion as shown in FIG. 15E. Additionally or alternatively, the computer system 101 is configured to maintain a same level of immersion as the second content 1502b in the previous figure, FIG. 15D. In some embodiments, the generated spatial audio is based on a weather condition as described in method(s) 1000 and/or 1600. For example, in FIG. 15E, the computer system 101 determines based on information from an application (e.g., weather application), different from the application associated with the second content 1502b, that at the particular time (e.g., 2:00 PM), the weather indicates rain at the physical location associated with the second content 1502b. In some embodiments, in accordance with this determination, the computer system 101 displays the second content 1502b including rain, as shown in FIG. 15E. Thus, in some embodiments, the computer system 101 augments the second content 1502b to include one or more virtual objects (e.g., representations of weather conditions) at the respective physical location as described in more detail with reference to method(s) 1000 and/or 1600. In some embodiments, while the computer system 101 displays the second content 1502b including the one or more virtual objects indicative of the weather condition, the computer system 101 generates for presentation spatial audio based on the weather condition. For example, in FIG. 15E, the computer system 101 generates for presentation spatial audio that includes a fourth audio component (e.g., rain sounds 1510c). In some embodiments, the fourth audio component is presented at a respective volume level in accordance with the level of immersion (e.g., proportionally, inversely, or otherwise based upon the change in level of immersion). For example, as shown in the overhead view 1512 of FIG. 15E, the computer system 101 presents the generated spatial audio including the one or more audio components (e.g., bird sounds 1506b, wind/tree sounds 1508b, waterfall sounds 1510b, and/or rain sounds 1510c) in a respective spatial arrangement 1594 relative to the viewpoint of the user 1514 in the three-dimensional environment 1500. The respective spatial arrangement 1594 at which the computer system 101 presents the spatial audio provides a respective immersive experience as if emanating from locations all around the user 1514. Additionally or alternatively, the computer system 101 optionally concurrently changes a respective audio characteristic (e.g., volume, direction, position and/or orientation, movement, echo, reverb, and/or other characteristic described in method 1600) based on the weather condition. For example, in FIG. 15E, the computer system 101 presents the second audio component (e.g., waterfall sounds 1510b) with a fifth volume level in accordance with the determination of the weather condition. The fifth volume level is optionally greater than the fourth volume associated with the second audio component (e.g., waterfall sounds 1510b in FIG. 15B) prior to the determination of the weather condition.

In some embodiments, the computer system 101 is configured to display the second content 1502b concurrently with one or more other virtual objects. For example, in FIG. 15E, the computer system 101 detects user input, such as an air pinch gesture 1534b (e.g., described in more detail in method(s) 800, 1000, 1200, 1400, and/or 1600) while attention 1534a (e.g., gaze) of the user of the computer system 101 is directed to the first selectable option 1504a (e.g., described above). In response to detecting this user input, the computer system 101 displays the second content 1502b with a different level of immersion (e.g., lower level of immersion) as shown in FIG. 15F than the respective level of immersion the computer system 101 displayed the second content 1502b in FIG. 15E. In FIG. 15F, the second content 1502b is displayed within a portal or window (or volume) user interface element 1540a. The user interface element 1540a includes a first selectable option 1540c and a second selectable option 1540b as described above with reference to FIG. 15A; and a selectable control element 1540c as described above with reference to FIG. 15C. In some embodiments, while displaying the user interface element 1540a including the second content 1502b, the computer system 101, displays, via the display generation component 120, a navigation user interface element 1538a, as shown in FIG. 15F and described in more detail in method(s) 800, 1000, 1200, 1400, and/or 1600. For example, the navigation user interface element 1538a is a volumetric map representing a map region or physical area including the respective physical location associated with the second content 1502b. The navigation user interface element 1538a includes one or more representations of trees, roadways, parks, bodies of water and/or other geographical features in the physical area. In FIG. 15F, the navigation user interface element 1538a also includes a visual indication 1538b having one or more same characteristics and/or functions as the visual indication 1524 of FIG. 15C. For example, visual indication 1538b represents a respective navigation viewpoint corresponding to a respective viewpoint at which the second content 1502b is presented by the computer system 101. In some embodiments, the computer system 101 optionally displays the user interface element 1540a and the navigation user interface element 1538 in a respective spatial arrangement in which the user interface element 1540a and the navigation user interface element 1538 are centered in the field of view of the user 1514 as shown in the overhead view 1512 of FIG. 15F. In some embodiments, the computer system 101 moves, resizes, and/or changes the respective spatial arrangement of the user interface element 1540a and/or the navigation user interface element 1538 automatically (e.g., without detecting user input) and/or in response to user input as described in more detail with reference to method(s) 800, 1000, 1200, 1400, and/or 1600.

In some embodiments, the computer system 101 is configured to perform a search for content in response to user input and present one or more search results. For example, in FIG. 15F, the computer system 101 detects a user input, such as voice input 1536 corresponding to a request to present content, different from the content displayed (e.g., the second content 1502b). In response to this voice input 1536, the computer system 101 conducts a search using the voice input 1536 including one or more search characteristics (e.g., “quiet” and “café”) as search parameters for input into the map application and/or other application as described in method(s) 800 and/or 1600. In some embodiments, the computer system 101 presents one or more search results including spatial audio related to the one or more search characteristics. For example and as shown in FIG. 15G, in response to the voice input 1536, the computer system 101 presents user interface element 1540a including third content 1540e related to the one or more search characteristics (e.g., “quiet” and “café”) of the voice input 1536. The third content 1540e includes one or more images or video (or, optionally, including spatial video), such as street-level imagery, panoramas, and/or 360 degrees camera views taken from and/or of a point of interest (e.g., café and patio 1540g) matching the one or more search characteristics of the voice input 1536. In FIG. 15G, the computer system 101 updates the navigation user interface element 1538a to represent a respective physical area that includes the point of interest matching the one or more search characteristics of the voice input 1536. The navigation user interface element 1538a includes a representation of the point of interest (e.g., café 1538c). In FIG. 15G, the computer system 101 updates the visual indication 1538b to correspond to the respective viewpoint at which the third content 1540e is presented by the computer system 101. The visual indication 1538b also indicates the respective viewpoint at which respective spatial audio is presented by the computer system 101. For example, in FIG. 15G, the respective spatial audio that is presented by the computer system 101 corresponding to a respective physical location that corresponds to a location of the visual indication 1538b includes a first audio component 1542a (e.g., espresso machine sounds) at a first volume level, a second audio component (e.g., people sounds) at the first volume level, and a third audio component (e.g., music) at a second volume level less than the first volume level.

In some embodiments, the computer system 101 generates and presents spatial audio based on the attention (e.g., gaze of the user). For example, in FIG. 15G, the computer system 101 detects user input that includes an air pinch gesture 1544b (e.g., described in more detail in method(s) 800, 1000, 1200, 1400, and/or 1600) while attention 1544a (e.g., gaze) of the user of the computer system 101 is directed to a location within the navigation user interface element 1538a corresponding to a representation of an area of the point of interest (e.g., patio 1538d). In response to detecting this user input, the computer system 101 displays fourth content 1540f that includes one or more images or video (e.g., similar to third content 1540e described above) of the area of the point of interest (e.g., café patio). While the computer system 101 displays the fourth content, the computer system 101 presents spatial audio corresponding to a respective viewpoint of the fourth content 1540f.

In some embodiments, the computer system 101 generates and presents spatial audio based on the attention (e.g., gaze) of the user. For example, in FIG. 15G, the computer system 101 detects user input that includes an air pinch gesture 1544b (e.g., described in more detail in method(s) 800, 1000, 1200, 1400, and/or 1600) while attention 1544a (e.g., gaze) of the user of the computer system 101 is directed to a location within the navigation user interface element 1538a corresponding to an area associated with the point of interest (e.g., patio 1538d). In response to detecting this user input, the computer system 101 displays fourth content 1540f that includes one or more images or video (e.g., similar to third content 1540e described above) of the area associated with the point of interest (e.g., café patio). While the computer system 101 displays the fourth content 1540f, the computer system 101 presents spatial audio corresponding to a respective viewpoint of the fourth content 1540f. For example, in FIG. 15H, the computer system 101 generates for presentation spatial audio that includes the following audio components: the second audio component 1542b (e.g., people sounds), a fourth audio component 1542d (e.g., street sounds), a fifth audio component 1542e (e.g., wind/tree sounds), and a sixth audio component 1542f (e.g., bird sounds). In some embodiments, the generated spatial audio does not include one or more audio components, such as the first audio component 1542a (e.g., espresso machine sounds) and the third audio component 1542c (e.g., music sounds) in accordance with a determination that at the respective viewpoint of the fourth content 1540f is beyond a predetermined distance away (e.g., described in method 1600) from the location of the point of interest (e.g., café 1538c). Thus, in some embodiments, the computer system 101 presents spatial audio that attenuates or mutes the first audio component 1542a (e.g., espresso machine sounds) and the third audio component 1542c (e.g., music sounds) based on the respective viewpoint of the fourth content 1540f.

In some embodiments, the generated spatial audio includes the one or more audio components (e.g., the second audio component 1542b, the fourth audio component 1542d, the fifth audio component 1542e, and the sixth audio component 1542f) based on one or more objects visible or not visible within the fourth content 1540f as described in more detail in method 1600. For example, in FIG. 15H, the fourth content 1540f includes one or more tree objects 1552b, and in accordance with a determination that the fourth content 1540f includes one or more tree objects 1552b, the computer system 101 generates spatial audio that includes the fifth audio component 1542e (e.g., wind/tree sounds). In another example, the computer system 101 generates spatial audio that includes the fourth audio component 1542d (e.g., street sounds) in accordance with a determination that the physical location associated with the fourth content 1540f is within a predetermined distance (e.g., described in method 1600) from a street 1538e (e.g., “Main St”).

In some embodiments, the computer system 101 changes a respective audio characteristic (e.g., volume, direction, position and/or orientation, movement, echo, reverb, and/or other characteristic described in more detail in method 1600) of the one or more audio components in response to a change in a level of immersion at which the computer system 101 presents content. For example, in FIG. 15H, the computer system 101 detects user input, such as an air pinch gesture 1546b (e.g., described in more detail in method(s) 800, 1000, 1200, 1400, and/or 1600) while attention 1546a (e.g., gaze) of the user of the computer system 101 is directed to the first selectable option 1540c (e.g., described above). In response to detecting this user input, the computer system 101 displays the fourth content 1540f with a different level of immersion (e.g., higher level of immersion) as shown in FIG. 15I than the respective level of immersion the computer system 101 displayed the fourth content 1549f in FIG. 15H. In FIG. 15I, the fourth content 1540f is displayed, via the display generation component 120, as partially curved around the user 1514 as shown in the overhead view 1512 to simulate a user experience of being surrounded by the fourth content 1540f. In some embodiments, the fourth content 1540f includes a first selectable option 1504a and a second selectable option (e.g., described above with reference to FIG. 15A). In some embodiments, while and/or in response to presenting the fourth content 1540f at the respective level of immersion as shown in FIG. 15I, the computer system 101 changes one or more respective audio characteristics of one or more audio components. For example, in FIG. 15I, the computer system increases a respective volume level of the fourth audio component 1542d (e.g., street sounds), the fifth audio component 1542e (e.g., wind/tree sounds), and the sixth audio component 1542f (e.g., bird sounds) compared to the respective volume levels of these audio components while the computer system displayed the fourth content 1540f with the respective level of immersion as shown in FIG. 15H.

In some embodiments, the computer system 101 displays content and re-generates the spatial audio that is presented based on a distance between the viewpoint of the user of the computer system 101 and a respective location associated with the content. For example, in FIG. 15I and as shown in overhead view 1512, a distance between the viewpoint of the user 1514 of computer system 101 to the respective location associated with the fourth content 1540f is a first distance. In some embodiments, while at this distance, the computer system 101 displays the fourth content 1540f and presents corresponding generated spatial audio that includes the fourth audio component 1542d (e.g., street sounds), the fifth audio component 1542e (e.g., wind/tree sounds), and the sixth audio component 1542f (e.g., bird sounds). In some embodiments, while displaying the fourth content 1540f and presenting the corresponding generated spatial audio, the computer system 101 detects the user 1514 moving to a location within the three-dimensional environment 1500 that is closer to the respective location associated with the fourth content 1540f. FIG. 15I illustrates this movement of the user 1514 with arrow 1556. In response to detecting the movement of the user 1514, the computer system 101 determines that the distance between the viewpoint of the user 1514 at the location relative to the respective location associated with the fourth content 1540f is a second distance, different from the first distance (e.g., shorter or less than the first distance). In some embodiments, at this determined second distance, the computer system 101 changes the content displayed via the display generation component 120. For example, in FIG. 15J, the computer system 101 displays, via the display generation component 120, fifth content 1558, different from the fourth content 1540f. In some embodiments, the fifth content 1558 includes a greater amount of detail (e.g., one or more additional objects) than the fourth content 1540f. For example, in FIG. 15J, the fifth content 1558 includes one or more representations (or indications) of people 1560a that was not included in the fourth content 1540f. In some embodiments, the one or more representations of people 1560a were not captured while capturing the fifth content 1558. For example, and in some embodiments, the computer system 101 adds the one or more representations of people to the fifth content 1558. In some embodiments, the computer system 101 adds the one or more representations of people to the fifth content 1558 in accordance with a determination that the point of interest is associated with user activity (e.g., the point of interest is a type of environment in which people gather). In some embodiments, the one or more representations of people do not include actual identifiable people. In some embodiments, the computer system 101 applies a visual treatment to one or more features of the people (e.g., applies a mask to the faces of people). In some embodiments, at the time the fifth content 1558 was captured, the fifth content 1558 optionally included people. In some embodiments, in accordance with a determination that the fifth content 1558 includes people, the computer system 101 optionally applies displays the fifth content 1558 including the people having the visual treatment as described herein.

In some embodiments, while the computer system 101 displays the fifth content 1558, the computer system 101 generates for presentation spatial audio corresponding to the respective viewpoint of the fifth content 1558. For example, in FIG. 15J, the spatial audio includes an additional audio component, the second audio component 1542b (e.g., people sounds) that was not included when presenting the respective spatial audio while displaying the fourth content 1540f. In some embodiments, the computer system 101 includes the second audio component 1542b in accordance with the determination that the point of interest is a particular type as described above (e.g., the point of interest is a type of environment in which people gather). In some embodiments, the spatial audio that is presented by the computer system 101 is presented in a manner that is based on the respective level of immersion. For example, as shown in the overhead view 1512 of FIG. 15J, the computer system 101 presents the generated spatial audio including the fourth audio component 1542d (e.g., street sounds), the fifth audio component 1542e (e.g., wind/tree sounds), the sixth audio component 1542f (e.g., bird sounds), and the seventh audio component 1542b (e.g., people sounds) in a respective spatial arrangement 1562 relative to the viewpoint of the user 1514 in the three-dimensional environment 1500. The respective spatial arrangement 1562 at which the computer system 101 presents the spatial audio provides a respective immersive experience as if emanating from locations all around the user 1514.

In some embodiments, the computer system 101 generates and presents spatial audio automatically in response to user input corresponding to a request to present content. For example, in FIG. 15J, the computer system 101 detects user input, such as voice input 1564 corresponding to a request to present content, different from the content currently displayed (e.g., the fifth content 1558). In response to detecting this voice input 1564, the computer system 101 determines, based on the user input 1564, that the user requests content that includes a point of interest (e.g., ballpark) and in accordance with this determination, the computer system 101 presents content 1566, via display generation component 120, as shown in FIG. 15K. Content 1566 includes street-level imagery, panoramas, and/or 360 degrees camera views taken from and/or of the requested point of interest (e.g., ballpark 1588a).

In FIG. 15K, the computer system 101 displays content 1566 with a level of immersion similar to (or the same as) the level of immersion of content 1558. In some embodiments, while and/or in response to the computer system 101 displaying content 1566, the computer system 101 presents spatial audio including a plurality of audio components, such as a first audio component 1568b (e.g., water sounds), a second audio component 1568c (e.g., bird sounds), and a third audio component 1570b (e.g., footsteps). In some embodiments, the plurality of audio components presented by the computer system is based on one or more objects visible or not visible within the content 1566 as described in more detail with reference to method 1600. For example, in FIG. 15K, the computer system 101 generates spatial audio that includes the first audio component 1568b in accordance with a determination that the content 1566 includes water 1568a. In another example, the computer system 101 generates spatial audio that includes the second audio component 1568c (e.g., bird sounds) in accordance with a determination that the content 1566 is associated with a physical location of a particular type (e.g., natural, urban, human-made, or other type described in method 1600). For example, in FIG. 15K, the computer system 101 determines that the physical location associated with the content 1566 includes a natural geographic feature (e.g., water 1568a), and in accordance with this determination, the computer system 101 generates spatial audio that includes one or more audio components found in nature, such as the second audio component (e.g., bird sounds). In another example, the computer system 101 determines that the physical location associated with the content 1566 is within a predetermined distance (e.g., as described in method 1600) from one or more geographic features. For example, the computer system 101 presents spatial audio that includes the third audio component (e.g., footsteps) in accordance with determination that the physical location associated with the content 1566 is within the predetermined distance from a running/walking trail as indicated by the trail 1570a illustrated in FIG. 15L.

In some embodiments, the computer system 101 detects a change in the viewpoint of the user of the computer system 101. For example, the computer system 101 detects movement of the user 1514 from a first respective position and/or first orientation corresponding to a first viewpoint (e.g., as shown in FIG. 15K) to a second position and/or second orientation corresponding to a second viewpoint (e.g., as shown in FIG. 15L). In response to detecting this movement, the computer system 101 presents, via the display generation component 120, content 1576 and presents spatial audio generated by the computer system 101 that is based on content 1576. In FIG. 15L, content 1576 includes the first selectable option 1504a and the second selectable option 1504b as described above with reference to FIG. 15A. As shown in FIG. 15L, the content 1576 includes one or more objects that were not visible in content 1566 of FIG. 15K. For example, content 1576 includes a trail 1570a, a bridge 1572a, and a partial view of the stadium. In some embodiments, while the computer system 101 presents the content 1576, the computer system 101 generates for presentation spatial audio. For example, in FIG. 15L, the computer system 101 presents the generated spatial audio including the first audio component 1568b (e.g., water sounds), the second audio component 1568c (e.g., bird sounds), the third audio component 1570b (e.g., footsteps), and a fourth audio component 1572b (e.g., bridge sounds). In some embodiments, the plurality of audio components presented by the computer system is based on one or more objects recognized by the computer system 101 to be within the content 1576 as described in more detail with reference to method 1600. For example, in FIG. 15L, the computer system 101 generates spatial audio that includes the fourth audio component 1570b (e.g., footsteps) in accordance with a determination that the content 1566 includes the trail 1570a. In another example, the computer system 101 generates spatial audio that includes the fifth audio component 1572b (e.g., bridge sounds) in accordance with a determination that the content 1566 includes a bridge 1572a.

In some embodiments, the computer system 101 displays map information associated with content 1576. For example, in FIG. 15L, the computer system 101 detects user input, such as an air pinch gesture 1574b (e.g., described in more detail in method(s) 800, 1000, 1200, 1400, and/or 1600) while attention 1574a (e.g., gaze) of the user of the computer system 101 is directed to the second selectable option 1504b (e.g., described above). In response to detecting this user input, the computer system 101 ceases to display content 1576, and displays, via the display generation component 120, user interface element 1578a and navigation user interface element 1580a, as shown in FIG. 15M. In some embodiments, the user interface element 1578a includes a map of a region or area associated with the point of interest (e.g., ball park) and a selectable option 1540a that, when selected, causes the computer system to close (e.g., cease to display) the user interface element 1578a or display the user interface element 1578 with a different level of immersion (e.g., higher or lower level of immersion as described in method 1600) than the respective level of immersion at which the user interface element 1578 is currently displayed in FIG. 15M. The user interface element 1578a also includes a selectable control element 1578f that, when selected, causes the computer system 101 to move and/or resize the user interface element 1578a or close the user interface element 1578a. The map of the region displayed by user interface element 1578a includes a representation of the ballpark 1578b corresponding to the ballpark 1588a of FIG. 15L, a representation of the bridge 1578d corresponding to the bridge 1572a of FIG. 15L, and a representation of the running train 1578e corresponding to the trail 1570a in FIG. 15L. In some embodiments, the computer system 101 utilizes information from the map in generating spatial audio, as described below and in method 1600. In FIG. 15L, the computer system 101 presents the map from a top-down (e.g., bird's eye) view. In some embodiments, the computer system 101 presents the map from another view, different from the top-down view as described in method(s) 800, 1000, 1200, 1400, and/or 1600.

In some embodiments, the navigation user interface element 1580a has one or characteristics and/or functions as the navigation user interface element 1538a in FIG. 15F. For example, in FIG. 15M, the navigation user interface element 1580a includes one or more representations of trees, roadways, parks, bodies of water and/or other geographical features in the physical area. In FIG. 15F, the navigation user interface element 1538a also includes a visual indication 1580c having one or more same characteristics and/or functions as the visual indication 1524 of FIG. 15C. For example, visual indication 1580c represents a respective navigation viewpoint corresponding to a respective viewpoint at which the map is presented by the computer system 101.

In some embodiments, the computer system 101 performs a search for content in response to user input and present one or more search results. For example, in FIG. 15M, the computer system 101 detects a user input, such as voice input 1582 corresponding to a request to present content, different from the map content displayed via the user interface element 1578a. In response to this voice input 1582, the computer system 101 conducts a search using the voice input 1582 including one or more search characteristics (e.g., “ballpark” and “event”) as search parameters for input into the map application and/or other application as described in method(s) 800 and/or 1600. In some embodiments, the computer system 101 presents one or more search results including computer-generated spatial audio related to the one or more search characteristics. For example, in response to the voice input 1582, the computer system 101 displays, via display generation component 120, content 1584 related to the one or more search characteristics (e.g., “ballpark” and “event”) of the voice input 1582. The content 1584 includes one or more images or video (or, optionally, including spatial video), such as street-level imagery, panoramas, and/or 360 degrees camera views taken from and/or of a point of interest (e.g., ballpark 1588a). In some embodiments, the computer system 101 displays supplemental content matching the one or more search characteristics of the voice input 1582. For example, and a shown in FIG. 15N, the computer system 101 includes one or more representations of fireworks 1586a in the content 1584 in accordance with a determination that the user requests to view the point of interest during an event. In FIG. 15N, while the computer system 101 displays the content 1584 including the one or more representations of fireworks 1586a, the computer system 101 presents spatial audio including an audio component 1586b (e.g., fireworks) corresponding to the one or more representations of fireworks 1586a. In another example, the spatial audio that is generated by the computer system 101 optionally includes one or more additional audio components related to the one or more search characteristics of the voice input 1582, such as audio component 1588b (e.g., crowd cheering) corresponding to the search characteristic “event”. In this instance, the computer system 101 generates spatial audio that includes the audio component 1588b in accordance with a determination that the user request for content indicates an event, which typically is attended by a large crowd of people.

FIG. 15O illustrates an exemplary process 1590 of generating spatial audio. For example, the computer system 101 produces an output 1592d including generative spatial audio in response to detecting input 1592a. In some embodiments, the input 1592a includes content, such as content 1502a in FIG. 15A or any of the other content described above and/or in method 1600. In FIG. 15O, the computer system 101 generates spatial audio by applying one or more generative audio techniques, such as text/image analysis 1592e, scene segmentation 1592f, audio diffusion modeling 1592g, and sound extrapolation 1592h to the input 1592a together with information from sound data 1592b and map data 1592c. In some embodiments, the sound data 1592b is retrieved and/or captured by the computer system 101 from an application other than the map application, such as a music application, generative media application, or other application described in method 1600. In some embodiments, the sound data 1592b includes pre-existing spatial audio or soundscapes (e.g., natural and/or urban soundscapes generated in the real world such as soundscapes captured by a microphone or user created soundscapes or a modified version of a real-world soundscape or user created soundscape). In some embodiments, the computer system 101 utilizes the sound data as a seed for generating spatial audio as described in more detail with reference to method 1600. In some embodiments, the computer system 101 retrieves and/or captures map data 1592c from the map application or other application described in method 1600. In some embodiments, the map data 1592c includes map information related to the physical location associated with the content. For example, the map information includes one or more points of interest, geographic features, and/or other map information described in method 1600.

In FIG. 15O, the computer system 101 applies text/image analysis 1592e to generate spatial audio. For example, the computer system 101, using optical character recognition (OCR), computer vision, scanning technology, machine or computer vision analysis, and/or pattern recognition techniques, analyzes the input 1592a (e.g., content) to determine one or more objects in the content. In some embodiments, the computer system 101 applies a scene segmentation 1592f technique including one or more processes to segment out one or more notable objects within the content (e.g., the one or more largest objects; the one or more objects recognized with a high degree of confidence, greater than a confidence threshold (e.g., 75, 80, and/or 90%); and/or the one or more salient objects). In some embodiments, the computer system 101 performs one or more object recognition techniques, using one or more object classifiers or tags, on the one or more segmented objects to determine the objects in the content. In some embodiments, the computer system 101 applies one or more machine learning based audio diffusion modeling 1592g techniques or diffusion probabilistic modeling techniques to generate the spatial audio based on the content including the recognized objects. In some embodiments, the computer system 101 generates and presents the spatial audio in a manner that simulates the spatial audio diffusing or spreading in the three-dimensional environment realistically. In some embodiments, the computer system 101 performs and/or facilitates sound extrapolation 1592h in which sound is extrapolated based on the content and/or map information as described in method 1600.

In some embodiments, method 1600 is performed at a computer system in communication with a display generation component and one or more input devices. In some embodiments, the computer system has one or more of the characteristics of the computer system of method(s) 800, 1000, 1200, and/or 1400. In some embodiments, the one or more input devices have one or more of the characteristics of the one or more input devices of method(s) 800, 1000, 1200, and/or 1400. In some embodiments, the display generation component has one or more of the characteristics of the display generation component of method(s) 800, 1000, 1200, and/or 1400.

In some embodiments, while displaying, via the display generation component, content (e.g., with a respective level of immersion) in a three-dimensional environment (1602a), wherein the content is not associated with corresponding audio (e.g., spatial audio, or non-spatial audio), such as content 1502a in FIG. 15A,

in accordance with a determination that a viewpoint of a user of the computer system is a first viewpoint, such as the viewpoint of the user 1514 as shown in the overhead view 1512 in FIG. 15A, the computer system presents (1602b) first spatial audio corresponding to the first viewpoint, such as spatial audio including bird sounds 1506b, wind/tree sounds 1508b, and waterfall sounds 1510b in FIG. 15A. In some embodiments, the content is visual content included in a user interface of a map application, such as and/or including one or more characteristics of the user interface of the map application of method(s) 800, 1000, 1200, and/or 1400. In some embodiments, the content includes two-dimensional content and/or three-dimensional content. In some embodiments, the content has one or more characteristics of a respective content item with a respective level of immersion corresponding to a respective view of a respective physical location described in method(s) 800, 1000, 1200, and/or 1400. In some embodiments, the content is pre-recorded content of the respective physical location that does not include audio captured audio during the recording of the respective physical location. In some embodiments, the pre-recorded content is retrieved from a remote server in communication with the computer system and/or a local processor (e.g., maintained by the computer system optionally from the map application operating on the computer system) for retrieving map content including identifying the respective physical location. In some embodiments, the computer system previously recorded the content and saved the content to the remote server and/or the map application or other database. In some embodiments, displaying the content includes accessing the server and retrieving the content (optionally including map information related to the content). In some embodiments, the computer system displays the content within a three-dimensional environment as described with reference to method(s) 800, 1000, 1200, and/or 1400. In some embodiments, the content includes one or more images or video (or, optionally, including spatial video), such as street-level imagery, panoramas, and/or 360 degrees camera views taken from and/or of a first physical location. In some embodiments, the content is live video recorded at the first physical location. In some embodiments, the computer system displays the content with a first level of immersion corresponding to a first view of the first physical location. In some embodiments, the computer system displays the content from a first-person perspective from a first viewpoint of a user of the computer system at a first location in the three-dimensional environment (e.g., corresponding to the first location of the computer system). In some embodiments, the first location (e.g., current location) of the computer system is different from the respective physical location corresponding to the content. In some embodiments, the computer system is configured to increase or decrease a level of immersion of the content (e.g., increases or decreases a quantity of virtual content, virtual objects, user interface elements in the content and/or increases or decreases a portion of which the content occupies the three-dimensional environment) automatically or in response to detecting user input. In some embodiments, a level of immersion includes an associated degree to which the content displayed by the computer system obscures a representation of the physical environment or optionally referred to as background content (e.g., the three-dimensional environment including the physical environment) around/behind the content, optionally including a number of objects of the representation of the physical environment displayed and the visual characteristics (e.g., colors, contrast, and/or opacity) with which the content is displayed. In some embodiments, the associated degree to which the content obscures the representation of the physical environment is based on the angular range of the content displayed via the display generation component (e.g., 60 degrees of content displayed at low immersion, 120 degrees of content displayed at medium immersion, and/or 180 degrees of content displayed at high immersion). In some embodiments, the associated degree to which the content obscures the representation of the physical environment is based on the proportion of the field of view displayed via the display generation consumed by the virtual content (e.g., 33% of the field of view consumed by the virtual content at low immersion, 66% of the field of view consumed by the virtual environment at medium immersion, and/or 100% of the field of view consumed by the virtual content at high immersion). In some embodiments, at a first (e.g., low) level of immersion, the representation of the physical environment, virtual and/or real objects are displayed, optionally in an unobscured manner (e.g., dimmed, blurred, and/or removed from display). For example, content with a low level of immersion is optionally displayed concurrently with the representation of the physical environment, which is optionally displayed with full brightness, color, and/or translucency. In some embodiments, at a second (e.g., high) level of immersion, the representation of the physical environment, virtual and/or real objects are displayed in an obscured manner. For example, content with a high level of immersion is displayed without concurrently displaying the representation of the physical environment (e.g., in a full screen or fully immersive mode). As another example, content displayed with a medium level of immersion is optionally displayed concurrently with darkened, blurred, or otherwise de-emphasized representation of the physical environment.

In some embodiments, presenting first spatial audio includes outputting one or more first sound components (e.g., environmental noises, man-made noises, urban acoustic noises, geophysical noises, animal noises, and/or traffic noises). In some embodiments, the one or more first sound components were not captured during the recording of the content. In some embodiments, the one or more first sound components are determined and/or generated by the computer system using one or more generative audio methodologies including image analysis described in more detail below. In some embodiments, the computer system presents the first spatial audio in a manner that simulates sources of various portions of audio (e.g., the one or more first sound components) having positions relative to the viewpoint of the user that correspond to the positions of the sources of the audio in a recorded environment. In some embodiments, the first spatial audio that is presented is based on content analysis and/or object recognition as will be described in more detail below. In some embodiments, the first spatial audio including the one or more first sound components are generated at least partially using one or more autonomous processes. For example, the computer system optionally inputs the content corresponding to the first view of the first physical location to generate the first spatial audio, optionally including audio corresponding to objects not shown in the first view. Thus, in some embodiments, to produce an increased level of audio realism of a simulated reality experience, the computer system includes audio of various objects (optionally, including the one or more respective sound components) within the first physical location independent of whether the objects are currently displayed and/or visible in the content (e.g., from the current viewpoint of the user). In some embodiments, the various objects are within a predetermined distance (e.g., 1, 5, 10, 50, 100, 200, 500, 1000, or 10,000 meters) of a respective location relative to the first physical location corresponding to the viewpoint of the user. Thus, in some embodiments, the various objects are behind the current viewpoint of the user (whether or not the objects are currently in the three-dimensional environment) and not visible to the user. In some embodiments, the computer system optionally inputs location information about the first physical location to generate the first spatial audio. In some embodiments, the computer system optionally inputs text describing one or more objects and/or concepts to be included when generating the first spatial audio as will be described in more detail below. In some embodiments, the computer system uses one or more autonomous processes such as artificial neural networks and/or machine learning to generate the first spatial audio. In some embodiments, the first spatial audio is generated using the inputs described herein and/or other inputs described in more detail below to enhance, supplement, and/or replace audio that was captured by one or more cameras and/or microphones at the first physical location. In some embodiments, audio was not captured when the content was captured, and thus, in some embodiments, the first spatial audio is generated and added to the content. In some embodiments, the first spatial audio corresponds to generative soundscapes (e.g., natural and/or human-made sounds in an environment) generated by a machine program that uses foundational models (FMs) (e.g., neural networks trained using data sourced from a variety of methods) to generate the soundscapes (e.g., first spatial audio), optionally without user input providing the sound components and/or sound descriptions that make up the generative soundscapes. Optionally, one or more sound components of the generative soundscapes are generated by the machine program, and not by a user providing such sound components. For example, and as will be described in more detail below, the computer system presents the first spatial audio using one or more methodologies, such as audio diffusion modeling, text and/or image analysis, scene segmentation, and/or sound extrapolation. For example, and as described in more detail below, the computer system presents the first spatial audio using, in part, map and/or location information (e.g., a waterfall located near the respective physical location, but not included in the displayed content corresponding to the respective view of the respective physical location) rather than using the displayed content.

In some embodiments, while displaying, via the display generation component, the content in the three-dimensional environment, in accordance with a determination that the viewpoint of the user is a second viewpoint, different from the first viewpoint (e.g., different position and/or orientation of the viewpoint relative to the three-dimensional environment and/or content), such as the viewpoint of the user 1514 as shown in the overhead view 1512 in FIG. 15B, the computer system presents (1602c) second spatial audio, different from the first spatial audio, corresponding to the second viewpoint, such as spatial audio including waterfall sounds 1510b having a volume level as shown in FIG. 15B greater than the volume level of the waterfall sounds 1510b in FIG. 15A. It is understood that although the embodiments described herein are directed to presenting first spatial audio, such functions and/or characteristics, optionally apply to other spatial audio including the second spatial audio. In some embodiments, the characteristics vary based on the view of the physical location (e.g., based on the position and/or orientation of the viewpoint of the user relative to the content), such as increasing or decreasing overall playback volume, and/or relative playback volumes for respective sound components output concurrently. In some embodiments, presenting the second spatial audio includes increasing or decreasing the volume of the one or more sound components compared to the first spatial audio that was presented in response to the determination that the viewpoint of the user is the first viewpoint. In some embodiments, presenting the second spatial audio includes one or more sound components that were not included in the first spatial audio that was presented in response to the determination that the viewpoint of the user is the first viewpoint. In some embodiments, the computer system changes the simulated locations of the one or more sound components of the spatial audio in accordance with the second viewpoint. In some embodiments, the first viewpoint includes a position and/or orientation different from a respective position and/or orientation of the second viewpoint relative to the three-dimensional environment. In some embodiments, the respective positions and/or orientations of the first viewpoint and/or the second viewpoint are different from a respective position and/or orientation of the content in the three-dimensional environment. Outputting spatial audio in accordance with a respective viewpoint of the user of the computer system enhances user interactions with the computer system by providing audio corresponding to the respective view which increases a level of realism of a scene, provides improved feedback to the user about the location of the viewpoint relative to the content, enhances spatial awareness, and enhances the operability of the computer system and makes the user-computer system interface more efficient.

In some embodiments, while displaying the content in the three-dimensional environment, the computer system detects, via the one or more input devices, a change in the viewpoint of the user of the computer system, such as the change from a first viewpoint as shown in FIG. 15A to a second viewpoint as shown in FIG. 15B. For example, while the computer system optionally displays the content from a respective viewpoint of the user of the computer system, such as the first or second viewpoint described above, the computer system detects the change in viewpoint of the user of the computer system from the respective viewpoint to a third viewpoint. In some embodiments, the viewpoint changes in response to detecting motion of the user and/or of the electronic device. For example, the computer system detects movement of the user (e.g., from a first location to a second location within the physical environment) and/or the head of the user (e.g., head rotation described in more detail below) from a respective position and/or orientation corresponding to a respective viewpoint (e.g., the first viewpoint or second viewpoint described above) to a third position and/or orientation, different from the respective position and/or orientation, and corresponding to the change in the viewpoint from the respective viewpoint to the third viewpoint. In some embodiments, in response to detecting the change in the viewpoint of the user of the computer system, the computer system optionally displays the content (or optionally, a respective portion of the three-dimensional environment) from the third viewpoint. In some embodiments, the change in the viewpoint of the user is in response to a recentering input to recenter the content including presenting the respective spatial audio to a current viewpoint of the user. In some embodiments, the recentering input has one or more characteristics of any of the user inputs described herein, above, and/or below. In some embodiments, the recentering input is performed automatically without detecting a user input as described below. In some embodiments, the change in the viewpoint of the user is in response to detecting a user input requesting to change the viewpoint of the user in the three-dimensional environment irrespective of the computer system moving and/or a request (user or computer-initiated) to change a mapping or spatial arrangement of the content within the three-dimensional environment.

In some embodiments, in response to detecting the change in the viewpoint of the user of the computer system (e.g., relative to the content in the three-dimensional environment), in accordance with a determination that the change in the viewpoint of the user of the computer system indicates a third viewpoint, different from the second viewpoint, the computer system presents third spatial audio, different from the second spatial audio, corresponding to the third viewpoint, such as spatial audio including waterfall sounds 1510b having a volume level as shown in FIG. 15B greater than the volume level of the waterfall sounds 1510b in FIG. 15A. For example, the change in the viewpoint of the user of the computer system optionally refers to a change in the position and/or orientation of the user relative to the content in the three-dimensional environment while the computer system maintains the position and/or orientation of the content in the three-dimensional environment. In some embodiments, while and/or in response to displaying the content from the third viewpoint, the computer system presents third spatial audio, different from respective spatial audio the electronic device presented while displaying the content from the respective viewpoint, corresponding to the third viewpoint. In some embodiments, presenting third spatial audio has one or more characteristics of presenting first spatial audio, second spatial audio, or another spatial audio described above and/or below. In some embodiments, presenting third spatial audio, different from the respective spatial audio, corresponding to the third viewpoint includes changing the manner in which the spatial audio is presented including changing one or more spatial audio characteristics of a sound source as will be described in more detail below, such as, for example, volume, direction, source position and/or orientation, source movement, echo, reverb, and/or other characteristic described in more detail below. In some embodiments, the computer system changes the respective spatial audio including the one or more spatial audio characteristics of the audio source based on the change in the viewpoint of the user. In some embodiments, in response to detecting the change in the viewpoint of the user, the computer system maintains a position and/or orientation of the content. For example, the computer system optionally does not reorient, tilt, move, or relocate the content such that the content is optionally no longer centered in the field of view of the user and/or a front-facing surface of the content optionally no longer faces toward the respective viewpoint of the user in response to detecting the change in viewpoint of the user. In some embodiments, the computer system maintains the position and/or orientation of the content until the computer detects user input corresponding to a request to move and/or reorient the content. In some embodiments, in response to detecting the change in the viewpoint of the user, the computer system changes a position and/or orientation of the content such that the content is centered in the field of view of the user and/or the front-facing surface of the content face toward the respective viewpoint of the user. In some embodiments, the computer system determines that the change in the viewpoint of the user of the computer system indicates a fourth viewpoint, different from the third viewpoint, and in response to this determination, the computer system presents fourth spatial audio, different from the third spatial audio, corresponding to the fourth viewpoint. Changing the spatial audio presented based on detecting a change in viewpoint of the user enhances user interactions with the computer system by providing audio corresponding to the respective view which increases a level of realism of a scene, provides improved feedback to the user about the location of the viewpoint relative to the content, enhances spatial awareness, and enhances the operability of the computer system and makes the user-computer system interface more efficient.

In some embodiments, the location of the first viewpoint and the second viewpoint relative to the three-dimensional environment (e.g., relative to the content in the three-dimensional environment as described above) are the same, such as the location of the first viewpoint of the user 1514 as shown in FIG. 15K and the location of the second viewpoint of the user 1514 as shown in FIG. 15L, and an orientation of the first viewpoint relative to the three-dimensional environment is different from the orientation of the second viewpoint relative to the three-dimensional environment (e.g., relative to the content in the three-dimensional environment as described above), such as the orientation of the first viewpoint of the user 1514 as shown in FIG. 15K and the orientation of the second viewpoint of the user 1514 as shown in FIG. 15L.

In some embodiments, fields of view of the first viewpoint and the second viewpoint overlap. In some embodiments, the fields of view of the first and second viewpoints do not overlap. In some embodiments, the computer system detects a change in an orientation of the viewpoint of the user of the computer system that is not based on the location of the viewpoint of the user relative to the three-dimensional environment (e.g., the user rotates their head to view the content from a third viewpoint). In some embodiments, in response to detecting the change in the orientation of the viewpoint of the user, the computer system displays the content from an updated viewpoint that includes, for presentation via the display generation component, the one or more second portions of the respective physical location that were not previously visible prior to detecting the change in the orientation of the viewpoint of the user. In some embodiments, in response to detecting the change in the orientation of the viewpoint of the user, the one or more first portions of the respective physical location are no longer visible via the display generation component. In some embodiments, the computer system changes an audio characteristic (e.g., volume, position and/or orientation, or other characteristic described in more detail below) of the one or more respective sound sources when changing between presenting the first spatial audio and the second spatial audio. For example, at the first location and the first orientation of the first viewpoint, the computer system optionally presents a first sound source of the first spatial audio with a first volume. In another example, at the first location and the second orientation of the second viewpoint, the computer system optionally presents the first sound source of the second spatial audio with a second volume that is greater than the first volume. In some embodiments, at the first location and the first orientation of the first viewpoint, the computer system optionally presents the first sound source of the first spatial audio as if emanating from a first direction relative the first viewpoint (e.g., left, right, up, and/or down). In some embodiments, at the first location and the second orientation of the second viewpoint, the computer system optionally presents the first sound source of the second spatial audio as if emanating from a second direction relative the second viewpoint, different from the first direction. Changing the spatial audio presented based on detecting a change in the orientation of the viewpoint of the user independent of the location of the viewpoint of the user relative to the three-dimensional environment enhances user interactions with the computer system by providing audio corresponding to the respective view which increases a level of realism of a scene, provides improved feedback to the user about the location of the viewpoint relative to the content, enhances spatial awareness, and enhances the operability of the computer system and makes the user-computer system interface more efficient.

In some embodiments, presenting the first spatial audio corresponding to the first viewpoint includes one or more audio components having a first spatial arrangement relative to the first viewpoint, such as at the first viewpoint of the user 1514 in FIG. 15A, the computer system presents the first spatial audio that includes bird sounds 1506b, wind/tree sounds 1508b, and waterfall sounds 1510b having a first spatial arrangement.

In some embodiments, presenting the second spatial audio corresponding to the second viewpoint includes the one or more audio components having a second spatial arrangement, different from the first spatial arrangement, relative to the second viewpoint, such as at the second viewpoint of the user 1514 in FIG. 15B, the computer system presents the second spatial audio that includes bird sounds 1506b, wind/tree sounds 1508b, and waterfall sounds 1510b having a second spatial arrangement. In some embodiments, the computer system virtually positions the one or more audio components (e.g., in a respective spatial arrangement relative to a respective viewpoint) in the three-dimensional environment to correspond to one or more portions (e.g., identified sound sources) of the content such that the user perceives sounds in the respective spatial audio (e.g., the one or more audio components) just as the user would experience the sounds at the respective physical location (e.g., in the real world). For example, presenting the respective spatial arrangement (e.g., the first spatial audio and/or the second spatial audio) corresponding to the respective viewpoint (e.g., the first viewpoint and/or the second viewpoint) optionally includes the computer system generating and/or presenting the one or more audio components as if emanating from respective spatial positions of the respective spatial arrangement (e.g., the first spatial arrangement and/or the second spatial arrangement). In some embodiments, a respective spatial arrangement dictates positions and/or orientations of the one or more audio components while presenting the respective spatial audio corresponding to the respective viewpoint.

For example, the one or more audio components having a first spatial arrangement optionally include a first audio component with a first position and/or first orientation and a second audio component with a second position and/or second orientation relative to a location of the head of the user (e.g., the location of the first spatial audio as perceived by the user while first spatial audio is presented via the computer system). In some embodiments, the one or more audio components having a second spatial arrangement optionally include the first audio component with a third position and/or third orientation and the second audio component with a fourth position and/or fourth orientation relative to a location of the head of the user. In some embodiments, the third position and/or third orientation associated with the first audio component having the second spatial arrangement is different from the first position and/or first orientation associated with the first audio component having the first spatial arrangement. In some embodiments, the fourth position and/or fourth orientation associated with the first audio component having the second spatial arrangement is different from the second position and/or second orientation associated with the first audio component having the first spatial arrangement. In some embodiments, a respective audio component has different (or optionally, the same) audio characteristics (e.g., described above and/or below) while being presented according to the first spatial arrangement than while being presented according to the second spatial arrangement. For example, the respective audio component is optionally presented at a first volume in accordance with the first spatial arrangement that is different than when presented at a second volume in accordance with the second spatial arrangement.

In some embodiments, the computer moves the one or more audio components (e.g., arranges the one or more audio components in a respective spatial arrangement) relative to the viewpoint of the user in response to a change in the viewpoint of the user and/or a change in the orientation of the viewpoint of the user as described above. For example, the computer system optionally recenters the content and presents the one or more audio components centered in the field of view of the user, such that the content including the one or more audio components are within a threshold distance (e.g., 10, 20, 30, 40, 50, 100, 200, 300, 400, 500, 1000 or 2000 centimeters) of the viewpoint of the user, and/or are within a threshold angle (e.g., 1, 3, 5, 10, 15, 30, 45, 60, 75, or 85 degrees) relative to a vector extending from the viewpoint of the user (e.g., a center of the eyes of the user parallel to a physical ground). Presenting respective spatial audio that includes one or more audio components having a respective spatial arrangement relative to a respective viewpoint enhances user interactions with the computer system by providing audio corresponding to the respective view which increases a level of realism of a scene, provides improved feedback to the user about the location of the viewpoint relative to the content, enhances spatial awareness, and enhances the operability of the computer system and makes the user-computer system interface more efficient.

In some embodiments, presenting respective spatial audio (e.g., the first spatial audio and/or the second spatial audio) includes generating the respective spatial audio by applying one or more generative audio techniques, such as text/image analysis 1592e, scene segmentation 1592f, audio diffusion modeling 1592g, and sound extrapolation 1592h described in process 1590 in FIG. 15O. In some embodiments, the one or more generative audio techniques includes text and/or image analysis, scene segmentation, audio diffusion modeling, and/or sound extrapolation. In some embodiments, applying text and/or image analysis to generate the respective spatial audio includes detecting, using the one or more input devices (e.g., one or more image sensor(s) described above), one or more objects in the content, such as structures, vehicles, natural objects, animals, weather elements, or other objects described above and/or below. In some embodiments, the computer system, using optical character recognition (OCR), computer vision, scanning technology, machine or computer vision analysis, and/or pattern recognition techniques, analyzes the content to determine the one or more objects in the content. In some embodiments, applying scene segmentation includes one or more processes to segment out one or more scene objects (e.g., the one or more largest objects; the one or more objects recognized with a high degree of confidence, greater than a confidence threshold (e.g., 75, 80, and/or 90%); and/or the one or more salient objects). In some embodiments, the computer system performs one or more object recognition techniques, using one or more object classifiers or tags, on the one or more segmented scene objects to determine the objects in the content. In some embodiments, the computer system utilizes map information, such as location information and/or metadata of the physical location associated with the content to determine the objects in the content and/or to determine objects within a predetermined distance (e.g., described above) of the physical location (and optionally, not visible in the content as described in more detail below). In some embodiments, the computer system applies one or more machine learning based audio diffusion modeling techniques or diffusion probabilistic modeling techniques to generate the respective spatial audio based on the content. In some embodiments, the computer system generates and presents the respective spatial audio in a manner that simulates the respective spatial audio diffusing or spreading in the three-dimensional environment realistically. In some embodiments, the computer system extrapolates sound based on the content and/or map information as described herein. In some embodiments, the generated respective spatial audio (e.g., the first spatial audio and/or the second spatial audio) is generated using the one or more generative audio techniques described herein and does not include sound captured at the physical location associated with the content. In some embodiments, the generated respective spatial audio or optionally referred to as generative spatial audio corresponds to the spatial audio produced by a machine program that uses foundational models (FMs) (e.g., neural networks trained using data sourced from a variety of methods) to generate the spatial audio, optionally without user input providing audio that ends up in the automatically-generated spatial audio. Optionally, one or more or all components of generative spatial audio are generated by the machine program, and not by a user providing such audio components. For example, the computer system optionally generates (e.g., using an AI process or a generative AI process) automatically-generated spatial audio using a non-audio input (e.g., using text, imagery, and/or map information) and not using an audio input such as environmental sounds, ambient noises, particular soundscapes, and/or animal sounds. For example, the computer system optionally generates (e.g., using an AI process or a generative AI process) automatically-generated spatial audio using recognized objects within the content rather than using audio inputs. In some embodiments, automatically-generated spatial audio is not spatial audio that is generated as a result of audio manipulation (e.g., adding sounds to a pre-existing spatial audio or soundscapes). In some embodiments, the computer system uses one or more components of pre-existing spatial audio (e.g., natural and/or urban soundscapes generated in the real world such as soundscapes captured by a microphone or user created soundscapes or a modified version of a real-world soundscape or user created soundscape) as a seed for creating automatically-generated spatial audio. In some embodiments, the computer system uses a random seed such as an audio clip or other audio fragment as a starting point for generating the spatial audio. For example, when generating the spatial audio, the computer system optionally adds additional audio components into the spatial audio. In some embodiments, generating automatically-generated spatial audio includes using a real-world soundscape as a starting point to create a new soundscape using one or more recognized audio sources. In some embodiments, automatically-generated spatial audio incorporates one or more recognized audio sources by including the audio characteristics of the recognized audio sources without including the one or more recognized audio sources exactly. For example, the computer system optionally uses one or more autonomous processes (e.g., machine learning processes) to reimagine the starting real-world soundscape with the additional recognized audio sources. Applying one or more generative audio techniques to present respective spatial audio provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, in accordance with a determination that the content includes a first object, such as the bird 1506a in FIG. 15A, respective spatial audio (e.g., the first spatial audio and/or the second spatial audio) that is presented is based on the first object, such as bird sounds 1506b in FIG. 15A. In some embodiments, in accordance with a determination that the content includes a second object, different from the first object, such as trees 1508a in FIG. 15A, the respective spatial audio that is presented is based on the second object, such as win/tree sounds 1508b in FIG. 15A. In some embodiments, the computer system utilizes one or more of the object recognition techniques (e.g., via image recognition) described above to determine a respective object in the content. In some embodiments, the computer system does not obtain and/or utilize embedded information or metadata from the content when generating the respective spatial audio. In some embodiments, in accordance with a determination that the content includes a third object, different from the first object and the second object, the respective spatial audio that is presented is independent of (e.g., not based on) the third object. For example, the respective spatial audio that is presented is optionally based on the first object, the second object, or another object other than the third object. In some embodiments, the respective spatial audio that is presented is selected and/or provided by the user of the computer system or another user (e.g., media content creator). In some embodiments, the respective spatial audio that is presented is not generated by the computer system (e.g., is not based on the one or more objects recognized in the content). In some embodiments, the first object and/or the second object is occluded by another object. In some embodiments the occluded first object and/or the second object would otherwise be visible in the field of view of the user and/or the viewport. For example, the computer system optionally determines that the first object is occluded in a first manner in which the first object is laterally and/or vertically displaced outside the field of view of the user. In another example, the computer system optionally determines that the first object is occluded in a second manner in which the first object is laterally and/or vertically within the field of view of the user but the first object is beyond a threshold distance (e.g., 0.5, 1, 3, 5, 7, 10, 15, 20, or 30 meters) away from the field of view and/or the first object is occluded by another object. In some embodiments, presenting the respective spatial audio based on a respective object has one or more characteristics of presenting the first spatial audio, the second spatial audio, and/or other spatial audio described above and/or below. In some embodiments, the respective spatial audio that is presented based on the first object has one or more first audio characteristics. The one or more first audio characteristics optionally have one or more characteristics of the audio characteristics described above and/or below. For example, the first audio characteristics optionally include a first volume level, a first orientation, a first position, or other first audio characteristic. In some embodiments, the respective spatial audio that is presented based on the second object has one or more second audio characteristics including one or more characteristics of the audio characteristics described above and/or below. For example, the second audio characteristics optionally include a second volume level, a second orientation, a second position, or other second audio characteristic. In some embodiments, the first volume is different from the second volume. In some embodiments, the first orientation is facing a first direction relative to a respective viewpoint of the user while the second orientation is facing a second direction relative to the respective viewpoint of the user. In some embodiments, the first position is a different distance from the viewpoint of the user than the second position. In some embodiments, the computer system presents the respective spatial audio based on the respective object included in the content automatically, without detecting user input to identify the respective object and/or request that the computer system present spatial audio that is based on the respective object. Presenting respective spatial audio based on a respective object included in the content provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, the first object or the second object is not visible within the content from the viewpoint of the user in the three-dimensional environment, such as the waterfall 1510a in FIG. 15B that is not visible in the content 1502a as shown in FIG. 15A. For example, the first object and/or the second object is included in a portion of the content that is not within the field of view of the user as described above. In some embodiments, the first object and/or the second object is not included in a visual portion of the content independent of the viewpoint of the user and/or the field of view of the user. For example, the first object and/or the second object is determined to be located within a predetermined distance from the physical location associated with the content as described above, but is occluded by another object as described above. In some embodiments, the computer system presents the respective spatial audio based on the first object and/or the second object despite the first object and/or second object being outside the field of view of the user. In some embodiments, the computer system associates one or more object classifiers or tags to the content. The one or more object classifiers correspond to one or more objects visible or not visible within the content as described herein.

In some embodiments, the computer system utilizes the one or more object classifiers to generate the respective spatial audio as described above. In some embodiments, the content is associated with respective spatial audio corresponding to objects that the computer system spatializes depending on the location of the objects in the three-dimensional environment relative to the viewpoint of the user. In some embodiments, the computer system automatically classifies (or tags) objects automatically without detecting user input to tag the objects and/or request that the computer system present spatial audio that is based on a respective object that is not visible within the content. In some embodiments, when the computer system determines that the respective object changes from being not visible within the content to being visible within the content in response to a change in the viewpoint of the user (or any of the other events described above and/or below), the computer system changes one or more audio characteristics associated with the respective object, such as increasing its volume and/or in another manner with respect to position, orientation, reverb, echo, and/or other characteristic as described above and/or below. In some embodiments, instead of increasing the volume, the computer system decreases the volume or presents a neutral volume. In some embodiments, the computer system displays, via the display generation component, an indication that the respective spatial audio being presented is based on the first object and/or second object not visible within the content. In some embodiments, the computer system detects user input (e.g., as described above) directed to the indication, and in response, the computer system presents second content that includes the first object and/or second object now visible within the second content. In some embodiments, in response to and/or while presenting the second content, the computer system changes one or more audio characteristics of the respective spatial audio, such as, for example, increasing a volume of respective audio component(s) corresponding to the first object and/or second object now visible within the second content.

In some embodiments, and as described above and with reference to method(s) 800, 1000, 1200, and/or 1400, the computer system displays the content with a respective level of immersion corresponding to a respective view of a respective physical location. For example, when the computer system displays the content with a first level of immersion, the content optionally occupies 33% of the field of view. In some embodiments, at this first level of immersion, the content includes one or more first portions of the content. In another example, when the computer system optionally displays the content with a second level of immersion, the content optionally occupies 100% of the field of view. In some embodiments, at this second level of immersion, the content includes one or more second portions of the content. In some embodiments, the one or more second portions of content displayed at the second level of immersion include a larger portion of the content than the one or more first portions of content displayed at the first level of immersion. In some embodiments, the computer system presents a same respective spatial audio when displaying the content at the first level of immersion and at the second level of immersion. In some embodiments, while displaying the content at the first level of immersion and presenting respective spatial audio, the computer system detects a change in the viewpoint of the user, and in response to this change, the computer system ceases to display the content (or ceases to display a portion of the content), and presents a same respective spatial audio as the respective spatial audio presented prior to detecting the change in the viewpoint. In some embodiments, the computer system detects user input (e.g., a voice command, selection(s) of virtual or physical button(s), a turning of an electromechanical or digital crown, and/or any of the other user inputs described herein) requesting to change the level of immersion, and in response to this user input, the computer system increases or decreases the level of visual prominence of the content in accordance with the user input (e.g., by a magnitude, and/or in a direction of the first input (e.g., force of a contact, amount of rotation of the crown, and/or a number and/or duration of contact of the virtual or physical button(s)). For example, the computer system optionally displays the content consuming a first region of the three-dimensional environment, and in response to a turning of the crown in a first direction and by a first amount, optionally displays the content consuming a second region of the three-dimensional environment (e.g., larger than or smaller than the first region). Additionally, in response to detecting a turning of the crown in a second direction opposing the first, and by a second amount that is different from the first amount, the computer system optionally displays the content consuming a third region (e.g., larger than or smaller than the first and/or the second regions). Additionally or alternatively, the computer system optionally concurrently scales the content in accordance with the input changing the level of immersion (e.g., proportionally, inversely, or otherwise based upon the change in level of immersion). Presenting respective spatial audio based on a respective object not visible within the content from the viewpoint of the user in the three-dimensional environment provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, the first object or the second object includes a person, an animal, a geographic feature, or a human-made object, such as the bird 1506a in FIG. 15A, the waterfall 1510a in FIG. 15B, the ballpark 1588a in FIG. 15K, and/or any of the other objects described in FIGS. 15A-15N. For example, a geographic feature optionally refers to a representation of a waterfall, lake, tree, weather element, or other object found in the environment. In some embodiments, a human-made object optionally refers to a building, bridge, transportation vehicle, or other object made by a human and/or machine. In some embodiments, the computer system presents respective spatial audio based on two or more objects and based on a known or predicted interaction among the two or more objects, such as for example, splashing sounds caused by boots on a puddle or rustling sounds of the wind through leaves and branches on a tree. In some embodiments, the computer system presents respective spatial audio that includes natural soundscapes, such as waterfall sounds, ocean sounds, and/or weather sounds. In another examples, the respective spatial audio optionally includes urban and industrial soundscapes, such as traffic sounds, and/or building construction sounds. In some embodiments, the respective spatial audio includes human and/or animal sounds, such as humans playing in a park and/or sports field, crowd cheering at a sporting event, bees buzzing, and/or birds chirping. In another example, the respective spatial audio includes ambient sounds, such as produced from wind chimes, sculptures, and/or organ pipes. Presenting respective spatial audio based objects such as people, animals, geographic features, and/or human-made objects within the content provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, the content corresponds to a first physical location such as the first physical location corresponding to the location of the water 1568a in FIG. 15K. In some embodiments, in accordance with a determination that the first physical location is within a view of second content for a second physical location, such as shown in FIG. 15L where the water 1568a is within the view of the content 1576, respective spatial audio (e.g., the first spatial audio and/or the second spatial audio) that is presented is based on the second content corresponding to the second physical location, such as the spatial audio that includes water sounds 1568b in FIG. 15L In some embodiments, in accordance with a determination that the first physical location is beyond the view of the second content, such as shown in FIG. 15M where the park 1580e is beyond the view of the content 1576 of FIG. 15L, the respective spatial audio that is presented is not based on the second content corresponding to the second physical location (e.g., is based on the content corresponding to the first physical location and/or respective content for a respective physical location with a respective view of the content associated with the first physical location), such as, for example, the computer system does not present spatial audio that includes park sounds corresponding to the park 1580e in FIG. 15M. In some embodiments, the first content is visible and/or within the viewing boundaries of the second content. In some embodiments, the second content has one or more characteristics of the content described above. In some embodiments, presenting respective spatial audio based on the second content has one or more characteristics of presenting the first spatial audio, the second spatial audio, and/or other spatial audio described above and/or below. In some embodiments, presenting the respective spatial audio based on the second content includes generating the respective spatial audio by applying one or more generative audio techniques on the second content as described above. In some embodiments, presenting the respective spatial audio based on the second content includes spatial audio selected and/or provided by the user of the computer system or another user. In some embodiments, the respective spatial audio that is based on the second content is not generated by the computer system. In some embodiments, presenting the respective spatial audio based on the second content includes presenting the respective spatial audio based on the second and the content described above and/or below. In some embodiments, presenting the respective spatial audio based on the second content includes one or more respective audio components corresponding to one or more respective objects visible and/or not visible within the second content and the content from the viewpoint of the user in the three-dimensional environment as described above. In some embodiments, the computer system displays the content (e.g., not the second content) while presenting respective spatial audio based on the second content. In some embodiments, the computer system presents the respective spatial audio based on the second content automatically, without detecting user input to identify the second content and/or request that the computer system present spatial audio that is based on the second physical location associated with the second content. In some embodiments, the computer system displays, via the display generation component, an indication that the respective spatial audio being presented is based on the second physical location and/or second object that is optionally not included (and optionally, not visible) within the content. In some embodiments, the computer system detects user input (e.g., as described above) directed to the indication, and in response, the computer system presents the second content. In some embodiments, in response to and/or while presenting the second content, the computer system changes one or more audio characteristics of the respective spatial audio, such as, for example, increasing a volume of respective audio component(s) corresponding to the one or more objects now visible within the second content that is displayed. In some embodiments, the computer system detects a second user input (e.g., as described above) corresponding to a request to display the second content, and in response to this second user input, the computer system displays the second content and determines whether the second physical location is within a view of third content for a third physical location. In some embodiments, when the computer system determines that the second physical location is within the view of the third content for the third physical location, the computer system presents spatial audio based on the third content in a manner that is optionally analogous to and/or has one or more of the characteristics of presenting spatial audio based on the second content described herein. Presenting respective spatial audio that is based on second content corresponding to a second physical location in response to a determination that the first physical location is within a view of the second content for the second physical location provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, the content corresponds to a first physical location, such as the location corresponding to the ballpark 1588a in FIG. 15K. In some embodiments, in accordance with a determination that the first physical location is within a predetermined distance (e.g., as described above) from a second physical location, such as the trail 1570a as shown in FIG. 15L, respective spatial audio (e.g., the first spatial audio and/or the second spatial audio) that is presented is based on the first physical location and map information associated with the second physical location, such as the spatial audio that includes audio component 1570b (e.g., footsteps) in FIG. 15L. In some embodiments, in accordance with a determination that the first physical location that is beyond the predetermined distance from the second physical location, such as shown in FIG. 15M where the park 1580e is beyond the predetermined distance from the location corresponding to the ballpark 1588a in FIG. 15L, the respective spatial audio that is presented is based on the first physical location and not the map information associated with the second physical location, such as, for example, the computer system does not present spatial audio that includes park sounds corresponding to the park 1580e in FIG. 15L. In some embodiments, the computer system obtains map information from a map application on the computer system. In some embodiments, the content does not include visual elements corresponding to the map information used when generating the respective spatial audio. In some embodiments, presenting the respective spatial audio that is based on the first physical location and/or the second physical location includes accessing the server and retrieving map information related to the first physical location and/or the second physical location as described above. In some embodiments, the map information includes one or more objects (e.g., landmarks, geographic features, human-made objects, and/or any of the objects described above and/or below) located at (or within the predetermined distance of) the first physical location and/or the second physical location. In some embodiments, the computer system generates the respective spatial audio based on the map information at the first physical location and/or the second physical location using any of the generative audio techniques described above. In some embodiments, the computer system presents the respective spatial audio that is based on the first physical location and/or the second physical location automatically, without detecting user input to identify the first physical location and/or the second physical location and/or request that the computer system present spatial audio that is based on the first physical location and/or the second physical location. In some embodiments, presenting the respective spatial audio that is based on the first physical location and/or the second physical location includes accessing media content information from an application other than the maps application, such as a music application, a podcast application, a media content streaming application, or other media content application. For example, the respective spatial audio generated and presented by the computer system optionally includes first media content (e.g., songs, movie scores, live broadcasts, or other media content) associated with the first physical location and/or the second physical location and/or one or more objects located at (or within the predetermined distance of) the first physical location and/or the second physical location. Presenting respective spatial audio that is based on a first physical location and/or a second physical location and respective map information associated with the first physical location and/or the second physical location in response to a determination whether the second physical location is within a predetermined distance from the first physical location provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, in accordance with a determination that a first physical location corresponding to the content includes first terrain, such as terrain 1522e in FIG. 15D, respective spatial audio (e.g., the first spatial audio and/or the second spatial audio) that is presented is based on the first terrain, such as, for example, presenting spatial audio that includes footsteps on gravel as described in FIG. 15D. In some embodiments, in accordance with a determination that the first physical location corresponding to the content includes second terrain, different from the first terrain, such as the trail 1570a in FIG. 15L, the respective spatial audio that is presented is based on the second terrain, such as spatial audio that includes audio component 1570b (e.g., footsteps) in FIG. 15L. In some embodiments, the first terrain, the second terrain, or other terrain refers to characteristics of the land, ground, or artificial equivalent (e.g., artificial surfaces and/or other objects) at the respective physical location associated with the content. In some embodiments, the computer system determines that the content includes a respective terrain using one or more of the object recognition techniques described above to determine the respective terrain (e.g., mountainous, forest, valley, marsh, dessert, urban, jungle, river, coast, cave, tundra, or other area of land having particular characteristics). In some embodiments, the computer system determines that the content includes a respective terrain based on map information and/or metadata associated with the content as described above. In some embodiments, the content does not include visual elements corresponding to the map information associated with the first physical location including visual elements corresponding to and/or indicative of the first terrain and/or the second terrain. In some embodiments, prior to displaying the content, the content undergoes processing to filter, remove, blur, and/or mask one or more visual elements in the content to provide a cleaner, less cluttered presentation, protect privacy, and/or prevent misuse. In some embodiments, prior to displaying the content, map information associated with the content undergoes similar processing to remove map information. In some embodiments, map information associated with the content is obtained from the map application and/or another application, different from the map application, such as a photo management application, a travel guide application, a media content application, or any of the other applications described herein. In some embodiments, the respective spatial audio that is presented based on the first terrain includes one or more first audio characteristics (e.g., volume, position and/or orientation, or other characteristic described above and/or below) different from one or more second audio characteristics associated with the second terrain. In some embodiments, the computer system presents the respective spatial audio based on the respective terrain automatically, without detecting user input to identify the respective physical location (optionally including the respective terrain) and/or request that the computer system present spatial audio that is based on the respective terrain. Presenting respective spatial audio that is based on respective terrain provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, in accordance with a determination that a first physical location corresponding to the content indicates a first time of day, such as the time of day included in the visual indication 1532 in FIG. 15E, respective spatial audio (e.g., the first spatial audio and/or the second spatial audio) that is presented is based on the first time of day, such as the spatial audio that includes the audio components illustrated in FIG. 15E. In some embodiments, in accordance with a determination that the first physical location corresponding to the content indicates a second time of day, different from the first time of day, such as, for example, a time of day shown by the content 1502a in FIG. 15B, the respective spatial audio that is presented is based on the second time of day, such as the spatial audio that includes the audio components illustrated in FIG. 15B. In some embodiments, in accordance with a determination that the content indicates a first time of day, respective spatial audio that is presented is based on the first time of day. In some embodiments, in accordance with a determination that the content indicates a second time of day, different from the first time of day, the respective spatial audio that is presented is based on the second time of day. In some embodiments, the first time of day, the second time of day, or other time of day refers to a time of day at the respective physical location associated with the content, different from the physical location of the computer system. In some embodiments, in accordance with a determination that the time of day is the first time of day, the computer system forgoes presenting respective spatial audio associated with the second time of day. In some embodiments, in accordance with a determination that the time of day is the first time of day, the computer system forgoes presenting respective spatial audio corresponding to the second time of day. In some embodiments, in accordance with a determination that the time of day is the first time of day, the computer system forgoes presenting the respective spatial audio associated with the first time of day. In some embodiments, the respective spatial audio that is presented is the same spatial audio irrespective of the time of day. In some embodiments, the computer system presents the respective spatial audio based on a respective time of day irrespective of a current time of day at the computer system. In some embodiments, the computer system determines that the content indicates a respective time of day using one or more of the object recognition techniques described above to determine the respective time of day. In some embodiments, the computer system determines that the content indicates the respective time of day based on map information and/or metadata associated with the content as described above. In some embodiments, the content does not include visual elements corresponding to the map information associated with the first physical location including visual elements corresponding to and/or indicative of the first time of day and/or the second time of day. In some embodiments, prior to displaying the content, the content including map information associated with the content undergo processing to filter the content and/or map information as described above. In some embodiments, and as described above, the content optionally includes pre-recorded content of the respective physical location during the respective time of day (e.g., not including audio captured during the recording of the respective physical location). In some embodiments, the respective time of day associated with the content is different from the time of day at the computer system. In some embodiments, the respective time of day includes the morning, afternoon, evening, nighttime, or other time of day. In some embodiments, the computer system sets the respective time of day of the content to a time of day different from the respective time of day at which the content was recorded. For example, while the content indicates the first time of day, the computer system sets the content to the first time of day automatically (or, in response to user input corresponding to a request to set the content to the second time of day). In some embodiments, the computer system sets the content to the second time of day automatically to align with the time of day of the computer system. In some embodiments, setting the content to the second time of day includes displaying the content in accordance with the second time of day including presenting respective spatial audio based on the second time of day. In some embodiments, the second time of day corresponds to a system appearance setting, such as a display setting or color scheme of the computer system as described in method 1000. In some embodiments, the respective spatial audio that is presented based on the first time of day includes one or more first audio characteristics (e.g., volume, position and/or orientation, or other characteristic described above and/or below) different from one or more second audio characteristics associated with the second time of day. In some embodiments, the respective spatial audio that is presented based on the first time of day is different from the respective spatial audio that is presented based on the second time of day. For example, presenting the spatial audio based on the first time of day includes one or more first audio sources, different from the one or more second audio sources associated with presenting the spatial audio based on the second time of day. Presenting respective spatial audio that is based on a respective time of day provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, in accordance with a determination that a first physical location corresponding to the content indicates a first weather condition, such as the rainy weather condition shown in content 1502b in FIG. 15E, respective spatial audio (e.g., the first spatial audio and/or the second spatial audio) that is presented is based on the first weather condition, such as spatial audio that includes rain sounds 1510c in FIG. 15E. In some embodiments, in accordance with a determination that the first physical location corresponding to the content indicates a second weather condition, different from the first weather condition, such as clear weather in FIG. 15B, the respective spatial audio that is presented is based on the second weather condition, such as, for example, spatial audio that indicates clear weather. In some embodiments, in accordance with a determination that the content indicates a first weather condition, respective spatial audio that is presented is based on the first weather condition. In some embodiments, in accordance with a determination that the content indicates a second weather condition, different from the first weather condition, the respective spatial audio that is presented is based on the second weather condition. In some embodiments, the first weather condition, the second weather condition, or other weather condition refers to a weather condition at the respective physical location associated with the content, different from the physical location of the computer system. For example, the weather condition optionally refers to the weather condition that happened at the time the content was captured. In another example, the weather condition optionally refers to the current weather condition happening at the respective physical location associated with the content. In some embodiments, in accordance with a determination that the content indicates the first weather condition, the computer system forgoes presenting respective spatial audio associated with the second weather condition. In some embodiments, in accordance with a determination that the content indicates the first weather condition, the computer system forgoes presenting respective spatial audio corresponding to the second weather condition. In some embodiments, in accordance with a determination that the content indicates the first weather condition, the computer system forgoes presenting the respective spatial audio associated with the first weather condition. In some embodiments, the respective spatial audio that is presented is the same spatial audio irrespective of the weather condition. In some embodiments, the computer system presents the respective spatial audio based on a respective weather condition irrespective of a current weather condition at the physical location of the computer system. In some embodiments, the respective weather condition associated with the content is different from the respective weather condition at the physical location of the computer system. In some embodiments, the computer system determines that the content indicates the respective weather condition using one or more of the object recognition techniques described above to determine the respective weather condition. In some embodiments, the computer system determines that the content indicates the respective weather condition based on map information and/or metadata associated with the content as described above. In some embodiments, the content does not include visual elements corresponding to the map information associated with the first physical location including visual elements corresponding to and/or indicative of the first weather condition and/or the second weather condition. In some embodiments, prior to displaying the content, the content including map information associated with the content undergo processing to filter the content and/or map information as described above. In some embodiments, the computer system changes the respective weather condition of the content to a weather condition different from the weather condition that occurred at the time the content was captured. For example, while the content indicates the first weather condition, the computer system sets the weather condition to the first weather condition automatically (or, in response to user input corresponding to a request to set the content to the second weather condition). In another example, while the content indicates the second weather condition, the computer system sets the weather condition to the second weather condition automatically (or, in response to user input corresponding to a request to set the content to the second weather condition). In some embodiments, the computer system sets the weather condition to the second weather condition automatically to align with the current weather condition occurring at the physical location at the current time of the computer system. In some embodiments, the computer system sets the weather condition to the second weather condition automatically to align with the weather condition that happened at the time the content was captured. In some embodiments, setting the content to the second weather condition includes displaying the content in accordance with the second weather condition occurring at the physical location (e.g., displaying, in the content, one or more representations of the second weather condition, such as clouds, rain, lightning, fog, or other representation of other weather conditions described in more detail with reference to method 1000) including presenting respective spatial audio based on the second weather condition occurring at the physical location. In some embodiments, the respective spatial audio that is presented based on the first weather condition includes one or more first audio characteristics (e.g., volume, position and/or orientation, or other characteristic described above and/or below) different from one or more second audio characteristics associated with the second weather condition. In some embodiments, the respective spatial audio that is presented based on the first weather condition is different from the respective spatial audio that is presented based on the second weather condition. For example, presenting the spatial audio based on the first weather condition includes one or more first audio sources, different from the one or more second audio sources associated with presenting the spatial audio based on the second weather condition. Presenting respective spatial audio that is based on a respective weather condition provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, in accordance with a determination that a first physical location corresponding to the content indicates a first event, such as for example, a celebratory event as indicated in FIG. 15N, respective spatial audio (e.g., the first spatial audio and/or the second spatial audio) that is presented is based on the first event, such as spatial audio that includes fireworks 1568b in FIG. 15N. In some embodiments, in accordance with a determination that the first physical location corresponding to the content indicates a second event, different from the first event, such as for example, a running event, the respective spatial audio that is presented is based on the second event, such as, for example, spatial audio that includes audio component 1570b (e.g., footsteps) in FIG. 15L In some embodiments, in accordance with a determination that the content does not indicate the first event or the second event, the respective spatial audio that is presented is not based on the first event or the second event, such as, for example, spatial audio that does not include audio component 1568b (e.g., fireworks) of FIG. 15N and footsteps 1770b of FIG. 15L. In some embodiments, in accordance with a determination that the content indicates a first event, respective spatial audio that is presented is based on the first event. In some embodiments, in accordance with a determination that the content indicates a second event, different from the first event, the respective spatial audio that is presented is based on the second event. In some embodiments, in accordance with a determination that the content indicates the first event, the computer system forgoes presenting respective spatial audio associated with the second event. In some embodiments, in accordance with a determination that the content indicates the first event, the computer system forgoes presenting respective spatial audio corresponding to the second event. In some embodiments, in accordance with a determination that the content indicates the first event, the computer system forgoes presenting the respective spatial audio associated with the first event. In some embodiments, the respective spatial audio that is presented is the same spatial audio irrespective of the event. In some embodiments, the first event, the second event, or other event refers to a sporting event, entertainment event, social event, community event, cultural event, charity event, or other event at the respective physical location associated with the content, different from the physical location of the computer system. In some embodiments, the computer system presents the respective spatial audio based on the respective event irrespective of an event occurring at the physical location of the computer system. In some embodiments, the computer system determines that the content indicates the respective event using one or more of the object recognition techniques described above to determine the respective event. In some embodiments, the computer system determines that the content indicates the respective event based on map information and/or metadata associated with the content as described above. In some embodiments, the content does not include visual elements corresponding to the map information associated with the first physical location including visual elements corresponding to and/or indicative of the first event and/or the second event. In some embodiments, prior to displaying the content, the content including map information associated with the content undergo processing to filter the content and/or map information as described above. In some embodiments, the computer system sets the respective event to a different event from the event that occurred at the time the content was recorded. For example, while the content optionally indicates the first event (or no event), the computer system sets the first event to be included in the content automatically (or, in response to user input corresponding to a request to include the second event in the content). In some embodiments, setting the event to the second event includes displaying the content in accordance with the second event (e.g., displaying, in the content, one or more representations associated with the second event, such as fireworks, decorations, and/or other visual indications of the second event) including presenting respective spatial audio based on the second event. In some embodiments, the respective spatial audio that is presented based on the first event includes one or more first audio characteristics (e.g., volume, position and/or orientation, or other characteristic described above and/or below) different from one or more second audio characteristics associated with the second event. In some embodiments, the respective spatial audio that is presented does not correspond to an event. In some embodiments, the respective spatial audio that is presented based on the first event is different from the respective spatial audio that is presented based on the second event. For example, presenting the spatial audio based on the first event includes one or more first audio sources, different from the one or more second audio sources associated with presenting the spatial audio based on the second event. Presenting respective spatial audio that is based on a respective event provides a high quality and realistic spatialized audio experience to the user which increases a level of realism of a scene, provides improved feedback to the user about the location of the content, enhances spatial awareness, and enhances the operability of the computer system and makes the user-computer system interface more efficient.

In some embodiments, while displaying content in the three-dimensional environment, such as content 1502b in FIG. 15F, the computer system detects, via the one or more input devices, a user input corresponding to a request to present second content, such as voice input 1536 in FIG. 15F. For example, the computer system optionally detects an attention of a user of the computer system, a contact on a touch-sensitive surface, actuation of a physical input device, a predefined gesture (e.g., pinch gesture or air tap gesture), a voice input from the user, and/or any of the user inputs described in method(s) 800, 1000, 1200, and/or 1400 corresponding to a request to present second content. In some embodiments, the request to present second content includes performing a search operation, optionally for something within the content, such as a particular business, location, restaurant, street or the like. In some embodiments, the search operation indicates a search characteristic or parameter such as, for example, a structure (e.g., store, restaurant, and/or hotel), building (e.g., library, post office, and/or business), natural landscape (e.g., river, lake, park, garden, and/or beach), landmark (e.g., tourist attractions, famous buildings and/or sculptures), street object (e.g., bench, bus stop, public transportation hubs), infrastructure (e.g., roads, bridges, bike paths, parking lots, and/or electric), and/or any of the other (non-audio) search characteristics described herein. In some embodiments, the search characteristic does not specify a particular physical location and/or a visual element in the content. In some embodiments, the search characteristic is different from the audio characteristic. In some embodiments, the search operation indicates a particular audio characteristic as described herein without optionally specifying the particular physical location. In some embodiments, performing the search operation includes interaction with a digital assistant as described in method(s) 800, 1000, and/or 1200. In some embodiments, the second content has one or more characteristics as the content described above.

In some embodiments, in response to detecting the user input, in accordance with a determination that the input indicates a first search characteristic, such as the word “café” included in the voice input 1536 in FIG. 15F, and a first audio characteristic, such as the word “quiet” included in the voice input 1536 in FIG. 15F, the computer system displays, via the display generation component, second content related to a first physical location that has (and/or is associated with) the first audio characteristic and the first search characteristic, such as content 1540e in FIG. 15G. In some embodiments, determining that the first physical location has the first audio characteristic and the first search characteristic is based on spatial audio corresponding to the content, such as the spatial audio that includes the audio components 1542a, 1542b, and 1542c in FIG. 15G. In some embodiments, in response to detecting the user input, in accordance with a determination that the input indicates the first search characteristic and a second audio characteristic, different from the first audio characteristic, such as, for example, when the voice input 1536 includes the word “jazz”, the computer system displays, via the display generation component, second content related to a second physical location, different from the first physical location, that has (and/or is associated with) the first audio characteristic and the first search characteristic, such as, for example, content that includes a jazz café. In some embodiments, determining that the second physical location has the first audio characteristic and the first search characteristic is based on spatial audio corresponding to the content, such as, for example, spatial audio that includes jazz music. In some embodiments, in accordance with a determination that the input indicates a second search characteristic, different from the first search characteristic, and the first audio characteristic, the computer system displays, via the display generation component, second content related to a third physical location, different from the second physical location, that has (and/or is associated with) the first audio characteristic and the second search characteristic, wherein determining that the third physical location has the first audio characteristic and the second search characteristic is based on spatial audio corresponding to the content. In some embodiments, in accordance with a determination that the input indicates the second search characteristic and the second audio characteristic, the computer system displays, via the display generation component, second content related to a fourth physical location, different from the third physical location, that has (and/or is associated with) the second audio characteristic and the second search characteristic, wherein determining that the fourth physical location has the second audio characteristic and the second search characteristic is based on spatial audio corresponding to the content. In some embodiments, the computer system utilizes the spatial audio (e.g., generated by the computer system) in determining a response to the user's request to present second content. In some embodiments, the second search characteristic is similar to the first search characteristic in that they are non-audio. In some embodiments, the second search characteristic can be one or more of the examples described above with respect to the first search characteristic. In some embodiments, the first audio characteristic, the second audio characteristic, or other audio characteristic has one or more characteristics of any of the one or more audio characteristics, such as volume, position and/or orientation, or other characteristic described above and/or below. In some embodiments, the first audio characteristic optionally refers to a particular sound source or sound component as described above. In some embodiments, while displaying the second content related to a respective physical location (e.g., the first physical location, the second physical location, the third physical location, the fourth physical location, or any of the other physical locations described herein), the computer system presents respective spatial audio having a respective audio characteristic (e.g., the first audio characteristic and/or the second audio characteristic) and a respective search characteristic (e.g., the first search characteristic and/or the second search characteristic). In some embodiments, presenting the respective spatial audio having the first audio characteristic is different (or optionally, the same) from presenting the respective spatial audio without having the first audio characteristic. In some embodiments, presenting respective spatial audio having the first audio characteristic includes presenting the respective spatial audio in a manner in which the sound source is emphasized, such as, for example, presented with a greater volume relative to other sound sources associated with the respective physical location in response to the request. It is understood that although this example is directed volume, the computer system optionally changes other audio characteristics, such as position, orientation, or any of the other audio characteristics described above and/or below. In some embodiments, the computer system determines that the user input seeks second content indicative of a respective audio characteristic and a respective search characteristic (e.g., the first search characteristic and/or the second search characteristic). For example, the user input optionally includes a voice input query asking the computer system and/or digital assistant a question, such as “Where is the closest quiet café?” or “Where can I listen to live jazz music?.” In some embodiments, the computer system and/or digital assistant uses the voice input to infer the respective audio characteristic for the request to present second content. For example, the computer system optionally determines that the voice input indicates a first audio characteristic, such as, for example, “jazz music” without specifying specific parameters, such music genre, artist, or location. For example, the computer system optionally determines possible content items and generates corresponding spatial audio that fulfills the request. In some embodiments, the computer system and/or digital assistant uses displayed content, the generated spatial audio associated with the displayed content, and/or the voice input to infer a location for the request to present second content. For example, the computer system uses a respective physical location associated with the content displayed to infer the physical location intended for the request is within a threshold distance (e.g., 5, 10, 20, 50, 100, 150, or 250 kilometers) of the respective physical location associated with the content displayed prior to detecting the user input. In some embodiments, the user input does not indicate or specify a particular point of interest and/or location. In some embodiments, in response to the user input, the computer system automatically (e.g., without detecting or receiving additional user input) provides map information associated with the displayed content (e.g., a respective physical location) along with the user input to the digital assistant to define the request to present second content and generate a response that satisfies the request. In some embodiments, the first physical location is within the threshold distance of the respective physical location associated with the content displayed prior to detecting the user input. In some embodiments, the first physical location includes content satisfying the request. For example, the content optionally includes a point of interest (e.g., major landmark, geographic feature, building, and/or structure) that satisfies the request, such as, for example, the request to locate a quiet café or locate a point of interest that includes live jazz music. In some embodiments, the computer system and/or digital assistant uses previous user dialogue history and/or previous user activity to infer a location for the request to present content. In some embodiments, previous user activity optionally refers to detected user interaction with a maps application or other application, different from the maps application.

In some embodiments, displaying the second content has one or more characteristics of displaying the content as described above. For example, the computer system optionally ceases to display the content and optionally displays the second content with a respective level of immersion corresponding to a respective view of the first physical location. In some embodiments, displaying the second content includes panning the second content and/or displaying the second content at a zoom level to center on a location of the second content corresponding to the search result. In some embodiments, the computer system displays a visual indication (e.g., pin, icon, or other user interface element) at the location of the search result in the second content. In some embodiments, the computer system provides more than one search result. In some embodiments, the computer system displays respective visual indications at respective locations in the second content corresponding to the search results. In some embodiments, displaying the second content includes displaying a navigation user interface element as described in more detail below. In some embodiments, displaying the second content includes displaying, via the display generation component, a user interface element (e.g., window or volume) that includes the second content. In some embodiments, displaying the second content includes displaying, via the display generation component, a user interface of a map application or other application (optionally different or the same as the application associated with displaying the content). In some embodiments, the computer system automatically (e.g., without detecting or receiving additional user input) presents third spatial audio having the first audio characteristic and associated with the first physical location. It is understood that although the embodiments described herein are directed to third spatial audio having the first audio characteristic and associated with the first physical location, such functions and/or characteristics, optionally apply to other spatial audio having other audio characteristics and associated with other physical locations such as the fourth spatial audio having the second audio characteristic associated with the second physical location. Displaying second content related to a respective physical location and presenting respective spatial audio having a respective audio characteristic and associated with the respective physical location in response to user input corresponding to a request to present second content provides an efficient way of obtaining content related to the respective location and presenting respective spatial audio having the respective audio characteristic without specifying the respective physical location and/or particular spatial audio provides an efficient way of obtaining content and presenting spatial audio related to the request, thereby reducing the need for subsequent inputs to locate content related to the respective physical location which simplifies the interaction between the user and the computer system and enhances the operability of the computer system and makes the user-computer system interface more efficient.

In some embodiments, the computer system displays, via the display generation component, a navigation user interface element representing a first view of a first physical location in the three-dimensional environment, such as the navigation user interface element 1538a in FIG. 15H In some embodiments, presenting respective spatial audio (e.g., the first spatial audio and/or the second spatial audio) includes presenting the respective spatial audio corresponding to the first view of the first physical location, such spatial audio that includes audio components 1542b, 1542d, 1542e, and 1542f in FIG. 15H. In some embodiments, displaying the content in the three-dimensional environment optionally refers to displaying the navigation user interface element as described herein. In some embodiments, the navigation user interface element has one or more of the characteristics of the navigation user interface element of method(s) 800, 1000, and/or 1200, and/or as described in more detail below. In some embodiments, the computer system displaying the navigation user interface element includes initiating or running a user interface of a maps application (or optionally, another application of method(s) 800, 1000, 1200, and/or 1400). In some embodiments, the computer system displays the user interface of the maps application including the navigation user interface element within the three-dimensional environment as described in method(s) 800, 1000, and/or 1200. In some embodiments, the user interface of the maps application has one or more of the characteristics of the user interface of the maps application of method(s) 800, 1000, 1200, and/or 1400, and/or as described in more detail below. In some embodiments, the computer system displays the navigation user interface element concurrently with the content in the three-dimensional environment as described above. In some embodiments, the computer system does not display the content concurrently with the navigation user interface element. In some embodiments, the navigation user interface element is a two-dimensional map of the first physical location as described in method(s) 800, 1000, and/or 1200. In some embodiments, and as will be described in more detail below, the computer system displays a visual indication (e.g., binoculars icon or other graphical representation) corresponding to the location of the first view of the first physical location (e.g., the location at which the first view of the first physical location was captured by a camera or simulated camera) within the navigation user interface element. In some embodiments, presenting the respective spatial audio corresponding to the first view of the first physical location has one or more characteristics of presenting first spatial audio, second spatial audio, or any of the other spatial audios described above and/or below. In some embodiments, presenting the respective spatial audio corresponding to the first view of the first physical location includes generating spatial using the one or more generative audio techniques described above. In some embodiments, the generated spatial audio corresponding to the first view of the first physical location includes spatial audio that was generated from a direction corresponding to a respective direction associated with the first physical location as if emanating from a location relative to the viewpoint of the user of the computer system. Presenting respective spatial audio corresponding to a respective view of a respective physical location that is represented by a navigation user interface element enhances user interactions with the computer system by providing audio corresponding to the respective view of the first physical location which provides improved feedback to the user, enhances spatial awareness, and enhances the operability of the computer system and makes the user-computer system interface more efficient.

In some embodiments, presenting the respective spatial audio (e.g., the first spatial audio and/or the second spatial audio) corresponding to the first view of the first physical location includes presenting one or more first audio components to simulate the one or more first audio components emanating from a first location within the navigation user interface element, such as people sounds 1542b from the location corresponding to the representation of the patio 1538d in FIG. 15H. In some embodiments, the one or more first audio components are associated with a physical location associated with the first location within the navigation user interface element, such as a physical patio corresponding to the representation of the patio 1538d in FIG. 15H In some embodiments, presenting the respective spatial audio corresponding to the first view of the first physical location includes presenting one or more second audio components to simulate the one or more second audio components emanating from a second location within the navigation user interface element, different from the first location, such as street sounds 1542d from the location corresponding to the representation of the street 1538e in FIG. 15H. In some embodiments, the one or more second audio components are associated with a physical location associated with the second location within the navigation user interface element, such as a physical street corresponding to the representation of the street 1538e in FIG. 15H. In some embodiments, presenting the respective spatial audio including presenting one or more respective audio components (e.g., the first audio components and/or the one or more second audio components) associated with a respective physical location includes generating the respective spatial audio using one or more of the generative audio techniques described above. In some embodiments, the second location is different from the first location and the spatial audio that is presented to simulate the one or more second audio components emanating from the second location is different from the spatial audio that is presented to simulate the one or more first audio components emanating from the first location. For example, presenting the one or more second audio components include one or more second audio characteristics (e.g., volume, position and/or orientation, or other characteristic described above and/or below) different from one or more first audio characteristics associated with the one or more first audio components. In some embodiments, the one or more first audio components and the one or more second audio components include one or more characteristics as the audio or sound components described above. In some embodiments, the one or more first audio components include the same or different sound components or sound sources as the one or more second audio components. In some embodiments, the computer system determines that the content includes a first object at a first location and a second object at a second location, and in response, the computer system presents corresponding audio components to simulate the corresponding audio components coming from the respective locations of the objects in the content. Presenting spatial audio corresponding to a respective location enhances user interactions with the computer system by providing audio corresponding to the respective physical location which provides improved feedback to the user, enhances spatial awareness, and enhances the operability of the computer system and makes the user-computer system interface more efficient.

In some embodiments, while displaying the navigation user interface element representing the first view of the first physical location in the three-dimensional environment and while detecting, via the one or more input devices, a location of an attention (e.g., gaze) of a user of the computer system on the navigation user interface element, such as attention 1544a directed to a location within the navigation user interface element 1538a in FIG. 15G (e.g., not including input from one or more portions of the user (e.g., a hand, arm, and/or finger) other than those portions (e.g., eyes) providing the attention input or an input received using another input device, such as a voice input or an input made with a hardware input device), in accordance with a determination that the location of the attention of the user is directed to a first location in the navigation user interface element, such as the attention 1544a directed to a location within the navigation user interface element 1538a corresponding to the representation of the patio 1538d, the computer system presents the respective spatial audio (e.g., the first spatial audio and/or the second spatial audio) with one or more characteristics corresponding to the first location, such as spatial audio that includes the audio components 1542b, 1542d, 1542e, and 1542f in FIG. 15H (e.g., corresponding to a physical location corresponding to that first location) In some embodiments, while displaying the navigation user interface element representing the first view of the first physical location in the three-dimensional environment and while detecting, via the one or more input devices, the location of the attention of the user of the computer system on the navigation user interface element, in accordance with a determination that the location of the attention of the user is directed to a second location in the navigation user interface element, different from the first location, such as, for example, the attention 1544a directed to a location within the navigation user interface element 1538a corresponding to the representation of the café 1538c, the computer system presents the respective spatial audio with one or more characteristics corresponding to the second location, such as spatial audio that includes the audio components 1542a, 1542b, 1542c in FIG. 15G, (e.g., corresponding to a physical location corresponding to that second location). In some embodiments, presenting the respective spatial audio with the one or more audio characteristics corresponding to a respective location (e.g., the first location and/or the second location) includes generating the respective spatial audio using one or more of the generative audio techniques described above. In some embodiments, the computer system detects that attention of the user has been directed to the navigation user interface element for an amount of time exceeding a predetermined time threshold (e.g., 0.05, 0.1, 0.2, 0.3, 0.5, 1, 2, 5, 10, 20, or 30 seconds). For example, the computer system optionally presents spatial audio corresponding to a respective location based on a determination that the attention of the user is directed to the respective location of the navigation user interface element. Presenting the respective spatial audio with one or more characteristics corresponding to the respective location optionally includes one or more characteristics of presenting first spatial audio, second spatial audio, or any other spatial audio described above and/or below. In some embodiments, the computer system correlates the attention point of the user to the respective location of the navigation user interface element that corresponds to a respective physical location in the physical world. In some embodiments, the one or more characteristics of the respective spatial audio corresponding to the respective location are based on map information (e.g., map coordinates, such as latitude, longitude, altitude) that correlate to respective locations of points of interest to locations in the physical world as described in more detail above. In some embodiments, the computer system generates the respective spatial audio based on the content as described in more detail above. In some embodiments, the computer system does not present the respective spatial audio to the user as generated. For example, when presenting the respective spatial audio, the computer system optionally turns on, turns off, attenuates, or amplifies the one or more sound characteristics and/or one or more audio sources corresponding to different portions of the content in response to a location of the attention of the user as described herein. Presenting respective spatial audio with one or more characteristics corresponding to a respective location in response the attention of the user directed to the navigation user interface element provides an efficient way of presenting spatial audio related to the physical location which provides improved feedback to the user, enhances spatial awareness, and enhances the operability of the computer system and makes the user-computer system interface more efficient.

In some embodiments, while displaying the navigation user interface element representing the first view of the first physical location in the three-dimensional environment, the computer system 101 displays, via the display generation component, a visual indication of a respective navigation viewpoint (e.g., as described in method(s) 800, 1000, 1200, and/or 1400) at a location within the navigation user interface element, such as the visual indication 1580c in FIG. 15M. In some embodiments, the respective navigation viewpoint corresponds to a respective viewpoint at which the respective spatial audio (e.g., the first spatial audio and/or the second spatial audio) is presented and the location within the navigation user interface element corresponds to the first physical location, such as the spatial audio that includes audio components 1568b, 1568c, 1570b, and 1572b in FIG. 15M. In some embodiments, the computer system displays the visual indication at a location (e.g., x, y, and z coordinates) within the navigation user interface element corresponding to the respective viewpoint. In some embodiments, the computer system displays the visual indication with an orientation that corresponds to the respective viewpoint. In some embodiments, the computer system changes the position and/or orientation of the visual indication to correspond to the position and/or orientation of the respective viewpoint shown in the content as the viewpoint of the user changes as described above. The computer system optionally displays the visual indication at a location within the navigation user interface element that corresponds to a viewpoint of a simulated camera as described above. In some embodiments, the computer system displays a second visual indication of the field of view corresponding to an orientation of the respective view of the first physical location (e.g., relative to a fixed coordinate system of the first physical location) within the first navigation user interface element. In some embodiments, the second visual indication of the field of view is displayed proximate to or in association with (e.g., proximate to or incorporated with) the visual indication of the respective navigation viewpoint described herein. In some embodiments, the second visual indication of the field of view indicates the boundaries of the first physical location that are presented via the respective spatial audio and/or displayed within the content. In some embodiments, the computer system detects user input (e.g., as described above) corresponding to a request to move the visual indication from a first location to a second location within the navigation user interface element. In some embodiments, in response to detecting the user input, the computer system presents respective spatial audio corresponding to a respective physical location that corresponds to the second location of the visual indication relative to the navigation user interface element. Displaying a visual indication of a respective navigation viewpoint at a location within a navigation user interface element, wherein the respective navigation viewpoint corresponds to a respective viewpoint at which the respective spatial audio is presented provides an efficient way of indicating to the user the viewpoint of the respective spatial audio, thereby improving communication between the users and enabling the user to use the computer system quickly and efficiently.

In some embodiments, while displaying the navigation user interface element representing the first view of the first physical location in the three-dimensional environment, such as the navigation user interface element 1538a in FIG. 15H, in accordance with a determination that a distance between the viewpoint of the user of the computer system to a respective location associated with the navigation user interface element is a first distance, such as the first distance shown in overhead view 1512 in FIG. 15I the computer system presents the respective spatial audio (e.g., the first spatial audio and/or the second spatial audio) with one or more first characteristics, such as spatial audio that includes audio components 1542d, 1542e, and 1542f. In some embodiments, while displaying the navigation user interface element presenting the first view of the first physical location in the three-dimensional environment, in accordance with a determination that a distance between the viewpoint of the user of the computer system to the respective location associated with the navigation user interface element is a second distance, different from the first distance, such as the second distance shown in overhead view 1512 in 15J, the computer system presents the respective spatial audio with one or more second characteristics, different from the one or more first characteristics, such as spatial audio that includes audio components 1542d, 1542e, 1542f, and 1542b. In some embodiments, the one or more characteristics of the respective spatial audio vary based on the distance between the location corresponding to the computer system relative to the respective location associated with the navigation user interface element, such as the overall volume, and/or relative volumes for respective sound sources or sound components of the respective spatial audio being different between the one or more first characteristics and the one or more second characteristics. For example, presenting the respective spatial audio with one or more second characteristics optionally includes presenting the respective spatial audio with a volume that is greater than the volume of the spatial audio presented with the one or more first audio characteristics. It is understood that although this example is directed to volume, the computer system optionally changes other audio characteristics, such as clarity, reverberation, and/or complexity, or any of the other audio characteristics described above and/or below. In some embodiments, at the first distance between the viewpoint of the user to the respective location associated with the navigation user interface element, the computer system presents the respective spatial audio with a first degree of clarity, first degree of reverberation, and/or a first degree of complexity. In some embodiments, at the second distance between the viewpoint of the user to the respective location associated with the navigation user interface element, the computer system presents the respective spatial audio with a second degree of clarity, second degree of reverberation, and/or a second degree of complexity. In some embodiments, the first degree of clarity is less than or greater than the second degree of clarity. In some embodiments, the first degree of reverberation is less than or greater than the second degree of reverberation. In some embodiments, the first degree of complexity is less than or greater than the second degree of complexity. Presenting spatial audio with one or more respective characteristics based on a distance between the location corresponding to the computer system relative to the respective location associated with the navigation user interface element enhances user interactions with the computer system by providing audio corresponding to a respective distance from the navigation user interface element which provides improved feedback to the user, enhances spatial awareness, and enhances the operability of the computer system and makes the user-computer system interface more efficient.

In some embodiments, the content is associated with an application that is not associated with the user of the computer system, such as, for example, an application that is associated with user interface element 1520a in FIG. 15C. For example, the application (optionally referred to as a third-party application) is developed by a second user (or company or entity), different from the user of the computer system. In some embodiments, the computer system receives and/or obtains spatial audio associated with the content and generated by the second user. In some embodiments, the computer system is running the application on the computer system and displays, via the display generation component, an audio creation user interface associated with the application. In some embodiments, while displaying the audio creation user interface associated with the application, the computer system receives, via the one or more input devices, one or more specifications for spatial audio and in response to receiving the one or more specifications, the computer system generates a respective spatial audio (e.g., the first spatial audio and/or the second spatial audio) based on the received one or more specifications. In some embodiments, the audio creation user interface includes one or more parameters (e.g., inputted by a user) that are used by the computer system to generate spatial audio. In some embodiments, the parameters (e.g., corresponding to the one or more specifications) displayed on and/or inputted via the audio creation user interface include any information that is relevant to the creation of spatial audio including but not limited to: the one or more sound sources or sound components to be associated with a respective physical location, the one or more audio characteristics associated with the respective spatial audio, the one or more generative audio techniques applied to generate spatial audio, and/or any other parameter that would influence the respective spatial audio presented. In some embodiments, the audio creation user interface is displayed the computer system while a user of the maps application is running or another application, different from the maps application is running. In some embodiments, the audio creation user interface includes one or more selectable options that, when selected, causes the computer system to set and/or define the one or more specifications that will be used by the computer system to generate and/or present the respective spatial audio. Displaying content that is associated with an application that is not associated with the user of the computer system provides a variety of spatial audio that is customizable, thereby minimizing additional user input required to generate, correct or modify the spatial audio, which, conserves computing and power resources that would otherwise be expended due to the additional input.

FIGS. 17A-17I illustrate examples of a computer system providing navigation assistance in accordance with some embodiments.

FIG. 17A illustrates a computer system 101 displaying, via a display generation component 120 (e.g., display generation components 1-122a and 1-122b of FIG. 1), a three-dimensional environment 1700a from a viewpoint of a user of the computer system 101. In some embodiments, the computer system 101 in FIG. 17A is analogous to and/or includes one or more characteristics, provides one or more features, and/or includes one or more components as the computer system 101 described with reference to FIGS. 7A-7Q. In FIG. 17A, the display generation component 120 is analogous to and/or includes one or more characteristics and/or one or more components (e.g., sensors 114a through 114c) as the display generation component 120 described with reference to FIG. 7A.

As shown in FIG. 17A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1700a. For example, three-dimensional environment 1700a includes representations of a lamp 1700b and a window 1700c in a room in which the computer system 101 is located.

In some embodiments, the computer system 101 displays, via display generation component 120, one or more virtual objects in the three-dimensional environment 1700a in response to a request to provide navigation assistance to a second user of a second computer system. As an example, the second user of the second computer system is a food delivery person providing a food delivery service to the user of the computer system 101. In particular, the user of the computer system 101 submitted a food order for delivery at a specific address that is being fulfilled by the second user of the second computer system. For example, the computer system 101 receives a request to participate in a communication session with the second user of the second computer system including providing navigation assistance to the second, and in response to this request, the computer system 101 displays, via the display generation component 120, a user interface element 1702a, as shown in FIG. 17A. The user interface element 1702a is a user interface element of a map application, videotelephony application, or other application described in method 1800. The user interface element 1702a includes information about the second user (e.g., name and contact information), a first selectable option that, when selected causes the computer system 101 to decline the communication session and a second selectable option 1702b that, when selected, causes the computer system 101 to initiate communication with the second computer system and provide navigation assistance.

In some embodiments, in response to the request to provide navigation assistance, the computer system 101 displays, via the display generation component 120, a navigation user interface element 1704a, as shown in FIG. 17A and described in more detail in method(s) 800, 1000, 1200, 1400, 1600, and/or 1800. For example, the navigation user interface element 1704a is a volumetric map representing a map region or physical area including an indication 1704b of a current location of the second computer system navigating along a route to a destination (e.g., the delivery address). The navigation user interface element 1538a includes one or more representations of buildings, trees, roadways, parks, bodies of water and/or other geographical features in the physical area. In some embodiments, the computer system 101 optionally displays the navigation user interface element 1704a concurrently with the user interface element 1702a. In some embodiments, the computer system 101 displays the navigation user interface element 1704a automatically (e.g., without detecting user input expressly requesting to display the navigation user interface element 1704a including a current location of the second computer system) and/or in response to the request to provide navigation assistance to the second computer system.

In FIG. 17A, the computer system detects user input that includes an air pinch gesture 1706b (e.g., described in more detail in method(s) 800, 1000, 1200, 1400, 1600, and/or 1800) while attention 1706a (e.g., gaze) of the user of the computer system 101 is directed to the second selectable option 1702b. In response to detecting this user input, the computer system 101 performs an action to provide navigation assistance to the second computer system including displaying one or more additional selectable options in the user interface element 1702a and displaying, via the display generation component 120, a user interface element 1708a as shown in FIG. 17B. User interface element 1702a includes a third selectable option 1702e that, when selected, causes the computer system 101 to enable video; a fourth selectable option 172f that, when selected, causes the computer system 101 to mute audio, a fifth selectable option 1702c that, when selected, causes the computer system 101 to disable navigation assistance that is currently running on the computer system 101; and a sixth selectable option 1702d that, when selected, causes the computer system 101 to end the communication session with the second computer system 101.

In FIG. 17B, the user interface element 1708a is a user interface element of a map application or other application described in method 1800. The user interface element 1708a includes a map region or physical area including an indication 1708f of a current location of the second computer system navigating along a route to the destination, as represented by indication 1708g. The user interface element 1708a includes navigation instructions 1708e. In some embodiments, while the computer system 101 is configured to provide navigation assistance to the second computer system, the computer system 101 displays, in the user interface element 1708a, an indication 1708b of an alternative route in accordance with a determination that navigating along the alternative route is more efficient. In FIG. 17B, the indication 1708b of the alternative route includes a first selectable option 1708c that, when selected, causes the computer system 101 to provide navigation instructions including the alternative route to the second computer system; and a second selectable option 1708d that, when selected, causes the computer system to decline providing navigation instructions including the alternative route to the second computer system. In some embodiments, when the computer system detects user input that includes an air pinch gesture 1710c (e.g., described in more detail in method(s) 800, 1000, 1200, 1400, 1600, and/or 1800) while attention 1710a (e.g., gaze) of the user of the computer system 101 is directed to the first selectable option 1708c, the computer system 101 transmits, to the second computer system, navigation instructions that include the alternative route.

In some embodiments, the computer system 101 provides user-defined navigation instructions to the second computer system as described in method 1800. For example, in FIG. 17B, the computer system 101 detects voice input 1710b, such as voice input 1710b corresponding to a request to add navigation instructions (e.g., “street parking on Mission Street”). In response to detecting this voice input 1710b, the computer system 101 displays in the navigation user interface element an annotation 1714 corresponding to the navigation instructions, as shown in FIG. 17C. For example, the annotation 1714 identifies/highlights the particular street where parking is available/permitted. In some embodiments, in response to detecting this voice input 1710b, the computer system 101 causes the second electronic device to display an annotation similar to annotation 1714 as described in more detail with reference to FIG. 17E. In some embodiments, while the computer system 101 is providing navigation assistance to the second computer system 101, the computer system 101 displays a notification of the arrival of the second computer system at the destination. For example, in FIG. 17C, the computer system 101, displays, via display generation component 120, indication 1712 of the arrival of the second computer system at the destination in accordance with a determination of arrival of the second computer system at the destination. As illustrated in FIG. 17C, the computer system 101 changes a respective location of the indication 1704b of the location of the second computer system (e.g., moves the indication 1704b) within the navigation user interface element 1704a as the computer system 101 detects the second computer system navigating along the route.

In some embodiments, the computer system 101 presents annotations within a view of a physical environment of the second computer system corresponding to a current location of the second computer system as described in more detail in method 1800. For example, in response to detecting voice input 1716 in FIG. 17C corresponding to a request to include building access instructions, the computer system 101, displays, via display generation component 120, user interface 1718a, as shown in FIG. 17D. User interface 1718a includes the view of the physical environment of the second computer system corresponding to the current location of the second computer system. User interface 1718a also includes annotation 1720a overlaid on and/or within this view. The annotation 1720a including the building access instructions is automatically generated by the computer system 101 in response to detecting voice input 1716. In FIG. 17D, the computer system 101 also displays user interface element 1702a including the plurality of selectable options (e.g., selectable options 1702e, 1702f, 1702c, and 1702d) described above. In some embodiments, while the computer system 101 displays the user interface 1718a including the view of the physical environment of the second computer system, the computer system 101 detects a sequence of user inputs corresponding to a request to generate for display annotation 1720b and move the annotation 1720b. In response to detecting this sequence of user inputs, the computer system 101 displays and moves annotation 1720b in accordance with the movement of an air pinch gesture. The movement of the air pinch gesture includes movement from a first location 1724a (e.g., described in more detail in method(s) 800, 1000, 1200, and/or 1400) within the three-dimensional environment 1700a to a second location 1724b within the three-dimensional environment 1700a. The computer system 101 moves annotation 1720b from a first location within user interface 1718a (e.g., corresponding to the first location 1724a) to a second location within user interface 1718a (e.g., corresponding to the second location 1724b) while attention 1722a (e.g., gaze) of the user of the computer system 101 is directed to the annotation 1720b. In response to detecting this sequence of user inputs, the computer system 101 performs an action to move the annotation 1720b in accordance with the movement of the air pinch gesture, as shown in FIG. 17D.

In some embodiments, the computer system 101 initiates a process to cause the second computer system to display a visual indication of the annotation generated by the computer system 101, as described in more detail with reference to method 1800. For example, and as shown in FIG. 17E, the visual indication of the annotation (e.g., annotation 1730a, annotation 1730b, and annotation 1730c) is displayed by the second computer system (e.g., computer system 1728) as immersive navigation directions shown in augmented reality. In FIG. 17E, the second computer system 1728 displays annotation 1730a (e.g., corresponding to annotation 1720a), annotation 1730b (corresponding to annotation 1720b), and annotation 1730c (e.g., corresponding to the current location of the second computer system and/or arrival at the destination) overlaid on a portion of the second environment 1726 of the second computer system 1728 (e.g., the physical environment of the second computer system corresponding to the current location of the second computer system). In some embodiments, the computer system 101 transmits placement and/or positioning information of the one or more annotations. For example and as shown in FIG. 17E, when the second computer system 1728 displays annotation 1730a, the second computer system 1728 displays annotation 1730a in a location or position within the second environment 1726 corresponding to a respective location or position at which the first computer system 101 placed or added the annotation within the view (e.g., the view of the physical environment of the second computer system corresponding to the current location of the second computer system). In some embodiments, the computer system 101 transmits an indication of annotation to the second computer system 1728 in accordance with a determination of the arrival of the second computer system 1728 at the destination. For example, in FIG. 17E, receipt of this indication of the annotation causes the second computer system 1728 to display annotation 1730c and content 1730d notifying the second computer system 1728 of its arrival at the destination.

In some embodiments, the computer system 101 is configured to add, remove, and/or edit the navigation instructions. For example, in FIG. 17F, the computer system 101, displays, via the display generation component 120, user interface element 1736a that includes content (e.g., detailed turn-by-turn instructions) for navigating along a route from the current location of the second computer system to the destination. In some embodiments, the user interface element 1736a includes the same (or optionally, similar) content to the content displayed by the second computer system for navigating to the destination. In FIG. 17F, the user interface element 1736a includes a first selectable option 1736b that, when selected, causes the computer system to add new navigation instructions and/or edit existing navigation instructions; and a second selectable option 1736c that, when selected, causes the computer system 101 to save the navigation instructions as a guide as described in the following figures and/or transmit the navigation instructions to the second computer system.

In FIG. 17F, the computer system 101 also displays, via the display generation component 120, user interface 1732, as shown in FIG. 17F. User interface 1732 includes the view of the physical environment of the second computer system corresponding to the current location of the second computer system. User interface 1732 also includes annotation 1734 overlaid on and/or within this view. The annotation 1734 includes content corresponding to instructions provided by the user of the computer system 101. User interface 1732 also includes first selectable option 1718c and second selectable option 1718b described above. In FIG. 17D, the computer system 101 also displays user interface element 1702a including the plurality of selectable options (e.g., selectable options 1702e, 1702f, 1702c, and 1702d) described above. In FIG. 17F, the computer system 101 detects user input that includes an air pinch gesture 1738b (e.g., described in more detail in method(s) 800, 1000, 1200, and/or 1400) while attention 1738a (e.g., gaze) of the user of the computer system 101 is directed to the second selectable option 1736c. In response to detecting this user input, the computer system 101 performs an action to save the navigation instructions as a guide as described in the following figures and/or transmit the navigation instructions to the second computer system.

In some embodiments, the computer system 101 determines that user of the computer system 101 has completed making changes to the navigation instructions and/or is no longer making changes to one or more annotations, and in accordance with this determination, the computer system 101 displays, via the display generation component 120, the navigation user interface element 1704a that includes one or more same characteristics and/or functions as the navigation user interface element 1704a described with reference to FIG. 17A. For example, in FIG. 17G, the navigation user interface element 1704a includes the plurality of annotations described above, such as annotation 1746c (e.g., generated in response to voice input 1710b in FIG. 17B), annotation 1746a, and annotation 1746b (e.g., generated in response to voice input 1710b in FIG. 17C). In some embodiments, the computer system 101 automatically generates and presents annotation 1746a within the navigation user interface element 1704a (e.g., without user input requesting to add the annotation 1746a) based on map information. For example, the computer system 101 optionally determines, based on map information, a nearby parking lot that is within a predetermined distance (e.g., described in method 1800) of the destination. As shown in FIG. 17G, the computer system 101 displays annotation 1746a indicative of the parking lot in accordance with the determination that a parking lot is within the predetermined distance of the destination.

In some embodiments, the computer system 101 determines that the second user of the second computer system has arrived at the destination, and in accordance with this determination, the computer system automatically terminates communication with the second computer system, and removes access to information associated with providing navigation assistance to the second computer system as described in method 1800. In some embodiments, the computer system 101 receives a communication message (e.g., text, voice, and/or via another communication channel) from the second computer system indicative that the user of the second computer system has arrived at the destination. For example, in FIG. 17G, the computer system 101 displays the user interface element 1740a including content 1740b indicative of the arrival of the second computer system at the destination. With respect to the example use case related to food delivery, and as shown in FIG. 17G, the content 1740b includes a hyperlink that, when selected, causes the computer system 101 to display information related to the food delivery service, such as a photo of the food. In FIG. 17G, the user interface element 1740a also includes content 1742a that includes a first selectable option that, when selected, causes the computer system 101 to forgo performing the action to delete information associated with providing navigation assistance to the second computer system (e.g., forgo deleting building access code information); and a second selectable option that, when selected, causes the computer system 101 to perform the action to delete said information. In FIG. 17G, the computer system 101 detects user input that includes an air pinch gesture 1748b (e.g., described in more detail in method(s) 800, 1000, 1200, and/or 1400) while attention 1748a (e.g., gaze) of the user of the computer system 101 is directed to the second selectable option 1742b. In response to detecting this user input, the computer system 101 performs the action to delete information associated with providing navigation assistance to the second computer system as described in more detail in method 1800. In some embodiments, performing this action to delete the information includes deleting the second computer system's access to the information and/or presenting an option to the user of the computer system 101 to save the information as described in the figures that follow.

For example, in FIG. 17H, the computer system 101 is configured to save the navigation instructions for later retrieval (e.g., as a map guide described in more detail in method 1800). In FIG. 17H, the computer system 101 displays, via the display generation component 120, a prompt or user interface element 1750a that includes a first selectable option 1750c that, when selected, causes the computer system 101 to forgo saving the navigation instructions; and a second selectable option 1750b that, when selected, causes the computer system 101 to save the navigation instructions. In FIG. 17H, the computer system 101 detects user input that includes an air pinch gesture 1752b (e.g., described in more detail in method(s) 800, 1000, 1200, and/or 1400) while attention 1752a (e.g., gaze) of the user of the computer system 101 is directed to the second selectable option 1750b. In response to detecting this user input, the computer system 101 performs the action to save the navigation instructions for later retrieval (e.g., as a map guide described in more detail in method 1800). In some embodiments, performing this action includes the computer system 101 displaying, via the display generation component 120, a user interface element 1754a that includes one or more map guides that include respective navigation instructions, as shown in FIG. 17I. For example, the user interface element 1754a includes a map guide 1754b that includes navigation instructions related to food delivery services. The map guide 1754b includes an option 1754c that, when selected, causes the computer system to automatically generate information, such as building access code information for inclusion in the respective navigation instructions.

In some embodiments, method 1800 is performed at a first computer system in communication with a display generation component, one or more input devices, and a second computer system. In some embodiments, the first computer system and the second computer system have one or more of the characteristics of the computer system of method(s) 800, 1000, 1200, 1400, and/or 1600. In some embodiments, the one or more input devices have one or more of the characteristics of the one or more input devices of method(s) 800, 1000, 1200, 1400, and/or 1600. In some embodiments, the display generation component has one or more of the characteristics of the display generation component of method(s) 800, 1000, 1200, 1400, and/or 1600.

In some embodiments, the computer system receives (1802a) a request to provide navigation assistance to the second computer system, such as the request associated with displaying user interface element 1702a in FIG. 17A. In some embodiments, the computer system receives the request to provide navigation assistance while the computer system displays, via the display generation component, a user interface of a map application in a three-dimensional environment. In some embodiments, the user interface of the map application has one or more characteristics of the user interface of the map application of method(s) 800, 1000, 1200, 1400, and/or 1600. In some embodiments, the computer system receives the request to provide navigation assistance while the three-dimensional environment is visible via the display generation component. In some embodiments, the three-dimensional environment has one or more characteristics of the three-dimensional environment described with reference to method(s) 800, 1000, 1200, 1400, and/or 1600. In some embodiments, the request to provide navigation assistance to the second computer system is received from the second computer system. In some embodiments, a first user of the first computer system and a second user of the second computer system are participants in a real-time or nearly real-time communication session involving the transmission of captured audio and/or video content from one or more respective one or more input devices and/or one or more respective cameras from the first computer system and/or the second computer system. In some embodiments, the communication session includes displaying and/or otherwise communicating, via the first computer system and/or the second computer system, a current location of the second computer system navigating along a route to a destination. In some embodiments, prior to receiving the request to provide navigation assistance to the second computer system, the first computer system and the second computer system are not participants in a communication session. In some embodiments, the communication session starts when the first electronic device accepts the request to provide navigation assistance to the second computer system. In some embodiments, the second computer system is providing navigation directions to the user of the second computer system (e.g., using a maps application on the second computer system). In some embodiments, providing navigation assistance includes the first computer system displaying an indication of the current location of the second computer system and transmitting content (e.g., annotations) for display, via the second computer system, instructing the second user of the second computer system to navigate from the current location to the destination. In some embodiments, while providing navigation assistance, the first computer system displays a view of the second user navigating to the destination (e.g., the displayed view corresponds to the viewpoint of the second user) including the content described in more detail below. In some embodiments, the request to provide navigation assistance to the second computer system is received at the first computer system. For example, the first computer system optionally detects user input directed to a user interface element of the user interface of the map application or, optionally, another application, different from the map application, such as a messaging application, a videotelephony application, a ride-hailing application, a food delivery application, or other application. In some embodiments, the user input includes a gaze of the first user of the first computer system, a contact on a touch-sensitive surface, actuation of a physical input device, a predefined gesture (e.g., pinch gesture or air tap gesture) and/or a voice input from the first user directed to the user interface element. In some embodiments, providing navigation assistance is initiated automatically without receiving user input from the first computer system or the second computer system. For example, the first computer system optionally initiates navigation assistance in accordance with a determination that the current location of the second computer system is within a predetermined distance (e.g., 20, 50, 100, 200, 300, 400, or 500 meters) of the destination.

In some embodiments, in response to receiving the request (1802b), the computer system displays (1802c), via the display generation component, a user interface including a view of a physical environment of the second computer system corresponding to a current location of the second computer system navigating along a route to a destination, such as the user interface 1718a in FIG. 17D. In some embodiments, the view includes one or more portions of a second environment (e.g., physical environment) of the second computer system visible in the three-dimensional environment of the first computer system as will be described in more detail below. For example, the one or more portions of the second environment are optionally based on a live camera feed of the physical environment of the second computer system being captured by the second computer system. In another example, the one or more portions of the second environment optionally include representations of the physical environment of the second computer system based on previously captured images or video (or, optionally, including spatial video), such as street-level imagery, panoramas, and/or 360 degrees camera views taken from and/or of the physical environment of the second computer system. In some embodiments, the previously captured images or video were not captured by the second computer system or the first computer system. In some embodiments, the previously captured images or video are retrieved from a remote server in communication with the first computer system and/or a local processor (e.g., maintained by the first computer system optionally from the map application operating on the first computer system) for retrieving map information including identifying a location including points of interest corresponding to the physical environment of the second computer system. In some embodiments, the first computer system controls how much of the physical environment (or representation of the physical environment) of the second computer system is displayed in the three-dimensional environment of the first computer system as will be described in more detail below. In some embodiments, and as will be described in more detail below, while displaying the user interface including the view of the current location of the second computer system navigating along the route to the destination, the first computer system displays a three-dimensional topographical map representing a respective physical area corresponding to the physical environment of the second computer system.

In some embodiments, while displaying the view of the physical environment of the second computer system corresponding to the current location of the second computer system, the computer system detects (1802d), via the one or more input devices, a first input corresponding to a request to include an annotation within the view, such as annotation 1720b in FIG. 17D. In some embodiments, in response to detecting the first input (1802e), the computer system displays (1802f) the view of the physical environment of the second computer system corresponding to the current location of the second computer system including the annotation, such as the annotation as shown in FIG. 17D and initiates (1802g) a process to cause the second computer system to display a visual indication of the annotation, such as annotation 1730b in FIG. 17E. In some embodiments, the first input includes a sequence of user inputs including any number of user inputs described herein and/or below. In some embodiments, the annotation provides information to guide the second user of the second computer system to the destination. For example, the annotation optionally includes text, images, graphics, handwritten input, references (e.g., links to information), or other information to guide the second user. In some embodiments, the first computer system displays the annotation overlaid on a portion of the view of the physical environment of the second computer system corresponding to the current location of the second computer system. In some embodiments, initiating the process to cause the second computer system to display a visual indication of the annotation includes the first computer system transmitting, to the second computer system, an indication of the annotation. In some embodiments, the visual indication of the annotation is displayed by the second computer system as immersive navigation directions shown in augmented reality, three-dimensional map views, and/or step-by-step navigation directions as will be described in more detail below. In some embodiments, the second computer system displays the visual indication of the annotation overlaid on a portion of the second environment of the second computer system (e.g., the physical environment of the second computer system corresponding to the current location of the second computer system). In some embodiments, transmitting the indication of the annotation to the second computer system includes placement or positioning information. For example, when the second computer system displays the visual indication of the annotation, the second computer system displays the visual indication of the annotation in a location or position within the second environment of the second computer system corresponding to a respective location or position at which the first computer system placed or added the annotation within the view (e.g., the view of the physical environment of the second computer system corresponding to the current location of the second computer system). In some embodiments, and as will be described in more detail below, the first computer system displays an indication of the annotation within the three-dimensional topographical map at a respective location corresponding to a physical location associated with the current location of the second computer system. Providing a view of a physical environment of the second computer system corresponding to a current location of a second computer system navigating along a route to a destination including an annotation that provides navigation assistance to the second computer system in response to a request to provide navigation assistance to the second computer system provides an efficient way of providing navigation assistance, which reduces power usage and improves battery life of the computer system by enabling the user to use the computer system more quickly and efficiently.

In some embodiments, the request to provide navigation assistance to the second computer system is received while a first user of the first computer system and a second user of the second computer system are participants in a communication session between the first computer system and the second computer system, such as the communication associated with user interface element 1702a in FIG. 17B. In some embodiments, the communication session is a video and/or audio communication session. In some embodiments, the communication session is a messaging communication session. In some embodiments, the first computer system does not receive and/or is not receptive to and/or does not initiate navigation assistance when the first computer system is not a participant in a communication session with the second computer system. Thus, in some embodiments, in order to provide navigation assistance, the first computer system determines that the user of the first computer system is a participant in a communication session with the second user of the second computer system. In some embodiments, the first computer system is located at a first location and the second computer system is located at a second location, different from the first location of the first computer system. In some embodiments, the request is received while the first computer system and the second computer system are in a first type of communication session (e.g., messaging communication session or any of the other communication sessions described herein). In some embodiments, when the first computer system provides navigation assistance to the second computer system as described above, the type of communication session changes from the first type to a second type of communication session (e.g., video and/or audio communication session), different from the first type of communication session. In some embodiments, the type of communication session does not change. In some embodiments, and as will be described in more detail below, in an instance when the first computer system determines that the second computer system has arrived at the destination, the first computer system ends the communication session between the first computer system and the second computer system. In some embodiments, the first computer system ends the communication session in response to detecting user input corresponding to a request to end the communication session. In some embodiments, the user input corresponding to the request to end the communication session has one or more characteristics as the first input described above. Receiving the request to provide navigation assistance while in a communication session between the first computer system and the second computer system provides an efficient way of providing navigation assistance, which reduces power usage and improves battery life of the computer system by enabling the user to use the computer system more quickly and efficiently.

In some embodiments, the computer system displays, via the display generation component, a navigation user interface element representing a first view of the current location of the second computer system in the three-dimensional environment, such as navigation user interface element 1704a in FIG. 17A. In some embodiments, the navigation user interface element has one or more of the characteristics of the navigation user interface element of method(s) 800, 1000, 1200, and/or 1600. In some embodiments, the first view is the view of the physical environment of the second computer system displayed via the user interface described above. In some embodiments, the navigation user interface element representing the first view is displayed concurrently with the view of the physical environment of the second computer system displayed via the user interface described above.

In some embodiments, the navigation user interface element includes a representation of the second computer system navigating along the route to the destination, such as indication 1704b in FIG. 17A. For example, the representation of the second computer system includes an image, icon, avatar, and/or other graphic representing the second computer system. In some embodiments, the first computer system displays the representation of the second computer system at a respective location within the navigation user interface element corresponding to a current location of the second computer system. In some embodiments, the first computer system changes the respective location of the representation of the second computer system (e.g., moves the representation) within the navigation user interface element as the first computer system detects the second computer system navigating along the route. Presenting a representation of the second computer system navigation along the route to the destination within a navigation user interface element provides an efficient way of indicating to the user a location of the second computer system navigating along the route, thereby improving communication between the users and enabling the user to use the computer system quickly and efficiently.

In some embodiments, initiating the process to cause the second computer system to display the visual indication of the annotation includes initiating an augmented reality process to cause the second computer system to display the visual indication of the annotation (overlaid and/or) within a second environment (e.g., second three-dimensional environment) of the second computer system corresponding to a respective location at which the first computer system included the annotation within the view, such as annotations 1730a, 173ba, and 1730c overlaid on the environment 1726 of the second computer system 1728 in FIG. 17E. In some embodiments, the first computer system transmits a request to invoke or run a respective function on the second computer system, such as immersive walking directions shown in augmented reality, three-dimensional map views, and/or step-by-step walking directions. In some embodiments, in response to receiving the request to run the function (and optionally, after receiving user input accepting the request), the second computer system displays the visual indication of the annotation in a location or position within the second environment of the second computer system corresponding to a respective location or position at which the first computer system placed or added the annotation within the view (e.g., the view of the physical environment of the second computer system corresponding to the current location of the second computer system). In some embodiments, and as described above, the first computer system transmits placement or positioning information for the indication of the annotation. In some embodiments, the first computer system transmits one or more different representations of the annotation to the second computer system. In some embodiments, the one or more different representations of the annotation that are displayed is based on the type of computer system and/or the type of application installed on the computer system. For example, in accordance with a determination that the second computer system optionally includes a first function (e.g., spatial computing system for presenting immersive augmented reality and/or virtual reality), the first computer system optionally generates and/or transmits a visual indication of the annotation that includes a first spatial arrangement. In some embodiments, the first spatial arrangement includes a spatial position, orientation, and/or other placement characteristic for overlaying the annotation within the second environment of the second computer system. In some embodiments, in accordance with a determination that the second computer system includes a second function (e.g., computing system for presenting two-dimensional content), different from the first function, the first computer system optionally generates and/or transmits a visual indication of the annotation that includes a second spatial arrangement, different from the first spatial arrangement. For example, the second spatial arrangement optionally includes a non-spatial position, orientation, and/or other placement characteristic for displaying the annotation within the second environment of the second computer system, such as within a maps user interface, turn-by-turn directions user interface, or other user interface providing two-dimensional content. In some embodiments, the first computer system propagates annotations to all views including the second view of the second computer system and the view of the physical environment of the second computer system displayed within the three-dimensional environment of the computer system. For example, when the first computer system determines a first annotation applied to a first location and a second annotation applied to a second location within the view, the first computer system transmits a first visual indication of the first annotation and a second visual indication of the second annotation to the second computer system such that the first annotation is displayed at a first location within the second environment of the second computer system and the second annotation is displayed at a second location within the second environment. The first location within the second environment corresponds to the first location within the view and the second location within the second environment corresponds to the second location within the view. In another example, the first computer system detects user input (e.g. as described above) corresponding to a request to move the first annotation from the first location to a third location within the view, and in response to detecting this user input, the first computer system moves the annotation from the first location to the third location within the view and transmits a third indication of the movement of the first annotation such that the first annotation is displayed at a respective location in the second environment of the second computer system corresponding to third location. Initiating an augmented reality process to cause the second computer system to display the visual indication of the annotation overlaid within a second environment of the second computer system corresponding to a respective location at which the first computer system included the annotation within the view in response to a request to provide navigation assistance to the second computer system provides an efficient way of providing navigation assistance, which reduces power usage and improves battery life of the computer system by enabling the user to use the computer system more quickly and efficiently.

In some embodiments, while displaying the view of the physical environment of the second computer system corresponding to the current location of the second computer system, the computer system displays, via the display generation component, one or more options that, when selected, cause the first computer system to provide navigation assistance using one or more suggested routes to the destination, different from the route to the destination, and based on map information, such as indication 1708b of an alternative route in FIG. 17B. For example, the one or more options are optionally displayed within the three-dimensional environment of the first computer system. In some embodiments, the first computer system detects user input from the user of the computer system directed to the one or more options displayed by the first computer system. In some embodiments, the first computer system displays a route configuration user interface including the one or more selectable options for selecting one or more suggested routes using other roadways, paths, and/or modes of transportation for navigating to the destination, different from the route to the destination. In some embodiments, the one or more suggested routes are based on map information and/or contextual information (e.g., retrieved from a remote server in communication with the first computer system and/or a local processor; and/or retrieved from one or more sensors such as a camera device to capture the second environment of the second computer system). For example, the one or more suggested routes are based on traffic information, weather information, user transportation preferences, recently traversed roadways and/or paths, frequently used roadways and/or paths, and/or other map information as described in method(s) 800, 1000, 1200, 1400, and/or 1600. In some embodiments, the first computer system continually monitors map information and/or contextual information for the remainder of the route and presents recommendations to (or optionally, automatically without user input) change the remainder of the route. In some embodiments, the first computer system transmits the one or more suggested routes to the second computer system such that the second computer system displays the one or more suggested routes to the second user of the second computer system. Providing one or more options that, when selected, causes the first computer system to provide navigation assistance using one or more suggested routes to the destination enhances interactions with the first computer system (e.g., by reducing the amount of time needed for the user of the computer system to perform route configuration operations), which reduces power usage and improves battery life of the computer system by enabling the user to use the computer system more quickly and efficiently.

In some embodiments, while displaying the view of the physical environment of the second computer system corresponding to the current location of the second computer system, the computer system displays, via the display generation component, instructions for navigating along the route from the current location of the second computer system to the destination, such as navigation instructions 1708e in FIG. 17B. For example, the first computer system optionally displays a user interface of a maps application or other application that includes turn-by-turn instructions for navigating along the route. In some embodiments, the user interface is a window or volume. In some embodiments, the user interface is displayed on a third computer system in communication with the first computer system, different from the first computer system. In some embodiments, the third computer system is at a same location of the first computer system. In some embodiments, the third computer system has one or more characteristics of the first computer system as described in method(s) 800, 1000, 1200, 1400, and/or 1600. For example, the third computer system is optionally a watch, tablet, phone, wearable computer system, or other computer system described in method(s) 800, 1000, 1200, 1400, and/or 1600. In some embodiments, the computer system displays the instructions automatically without detecting user input corresponding to a request to display the instructions. In some embodiments, the computer system displays the instructions in response to user input corresponding to the request to display the instructions. Displaying instructions for navigating along the route from the current location of the second computer system to the destination avoids additional interaction between the user and the first computer system associated with inputting navigation instructions, thereby reducing errors in the interaction between the user and the first computer system and reducing inputs needed to correct such errors.

In some embodiments, while displaying the instructions for navigating along the route, the computer system displays, via the display generation component, a selectable option that, when selected, causes the computer system to add the instructions as a supplemental map accessible via a map application, such as option 1750b of user interface element 1750a in FIG. 17H. In some embodiments, the computer system displays a primary map via the map application. In some embodiments, the primary map is a map that includes map information (e.g., geographic information, road or highway information, traffic information, point of interest information, building information, vegetation information and/or traffic rule signage information) for multiple geographic areas, optionally including the destination. In some embodiments, a supplemental map includes map information for a subset of the geographic areas for which the primary map includes map information. For example, in an instance when the primary map includes map information for twenty geographic areas, the supplemental map optionally includes map information for one of those geographic areas. In some embodiments, a supplemental map includes a map for a geographic area that includes the destination. In some embodiments, the map includes destination-specific information, such as the instructions for navigation along the route to the destination as described above, the one or more suggested routes to the destination as described above, the one or more visual indications of the annotations described above, and/or other map information described in methods method(s) 800, 1000, 1200, 1400, and/or 1600. In some embodiments, displaying instructions for navigation along the route includes displaying a route line overlaid on the map and/or the supplemental map described herein. In some embodiments, the destination-specific information includes parking information related to the destination, access codes related to the destination, or other information for navigating to the destination. In some embodiments, in response to and/or while the first computer system adds the instructions as a supplemental map, the computer system is configured to automatically (e.g., without user input) update the destination-specific information, such as the parking information, the access codes, the one or more suggested routes, the visual indications of annotations, or any other map information described herein. In some embodiments, after adding the instructions to the supplemental map, the first computer system has access to the instructions to display and/or make changes to the supplemental map. Adding the instructions as a supplemental map accessible via a map application avoids additional interaction between the user and the first computer system associated with recreating the instructions every time the first computer system receives a request for navigation instructions, thereby reducing errors in the interaction between the user and the first computer system and reducing inputs needed to correct such errors.

In some embodiments, in accordance with a determination of arrival of the second computer system at the destination of the route, the computer system displays, via the display generation component, an indication of the arrival of the second computer system at the destination, such as indication 1712 in FIG. 17C. In some embodiments, the first computer system determines arrival at the destination when the current location of the second computer system is within a predetermined distance (e.g., 15 meters, 30 meters, 90 meters, 150 meters, 300 meters, 900 meters, 1.5 kilometers, 2 kilometers, 2.5 kilometers, 3 kilometers, or 4 kilometers) from the destination. In some embodiments, the first computer system determines arrival of the second computer system at the destination upon receiving an indication from the second computer system of the arrival of the second computer system at the destination. For example, the second computer system optionally transmits a command, instruction, or notification to the first computer system that the second computer system has arrived at the destination. In some embodiments, upon receiving the command, the first computer system displays the indication of the arrival of the second computer system at the destination. In some embodiments, the indication is not displayed unless and until the first computer system receives the command from the second computer system. In some embodiments, the first computer system determines arrival of the second computer system while displaying the view of the physical environment of the second computer system corresponding to the current location of the second computer system and/or while displaying the navigation user interface element as described above. In some embodiments, the indication of the arrival of the second computer system at the destination includes an image and/or text indicating to the user of the first computer system that the second computer system has arrived at the destination. In some embodiments, the first computer system presents an audible alert and/or voice output indicating that the second computer system has arrived at the destination. In some embodiments, the indication is displayed for a predetermined amount of time (e.g., 10 seconds, 30 seconds, 60 seconds, 2 minutes, or 5 minutes) before the first computer system ceases to display the indication. In some embodiments, the first computer system detects user input corresponding to a request to remove the indication, and in response, the first computer system ceases to display the indication. Displaying an indication of the arrival of the second computer system at the destination enables a user of the first computer system to easily determine the second computer system's arrival at the destination, thereby reducing the need for subsequent inputs from the user to continually monitor for the second computer's arrival which reduces power usage and improves battery life of the first computer system by enabling the user to use the first computer system more quickly and efficiently.

In some embodiments, while displaying the view of the physical environment of the second computer system corresponding to the current location of the second computer system, in accordance with a determination of arrival of the second computer system at the destination of the route (e.g., as described above), the computer system terminates communication with the second computer system, such as, for example, terminating communication in response to selection of option 1702d in FIG. 17B and removes access to information associated with providing navigation assistance to the second computer system, such as indicated with content 1742a in FIG. 17G. For example, the first computer system optionally ends the communication session with the second computer system and revokes the second computer system's access to information associated with navigation assistance. In some embodiments, revoking access includes removing the second computer from a list of computer systems approved to access the information, disabling and/or removing access credentials of the second user of the second computer system, and/or blocking the second computer system from accessing the information. In some embodiments, removing access to information includes deleting any information associated with providing navigation assistance, such as building access codes, parking information, contact information, and/or any of the other information described above. In some embodiments, the information was provided and/or accessible to the second computer system from the first computer system via one or more communication channels, such as text messaging, chat, email, voice recording, video/telephony calling, document sharing, screen-sharing, AR/VR session, and/or any other means described above and/or in method(s) 800, 1000, 1200, 1400, and/or 1600. In some embodiments, removing access to information to the second computer system does not includes removing access to the first computer system. In some embodiments, and as described above, the first computer system provide an option that, when selected, causes the computer system to access the information via a supplemental map as described above. Terminating communication with the second computer system and removing access to information associated with providing navigation assistance to the second computer system in response to a determination of the second computer system's arrival at the destination ensures privacy (e.g., by not allowing the second computer system to access the navigation information) and avoids additional interaction between the user and the first computer system associated with removing access to the information, thereby reducing errors in the interaction between the user and the first computer system and reducing inputs needed to correct such errors.

It should be understood that the particular order in which the operations in methods 800, 1000, 1200, 1400, 1600, and/or 1800 have been described is merely exemplary and is not intended to indicate that the described order is the only order in which the operations could be performed. One of ordinary skill in the art would recognize various ways to reorder the operations described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, location data may be used to provide insights into the appearance condition of one or more user interface elements to be presented to the user, or may be used for determining relevant map-related content to be presented to the user.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1.-26. (canceled)

27. A method comprising:
at a computer system in communication with a display generation component and one or more input devices:
while displaying, via the display generation component, a user interface of a map application including a navigation user interface element representing a first physical area according to a first appearance condition, detecting, via the one or more input devices, an event; and
in response to detecting the event:
in accordance with a determination that one or more criteria are satisfied, including a criterion that is satisfied when the event indicates a change from displaying the navigation user interface element according to the first appearance condition to displaying the navigation user interface element according to a second appearance condition:
ceasing display of the navigation user interface element according to the first appearance condition; and
displaying the navigation user interface element according to the second appearance condition; and
in accordance with a determination that the one or more criteria are not satisfied, continuing to display the navigation user interface element according to the first appearance condition.

28. The method of claim 27, wherein:
the one or more criteria are not satisfied when the event indicates a first time of day corresponding to the first appearance condition; and
the one or more criteria include a requirement that the event indicates a second time of day, different from the first time of day, corresponding to the second appearance condition in order for the one or more criteria to be satisfied.

29. The method of claim 28, wherein satisfying the one or more criteria is based on a current time of day of a system virtual environment of the computer system.

30. The method of claim 28, wherein satisfying the one or more criteria is based on a current time of day at the computer system.

31. The method of claim 28, wherein satisfying the one or more criteria includes in accordance with a user-defined system appearance setting being a respective user-selected setting, displaying the navigation user interface element according to a third appearance condition.

32. The method of claim 27, wherein:
the one or more criteria are not satisfied when the event indicates a first weather condition while the computer system displays the navigation user interface element according to the first appearance condition; and
the one or more criteria include a requirement that the event indicates a second weather condition, different from the first weather condition while the computer system displays the navigation user interface element according to the first appearance condition in order for the one or more criteria to be satisfied.

33. The method of claim 32, further comprising:
in response to detecting the event:
in accordance with a determination that the event satisfies the one or more criteria, displaying, via the display generation component, a visual indication of the second weather condition.

34. The method of claim 33, wherein the visual indication of the second weather condition includes particle effects.

35. The method of claim 33, wherein the visual indication of the second weather condition includes virtual lighting effects.

36. The method of claim 33, wherein the visual indication of the second weather condition includes virtual atmospheric characteristics.

37. The method of claim 27, further comprising:
wherein displaying the navigation user interface element according to the first appearance condition includes presenting, via the display generation component, a representation of a physical environment of a user of the computer system with a first visual effect based on the first appearance condition; and
wherein displaying the navigation user interface element according to the second appearance condition includes presenting, via the display generation component, the representation of the physical environment of the user of the computer system with a second visual effect, different from the first visual effect, based on the second appearance condition.

38. The method of claim 37, further comprising:
while displaying the navigation user interface element according to the second appearance condition, detecting a user input, via the one or more inputs devices, that corresponds to a request to change a zoom level of the navigation user interface element; and in response to detecting the user input, in accordance with a determination that changing the zoom level of the navigation user interface element in accordance with the user input satisfies one or more second criteria:
displaying, via the display generation component, a second navigation user interface element different from the navigation user interface element, wherein the second navigation user interface element represents the first physical area; and
presenting the representation of the physical environment of the user of the computer system with the second visual effect based on the second appearance condition.

39. The method of claim 38, further comprising:
in response to detecting the user input, in accordance with a determination that changing the zoom level of the navigation user interface element in accordance with the user input does not satisfy the one or more second criteria:
displaying the navigation user interface element at a respective zoom level without displaying the second navigation user interface element; and
continuing to display the navigation user interface element according to a respective appearance condition.

40. The method of claim 37, further comprising:
in response to detecting the event:
in accordance with the determination that one or more second criteria are satisfied and independent of a zoom level of the navigation user interface element, presenting the representation of the physical environment of the user of the computer system with the second visual effect based on the second appearance condition.

41. The method of claim 37, wherein presenting the representation of the physical environment with a respective visual effect based on a respective appearance condition includes displaying, via the display generation component, a simulated lighting effect within a portion of the representation of the physical environment corresponding to the respective appearance condition.

42. The method of claim 37, wherein presenting the representation of the physical environment includes displaying, via the display generation component, a particle effect within a portion of the representation of the physical environment.

43. The method of claim 37, wherein displaying the representation of the physical environment includes displaying, via the display generation component, one or more simulated atmospheric characteristics within a portion of the representation of the physical environment.

44. The method of claim 27, further comprising:
while displaying the user interface including the navigation user interface element representing the first physical area according to a respective appearance condition, detecting, via the one or more input devices, a second event, different from the event; and in response to detecting the second event:
in accordance with a determination that one or more second criteria are satisfied, including a criterion that is satisfied when the second event indicates a change from displaying the navigation user interface element according to the respective appearance condition to displaying the navigation user interface element according to a third appearance condition, different from the first appearance condition and the second appearance condition:
ceasing display of the navigation user interface element according to the respective appearance condition; and
displaying the navigation user interface element according to the third appearance condition; and
in accordance with a determination that the one or more second criteria are not satisfied, continuing to display the navigation user interface element according to the respective appearance condition.

45. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the display generation component, a user interface of a map application including a navigation user interface element representing a first physical area according to a first appearance condition, detecting, via the one or more input devices, an event; and
in response to detecting the event:
in accordance with a determination that one or more criteria are satisfied, including a criterion that is satisfied when the event indicates a change from displaying the navigation user interface element according to the first appearance condition to displaying the navigation user interface element according to a second appearance condition:
ceasing display of the navigation user interface element according to the first appearance condition; and
displaying the navigation user interface element according to the second appearance condition; and
in accordance with a determination that the one or more criteria are not satisfied, continuing to display the navigation user interface element according to the first appearance condition.

46. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the display generation component, a user interface of a map application including a navigation user interface element representing a first physical area according to a first appearance condition, detecting, via the one or more input devices, an event; and
in response to detecting the event:
in accordance with a determination that one or more criteria are satisfied, including a criterion that is satisfied when the event indicates a change from displaying the navigation user interface element according to the first appearance condition to displaying the navigation user interface element according to a second appearance condition:
ceasing display of the navigation user interface element according to the first appearance condition; and
displaying the navigation user interface element according to the second appearance condition; and
in accordance with a determination that the one or more criteria are not satisfied, continuing to display the navigation user interface element according to the first appearance condition.

47.-117. (canceled)
